(19) United States
(12) Patent Application Publication
(10) Pub. No.: US 2023/0209538 A1
(43) Pub. Date: Jun. 29, 2023

(54) Unified Transmission Configuration Indicator State Indication

(71) Applicant: Comcast Cable Communications, LLC, Philadelphia, PA (US)

(72) Inventors: Ali Cagatay Cirik, Chantilly, VA (US); Hua Zhou, Vienna, VA (US); Esmael Hejazi Dinan, McLean, VA (US)

(21) Appl. No.: 18/147,908

(22) Filed: Dec. 29, 2022

Related U.S. Application Data
(60) Provisional application No. 63/294,708, filed on Dec. 29, 2021.
(60) Provisional application No. 63/294,705, filed on Dec. 29, 2021.
(60) Provisional application No. 63/294,711, filed on Dec. 29, 2021.
(60) Provisional application No. 63/294,716, filed on Dec. 29, 2021.

(51) Int. Cl. H04W 72/1268; H04W 72/231; H04W 16/28

(52) U.S. Cl. CPC H04W 72/1268; H04W 72/231; H04W 16/28

(57) ABSTRACT

A wireless device and a base station may use resources for wireless communications. One or more unified transmission configuration indicator (TCI) state(s) may be indicated using a parameter, field, message, and/or signaling. The unified TCI state(s) may be associated with physical uplink control channel (PUCCH) resource (or a PUCCH resource group). The unified TCI state(s) may be applied for communications, via the PUCCH resource, between the wireless device and the base station for which at least two unified TCI states may be activated, without requiring additional signaling to configure parameters for each communication.

### CROSS-REFERENCE TO RELATED APPLICATIONS

This application claims the benefit of U.S. Provisional Application No. 63/294,708, filed on Dec. 29, 2021; U.S. Provisional Application No. 63/294,705, filed on Dec. 29, 2021; U.S. Provisional Application No. 63/294,711, filed on Dec. 29, 2021; and U.S. Provisional Application No. 63/294,716, filed on Dec. 29, 2021. Each of the above-referenced applications is hereby incorporated by reference in its entirety.

### BACKGROUND

Wireless communications use configuration parameters to indicate resources for communications between devices. A transmission configuration indicator (TCI) state parameter is used to indicate a beam for transmission or reception.

### SUMMARY

The following summary presents a simplified summary of certain features. The summary is not an extensive overview and is not intended to identify key or critical elements.

A wireless device and a base station may use resources for wireless communications. A TCI state may be used to align one or more resources for wireless communications between the wireless device and the base station. For example, a TCI state may correspond to one or more beams, spatial transmission and/or reception filters, and/or precoders that may be used by the wireless device and the base station for alignment of wireless communications. At least some wireless devices and/or base stations may use more than one transmission and reception point (TRP) and/or other transmission/reception device(s) (e.g., antenna panels, nodes, etc.), at least some of which may be configured with different wireless resources, which may lead to misalignment between such wireless device(s) and base station(s) for at least some wireless communications. For example, one or more reference signals (e.g., sounding reference signal(s) (SRS), channel state information reference signal(s) (CSI-RS), etc.), control signals and/or channels (e.g., physical uplink control channel (PUCCH) resource signal(s), physical downlink control channel (PDCCH) signal, etc.), data signals and/or channels (e.g., physical downlink shared channel (PDSCH), physical uplink shared channel (PUSCH), etc.), configurations (e.g., using one or more resources such as control resource set(s) (CORESET(s))), and/or other signal(s), channel(s), and/or resource(s) may be used for transmission and/or reception by a first device (e.g., wireless device/base station) using a first TCI state, but it may be unclear to a second device (e.g., base station/wireless device) whether the first TCI state or a second TCI state (or other TCI state) is to be used for the corresponding reception and/or for the corresponding transmission (e.g., if at least two TCI states are activated). For example, a transmitting device may use a first beam to transmit a first signal in a particular direction, but the intended receiving device may be monitoring a second beam for signals transmitted from a different direction, such that the first signal may not be successfully received. As described herein, a parameter (e.g., configuration parameter), field (e.g., unified TCI state index), configuration (e.g., single frequency network (SFN) configuration), message (e.g., downlink control information (DCI), medium access control (MAC)-control element (CE), etc.), and/or any signaling may be used to indicate a unified TCI state for application by both transmitting and receiving devices (e.g., wireless device and base station). The unified TCI state may be applied to one or more signal(s), channels, configurations, and/or resources such that a transmission and a corresponding reception may both use the same TCI state(s) which may result in improved alignment of wireless communications, and which may in turn provide advantages such as reduced retransmissions, reduced overhead signaling, reduced latency, and/or increased efficiency for wireless communications.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1A and FIG. 1B show example communication networks.

FIG. 2A shows an example user plane.

FIG. 2B shows an example control plane configuration.

FIG. 3 shows example of protocol layers.

FIG. 4A shows an example downlink data flow for a user plane configuration.

FIG. 4B shows an example format of a Medium Access Control (MAC) subheader in a MAC Protocol Data Unit (PDU).

FIG. 5A shows an example mapping for downlink channels.

FIG. 5B shows an example mapping for uplink channels.

FIG. 6 shows example radio resource control (RRC) states and RRC state transitions.

FIG. 7 shows an example configuration of a frame.

FIG. 8 shows an example resource configuration of one or more carriers.

FIG. 9 shows an example configuration of bandwidth parts (BWPs).

FIG. 10A shows example carrier aggregation configurations based on component carriers.

FIG. 10B shows example group of cells.

FIG. 11A shows an example mapping of one or more synchronization signal/physical broadcast channel (SS/PBCH) blocks.

FIG. 11B shows an example mapping of one or more channel state information reference signals (CSI-RSs).

FIG. 12A shows examples of downlink beam management procedures.

FIG. 12B shows examples of uplink beam management procedures.

FIG. 13A shows an example four-step random access procedure.

FIG. 13B shows an example two-step random access procedure.

FIG. 13C shows an example two-step random access procedure.

FIG. 14A shows an example of control resource set (CORESET) configurations.

FIG. 14B shows an example of a control channel element to resource element group (CCE-to-REG) mapping.

FIG. 15A shows an example of communications between a wireless device and a base station.

FIG. 15B shows example elements of a computing device that may be used to implement any of the various devices described herein

FIG. 16A, FIG. 16B, FIG. 16C, and FIG. 16D show examples of uplink and downlink signal transmission.

FIG. 17 shows an example TCI state update.

FIG. 18A and FIG. 18B show examples of parameters.

FIG. 19A and FIG. 19B show examples of parameters.

FIG. 20A and FIG. 20B show example methods using an indication of a TCI state.

FIG. 21A and FIG. 21B show examples of activation commands.

FIG. 22 shows an example using a TCI field.

FIG. 23 and FIG. 23B show examples of parameters.

FIG. 24A and FIG. 24B show example methods using an indication of a TCI state.

FIG. 25A and FIG. 25B show examples of activation commands.

FIG. 26A and FIG. 26B show examples of parameters.

FIG. 27A, FIG. 27B, and FIG. 27C show example methods using an indication of a TCI state.

FIG. 28 shows an example activation command.

FIG. 29A and FIG. 29B show examples of a field and associated TCI state indication.

FIG. 30A and FIG. 30B show example methods using an indication of a TCI state.

### DETAILED DESCRIPTION

The accompanying drawings and descriptions provide examples. It is to be understood that the examples shown in the drawings and/or described are non-exclusive, and that features shown and described may be practiced in other examples. Examples are provided for operation of wireless communication systems, which may be used in the technical field of multicarrier communication systems. More particularly, the technology disclosed herein may relate to wireless communication exposure detection and/or reporting.

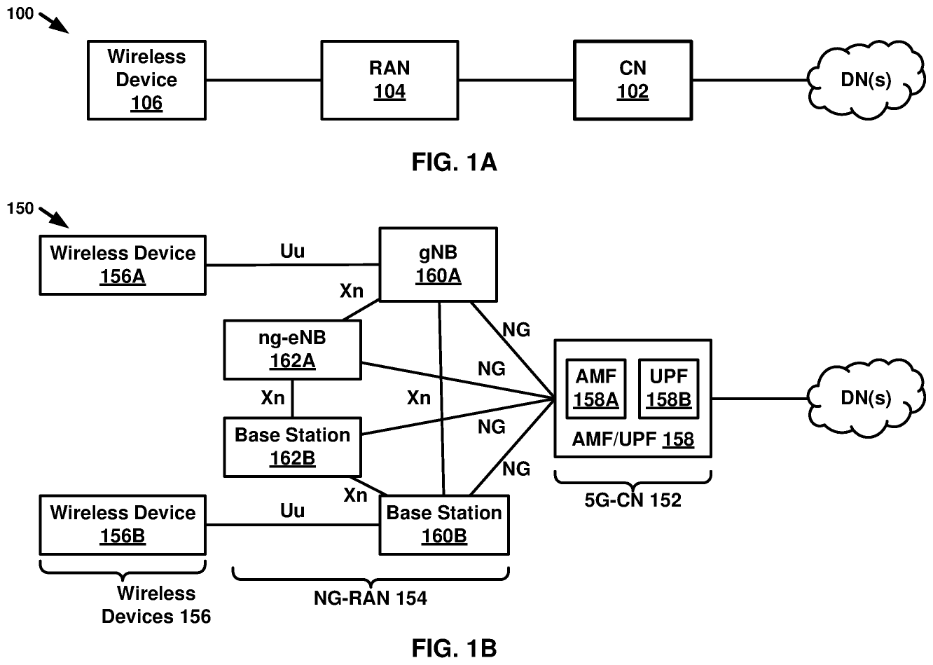

FIG. 1A shows an example communication network 100. The communication network 100 may comprise a mobile communication network). The communication network 100 may comprise, for example, a public land mobile network (PLMN) operated/managed/run by a network operator. The communication network 100 may comprise one or more of a core network (CN) 102, a radio access network (RAN) 104, and/or a wireless device 106. The communication network 100 may comprise, and/or a device within the communication network 100 may communicate with (e.g., via CN 102), one or more data networks (DN(s)) 108. The wireless device 106 may communicate with one or more DNs 108, such as public DNs (e.g., the Internet), private DNs, and/or intra-operator DNs. The wireless device 106 may communicate with the one or more DNs 108 via the RAN 104 and/or via the CN 102. The CN 102 may provide/configure the wireless device 106 with one or more interfaces to the one or more DNs 108. As part of the interface functionality, the CN 102 may set up end-to-end connections between the wireless device 106 and the one or more DNs 108, authenticate the wireless device 106, provide/configure charging functionality, etc.

The wireless device 106 may communicate with the RAN 104 via radio communications over an air interface. The RAN 104 may communicate with the CN 102 via various communications (e.g., wired communications and/or wireless communications). The wireless device 106 may establish a connection with the CN 102 via the RAN 104. The RAN 104 may provide/configure scheduling, radio resource management, and/or retransmission protocols, for example, as part of the radio communications. The communication direction from the RAN 104 to the wireless device 106 over/via the air interface may be referred to as the downlink and/or downlink communication direction. The communication direction from the wireless device 106 to the RAN 104 over/via the air interface may be referred to as the uplink and/or uplink communication direction. Downlink transmissions may be separated and/or distinguished from uplink transmissions, for example, based on at least one of: frequency division duplexing (FDD), time-division duplexing (TDD), any other duplexing schemes, and/or one or more combinations thereof.

As used throughout, the term “wireless device” may comprise one or more of: a mobile device, a fixed (e.g., non-mobile) device for which wireless communication is configured or usable, a computing device, a node, a device capable of wirelessly communicating, or any other device capable of sending and/or receiving signals. As non-limiting examples, a wireless device may comprise, for example: a telephone, a cellular phone, a Wi-Fi phone, a smartphone, a tablet, a computer, a laptop, a sensor, a meter, a wearable device, an Internet of Things (IoT) device, a hotspot, a cellular repeater, a vehicle road side unit (RSU), a relay node, an automobile, a wireless user device (e.g., user equipment (UE), a user terminal (UT), etc.), an access terminal (AT), a mobile station, a handset, a wireless transmit and receive unit (WTRU), a wireless communication device, and/or any combination thereof.

The RAN 104 may comprise one or more base stations (not shown). As used throughout, the term “base station” may comprise one or more of: a base station, a node, a Node B (NB), an evolved NodeB (eNB), a gNB, an ng-eNB, a relay node (e.g., an integrated access and backhaul (IAB) node), a donor node (e.g., a donor eNB, a donor gNB, etc.), an access point (e.g., a Wi-Fi access point), a transmission and reception point (TRP), a computing device, a device capable of wirelessly communicating, or any other device capable of sending and/or receiving signals. A base station may comprise one or more of each element listed above. For example, a base station may comprise one or more TRPs. As other non-limiting examples, a base station may comprise for example, one or more of: a Node B (e.g., associated with Universal Mobile Telecommunications System (UMTS) and/or third-generation (3G) standards), an Evolved Node B (eNB) (e.g., associated with Evolved-Universal Terrestrial Radio Access (E-UTRA) and/or fourth-generation (4G) standards), a remote radio head (RRH), a baseband processing unit coupled to one or more remote radio heads (RRHs), a repeater node or relay node used to extend the coverage area of a donor node, a Next Generation Evolved Node B (ng-eNB), a Generation Node B (gNB) (e.g., associated with NR and/or fifth-generation (5G) standards), an access point (AP) (e.g., associated with, for example, Wi-Fi or any other suitable wireless communication standard), any other generation base station, and/or any combination thereof. A base station may comprise one or more devices, such as at least one base station central device (e.g., a gNB Central Unit (gNB-CU)) and at least one base station distributed device (e.g., a gNB Distributed Unit (gNB-DU)).

A base station (e.g., in the RAN 104) may comprise one or more sets of antennas for communicating with the wireless device 106 wirelessly (e.g., via an over the air interface). One or more base stations may comprise sets (e.g., three sets or any other quantity of sets) of antennas to respectively control multiple cells or sectors (e.g., three cells, three sectors, any other quantity of cells, or any other quantity of sectors). The size of a cell may be determined by a range at which a receiver (e.g., a base station receiver) may successfully receive transmissions from a transmitter (e.g., a wireless device transmitter) operating in the cell. One or more cells of base stations (e.g., by alone or in combination with other cells) may provide/configure a radio coverage to the wireless device 106 over a wide geographic area to support wireless device mobility. A base station comprising three sectors (e.g., or n-sector, where n refers to any quantity n) may be referred to as a three-sector site (e.g., or an n-sector site) or a three-sector base station (e.g., an n-sector base station).

One or more base stations (e.g., in the RAN 104) may be implemented as a sectored site with more or less than three sectors. One or more base stations of the RAN 104 may be implemented as an access point, as a baseband processing device/unit coupled to several RRHs, and/or as a repeater or relay node used to extend the coverage area of a node (e.g., a donor node). A baseband processing device/unit coupled to RRHs may be part of a centralized or cloud RAN architecture, for example, where the baseband processing device/unit may be centralized in a pool of baseband processing devices/units or virtualized. A repeater node may amplify and send (e.g., transmit, retransmit, rebroadcast, etc.) a radio signal received from a donor node. A relay node may perform the substantially the same/similar functions as a repeater node. The relay node may decode the radio signal received from the donor node, for example, to remove noise before amplifying and sending the radio signal.

The RAN 104 may be deployed as a homogenous network of base stations (e.g., macrocell base stations) that have similar antenna patterns and/or similar high-level transmit powers. The RAN 104 may be deployed as a heterogeneous network of base stations (e.g., different base stations that have different antenna patterns). In heterogeneous networks, small cell base stations may be used to provide/configure small coverage areas, for example, coverage areas that overlap with comparatively larger coverage areas provided/configured by other base stations (e.g., macrocell base stations). The small coverage areas may be provided/configured in areas with high data traffic (or so-called “hotspots”) or in areas with a weak macrocell coverage. Examples of small cell base stations may comprise, in order of decreasing coverage area, microcell base stations, picocell base stations, and femtocell base stations or home base stations.

Examples described herein may be used in a variety of types of communications. For example, communications may be in accordance with the Third-Generation Partnership Project (3GPP) (e.g., one or more network elements similar to those of the communication network 100), communications in accordance with Institute of Electrical and Electronics Engineers (IEEE), communications in accordance with International Telecommunication Union (ITU), communications in accordance with International Organization for Standardization (ISO), etc. The 3GPP has produced specifications for multiple generations of mobile networks: a 3G network known as UMTS, a 4G network known as Long-Term Evolution (LTE) and LTE Advanced (LTE-A), and a 5G network known as 5G System (5GS) and NR system. 3GPP may produce specifications for additional generations of communication networks (e.g., 6G and/or any other generation of communication network). Examples may be described with reference to one or more elements (e.g., the RAN) of a 3GPP 5G network, referred to as a next-generation RAN (NG-RAN), or any other communication network, such as a 3GPP network and/or a non-3GPP network. Examples described herein may be applicable to other communication networks, such as 3G and/or 4G networks, and communication networks that may not yet be finalized/specified (e.g., a 3GPP 6G network), satellite communication networks, and/or any other communication network. NG-RAN implements and updates 5G radio access technology referred to as NR and may be provisioned to implement 4G radio access technology and/or other radio access technologies, such as other 3GPP and/or non-3GPP radio access technologies.

FIG. 1B shows an example communication network 150. The communication network may comprise a mobile communication network. The communication network 150 may comprise, for example, a PLMN operated/managed/run by a network operator. The communication network 150 may comprise one or more of: a CN 152 (e.g., a 5G core network (5G-CN)), a RAN 154 (e.g., an NG-RAN), and/or wireless devices 156A and 156B (collectively wireless device(s) 156). The communication network 150 may comprise, and/or a device within the communication network 150 may communicate with (e.g., via CN 152), one or more data networks (DN(s)) 170. These components may be implemented and operate in substantially the same or similar manner as corresponding components described with respect to FIG. 1A.

The CN 152 (e.g., 5G-CN) may provide/configure the wireless device(s) 156 with one or more interfaces to one or more DNs 170, such as public DNs (e.g., the Internet), private DNs, and/or intra-operator DNs. As part of the interface functionality, the CN 152 (e.g., 5G-CN) may set up end-to-end connections between the wireless device(s) 156 and the one or more DNs, authenticate the wireless device(s) 156, and/or provide/configure charging functionality. The CN 152 (e.g., the 5G-CN) may be a service-based architecture, which may differ from other CNs (e.g., such as a 3GPP 4G CN). The architecture of nodes of the CN 152 (e.g., 5G-CN) may be defined as network functions that offer services via interfaces to other network functions. The network functions of the CN 152 (e.g., 5G CN) may be implemented in several ways, for example, as network elements on dedicated or shared hardware, as software instances running on dedicated or shared hardware, and/or as virtualized functions instantiated on a platform (e.g., a cloud-based platform).

The CN 152 (e.g., 5G-CN) may comprise an Access and Mobility Management Function (AMF) device 158A and/or a User Plane Function (UPF) device 158B, which may be separate components or one component AMF/UPF device 158. The UPF device 158B may serve as a gateway between a RAN 154 (e.g., NG-RAN) and the one or more DNs 170. The UPF device 158B may perform functions, such as: packet routing and forwarding, packet inspection and user plane policy rule enforcement, traffic usage reporting, uplink classification to support routing of traffic flows to the one or more DNs 170, quality of service (QoS) handling for the user plane (e.g., packet filtering, gating, uplink/downlink rate enforcement, and uplink traffic verification), downlink packet buffering, and/or downlink data notification triggering. The UPF device 158B may serve as an anchor point for intra-/inter-Radio Access Technology (RAT) mobility, an external protocol (or packet) data unit (PDU) session point of interconnect to the one or more DNs, and/or a branching point to support a multi-homed PDU session. The wireless device(s) 156 may be configured to receive services via a PDU session, which may be a logical connection between a wireless device and a DN.

The AMF device 158A may perform functions, such as: Non-Access Stratum (NAS) signaling termination, NAS signaling security, Access Stratum (AS) security control, inter-CN node signaling for mobility between access networks (e.g., 3GPP access networks and/or non-3GPP networks), idle mode wireless device reachability (e.g., idle mode UE reachability for control and execution of paging retransmission), registration area management, intra-system and inter-system mobility support, access authentication, access authorization including checking of roaming rights, mobility management control (e.g., subscription and policies), network slicing support, and/or session management function (SMF) selection. NAS may refer to the functionality operating between a CN and a wireless device, and AS may refer to the functionality operating between a wireless device and a RAN.

The CN 152 (e.g., 5G-CN) may comprise one or more additional network functions that may not be shown in FIG. 1B. The CN 152 (e.g., 5G-CN) may comprise one or more devices implementing at least one of: a Session Management Function (SMF), an NR Repository Function (NRF), a Policy Control Function (PCF), a Network Exposure Function (NEF), a Unified Data Management (UDM), an Application Function (AF), an Authentication Server Function (AUSF), and/or any other function.

The RAN 154 (e.g., NG-RAN) may communicate with the wireless device(s) 156 via radio communications (e.g., an over the air interface). The wireless device(s) 156 may communicate with the CN 152 via the RAN 154. The RAN 154 (e.g., NG-RAN) may comprise one or more first-type base stations (e.g., gNBs comprising a gNB 160A and a gNB 160B (collectively gNBs 160)) and/or one or more second-type base stations (e.g., ng eNBs comprising an ng-eNB 162A and an ng-eNB 162B (collectively ng eNBs 162)). The RAN 154 may comprise one or more of any quantity of types of base station. The gNBs 160 and ng eNBs 162 may be referred to as base stations. The base stations (e.g., the gNBs 160 and ng eNBs 162) may comprise one or more sets of antennas for communicating with the wireless device(s) 156 wirelessly (e.g., an over an air interface). One or more base stations (e.g., the gNBs 160 and/or the ng eNBs 162) may comprise multiple sets of antennas to respectively control multiple cells (or sectors). The cells of the base stations (e.g., the gNBs 160 and the ng-eNBs 162) may provide a radio coverage to the wireless device(s) 156 over a wide geographic area to support wireless device mobility.

The base stations (e.g., the gNBs 160 and/or the ng-eNBs 162) may be connected to the CN 152 (e.g., 5G CN) via a first interface (e.g., an NG interface) and to other base stations via a second interface (e.g., an Xn interface). The NG and Xn interfaces may be established using direct physical connections and/or indirect connections over an underlying transport network, such as an internet protocol (IP) transport network. The base stations (e.g., the gNBs 160 and/or the ng-eNBs 162) may communicate with the wireless device(s) 156 via a third interface (e.g., a Uu interface). A base station (e.g., the gNB 160A) may communicate with the wireless device 156A via a Uu interface. The NG, Xn, and Uu interfaces may be associated with a protocol stack. The protocol stacks associated with the interfaces may be used by the network elements shown in FIG. 1B to exchange data and signaling messages. The protocol stacks may comprise two planes: a user plane and a control plane. Any other quantity of planes may be used (e.g., in a protocol stack). The user plane may handle data of interest to a user. The control plane may handle signaling messages of interest to the network elements.

One or more base stations (e.g., the gNBs 160 and/or the ng-eNBs 162) may communicate with one or more AMF/UPF devices, such as the AMF/UPF 158, via one or more interfaces (e.g., NG interfaces). A base station (e.g., the gNB 160A) may be in communication with, and/or connected to, the UPF 158B of the AMF/UPF 158 via an NG-User plane (NG-U) interface. The NG-U interface may provide/perform delivery (e.g., non-guaranteed delivery) of user plane PDUs between a base station (e.g., the gNB 160A) and a UPF device (e.g., the UPF 158B). The base station (e.g., the gNB 160A) may be in communication with, and/or connected to, an AMF device (e.g., the AMF 158A) via an NG-Control plane (NG-C) interface. The NG-C interface may provide/perform, for example, NG interface management, wireless device context management (e.g., UE context management), wireless device mobility management (e.g., UE mobility management), transport of NAS messages, paging, PDU session management, configuration transfer, and/or warning message transmission.

A wireless device may access the base station, via an interface (e.g., Uu interface), for the user plane configuration and the control plane configuration. The base stations (e.g., gNBs 160) may provide user plane and control plane protocol terminations towards the wireless device(s) 156 via the Uu interface. A base station (e.g., the gNB 160A) may provide user plane and control plane protocol terminations toward the wireless device 156A over a Uu interface associated with a first protocol stack. A base station (e.g., the ng-eNBs 162) may provide Evolved UMTS Terrestrial Radio Access (E UTRA) user plane and control plane protocol terminations towards the wireless device(s) 156 via a Uu interface (e.g., where E UTRA may refer to the 3GPP 4G radio-access technology). A base station (e.g., the ng-eNB 162B) may provide E UTRA user plane and control plane protocol terminations towards the wireless device 156B via a Uu interface associated with a second protocol stack. The user plane and control plane protocol terminations may comprise, for example, NR user plane and control plane protocol terminations, 4G user plane and control plane protocol terminations, etc.

The CN 152 (e.g., 5G-CN) may be configured to handle one or more radio accesses (e.g., NR, 4G, and/or any other radio accesses). It may also be possible for an NR network/device (or any first network/device) to connect to a 4G core network/device (or any second network/device) in a non-standalone mode (e.g., non-standalone operation). In a non-standalone mode/operation, a 4G core network may be used to provide (or at least support) control-plane functionality (e.g., initial access, mobility, and/or paging). Although only one AMF/UPF 158 is shown in FIG. 1B, one or more base stations (e.g., one or more gNBs and/or one or more ng-eNBs) may be connected to multiple AMF/UPF nodes, for example, to provide redundancy and/or to load share across the multiple AMF/UPF nodes.

An interface (e.g., Uu, Xn, and/or NG interfaces) between network elements (e.g., the network elements shown in FIG. 1B) may be associated with a protocol stack that the network elements may use to exchange data and signaling messages. A protocol stack may comprise two planes: a user plane and a control plane. Any other quantity of planes may be used (e.g., in a protocol stack). The user plane may handle data associated with a user (e.g., data of interest to a user). The control plane may handle data associated with one or more network elements (e.g., signaling messages of interest to the network elements).

The communication network 100 in FIG. 1A and/or the communication network 150 in FIG. 1B may comprise any quantity/number and/or type of devices, such as, for example, computing devices, wireless devices, mobile devices, handsets, tablets, laptops, internet of things (IoT) devices, hotspots, cellular repeaters, computing devices, and/or, more generally, user equipment (e.g., UE). Although one or more of the above types of devices may be referenced herein (e.g., UE, wireless device, computing device, etc.), it should be understood that any device herein may comprise any one or more of the above types of devices or similar devices. The communication network, and any other network referenced herein, may comprise an LTE network, a 5G network, a satellite network, and/or any other network for wireless communications (e.g., any 3GPP network and/or any non-3GPP network). Apparatuses, systems, and/or methods described herein may generally be described as implemented on one or more devices (e.g., wireless device, base station, eNB, gNB, computing device, etc.), in one or more networks, but it will be understood that one or more features and steps may be implemented on any device and/or in any network.

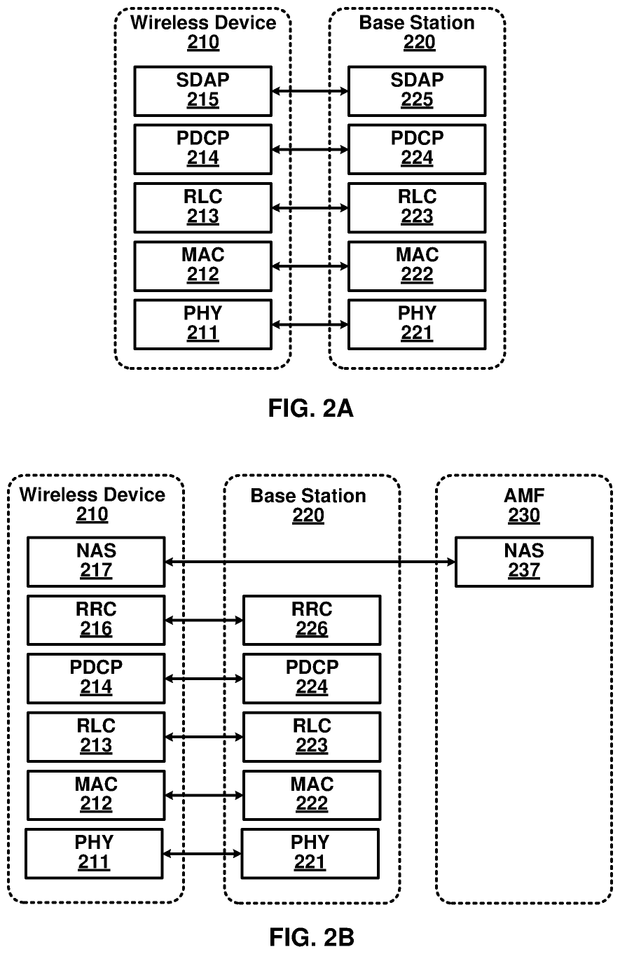

FIG. 2A shows an example user plane configuration. The user plane configuration may comprise, for example, an NR user plane protocol stack. FIG. 2B shows an example control plane configuration. The control plane configuration may comprise, for example, an NR control plane protocol stack. One or more of the user plane configuration and/or the control plane configuration may use a Uu interface that may be between a wireless device 210 and a base station 220. The protocol stacks shown in FIG. 2A and FIG. 2B may be substantially the same or similar to those used for the Uu interface between, for example, the wireless device 156A and the base station 160A shown in FIG. 1B.

A user plane configuration (e.g., an NR user plane protocol stack) may comprise multiple layers (e.g., five layers or any other quantity of layers) implemented in the wireless device 210 and the base station 220 (e.g., as shown in FIG. 2A). At the bottom of the protocol stack, physical layers (PHYs) 211 and 221 may provide transport services to the higher layers of the protocol stack and may correspond to layer 1 of the Open Systems Interconnection (OSI) model. The protocol layers above PHY 211 may comprise a medium access control layer (MAC) 212, a radio link control layer (RLC) 213, a packet data convergence protocol layer (PDCP) 214, and/or a service data application protocol layer (SDAP) 215. The protocol layers above PHY 221 may comprise a medium access control layer (MAC) 222, a radio link control layer (RLC) 223, a packet data convergence protocol layer (PDCP) 224, and/or a service data application protocol layer (SDAP) 225. One or more of the four protocol layers above PHY 211 may correspond to layer 2, or the data link layer, of the OSI model. One or more of the four protocol layers above PHY 221 may correspond to layer 2, or the data link layer, of the OSI model.

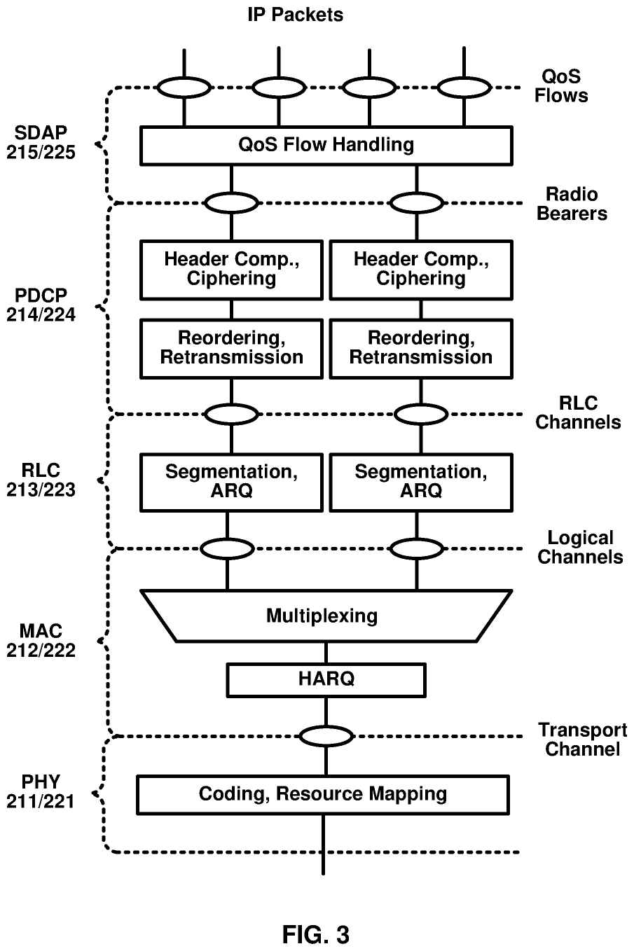

FIG. 3 shows an example of protocol layers. The protocol layers may comprise, for example, protocol layers of the NR user plane protocol stack. One or more services may be provided between protocol layers. SDAPs (e.g., SDAPS 215 and 225 shown in FIG. 2A and FIG. 3) may perform Quality of Service (QoS) flow handling. A wireless device (e.g., the wireless devices 106, 156A, 156B, and 210) may receive services through/via a PDU session, which may be a logical connection between the wireless device and a DN. The PDU session may have one or more QoS flows 310. A UPF (e.g., the UPF 158B) of a CN may map IP packets to the one or more QoS flows of the PDU session, for example, based on one or more QoS requirements (e.g., in terms of delay, data rate, error rate, and/or any other quality/service requirement). The SDAPs 215 and 225 may perform mapping/de-mapping between the one or more QoS flows 310 and one or more radio bearers 320 (e.g., data radio bearers). The mapping/de-mapping between the one or more QoS flows 310 and the radio bearers 320 may be determined by the SDAP 225 of the base station 220. The SDAP 215 of the wireless device 210 may be informed of the mapping between the QoS flows 310 and the radio bearers 320 via reflective mapping and/or control signaling received from the base station 220. For reflective mapping, the SDAP 225 of the base station 220 may mark the downlink packets with a QoS flow indicator (QFI), which may be monitored/detected/identified/indicated/observed by the SDAP 215 of the wireless device 210 to determine the mapping/de-mapping between the one or more QoS flows 310 and the radio bearers 320.

PDCPs (e.g., the PDCPs 214 and 224 shown in FIG. 2A and FIG. 3) may perform header compression/decompression, for example, to reduce the amount of data that may need to be transmitted (e.g., sent) over the air interface, ciphering/deciphering to prevent unauthorized decoding of data transmitted (e.g., sent) over the air interface, and/or integrity protection (e.g., to ensure control messages originate from intended sources). The PDCPs 214 and 224 may perform retransmissions of undelivered packets, in-sequence delivery and reordering of packets, and/or removal of packets received in duplicate due to, for example, a handover (e.g., an intra-gNB handover). The PDCPs 214 and 224 may perform packet duplication, for example, to improve the likelihood of the packet being received. A receiver may receive the packet in duplicate and may remove any duplicate packets. Packet duplication may be useful for certain services, such as services that require high reliability.

The PDCP layers (e.g., PDCPs 214 and 224) may perform mapping/de-mapping between a split radio bearer and RLC channels (e.g., RLC channels 330) (e.g., in a dual connectivity scenario/configuration). Dual connectivity may refer to a technique that allows a wireless device to communicate with multiple cells (e.g., two cells) or, more generally, multiple cell groups comprising: a master cell group (MCG) and a secondary cell group (SCG). A split bearer may be configured and/or used, for example, if a single radio bearer (e.g., such as one of the radio bearers provided/configured by the PDCPs 214 and 224 as a service to the SDAPs 215 and 225) is handled by cell groups in dual connectivity. The PDCPs 214 and 224 may map/de-map between the split radio bearer and RLC channels 330 belonging to the cell groups.

RLC layers (e.g., RLCs 213 and 223) may perform segmentation, retransmission via Automatic Repeat Request (ARQ), and/or removal of duplicate data units received from MAC layers (e.g., MACs 212 and 222, respectively). The RLC layers (e.g., RLCs 213 and 223) may support multiple transmission modes (e.g., three transmission modes: transparent mode (TM); unacknowledged mode (UM); and acknowledged mode (AM)). The RLC layers may perform one or more of the noted functions, for example, based on the transmission mode an RLC layer is operating. The RLC configuration may be per logical channel. The RLC configuration may not depend on numerologies and/or Transmission Time Interval (TTI) durations (or other durations). The RLC layers (e.g., RLCs 213 and 223) may provide/configure RLC channels as a service to the PDCP layers (e.g., PDCPs 214 and 224, respectively), such as shown in FIG. 3.

The MAC layers (e.g., MACs 212 and 222) may perform multiplexing/demultiplexing of logical channels and/or mapping between logical channels and transport channels. The multiplexing/demultiplexing may comprise multiplexing/demultiplexing of data units/data portions, belonging to the one or more logical channels, into/from Transport Blocks (TBs) delivered to/from the PHY layers (e.g., PHYs 211 and 221, respectively). The MAC layer of a base station (e.g., MAC 222) may be configured to perform scheduling, scheduling information reporting, and/or priority handling between wireless devices via dynamic scheduling. Scheduling may be performed by a base station (e.g., the base station 220 at the MAC 222) for downlink/or and uplink. The MAC layers (e.g., MACs 212 and 222) may be configured to perform error correction(s) via Hybrid Automatic Repeat Request (HARQ) (e.g., one HARQ entity per carrier in case of Carrier Aggregation (CA)), priority handling between logical channels of the wireless device 210 via logical channel prioritization and/or padding. The MAC layers (e.g., MACs 212 and 222) may support one or more numerologies and/or transmission timings. Mapping restrictions in a logical channel prioritization may control which numerology and/or transmission timing a logical channel may use. The MAC layers (e.g., the MACs 212 and 222) may provide/configure logical channels 340 as a service to the RLC layers (e.g., the RLCs 213 and 223).

The PHY layers (e.g., PHYs 211 and 221) may perform mapping of transport channels to physical channels and/or digital and analog signal processing functions, for example, for sending and/or receiving information (e.g., via an over the air interface). The digital and/or analog signal processing functions may comprise, for example, coding/decoding and/or modulation/demodulation. The PHY layers (e.g., PHYs 211 and 221) may perform multi-antenna mapping. The PHY layers (e.g., the PHYs 211 and 221) may provide/configure one or more transport channels (e.g., transport channels 350) as a service to the MAC layers (e.g., the MACs 212 and 222, respectively).

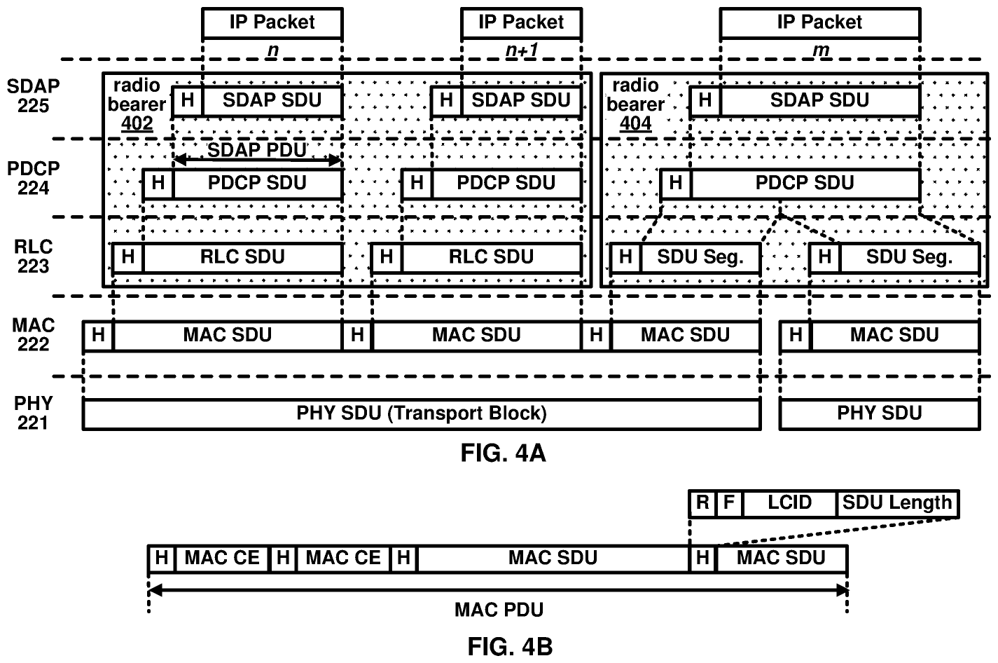

FIG. 4A shows an example downlink data flow for a user plane configuration. The user plane configuration may comprise, for example, the NR user plane protocol stack shown in FIG. 2A. One or more TBs may be generated, for example, based on a data flow via a user plane protocol stack. As shown in FIG. 4A, a downlink data flow of three IP packets (n, n+1, and m) via the NR user plane protocol stack may generate two TBs (e.g., at the base station 220). An uplink data flow via the NR user plane protocol stack may be similar to the downlink data flow shown in FIG. 4A. The three IP packets (n, n+1, and m) may be determined from the two TBs, for example, based on the uplink data flow via an NR user plane protocol stack. A first quantity of packets (e.g., three or any other quantity) may be determined from a second quantity of TBs (e.g., two or another quantity).

The downlink data flow may begin, for example, if the SDAP 225 receives the three IP packets (or other quantity of IP packets) from one or more QoS flows and maps the three packets (or other quantity of packets) to radio bearers (e.g., radio bearers 402 and 404). The SDAP 225 may map the IP packets n and n+1 to a first radio bearer 402 and map the IP packet m to a second radio bearer 404. An SDAP header (labeled with “H” preceding each SDAP SDU shown in FIG. 4A) may be added to an IP packet to generate an SDAP PDU, which may be referred to as a PDCP SDU. The data unit transferred from/to a higher protocol layer may be referred to as a service data unit (SDU) of the lower protocol layer, and the data unit transferred to/from a lower protocol layer may be referred to as a protocol data unit (PDU) of the higher protocol layer. As shown in FIG. 4A, the data unit from the SDAP 225 may be an SDU of lower protocol layer PDCP 224 (e.g., PDCP SDU) and may be a PDU of the SDAP 225 (e.g., SDAP PDU).

Each protocol layer (e.g., protocol layers shown in FIG. 4A) or at least some protocol layers may: perform its own function(s) (e.g., one or more functions of each protocol layer described with respect to FIG. 3), add a corresponding header, and/or forward a respective output to the next lower layer (e.g., its respective lower layer). The PDCP 224 may perform an IP-header compression and/or ciphering. The PDCP 224 may forward its output (e.g., a PDCP PDU, which is an RLC SDU) to the RLC 223. The RLC 223 may optionally perform segmentation (e.g., as shown for IP packet m in FIG. 4A). The RLC 223 may forward its outputs (e.g., two RLC PDUs, which are two MAC SDUs, generated by adding respective subheaders to two SDU segments (SDU Segs)) to the MAC 222. The MAC 222 may multiplex a number of RLC PDUs (MAC SDUs). The MAC 222 may attach a MAC subheader to an RLC PDU (MAC SDU) to form a TB. The MAC subheaders may be distributed across the MAC PDU (e.g., in an NR configuration as shown in FIG. 4A). The MAC subheaders may be entirely located at the beginning of a MAC PDU (e.g., in an LTE configuration). The NR MAC PDU structure may reduce a processing time and/or associated latency, for example, if the MAC PDU subheaders are computed before assembling the full MAC PDU.

FIG. 4B shows an example format of a MAC subheader in a MAC PDU. A MAC PDU may comprise a MAC subheader (H) and a MAC SDU. Each of one or more MAC subheaders may comprise an SDU length field for indicating the length (e.g., in bytes) of the MAC SDU to which the MAC subheader corresponds; a logical channel identifier (LCID) field for identifying/indicating the logical channel from which the MAC SDU originated to aid in the demultiplexing process; a flag (F) for indicating the size of the SDU length field; and a reserved bit (R) field for future use.

One or more MAC control elements (CEs) may be added to, or inserted into, the MAC PDU by a MAC layer, such as MAC 223 or MAC 222. As shown in FIG. 4B, two MAC CEs may be inserted/added before two MAC PDUs. The MAC CEs may be inserted/added at the beginning of a MAC PDU for downlink transmissions (as shown in FIG. 4B). One or more MAC CEs may be inserted/added at the end of a MAC PDU for uplink transmissions. MAC CEs may be used for in band control signaling. Example MAC CEs may comprise scheduling-related MAC CEs, such as buffer status reports and power headroom reports; activation/deactivation MAC CEs (e.g., MAC CEs for activation/deactivation of PDCP duplication detection, channel state information (CSI) reporting, sounding reference signal (SRS) transmission, and prior configured components); discontinuous reception (DRX)-related MAC CEs; timing advance MAC CEs; and random access-related MAC CEs. A MAC CE may be preceded by a MAC subheader with a similar format as described for the MAC subheader for MAC SDUs and may be identified with a reserved value in the LCID field that indicates the type of control information included in the corresponding MAC CE.

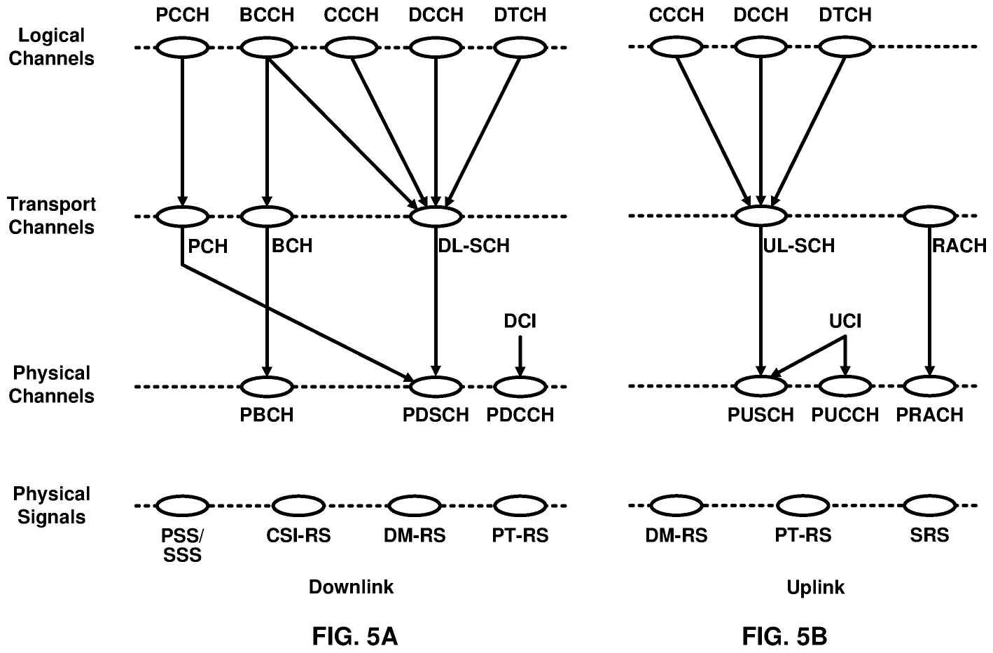

FIG. 5A shows an example mapping for downlink channels. The mapping for uplink channels may comprise mapping between channels (e.g., logical channels, transport channels, and physical channels) for downlink. FIG. 5B shows an example mapping for uplink channels. The mapping for uplink channels may comprise mapping between channels (e.g., logical channels, transport channels, and physical channels) for uplink. Information may be passed through/via channels between the RLC, the MAC, and the PHY layers of a protocol stack (e.g., the NR protocol stack). A logical channel may be used between the RLC and the MAC layers. The logical channel may be classified/indicated as a control channel that may carry control and/or configuration information (e.g., in the NR control plane), or as a traffic channel that may carry data (e.g., in the NR user plane). A logical channel may be classified/indicated as a dedicated logical channel that may be dedicated to a specific wireless device, and/or as a common logical channel that may be used by more than one wireless device (e.g., a group of wireless device).

A logical channel may be defined by the type of information it carries. The set of logical channels (e.g., in an NR configuration) may comprise one or more channels described below. A paging control channel (PCCH) may comprise/carry one or more paging messages used to page a wireless device whose location is not known to the network on a cell level. A broadcast control channel (BCCH) may comprise/carry system information messages in the form of a master information block (MIB) and several system information blocks (SIBs). The system information messages may be used by wireless devices to obtain information about how a cell is configured and how to operate within the cell. A common control channel (CCCH) may comprise/carry control messages together with random access. A dedicated control channel (DCCH) may comprise/carry control messages to/from a specific wireless device to configure the wireless device with configuration information. A dedicated traffic channel (DTCH) may comprise/carry user data to/from a specific wireless device.

Transport channels may be used between the MAC and PHY layers. Transport channels may be defined by how the information they carry is sent/transmitted (e.g., via an over the air interface). The set of transport channels (e.g., that may be defined by an NR configuration or any other configuration) may comprise one or more of the following channels. A paging channel (PCH) may comprise/carry paging messages that originated from the PCCH. A broadcast channel (BCH) may comprise/carry the MIB from the BCCH. A downlink shared channel (DL-SCH) may comprise/carry downlink data and signaling messages, including the SIBs from the BCCH. An uplink shared channel (UL-SCH) may comprise/carry uplink data and signaling messages. A random access channel (RACH) may provide a wireless device with an access to the network without any prior scheduling.

The PHY layer may use physical channels to pass/transfer information between processing levels of the PHY layer. A physical channel may have an associated set of time-frequency resources for carrying the information of one or more transport channels. The PHY layer may generate control information to support the low-level operation of the PHY layer. The PHY layer may provide/transfer the control information to the lower levels of the PHY layer via physical control channels (e.g., referred to as L1/L2 control channels). The set of physical channels and physical control channels (e.g., that may be defined by an NR configuration or any other configuration) may comprise one or more of the following channels. A physical broadcast channel (PBCH) may comprise/carry the MIB from the BCH. A physical downlink shared channel (PDSCH) may comprise/carry downlink data and signaling messages from the DL-SCH, as well as paging messages from the PCH. A physical downlink control channel (PDCCH) may comprise/carry downlink control information (DCI), which may comprise downlink scheduling commands, uplink scheduling grants, and uplink power control commands. A physical uplink shared channel (PUSCH) may comprise/carry uplink data and signaling messages from the UL-SCH and in some instances uplink control information (UCI) as described below. A physical uplink control channel (PUCCH) may comprise/carry UCI, which may comprise HARQ acknowledgments, channel quality indicators (CQI), pre-coding matrix indicators (PMI), rank indicators (RI), and scheduling requests (SR). A physical random access channel (PRACH) may be used for random access.

The physical layer may generate physical signals to support the low-level operation of the physical layer, which may be similar to the physical control channels. As shown in FIG. 5A and FIG. 5B, the physical layer signals (e.g., that may be defined by an NR configuration or any other configuration) may comprise primary synchronization signals (PSS), secondary synchronization signals (SSS), channel state information reference signals (CSI-RS), demodulation reference signals (DM-RS), sounding reference signals (SRS), phase-tracking reference signals (PT RS), and/or any other signals.

One or more of the channels (e.g., logical channels, transport channels, physical channels, etc.) may be used to carry out functions associated with the control plan protocol stack (e.g., NR control plane protocol stack). FIG. 2B shows an example control plane configuration (e.g., an NR control plane protocol stack). As shown in FIG. 2B, the control plane configuration (e.g., the NR control plane protocol stack) may use substantially the same/similar one or more protocol layers (e.g., PHY 211 and 221, MAC 212 and 222, RLC 213 and 223, and PDCP 214 and 224) as the example user plane configuration (e.g., the NR user plane protocol stack). Similar four protocol layers may comprise the PHYs 211 and 221, the MACs 212 and 222, the RLCs 213 and 223, and the PDCPs 214 and 224. The control plane configuration (e.g., the NR control plane stack) may have radio resource controls (RRCs) 216 and 226 and NAS protocols 217 and 237 at the top of the control plane configuration (e.g., the NR control plane protocol stack), for example, instead of having the SDAPs 215 and 225. The control plane configuration may comprise an AMF 230 comprising the NAS protocol 237.

The NAS protocols 217 and 237 may provide control plane functionality between the wireless device 210 and the AMF 230 (e.g., the AMF 158A or any other AMF) and/or, more generally, between the wireless device 210 and a CN (e.g., the CN 152 or any other CN). The NAS protocols 217 and 237 may provide control plane functionality between the wireless device 210 and the AMF 230 via signaling messages, referred to as NAS messages. There may be no direct path between the wireless device 210 and the AMF 230 via which the NAS messages may be transported. The NAS messages may be transported using the AS of the Uu and NG interfaces. The NAS protocols 217 and 237 may provide control plane functionality, such as authentication, security, a connection setup, mobility management, session management, and/or any other functionality.

The RRCs 216 and 226 may provide/configure control plane functionality between the wireless device 210 and the base station 220 and/or, more generally, between the wireless device 210 and the RAN (e.g., the base station 220). The RRC layers 216 and 226 may provide/configure control plane functionality between the wireless device 210 and the base station 220 via signaling messages, which may be referred to as RRC messages. The RRC messages may be sent/transmitted between the wireless device 210 and the RAN (e.g., the base station 220) using signaling radio bearers and the same/similar PDCP, RLC, MAC, and PHY protocol layers. The MAC layer may multiplex control-plane and user-plane data into the same TB. The RRC layers 216 and 226 may provide/configure control plane functionality, such as one or more of the following functionalities: broadcast of system information related to AS and NAS; paging initiated by the CN or the RAN; establishment, maintenance and release of an RRC connection between the wireless device 210 and the RAN (e.g., the base station 220); security functions including key management; establishment, configuration, maintenance and release of signaling radio bearers and data radio bearers; mobility functions; QoS management functions; wireless device measurement reporting (e.g., the wireless device measurement reporting) and control of the reporting; detection of and recovery from radio link failure (RLF); and/or NAS message transfer. As part of establishing an RRC connection, RRC layers 216 and 226 may establish an RRC context, which may involve configuring parameters for communication between the wireless device 210 and the RAN (e.g., the base station 220).

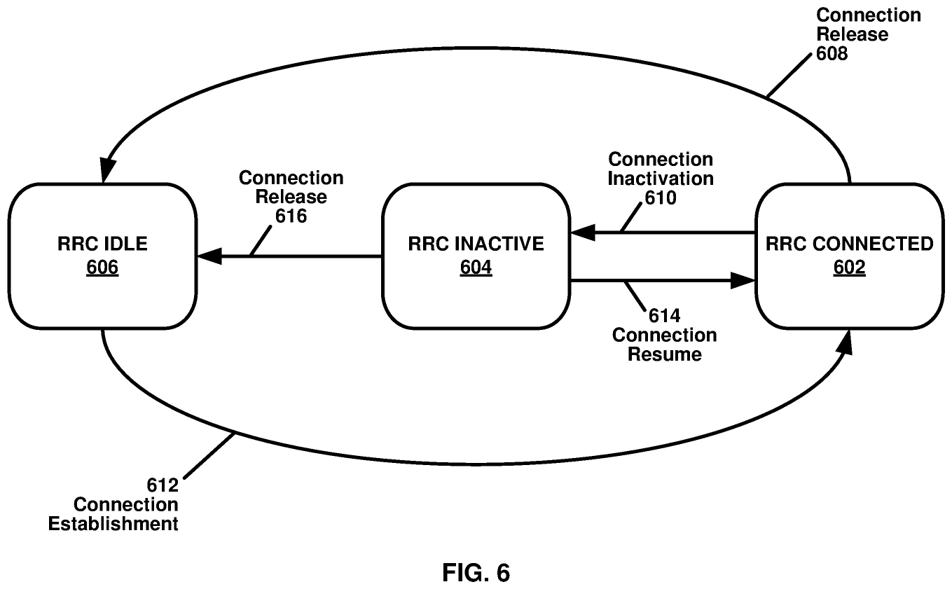

FIG. 6 shows example RRC states and RRC state transitions. An RRC state of a wireless device may be changed to another RRC state (e.g., RRC state transitions of a wireless device). The wireless device may be substantially the same or similar to the wireless device 106, 210, or any other wireless device. A wireless device may be in at least one of a plurality of states, such as three RRC states comprising RRC connected 602 (e.g., RRC_CONNECTED), RRC idle 606 (e.g., RRC_IDLE), and RRC inactive 604 (e.g., RRC_INACTIVE). The RRC inactive 604 may be RRC connected but inactive.

An RRC connection may be established for the wireless device. For example, this may be during an RRC connected state. During the RRC connected state (e.g., during the RRC connected 602), the wireless device may have an established RRC context and may have at least one RRC connection with a base station. The base station may be similar to one of the one or more base stations (e.g., one or more base stations of the RAN 104 shown in FIG. 1A, one of the gNBs 160 or ng-eNBs 162 shown in FIG. 1B, the base station 220 shown in FIG. 2A and FIG. 2B, or any other base stations). The base station with which the wireless device is connected (e.g., has established an RRC connection) may have the RRC context for the wireless device. The RRC context, which may be referred to as a wireless device context (e.g., the UE context), may comprise parameters for communication between the wireless device and the base station. These parameters may comprise, for example, one or more of: AS contexts; radio link configuration parameters; bearer configuration information (e.g., relating to a data radio bearer, a signaling radio bearer, a logical channel, a QoS flow, and/or a PDU session); security information; and/or layer configuration information (e.g., PHY, MAC, RLC, PDCP, and/or SDAP layer configuration information). During the RRC connected state (e.g., the RRC connected 602), mobility of the wireless device may be managed/controlled by an RAN (e.g., the RAN 104 or the NG RAN 154). The wireless device may measure received signal levels (e.g., reference signal levels, reference signal received power, reference signal received quality, received signal strength indicator, etc.) based on one or more signals sent from a serving cell and neighboring cells. The wireless device may report these measurements to a serving base station (e.g., the base station currently serving the wireless device). The serving base station of the wireless device may request a handover to a cell of one of the neighboring base stations, for example, based on the reported measurements. The RRC state may transition from the RRC connected state (e.g., RRC connected 602) to an RRC idle state (e.g., the RRC idle 606) via a connection release procedure 608. The RRC state may transition from the RRC connected state (e.g., RRC connected 602) to the RRC inactive state (e.g., RRC inactive 604) via a connection inactivation procedure 610.

An RRC context may not be established for the wireless device. For example, this may be during the RRC idle state. During the RRC idle state (e.g., the RRC idle 606), an RRC context may not be established for the wireless device. During the RRC idle state (e.g., the RRC idle 606), the wireless device may not have an RRC connection with the base station. During the RRC idle state (e.g., the RRC idle 606), the wireless device may be in a sleep state for the majority of the time (e.g., to conserve battery power). The wireless device may wake up periodically (e.g., once in every discontinuous reception (DRX) cycle) to monitor for paging messages (e.g., paging messages set from the RAN). Mobility of the wireless device may be managed by the wireless device via a procedure of a cell reselection. The RRC state may transition from the RRC idle state (e.g., the RRC idle 606) to the RRC connected state (e.g., the RRC connected 602) via a connection establishment procedure 612, which may involve a random-access procedure.

A previously established RRC context may be maintained for the wireless device. For example, this may be during the RRC inactive state. During the RRC inactive state (e.g., the RRC inactive 604), the RRC context previously established may be maintained in the wireless device and the base station. The maintenance of the RRC context may enable/allow a fast transition to the RRC connected state (e.g., the RRC connected 602) with reduced signaling overhead as compared to the transition from the RRC idle state (e.g., the RRC idle 606) to the RRC connected state (e.g., the RRC connected 602). During the RRC inactive state (e.g., the RRC inactive 604), the wireless device may be in a sleep state and mobility of the wireless device may be managed/controlled by the wireless device via a cell reselection. The RRC state may transition from the RRC inactive state (e.g., the RRC inactive 604) to the RRC connected state (e.g., the RRC connected 602) via a connection resume procedure 614. The RRC state may transition from the RRC inactive state (e.g., the RRC inactive 604) to the RRC idle state (e.g., the RRC idle 606) via a connection release procedure 616 that may be the same as or similar to connection release procedure 608.

An RRC state may be associated with a mobility management mechanism. During the RRC idle state (e.g., RRC idle 606) and the RRC inactive state (e.g., the RRC inactive 604), mobility may be managed/controlled by the wireless device via a cell reselection. The purpose of mobility management during the RRC idle state (e.g., the RRC idle 606) or during the RRC inactive state (e.g., the RRC inactive 604) may be to enable/allow the network to be able to notify the wireless device of an event via a paging message without having to broadcast the paging message over the entire mobile communications network. The mobility management mechanism used during the RRC idle state (e.g., the RRC idle 606) or during the RRC idle state (e.g., the RRC inactive 604) may enable/allow the network to track the wireless device on a cell-group level, for example, so that the paging message may be broadcast over the cells of the cell group that the wireless device currently resides within (e.g. instead of sending the paging message over the entire mobile communication network). The mobility management mechanisms for the RRC idle state (e.g., the RRC idle 606) and the RRC inactive state (e.g., the RRC inactive 604) may track the wireless device on a cell-group level. The mobility management mechanisms may do the tracking, for example, using different granularities of grouping. There may be a plurality of levels of cell-grouping granularity (e.g., three levels of cell-grouping granularity: individual cells; cells within a RAN area identified by a RAN area identifier (RAI); and cells within a group of RAN areas, referred to as a tracking area and identified by a tracking area identifier (TAI)).

Tracking areas may be used to track the wireless device (e.g., tracking the location of the wireless device at the CN level). The CN (e.g., the CN 102, the 5G CN 152, or any other CN) may send to the wireless device a list of TAIs associated with a wireless device registration area (e.g., a UE registration area). A wireless device may perform a registration update with the CN to allow the CN to update the location of the wireless device and provide the wireless device with a new the UE registration area, for example, if the wireless device moves (e.g., via a cell reselection) to a cell associated with a TAI that may not be included in the list of TAIs associated with the UE registration area.

RAN areas may be used to track the wireless device (e.g., the location of the wireless device at the RAN level). For a wireless device in an RRC inactive state (e.g., the RRC inactive 604), the wireless device may be assigned/provided/configured with a RAN notification area. A RAN notification area may comprise one or more cell identities (e.g., a list of RAIs and/or a list of TAIs). A base station may belong to one or more RAN notification areas. A cell may belong to one or more RAN notification areas. A wireless device may perform a notification area update with the RAN to update the RAN notification area of the wireless device, for example, if the wireless device moves (e.g., via a cell reselection) to a cell not included in the RAN notification area assigned/provided/configured to the wireless device.

A base station storing an RRC context for a wireless device or a last serving base station of the wireless device may be referred to as an anchor base station. An anchor base station may maintain an RRC context for the wireless device at least during a period of time that the wireless device stays in a RAN notification area of the anchor base station and/or during a period of time that the wireless device stays in an RRC inactive state (e.g., RRC inactive 604).

A base station (e.g., gNBs 160 in FIG. 1B or any other base station) may be split in two parts: a central unit (e.g., a base station central unit, such as a gNB CU) and one or more distributed units (e.g., a base station distributed unit, such as a gNB DU). A base station central unit (CU) may be coupled to one or more base station distributed units (DUs) using an F1 interface (e.g., an F1 interface defined in an NR configuration). The base station CU may comprise the RRC, the PDCP, and the SDAP layers. A base station distributed unit (DU) may comprise the RLC, the MAC, and the PHY layers.

The physical signals and physical channels (e.g., described with respect to FIG. 5A and FIG. 5B) may be mapped onto one or more symbols (e.g., orthogonal frequency divisional multiplexing (OFDM) symbols in an NR configuration or any other symbols). OFDM is a multicarrier communication scheme that sends/transmits data over F orthogonal subcarriers (or tones). The data may be mapped to a series of complex symbols (e.g., M-quadrature amplitude modulation (M-QAM) symbols or M-phase shift keying (M PSK) symbols or any other modulated symbols), referred to as source symbols, and divided into F parallel symbol streams, for example, before transmission of the data. The F parallel symbol streams may be treated as if they are in the frequency domain. The F parallel symbols may be used as inputs to an Inverse Fast Fourier Transform (IFFT) block that transforms them into the time domain. The IFFT block may take in F source symbols at a time, one from each of the F parallel symbol streams. The IFFT block may use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. An OFDM symbol provided/output by the IFFT block may be sent/transmitted over the air interface on a carrier frequency, for example, after one or more processes (e.g., addition of a cyclic prefix) and up-conversion. The F parallel symbol streams may be mixed, for example, using a Fast Fourier Transform (FFT) block before being processed by the IFFT block. This operation may produce Discrete Fourier Transform (DFT)-precoded OFDM symbols and may be used by one or more wireless devices in the uplink to reduce the peak to average power ratio (PAPR). Inverse processing may be performed on the OFDM symbol at a receiver using an FFT block to recover the data mapped to the source symbols.

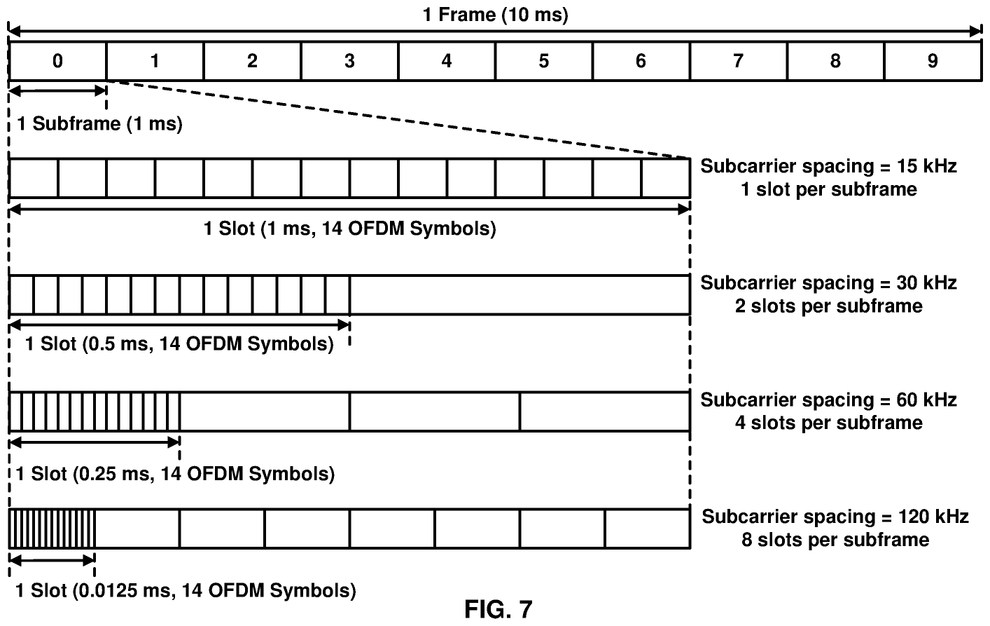

FIG. 7 shows an example configuration of a frame. The frame may comprise, for example, an NR radio frame into which OFDM symbols may be grouped. A frame (e.g., an NR radio frame) may be identified/indicated by a system frame number (SFN) or any other value. The SFN may repeat with a period of 1024 frames. One NR frame may be 10 milliseconds (ms) in duration and may comprise 10 subframes that are 1 ms in duration. A subframe may be divided into one or more slots (e.g., depending on numerologies and/or different subcarrier spacings). Each of the one or more slots may comprise, for example, 14 OFDM symbols per slot. Any quantity of symbols, slots, or duration may be used for any time interval.

The duration of a slot may depend on the numerology used for the OFDM symbols of the slot. A flexible numerology may be supported, for example, to accommodate different deployments (e.g., cells with carrier frequencies below 1 GHz up to cells with carrier frequencies in the mm-wave range). A flexible numerology may be supported, for example, in an NR configuration or any other radio configurations. A numerology may be defined in terms of subcarrier spacing and/or cyclic prefix duration. Subcarrier spacings may be scaled up by powers of two from a baseline subcarrier spacing of 15 kHz. Cyclic prefix durations may be scaled down by powers of two from a baseline cyclic prefix duration of 4.7 μs, for example, for a numerology in an NR configuration or any other radio configurations. Numerologies may be defined with the following subcarrier spacing/cyclic prefix duration combinations: 15 kHz/4.7 μs; 30 kHz/2.3 μs; 60 kHz/1.2 μs; 120 kHz/0.59 μs; 240 kHz/0.29 μs, and/or any other subcarrier spacing/cyclic prefix duration combinations.

A slot may have a fixed number/quantity of OFDM symbols (e.g., 14 OFDM symbols). A numerology with a higher subcarrier spacing may have a shorter slot duration and more slots per subframe. Examples of numerology-dependent slot duration and slots-per-subframe transmission structure are shown in FIG. 7 (the numerology with a subcarrier spacing of 240 kHz is not shown in FIG. 7). A subframe (e.g., in an NR configuration) may be used as a numerology-independent time reference. A slot may be used as the unit upon which uplink and downlink transmissions are scheduled. Scheduling (e.g., in an NR configuration) may be decoupled from the slot duration. Scheduling may start at any OFDM symbol. Scheduling may last for as many symbols as needed for a transmission, for example, to support low latency. These partial slot transmissions may be referred to as mini-slot or sub-slot transmissions.

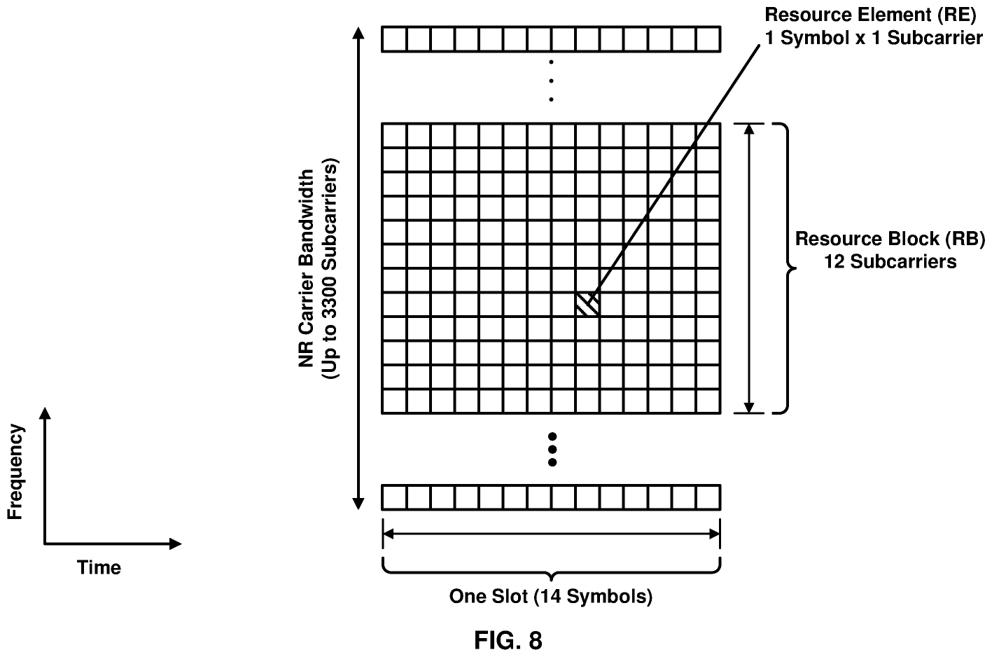

FIG. 8 shows an example resource configuration of one or more carriers. The resource configuration of may comprise a slot in the time and frequency domain for an NR carrier or any other carrier. The slot may comprise resource elements (REs) and resource blocks (RBs). A resource element (RE) may be the smallest physical resource (e.g., in an NR configuration). An RE may span one OFDM symbol in the time domain by one subcarrier in the frequency domain, such as shown in FIG. 8. An RB may span twelve consecutive REs in the frequency domain, such as shown in FIG. 8. A carrier (e.g., an NR carrier) may be limited to a width of a certain quantity of RBs and/or subcarriers (e.g., 275 RBs or 275×12=3300 subcarriers). Such limitation(s), if used, may limit the carrier (e.g., NR carrier) frequency based on subcarrier spacing (e.g., carrier frequency of 50, 100, 200, and 400 MHz for subcarrier spacings of 15, 30, 60, and 120 kHz, respectively). A 400 MHz bandwidth may be set based on a 400 MHz per carrier bandwidth limit. Any other bandwidth may be set based on a per carrier bandwidth limit.

A single numerology may be used across the entire bandwidth of a carrier (e.g., an NR such as shown in FIG. 8). In other example configurations, multiple numerologies may be supported on the same carrier. NR and/or other access technologies may support wide carrier bandwidths (e.g., up to 400 MHz for a subcarrier spacing of 120 kHz). Not all wireless devices may be able to receive the full carrier bandwidth (e.g., due to hardware limitations and/or different wireless device capabilities). Receiving and/or utilizing the full carrier bandwidth may be prohibitive, for example, in terms of wireless device power consumption. A wireless device may adapt the size of the receive bandwidth of the wireless device, for example, based on the amount of traffic the wireless device is scheduled to receive (e.g., to reduce power consumption and/or for other purposes). Such an adaptation may be referred to as bandwidth adaptation.

Configuration of one or more bandwidth parts (BWPs) may support one or more wireless devices not capable of receiving the full carrier bandwidth. BWPs may support bandwidth adaptation, for example, for such wireless devices not capable of receiving the full carrier bandwidth. A BWP (e.g., a BWP of an NR configuration) may be defined by a subset of contiguous RBs on a carrier. A wireless device may be configured (e.g., via an RRC layer) with one or more downlink BWPs per serving cell and one or more uplink BWPs per serving cell (e.g., up to four downlink BWPs per serving cell and up to four uplink BWPs per serving cell). One or more of the configured BWPs for a serving cell may be active, for example, at a given time. The one or more BWPs may be referred to as active BWPs of the serving cell. A serving cell may have one or more first active BWPs in the uplink carrier and one or more second active BWPs in the secondary uplink carrier, for example, if the serving cell is configured with a secondary uplink carrier.

A downlink BWP from a set of configured downlink BWPs may be linked with an uplink BWP from a set of configured uplink BWPs (e.g., for unpaired spectra). A downlink BWP and an uplink BWP may be linked, for example, if a downlink BWP index of the downlink BWP and an uplink BWP index of the uplink BWP are the same. A wireless device may expect that the center frequency for a downlink BWP is the same as the center frequency for an uplink BWP (e.g., for unpaired spectra).

A base station may configure a wireless device with one or more control resource sets (CORESETs) for at least one search space. The base station may configure the wireless device with one or more CORESETS, for example, for a downlink BWP in a set of configured downlink BWPs on a primary cell (PCell) or on a secondary cell (SCell). A search space may comprise a set of locations in the time and frequency domains where the wireless device may monitor/find/detect/identify control information. The search space may be a wireless device-specific search space (e.g., a UE-specific search space) or a common search space (e.g., potentially usable by a plurality of wireless devices or a group of wireless user devices). A base station may configure a group of wireless devices with a common search space, on a PCell or on a primary secondary cell (PSCell), in an active downlink BWP.

A base station may configure a wireless device with one or more resource sets for one or more PUCCH transmissions, for example, for an uplink BWP in a set of configured uplink BWPs. A wireless device may receive downlink receptions (e.g., PDCCH or PDSCH) in a downlink BWP, for example, according to a configured numerology (e.g., a configured subcarrier spacing and/or a configured cyclic prefix duration) for the downlink BWP. The wireless device may send/transmit uplink transmissions (e.g., PUCCH or PUSCH) in an uplink BWP, for example, according to a configured numerology (e.g., a configured subcarrier spacing and/or a configured cyclic prefix length for the uplink BWP).

One or more BWP indicator fields may be provided/comprised in Downlink Control Information (DCI). A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a wireless device with a default downlink BWP within a set of configured downlink BWPs associated with a PCell. A default downlink BWP may be an initial active downlink BWP, for example, if the base station does not provide/configure a default downlink BWP to/for the wireless device. The wireless device may determine which BWP is the initial active downlink BWP, for example, based on a CORESET configuration obtained using the PBCH.

A base station may configure a wireless device with a BWP inactivity timer value for a PCell. The wireless device may start or restart a BWP inactivity timer at any appropriate time. The wireless device may start or restart the BWP inactivity timer, for example, if one or more conditions are satisfied. The one or more conditions may comprise at least one of: the wireless device detects DCI indicating an active downlink BWP other than a default downlink BWP for a paired spectra operation; the wireless device detects DCI indicating an active downlink BWP other than a default downlink BWP for an unpaired spectra operation; and/or the wireless device detects DCI indicating an active uplink BWP other than a default uplink BWP for an unpaired spectra operation. The wireless device may start/run the BWP inactivity timer toward expiration (e.g., increment from zero to the BWP inactivity timer value, or decrement from the BWP inactivity timer value to zero), for example, if the wireless device does not detect DCI during a time interval (e.g., 1 ms or 0.5 ms). The wireless device may switch from the active downlink BWP to the default downlink BWP, for example, if the BWP inactivity timer expires.

A base station may semi-statically configure a wireless device with one or more BWPs. A wireless device may switch an active BWP from a first BWP to a second BWP, for example, based on (e.g., after or in response to) receiving DCI indicating the second BWP as an active BWP. A wireless device may switch an active BWP from a first BWP to a second BWP, for example, based on (e.g., after or in response to) an expiry of the BWP inactivity timer (e.g., if the second BWP is the default BWP).

A downlink BWP switching may refer to switching an active downlink BWP from a first downlink BWP to a second downlink BWP (e.g., the second downlink BWP is activated and the first downlink BWP is deactivated). An uplink BWP switching may refer to switching an active uplink BWP from a first uplink BWP to a second uplink BWP (e.g., the second uplink BWP is activated and the first uplink BWP is deactivated). Downlink and uplink BWP switching may be performed independently (e.g., in paired spectrum/spectra). Downlink and uplink BWP switching may be performed simultaneously (e.g., in unpaired spectrum/spectra). Switching between configured BWPs may occur, for example, based on RRC signaling, DCI signaling, expiration of a BWP inactivity timer, and/or an initiation of random access.

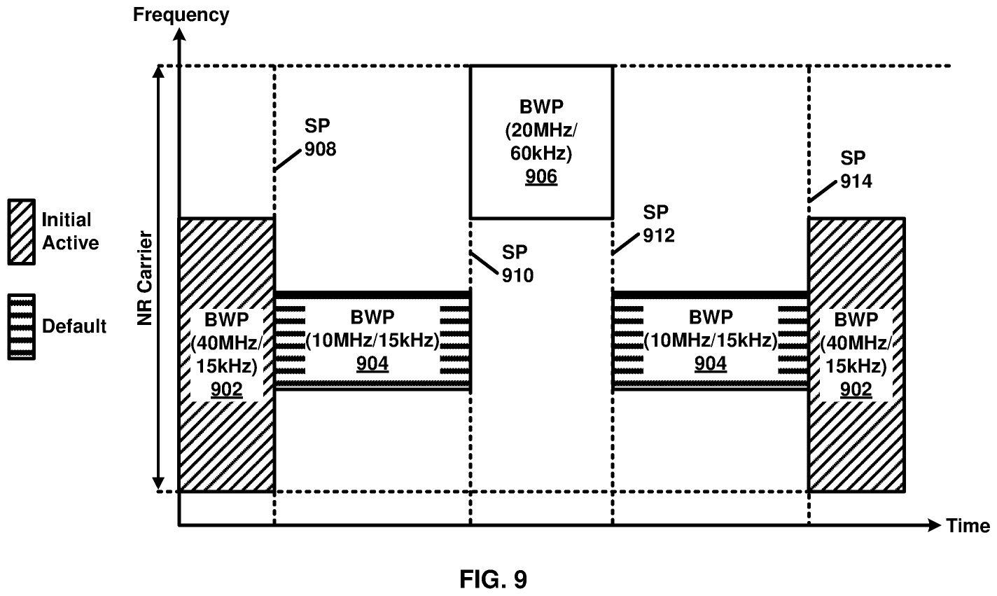

FIG. 9 shows an example of configured BWPs. Bandwidth adaptation using multiple BWPs (e.g., three configured BWPs for an NR carrier) may be available. A wireless device configured with multiple BWPs (e.g., the three BWPs) may switch from one BWP to another BWP at a switching point. The BWPs may comprise: a BWP 902 having a bandwidth of 40 MHz and a subcarrier spacing of 15 kHz; a BWP 904 having a bandwidth of 10 MHz and a subcarrier spacing of 15 kHz; and a BWP 906 having a bandwidth of 20 MHz and a subcarrier spacing of 60 kHz. The BWP 902 may be an initial active BWP, and the BWP 904 may be a default BWP. The wireless device may switch between BWPs at switching points. The wireless device may switch from the BWP 902 to the BWP 904 at a switching point 908. The switching at the switching point 908 may occur for any suitable reasons. The switching at a switching point 908 may occur, for example, based on (e.g., after or in response to) an expiry of a BWP inactivity timer (e.g., indicating switching to the default BWP). The switching at the switching point 908 may occur, for example, based on (e.g., after or in response to) receiving DCI indicating BWP 904 as the active BWP. The wireless device may switch at a switching point 910 from an active BWP 904 to the BWP 906, for example, after or in response receiving DCI indicating BWP 906 as a new active BWP. The wireless device may switch at a switching point 912 from an active BWP 906 to the BWP 904, for example, a based on (e.g., after or in response to) an expiry of a BWP inactivity timer. The wireless device may switch at the switching point 912 from an active BWP 906 to the BWP 904, for example, after or in response receiving DCI indicating BWP 904 as a new active BWP. The wireless device may switch at a switching point 914 from an active BWP 904 to the BWP 902, for example, after or in response receiving DCI indicating the BWP 902 as a new active BWP.

Wireless device procedures for switching BWPs on a secondary cell may be the same/similar as those on a primary cell, for example, if the wireless device is configured for a secondary cell with a default downlink BWP in a set of configured downlink BWPs and a timer value. The wireless device may use the timer value and the default downlink BWP for the secondary cell in the same/similar manner as the wireless device uses the timer value and/or default BWPs for a primary cell. The timer value (e.g., the BWP inactivity timer) may be configured per cell (e.g., for one or more BWPs), for example, via RRC signaling or any other signaling. One or more active BWPs may switch to another BWP, for example, based on an expiration of the BWP inactivity timer.

Two or more carriers may be aggregated and data may be simultaneously sent/transmitted to/from the same wireless device using carrier aggregation (CA) (e.g., to increase data rates). The aggregated carriers in CA may be referred to as component carriers (CCs). There may be a number/quantity of serving cells for the wireless device (e.g., one serving cell for a CC), for example, if CA is configured/used. The CCs may have multiple configurations in the frequency domain.

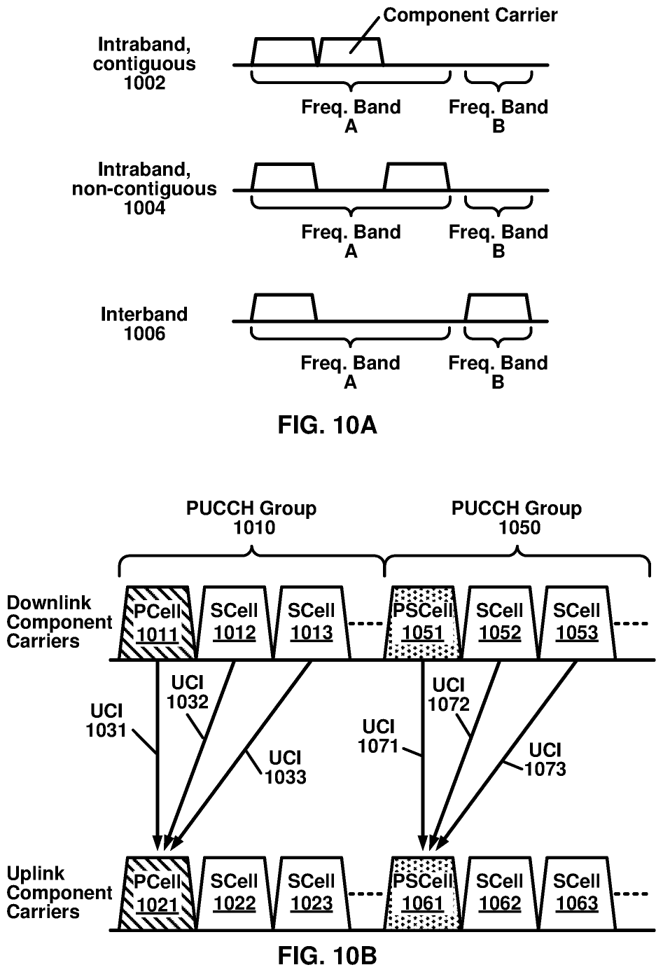

FIG. 10A shows example CA configurations based on CCs. As shown in FIG. 10A, three types of CA configurations may comprise an intraband (contiguous) configuration 1002, an intraband (non-contiguous) configuration 1004, and/or an interband configuration 1006. In the intraband (contiguous) configuration 1002, two CCs may be aggregated in the same frequency band (frequency band A) and may be located directly adjacent to each other within the frequency band. In the intraband (non-contiguous) configuration 1004, two CCs may be aggregated in the same frequency band (frequency band A) but may be separated from each other in the frequency band by a gap. In the interband configuration 1006, two CCs may be located in different frequency bands (e.g., frequency band A and frequency band B, respectively).

A network may set the maximum quantity of CCs that can be aggregated (e.g., up to 32 CCs may be aggregated in NR, or any other quantity may be aggregated in other systems). The aggregated CCs may have the same or different bandwidths, subcarrier spacing, and/or duplexing schemes (TDD, FDD, or any other duplexing schemes). A serving cell for a wireless device using CA may have a downlink CC. One or more uplink CCs may be optionally configured for a serving cell (e.g., for FDD). The ability to aggregate more downlink carriers than uplink carriers may be useful, for example, if the wireless device has more data traffic in the downlink than in the uplink.

One of the aggregated cells for a wireless device may be referred to as a primary cell (PCell), for example, if a CA is configured. The PCell may be the serving cell that the wireless initially connects to or access to, for example, during or at an RRC connection establishment, an RRC connection reestablishment, and/or a handover. The PCell may provide/configure the wireless device with NAS mobility information and the security input. Wireless device may have different PCells. For the downlink, the carrier corresponding to the PCell may be referred to as the downlink primary CC (DL PCC). For the uplink, the carrier corresponding to the PCell may be referred to as the uplink primary CC (UL PCC). The other aggregated cells (e.g., associated with CCs other than the DL PCC and UL PCC) for the wireless device may be referred to as secondary cells (SCells). The SCells may be configured, for example, after the PCell is configured for the wireless device. An SCell may be configured via an RRC connection reconfiguration procedure. For the downlink, the carrier corresponding to an SCell may be referred to as a downlink secondary CC (DL SCC). For the uplink, the carrier corresponding to the SCell may be referred to as the uplink secondary CC (UL SCC).

Configured SCells for a wireless device may be activated or deactivated, for example, based on traffic and channel conditions. Deactivation of an SCell may cause the wireless device to stop PDCCH and PDSCH reception on the SCell and PUSCH, SRS, and CQI transmissions on the SCell. Configured SCells may be activated or deactivated, for example, using a MAC CE (e.g., the MAC CE described with respect to FIG. 4B). A MAC CE may use a bitmap (e.g., one bit per SCell) to indicate which SCells (e.g., in a subset of configured SCells) for the wireless device are activated or deactivated. Configured SCells may be deactivated, for example, based on (e.g., after or in response to) an expiration of an SCell deactivation timer (e.g., one SCell deactivation timer per SCell may be configured).

DCI may comprise control information, such as scheduling assignments and scheduling grants, for a cell. DCI may be sent/transmitted via the cell corresponding to the scheduling assignments and/or scheduling grants, which may be referred to as a self-scheduling. DCI comprising control information for a cell may be sent/transmitted via another cell, which may be referred to as a cross-carrier scheduling. Uplink control information (UCI) may comprise control information, such as HARQ acknowledgments and channel state feedback (e.g., CQI, PMI, and/or RI) for aggregated cells. UCI may be sent/transmitted via an uplink control channel (e.g., a PUCCH) of the PCell or a certain SCell (e.g., an SCell configured with PUCCH). For a larger number of aggregated downlink CCs, the PUCCH of the PCell may become overloaded. Cells may be divided into multiple PUCCH groups.

FIG. 10B shows example group of cells. Aggregated cells may be configured into one or more PUCCH groups (e.g., as shown in FIG. 10B). One or more cell groups or one or more uplink control channel groups (e.g., a PUCCH group 1010 and a PUCCH group 1050) may comprise one or more downlink CCs, respectively. The PUCCH group 1010 may comprise one or more downlink CCs, for example, three downlink CCs: a PCell 1011 (e.g., a DL PCC), an SCell 1012 (e.g., a DL SCC), and an SCell 1013 (e.g., a DL SCC). The PUCCH group 1050 may comprise one or more downlink CCs, for example, three downlink CCs: a PUCCH SCell (or PSCell) 1051 (e.g., a DL SCC), an SCell 1052 (e.g., a DL SCC), and an SCell 1053 (e.g., a DL SCC). One or more uplink CCs of the PUCCH group 1010 may be configured as a PCell 1021 (e.g., a UL PCC), an SCell 1022 (e.g., a UL SCC), and an SCell 1023 (e.g., a UL SCC). One or more uplink CCs of the PUCCH group 1050 may be configured as a PUCCH SCell (or PSCell) 1061 (e.g., a UL SCC), an SCell 1062 (e.g., a UL SCC), and an SCell 1063 (e.g., a UL SCC). UCI related to the downlink CCs of the PUCCH group 1010, shown as UCI 1031, UCI 1032, and UCI 1033, may be sent/transmitted via the uplink of the PCell 1021 (e.g., via the PUCCH of the PCell 1021). UCI related to the downlink CCs of the PUCCH group 1050, shown as UCI 1071, UCI 1072, and UCI 1073, may be sent/transmitted via the uplink of the PUCCH SCell (or PSCell) 1061 (e.g., via the PUCCH of the PUCCH SCell 1061). A single uplink PCell may be configured to send/transmit UCI relating to the six downlink CCs, for example, if the aggregated cells shown in FIG. 10B are not divided into the PUCCH group 1010 and the PUCCH group 1050. The PCell 1021 may become overloaded, for example, if the UCIs 1031, 1032, 1033, 1071, 1072, and 1073 are sent/transmitted via the PCell 1021. By dividing transmissions of UCI between the PCell 1021 and the PUCCH SCell (or PSCell) 1061, overloading may be prevented and/or reduced.

A PCell may comprise a downlink carrier (e.g., the PCell 1011) and an uplink carrier (e.g., the PCell 1021). An SCell may comprise only a downlink carrier. A cell, comprising a downlink carrier and optionally an uplink carrier, may be assigned with a physical cell ID and a cell index. The physical cell ID or the cell index may indicate/identify a downlink carrier and/or an uplink carrier of the cell, for example, depending on the context in which the physical cell ID is used. A physical cell ID may be determined, for example, using a synchronization signal (e.g., PSS and/or SSS) sent/transmitted via a downlink component carrier. A cell index may be determined, for example, using one or more RRC messages. A physical cell ID may be referred to as a carrier ID, and a cell index may be referred to as a carrier index. A first physical cell ID for a first downlink carrier may refer to the first physical cell ID for a cell comprising the first downlink carrier. Substantially the same/similar concept may apply to, for example, a carrier activation. Activation of a first carrier may refer to activation of a cell comprising the first carrier.

A multi-carrier nature of a PHY layer may be exposed/indicated to a MAC layer (e.g., in a CA configuration). A HARQ entity may operate on a serving cell. A transport block may be generated per assignment/grant per serving cell. A transport block and potential HARQ retransmissions of the transport block may be mapped to a serving cell.

For the downlink, a base station may send/transmit (e.g., unicast, multicast, and/or broadcast), to one or more wireless devices, one or more reference signals (RSs) (e.g., PSS, SSS, CSI-RS, DM-RS, and/or PT-RS). For the uplink, the one or more wireless devices may send/transmit one or more RSs to the base station (e.g., DM-RS, PT-RS, and/or SRS). The PSS and the SSS may be sent/transmitted by the base station and used by the one or more wireless devices to synchronize the one or more wireless devices with the base station. A synchronization signal (SS)/physical broadcast channel (PBCH) block may comprise the PSS, the SSS, and the PBCH. The base station may periodically send/transmit a burst of SS/PBCH blocks, which may be referred to as SSBs.

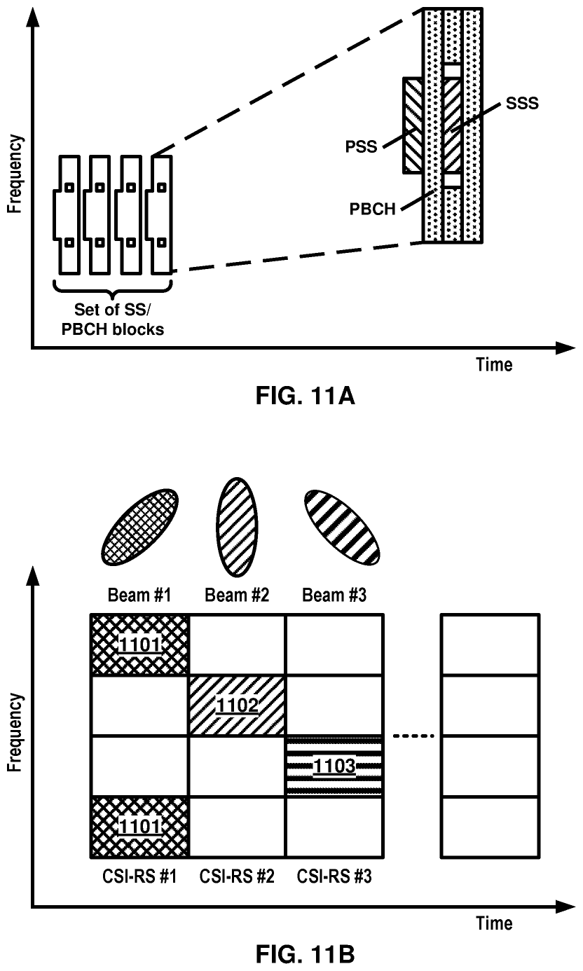

FIG. 11A shows an example mapping of one or more SS/PBCH blocks. A burst of SS/PBCH blocks may comprise one or more SS/PBCH blocks (e.g., 4 SS/PBCH blocks, as shown in FIG. 11A). Bursts may be sent/transmitted periodically (e.g., every 2 frames, 20 ms, or any other durations). A burst may be restricted to a half-frame (e.g., a first half-frame having a duration of 5 ms). Such parameters (e.g., the number of SS/PBCH blocks per burst, periodicity of bursts, position of the burst within the frame) may be configured, for example, based on at least one of: a carrier frequency of a cell in which the SS/PBCH block is sent/transmitted; a numerology or subcarrier spacing of the cell; a configuration by the network (e.g., using RRC signaling); and/or any other suitable factor(s). A wireless device may assume a subcarrier spacing for the SS/PBCH block based on the carrier frequency being monitored, for example, unless the radio network configured the wireless device to assume a different subcarrier spacing.

The SS/PBCH block may span one or more OFDM symbols in the time domain (e.g., 4 OFDM symbols, as shown in FIG. 11A or any other quantity/number of symbols) and may span one or more subcarriers in the frequency domain (e.g., 240 contiguous subcarriers or any other quantity/number of subcarriers). The PSS, the SSS, and the PBCH may have a common center frequency. The PSS may be sent/transmitted first and may span, for example, 1 OFDM symbol and 127 subcarriers. The SSS may be sent/transmitted after the PSS (e.g., two symbols later) and may span 1 OFDM symbol and 127 subcarriers. The PBCH may be sent/transmitted after the PSS (e.g., across the next 3 OFDM symbols) and may span 240 subcarriers (e.g., in the second and fourth OFDM symbols as shown in FIG. 11A) and/or may span fewer than 240 subcarriers (e.g., in the third OFDM symbols as shown in FIG. 11A).

The location of the SS/PBCH block in the time and frequency domains may not be known to the wireless device (e.g., if the wireless device is searching for the cell). The wireless device may monitor a carrier for the PSS, for example, to find and select the cell. The wireless device may monitor a frequency location within the carrier. The wireless device may search for the PSS at a different frequency location within the carrier, for example, if the PSS is not found after a certain duration (e.g., 20 ms). The wireless device may search for the PSS at a different frequency location within the carrier, for example, as indicated by a synchronization raster. The wireless device may determine the locations of the SSS and the PBCH, respectively, for example, based on a known structure of the SS/PBCH block if the PSS is found at a location in the time and frequency domains. The SS/PBCH block may be a cell-defining SS block (CD-SSB). A primary cell may be associated with a CD-SSB. The CD-SSB may be located on a synchronization raster. A cell selection/search and/or reselection may be based on the CD-SSB.

The SS/PBCH block may be used by the wireless device to determine one or more parameters of the cell. The wireless device may determine a physical cell identifier (PCI) of the cell, for example, based on the sequences of the PSS and the SSS, respectively. The wireless device may determine a location of a frame boundary of the cell, for example, based on the location of the SS/PBCH block. The SS/PBCH block may indicate that it has been sent/transmitted in accordance with a transmission pattern. An SS/PBCH block in the transmission pattern may be a known distance from the frame boundary (e.g., a predefined distance for a RAN configuration among one or more networks, one or more base stations, and one or more wireless devices).

The PBCH may use a QPSK modulation and/or forward error correction (FEC). The FEC may use polar coding. One or more symbols spanned by the PBCH may comprise/carry one or more DM-RSs for demodulation of the PBCH. The PBCH may comprise an indication of a current system frame number (SFN) of the cell and/or a SS/PBCH block timing index. These parameters may facilitate time synchronization of the wireless device to the base station. The PBCH may comprise a MIB used to send/transmit to the wireless device one or more parameters. The MIB may be used by the wireless device to locate remaining minimum system information (RMSI) associated with the cell. The RMSI may comprise a System Information Block Type 1 (SIB1). The SIB1 may comprise information for the wireless device to access the cell. The wireless device may use one or more parameters of the MIB to monitor a PDCCH, which may be used to schedule a PDSCH. The PDSCH may comprise the SIB1. The SIB1 may be decoded using parameters provided/comprised in the MIB. The PBCH may indicate an absence of SIB1. The wireless device may be pointed to a frequency, for example, based on the PBCH indicating the absence of SIB1. The wireless device may search for an SS/PBCH block at the frequency to which the wireless device is pointed.

The wireless device may assume that one or more SS/PBCH blocks sent/transmitted with a same SS/PBCH block index are quasi co-located (QCLed) (e.g., having substantially the same/similar Doppler spread, Doppler shift, average gain, average delay, and/or spatial Rx parameters). The wireless device may not assume QCL for SS/PBCH block transmissions having different SS/PBCH block indices. SS/PBCH blocks (e.g., those within a half-frame) may be sent/transmitted in spatial directions (e.g., using different beams that span a coverage area of the cell). A first SS/PBCH block may be sent/transmitted in a first spatial direction using a first beam, a second SS/PBCH block may be sent/transmitted in a second spatial direction using a second beam, a third SS/PBCH block may be sent/transmitted in a third spatial direction using a third beam, a fourth SS/PBCH block may be sent/transmitted in a fourth spatial direction using a fourth beam, etc.

A base station may send/transmit a plurality of SS/PBCH blocks, for example, within a frequency span of a carrier. A first PCI of a first SS/PBCH block of the plurality of SS/PBCH blocks may be different from a second PCI of a second SS/PBCH block of the plurality of SS/PBCH blocks. The PCIs of SS/PBCH blocks sent/transmitted in different frequency locations may be different or substantially the same.

The CSI-RS may be sent/transmitted by the base station and used by the wireless device to acquire/obtain/determine channel state information (CSI). The base station may configure the wireless device with one or more CSI-RSs for channel estimation or any other suitable purpose. The base station may configure a wireless device with one or more of the same/similar CSI-RSs. The wireless device may measure the one or more CSI-RSs. The wireless device may estimate a downlink channel state and/or generate a CSI report, for example, based on the measuring of the one or more downlink CSI-RSs. The wireless device may send/transmit the CSI report to the base station (e.g., based on periodic CSI reporting, semi-persistent CSI reporting, and/or aperiodic CSI reporting). The base station may use feedback provided by the wireless device (e.g., the estimated downlink channel state) to perform a link adaptation.

The base station may semi-statically configure the wireless device with one or more CSI-RS resource sets. A CSI-RS resource may be associated with a location in the time and frequency domains and a periodicity. The base station may selectively activate and/or deactivate a CSI-RS resource. The base station may indicate to the wireless device that a CSI-RS resource in the CSI-RS resource set is activated and/or deactivated.

The base station may configure the wireless device to report CSI measurements. The base station may configure the wireless device to provide CSI reports periodically, aperiodically, or semi-persistently. For periodic CSI reporting, the wireless device may be configured with a timing and/or periodicity of a plurality of CSI reports. For aperiodic CSI reporting, the base station may request a CSI report. The base station may command the wireless device to measure a configured CSI-RS resource and provide a CSI report relating to the measurement(s). For semi-persistent CSI reporting, the base station may configure the wireless device to send/transmit periodically, and selectively activate or deactivate the periodic reporting (e.g., via one or more activation/deactivation MAC CEs and/or one or more DCIs). The base station may configure the wireless device with a CSI-RS resource set and CSI reports, for example, using RRC signaling.

The CSI-RS configuration may comprise one or more parameters indicating, for example, up to 32 antenna ports (or any other quantity of antenna ports). The wireless device may be configured to use/employ the same OFDM symbols for a downlink CSI-RS and a CORESET, for example, if the downlink CSI-RS and CORESET are spatially QCLed and resource elements associated with the downlink CSI-RS are outside of the physical resource blocks (PRBs) configured for the CORESET. The wireless device may be configured to use/employ the same OFDM symbols for a downlink CSI-RS and SS/PBCH blocks, for example, if the downlink CSI-RS and SS/PBCH blocks are spatially QCLed and resource elements associated with the downlink CSI-RS are outside of PRBs configured for the SS/PBCH blocks.

Downlink DM-RSs may be sent/transmitted by a base station and received/used by a wireless device for a channel estimation. The downlink DM-RSs may be used for coherent demodulation of one or more downlink physical channels (e.g., PDSCH). A network (e.g., an NR network) may support one or more variable and/or configurable DM-RS patterns for data demodulation. At least one downlink DM-RS configuration may support a front-loaded DM-RS pattern. A front-loaded DM-RS may be mapped over one or more OFDM symbols (e.g., one or two adjacent OFDM symbols). A base station may semi-statically configure the wireless device with a number/quantity (e.g. a maximum number/quantity) of front-loaded DM-RS symbols for a PDSCH. A DM-RS configuration may support one or more DM-RS ports. A DM-RS configuration may support up to eight orthogonal downlink DM-RS ports per wireless device (e.g., for single user-MIMO). A DM-RS configuration may support up to 4 orthogonal downlink DM-RS ports per wireless device (e.g., for multiuser-MIMO). A radio network may support (e.g., at least for CP-OFDM) a common DM-RS structure for downlink and uplink. A DM-RS location, a DM-RS pattern, and/or a scrambling sequence may be the same or different. The base station may send/transmit a downlink DM-RS and a corresponding PDSCH, for example, using the same precoding matrix. The wireless device may use the one or more downlink DM-RSs for coherent demodulation/channel estimation of the PDSCH.

A transmitter (e.g., a transmitter of a base station) may use a precoder matrices for a part of a transmission bandwidth. The transmitter may use a first precoder matrix for a first bandwidth and a second precoder matrix for a second bandwidth. The first precoder matrix and the second precoder matrix may be different, for example, based on the first bandwidth being different from the second bandwidth. The wireless device may assume that a same precoding matrix is used across a set of PRBs. The set of PRBs may be determined/indicated/identified/denoted as a precoding resource block group (PRG).

A PDSCH may comprise one or more layers. The wireless device may assume that at least one symbol with DM-RS is present on a layer of the one or more layers of the PDSCH. A higher layer may configure one or more DM-RSs for a PDSCH (e.g., up to 3 DMRSs for the PDSCH). Downlink PT-RS may be sent/transmitted by a base station and used by a wireless device, for example, for a phase-noise compensation. Whether a downlink PT-RS is present or not may depend on an RRC configuration. The presence and/or the pattern of the downlink PT-RS may be configured on a wireless device-specific basis, for example, using a combination of RRC signaling and/or an association with one or more parameters used/employed for other purposes (e.g., modulation and coding scheme (MCS)), which may be indicated by DCI. A dynamic presence of a downlink PT-RS, if configured, may be associated with one or more DCI parameters comprising at least MCS. A network (e.g., an NR network) may support a plurality of PT-RS densities defined in the time and/or frequency domains. A frequency domain density (if configured/present) may be associated with at least one configuration of a scheduled bandwidth. The wireless device may assume a same precoding for a DM-RS port and a PT-RS port. The quantity/number of PT-RS ports may be fewer than the quantity/number of DM-RS ports in a scheduled resource. Downlink PT-RS may be configured/allocated/confined in the scheduled time/frequency duration for the wireless device. Downlink PT-RS may be sent/transmitted via symbols, for example, to facilitate a phase tracking at the receiver.

The wireless device may send/transmit an uplink DM-RS to a base station, for example, for a channel estimation. The base station may use the uplink DM-RS for coherent demodulation of one or more uplink physical channels. The wireless device may send/transmit an uplink DM-RS with a PUSCH and/or a PUCCH. The uplink DM-RS may span a range of frequencies that is similar to a range of frequencies associated with the corresponding physical channel. The base station may configure the wireless device with one or more uplink DM-RS configurations. At least one DM-RS configuration may support a front-loaded DM-RS pattern. The front-loaded DM-RS may be mapped over one or more OFDM symbols (e.g., one or two adjacent OFDM symbols). One or more uplink DM-RSs may be configured to send/transmit at one or more symbols of a PUSCH and/or a PUCCH. The base station may semi-statically configure the wireless device with a number/quantity (e.g. the maximum number/quantity) of front-loaded DM-RS symbols for the PUSCH and/or the PUCCH, which the wireless device may use to schedule a single-symbol DM-RS and/or a double-symbol DM-RS. A network (e.g., an NR network) may support (e.g., for cyclic prefix orthogonal frequency division multiplexing (CP-OFDM)) a common DM-RS structure for downlink and uplink. A DM-RS location, a DM-RS pattern, and/or a scrambling sequence for the DM-RS may be substantially the same or different.

A PUSCH may comprise one or more layers. A wireless device may send/transmit at least one symbol with DM-RS present on a layer of the one or more layers of the PUSCH. A higher layer may configure one or more DM-RSs (e.g., up to three DMRSs) for the PUSCH. Uplink PT-RS (which may be used by a base station for a phase tracking and/or a phase-noise compensation) may or may not be present, for example, depending on an RRC configuration of the wireless device. The presence and/or the pattern of an uplink PT-RS may be configured on a wireless device-specific basis (e.g., a UE-specific basis), for example, by a combination of RRC signaling and/or one or more parameters configured/employed for other purposes (e.g., MCS), which may be indicated by DCI. A dynamic presence of an uplink PT-RS, if configured, may be associated with one or more DCI parameters comprising at least MCS. A radio network may support a plurality of uplink PT-RS densities defined in time/frequency domain. A frequency domain density (if configured/present) may be associated with at least one configuration of a scheduled bandwidth. The wireless device may assume a same precoding for a DM-RS port and a PT-RS port. A quantity/number of PT-RS ports may be less than a quantity/number of DM-RS ports in a scheduled resource. An uplink PT-RS may be configured/allocated/confined in the scheduled time/frequency duration for the wireless device.

One or more SRSs may be sent/transmitted by a wireless device to a base station, for example, for a channel state estimation to support uplink channel dependent scheduling and/or a link adaptation. SRS sent/transmitted by the wireless device may enable/allow a base station to estimate an uplink channel state at one or more frequencies. A scheduler at the base station may use/employ the estimated uplink channel state to assign one or more resource blocks for an uplink PUSCH transmission for the wireless device. The base station may semi-statically configure the wireless device with one or more SRS resource sets. For an SRS resource set, the base station may configure the wireless device with one or more SRS resources. An SRS resource set applicability may be configured, for example, by a higher layer (e.g., RRC) parameter. An SRS resource in a SRS resource set of the one or more SRS resource sets (e.g., with the same/similar time domain behavior, periodic, aperiodic, and/or the like) may be sent/transmitted at a time instant (e.g., simultaneously), for example, if a higher layer parameter indicates beam management. The wireless device may send/transmit one or more SRS resources in SRS resource sets. A network (e.g., an NR network) may support aperiodic, periodic, and/or semi-persistent SRS transmissions. The wireless device may send/transmit SRS resources, for example, based on one or more trigger types. The one or more trigger types may comprise higher layer signaling (e.g., RRC) and/or one or more DCI formats. At least one DCI format may be used/employed for the wireless device to select at least one of one or more configured SRS resource sets. An SRS trigger type 0 may refer to an SRS triggered based on higher layer signaling. An SRS trigger type 1 may refer to an SRS triggered based on one or more DCI formats. The wireless device may be configured to send/transmit an SRS, for example, after a transmission of a PUSCH and a corresponding uplink DM-RS if a PUSCH and an SRS are sent/transmitted in a same slot. A base station may semi-statically configure a wireless device with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; an offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port may be determined/defined such that the channel over which a symbol on the antenna port is conveyed can be inferred from the channel over which another symbol on the same antenna port is conveyed. The receiver may infer/determine the channel (e.g., fading gain, multipath delay, and/or the like) for conveying a second symbol on an antenna port, from the channel for conveying a first symbol on the antenna port, for example, if the first symbol and the second symbol are sent/transmitted on the same antenna port. A first antenna port and a second antenna port may be referred to as quasi co-located (QCLed), for example, if one or more large-scale properties of the channel over which a first symbol on the first antenna port is conveyed may be inferred from the channel over which a second symbol on a second antenna port is conveyed. The one or more large-scale properties may comprise at least one of: a delay spread; a Doppler spread; a Doppler shift; an average gain; an average delay; and/or spatial Receiving (Rx) parameters.

Channels that use beamforming may require beam management. Beam management may comprise a beam measurement, a beam selection, and/or a beam indication. A beam may be associated with one or more reference signals. A beam may be identified by one or more beamformed reference signals. The wireless device may perform a downlink beam measurement, for example, based on one or more downlink reference signals (e.g., a CSI-RS) and generate a beam measurement report. The wireless device may perform the downlink beam measurement procedure, for example, after an RRC connection is set up with a base station.

FIG. 11B shows an example mapping of one or more CSI-RSs. The CSI-RSs may be mapped in the time and frequency domains. Each rectangular block shown in FIG. 111B may correspond to a resource block (RB) within a bandwidth of a cell. A base station may send/transmit one or more RRC messages comprising CSI-RS resource configuration parameters indicating one or more CSI-RSs. One or more of parameters may be configured by higher layer signaling (e.g., RRC and/or MAC signaling) for a CSI-RS resource configuration. The one or more of the parameters may comprise at least one of: a CSI-RS resource configuration identity, a number of CSI-RS ports, a CSI-RS configuration (e.g., symbol and resource element (RE) locations in a subframe), a CSI-RS subframe configuration (e.g., a subframe location, an offset, and periodicity in a radio frame), a CSI-RS power parameter, a CSI-RS sequence parameter, a code division multiplexing (CDM) type parameter, a frequency density, a transmission comb, quasi co-location (QCL) parameters (e.g., QCL-scramblingidentity, crs-portscount, mbsfn-subframeconfiglist, csi-rs-configZPid, qcl-csi-rs-configNZPid), and/or other radio resource parameters.

One or more beams may be configured for a wireless device in a wireless device-specific configuration. Three beams are shown in FIG. 11B (beam #1, beam #2, and beam #3), but more or fewer beams may be configured. Beam #1 may be allocated with CSI-RS 1101 that may be sent/transmitted in one or more subcarriers in an RB of a first symbol. Beam #2 may be allocated with CSI-RS 1102 that may be sent/transmitted in one or more subcarriers in an RB of a second symbol. Beam #3 may be allocated with CSI-RS 1103 that may be sent/transmitted in one or more subcarriers in an RB of a third symbol. A base station may use other subcarriers in the same RB (e.g., those that are not used to send/transmit CSI-RS 1101) to transmit another CSI-RS associated with a beam for another wireless device, for example, by using frequency division multiplexing (FDM). Beams used for a wireless device may be configured such that beams for the wireless device use symbols different from symbols used by beams of other wireless devices, for example, by using time domain multiplexing (TDM). A wireless device may be served with beams in orthogonal symbols (e.g., no overlapping symbols), for example, by using the TDM.

CSI-RSs (e.g., CSI-RSs 1101, 1102, 1103) may be sent/transmitted by the base station and used by the wireless device for one or more measurements. The wireless device may measure an RSRP of configured CSI-RS resources. The base station may configure the wireless device with a reporting configuration, and the wireless device may report the RSRP measurements to a network (e.g., via one or more base stations) based on the reporting configuration. The base station may determine, based on the reported measurement results, one or more transmission configuration indication (TCI) states comprising a number of reference signals. The base station may indicate one or more TCI states to the wireless device (e.g., via RRC signaling, a MAC CE, and/or DCI). The wireless device may receive a downlink transmission with an Rx beam determined based on the one or more TCI states. The wireless device may or may not have a capability of beam correspondence. The wireless device may determine a spatial domain filter of a transmit (Tx) beam, for example, based on a spatial domain filter of the corresponding Rx beam, if the wireless device has the capability of beam correspondence. The wireless device may perform an uplink beam selection procedure to determine the spatial domain filter of the Tx beam, for example, if the wireless device does not have the capability of beam correspondence. The wireless device may perform the uplink beam selection procedure, for example, based on one or more sounding reference signal (SRS) resources configured to the wireless device by the base station. The base station may select and indicate uplink beams for the wireless device, for example, based on measurements of the one or more SRS resources sent/transmitted by the wireless device.

A wireless device may determine/assess (e.g., measure) a channel quality of one or more beam pair links, for example, in a beam management procedure. A beam pair link may comprise a Tx beam of a base station and an Rx beam of the wireless device. The Tx beam of the base station may send/transmit a downlink signal, and the Rx beam of the wireless device may receive the downlink signal. The wireless device may send/transmit a beam measurement report, for example, based on the assessment/determination. The beam measurement report may indicate one or more beam pair quality parameters comprising at least one of: one or more beam identifications (e.g., a beam index, a reference signal index, or the like), an RSRP, a precoding matrix indicator (PMI), a channel quality indicator (CQI), and/or a rank indicator (RI).

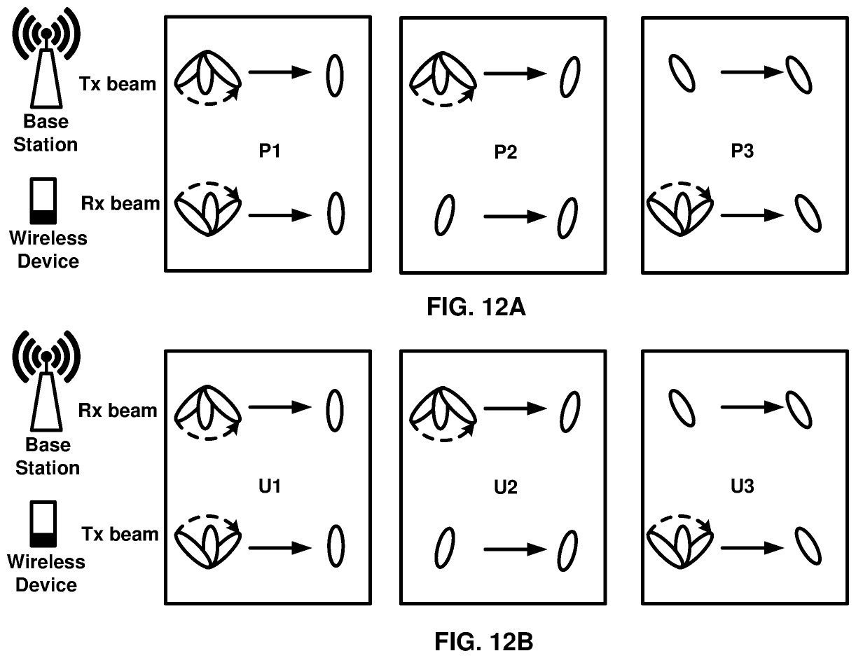

FIG. 12A shows examples of downlink beam management procedures. One or more downlink beam management procedures (e.g., downlink beam management procedures P1, P2, and P3) may be performed. Procedure P1 may enable a measurement (e.g., a wireless device measurement) on Tx beams of a TRP (or multiple TRPs) (e.g., to support a selection of one or more base station Tx beams and/or wireless device Rx beams). The Tx beams of a base station and the Rx beams of a wireless device are shown as ovals in the top row of P1 and bottom row of P1, respectively. Beamforming (e.g., at a TRP) may comprise a Tx beam sweep for a set of beams (e.g., the beam sweeps shown, in the top rows of P1 and P2, as ovals rotated in a counter-clockwise direction indicated by the dashed arrows). Beamforming (e.g., at a wireless device) may comprise an Rx beam sweep for a set of beams (e.g., the beam sweeps shown, in the bottom rows of P1 and P3, as ovals rotated in a clockwise direction indicated by the dashed arrows). Procedure P2 may be used to enable a measurement (e.g., a wireless device measurement) on Tx beams of a TRP (shown, in the top row of P2, as ovals rotated in a counter-clockwise direction indicated by the dashed arrow). The wireless device and/or the base station may perform procedure P2, for example, using a smaller set of beams than the set of beams used in procedure P1, or using narrower beams than the beams used in procedure P1. Procedure P2 may be referred to as a beam refinement. The wireless device may perform procedure P3 for an Rx beam determination, for example, by using the same Tx beam(s) of the base station and sweeping Rx beam(s) of the wireless device.

FIG. 12B shows examples of uplink beam management procedures. One or more uplink beam management procedures (e.g., uplink beam management procedures U1, U2, and U3) may be performed. Procedure U1 may be used to enable a base station to perform a measurement on Tx beams of a wireless device (e.g., to support a selection of one or more Tx beams of the wireless device and/or Rx beams of the base station). The Tx beams of the wireless device and the Rx beams of the base station are shown as ovals in the top row of U1 and bottom row of U1, respectively). Beamforming (e.g., at the wireless device) may comprise one or more beam sweeps, for example, a Tx beam sweep from a set of beams (shown, in the bottom rows of U1 and U3, as ovals rotated in a clockwise direction indicated by the dashed arrows). Beamforming (e.g., at the base station) may comprise one or more beam sweeps, for example, an Rx beam sweep from a set of beams (shown, in the top rows of U1 and U2, as ovals rotated in a counter-clockwise direction indicated by the dashed arrows). Procedure U2 may be used to enable the base station to adjust its Rx beam, for example, if the wireless device (e.g., UE) uses a fixed Tx beam. The wireless device and/or the base station may perform procedure U2, for example, using a smaller set of beams than the set of beams used in procedure P1, or using narrower beams than the beams used in procedure P1. Procedure U2 may be referred to as a beam refinement. The wireless device may perform procedure U3 to adjust its Tx beam, for example, if the base station uses a fixed Rx beam.

A wireless device may initiate/start/perform a beam failure recovery (BFR) procedure, for example, based on detecting a beam failure. The wireless device may send/transmit a BFR request (e.g., a preamble, UCI, an SR, a MAC CE, and/or the like), for example, based on the initiating the BFR procedure. The wireless device may detect the beam failure, for example, based on a determination that a quality of beam pair link(s) of an associated control channel is unsatisfactory (e.g., having an error rate higher than an error rate threshold, a received signal power lower than a received signal power threshold, an expiration of a timer, and/or the like).

The wireless device may measure a quality of a beam pair link, for example, using one or more reference signals (RSs) comprising one or more SS/PBCH blocks, one or more CSI-RS resources, and/or one or more DM-RSs. A quality of the beam pair link may be based on one or more of a block error rate (BLER), an RSRP value, a signal to interference plus noise ratio (SINR) value, an RSRQ value, and/or a CSI value measured on RS resources. The base station may indicate that an RS resource is QCLed with one or more DM-RSs of a channel (e.g., a control channel, a shared data channel, and/or the like). The RS resource and the one or more DM-RSs of the channel may be QCLed, for example, if the channel characteristics (e.g., Doppler shift, Doppler spread, an average delay, delay spread, a spatial Rx parameter, fading, and/or the like) from a transmission via the RS resource to the wireless device are similar or the same as the channel characteristics from a transmission via the channel to the wireless device.

A network (e.g., an NR network comprising a gNB and/or an ng-eNB) and/or the wireless device may initiate/start/perform a random-access procedure. A wireless device in an RRC idle (e.g., an RRC_IDLE) state and/or an RRC inactive (e.g., an RRC_INACTIVE) state may initiate/perform the random-access procedure to request a connection setup to a network. The wireless device may initiate/start/perform the random-access procedure from an RRC connected (e.g., an RRC_CONNECTED) state. The wireless device may initiate/start/perform the random-access procedure to request uplink resources (e.g., for uplink transmission of an SR if there is no PUCCH resource available) and/or acquire/obtain/determine an uplink timing (e.g., if an uplink synchronization status is non-synchronized). The wireless device may initiate/start/perform the random-access procedure to request one or more system information blocks (SIBs) (e.g., other system information blocks, such as SIB2, SIB3, and/or the like). The wireless device may initiate/start/perform the random-access procedure for a beam failure recovery request. A network may initiate/start/perform a random-access procedure, for example, for a handover and/or for establishing time alignment for an SCell addition.

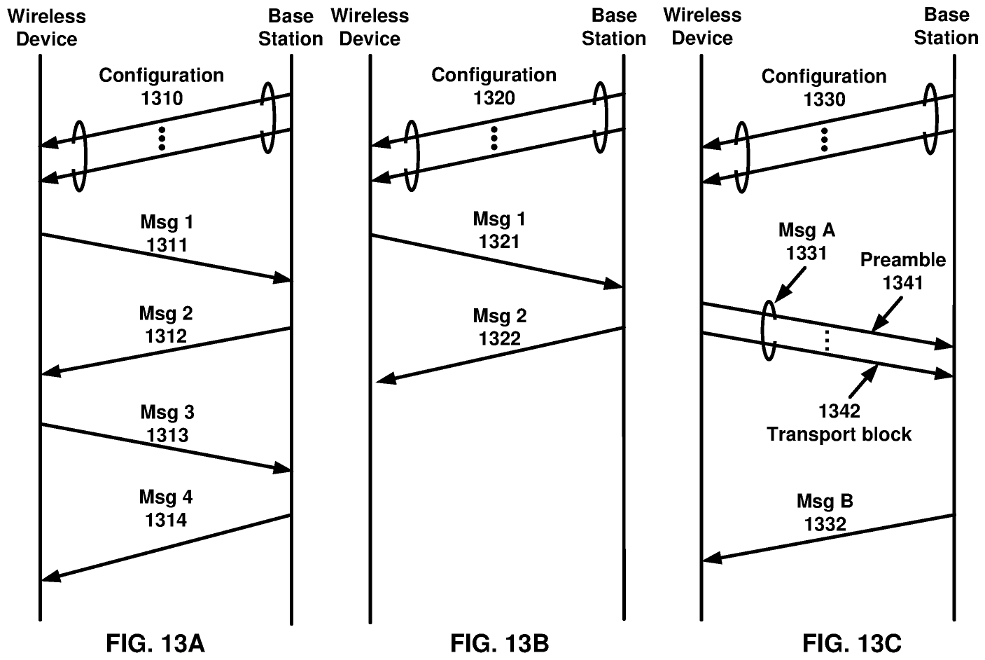

FIG. 13A shows an example four-step random access procedure. The four-step random access procedure may comprise a four-step contention-based random-access procedure. A base station may send/transmit a configuration message 1310 to a wireless device, for example, before initiating the random-access procedure. The four-step random access procedure may comprise transmissions of four messages comprising: a first message (e.g., Msg 1 1311), a second message (e.g., Msg 2 1312), a third message (e.g., Msg 3 1313), and a fourth message (e.g., Msg 4 1314). The first message (e.g., Msg 1 1311) may comprise a preamble (or a random-access preamble). The first message (e.g., Msg 1 1311) may be referred to as a preamble. The second message (e.g., Msg 2 1312) may comprise as a random-access response (RAR). The second message (e.g., Msg 2 1312) may be referred to as an RAR.

The configuration message 1310 may be sent/transmitted, for example, using one or more RRC messages. The one or more RRC messages may indicate one or more random access channel (RACH) parameters to the wireless device. The one or more RACH parameters may comprise at least one of: general parameters for one or more random access procedures (e.g., RACH-configGeneral); cell-specific parameters (e.g., RACH-ConfigCommon); and/or dedicated parameters (e.g., RACH-configDedicated). The base station may send/transmit (e.g., broadcast or multicast) the one or more RRC messages to one or more wireless devices. The one or more RRC messages may be wireless device-specific. The one or more RRC messages that are wireless device-specific may be, for example, dedicated RRC messages sent/transmitted to a wireless device in an RRC connected (e.g., an RRC_CONNECTED) state and/or in an RRC inactive (e.g., an RRC_INACTIVE) state. The wireless devices may determine, based on the one or more RACH parameters, a time-frequency resource and/or an uplink transmit power for transmission of the first message (e.g., Msg 1 1311) and/or the third message (e.g., Msg 3 1313). The wireless device may determine a reception timing and a downlink channel for receiving the second message (e.g., Msg 2 1312) and the fourth message (e.g., Msg 4 1314), for example, based on the one or more RACH parameters.

The one or more RACH parameters provided/configured/comprised in the configuration message 1310 may indicate one or more Physical RACH (PRACH) occasions available for transmission of the first message (e.g., Msg 1 1311). The one or more PRACH occasions may be predefined (e.g., by a network comprising one or more base stations). The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. The one or more RACH parameters may indicate a quantity/number of SS/PBCH blocks mapped to a PRACH occasion and/or a quantity/number of preambles mapped to a SS/PBCH blocks.

The one or more RACH parameters provided/configured/comprised in the configuration message 1310 may be used to determine an uplink transmit power of first message (e.g., Msg 1 1311) and/or third message (e.g., Msg 3 1313). The one or more RACH parameters may indicate a reference power for a preamble transmission (e.g., a received target power and/or an initial power of the preamble transmission). There may be one or more power offsets indicated by the one or more RACH parameters. The one or more RACH parameters may indicate: a power ramping step; a power offset between SSB and CSI-RS; a power offset between transmissions of the first message (e.g., Msg 1 1311) and the third message (e.g., Msg 3 1313); and/or a power offset value between preamble groups. The one or more RACH parameters may indicate one or more thresholds, for example, based on which the wireless device may determine at least one reference signal (e.g., an SSB and/or CSI-RS) and/or an uplink carrier (e.g., a normal uplink (NUL) carrier and/or a supplemental uplink (SUL) carrier).

The first message (e.g., Msg 1 1311) may comprise one or more preamble transmissions (e.g., a preamble transmission and one or more preamble retransmissions). An RRC message may be used to configure one or more preamble groups (e.g., group A and/or group B). A preamble group may comprise one or more preambles. The wireless device may determine the preamble group, for example, based on a pathloss measurement and/or a size of the third message (e.g., Msg 3 1313). The wireless device may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The wireless device may select at least one preamble associated with the one or more reference signals and/or a selected preamble group, for example, if the association between the one or more preambles and the at least one reference signal is configured by an RRC message.

The wireless device may determine the preamble, for example, based on the one or more RACH parameters provided/configured/comprised in the configuration message 1310. The wireless device may determine the preamble, for example, based on a pathloss measurement, an RSRP measurement, and/or a size of the third message (e.g., Msg 3 1313). The one or more RACH parameters may indicate: a preamble format; a maximum quantity/number of preamble transmissions; and/or one or more thresholds for determining one or more preamble groups (e.g., group A and group B). A base station may use the one or more RACH parameters to configure the wireless device with an association between one or more preambles and one or more reference signals (e.g., SSBs and/or CSI-RSs). The wireless device may determine the preamble to be comprised in first message (e.g., Msg 1 1311), for example, based on the association if the association is configured. The first message (e.g., Msg 1 1311) may be sent/transmitted to the base station via one or more PRACH occasions. The wireless device may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The wireless device may perform a preamble retransmission, for example, if no response is received based on (e.g., after or in response to) a preamble transmission (e.g., for a period of time, such as a monitoring window for monitoring an RAR). The wireless device may increase an uplink transmit power for the preamble retransmission. The wireless device may select an initial preamble transmit power, for example, based on a pathloss measurement and/or a target received preamble power configured by the network. The wireless device may determine to resend/retransmit a preamble and may ramp up the uplink transmit power. The wireless device may receive one or more RACH parameters (e.g., PREAMBLE_POWER_RAMPING_STEP) indicating a ramping step for the preamble retransmission. The ramping step may be an amount of incremental increase in uplink transmit power for a retransmission. The wireless device may ramp up the uplink transmit power, for example, if the wireless device determines a reference signal (e.g., SSB and/or CSI-RS) that is the same as a previous preamble transmission. The wireless device may count the quantity/number of preamble transmissions and/or retransmissions, for example, using a counter parameter (e.g., PREAMBLE_TRANSMISSION_COUNTER). The wireless device may determine that a random-access procedure has been completed unsuccessfully, for example, if the quantity/number of preamble transmissions exceeds a threshold configured by the one or more RACH parameters (e.g., preambleTransMax) without receiving a successful response (e.g., an RAR).

The second message (e.g., Msg 2 1312) (e.g., received by the wireless device) may comprise an RAR. The second message (e.g., Msg 2 1312) may comprise multiple RARs corresponding to multiple wireless devices. The second message (e.g., Msg 2 1312) may be received, for example, based on (e.g., after or in response to) the sending/transmitting of the first message (e.g., Msg 1 1311). The second message (e.g., Msg 2 1312) may be scheduled on the DL-SCH and may be indicated by a PDCCH, for example, using a random-access radio network temporary identifier (RA RNTI). The second message (e.g., Msg 2 1312) may indicate that the first message (e.g., Msg 1 1311) was received by the base station. The second message (e.g., Msg 2 1312) may comprise a time-alignment command that may be used by the wireless device to adjust the transmission timing of the wireless device, a scheduling grant for transmission of the third message (e.g., Msg 3 1313), and/or a Temporary Cell RNTI (TC-RNTI). The wireless device may determine/start a time window (e.g., ra-ResponseWindow) to monitor a PDCCH for the second message (e.g., Msg 2 1312), for example, after sending/transmitting the first message (e.g., Msg 1 1311) (e.g., a preamble). The wireless device may determine the start time of the time window, for example, based on a PRACH occasion that the wireless device uses to send/transmit the first message (e.g., Msg 1 1311) (e.g., the preamble). The wireless device may start the time window one or more symbols after the last symbol of the first message (e.g., Msg 1 1311) comprising the preamble (e.g., the symbol in which the first message (e.g., Msg 1 1311) comprising the preamble transmission was completed or at a first PDCCH occasion from an end of a preamble transmission). The one or more symbols may be determined based on a numerology. The PDCCH may be mapped in a common search space (e.g., a Type1-PDCCH common search space) configured by an RRC message. The wireless device may identify/determine the RAR, for example, based on an RNTI. Radio network temporary identifiers (RNTIs) may be used depending on one or more events initiating/starting the random-access procedure. The wireless device may use a RA-RNTI, for example, for one or more communications associated with random access or any other purpose. The RA-RNTI may be associated with PRACH occasions in which the wireless device sends/transmits a preamble. The wireless device may determine the RA-RNTI, for example, based on at least one of: an OFDM symbol index; a slot index; a frequency domain index; and/or a UL carrier indicator of the PRACH occasions. An example RA-RNTI may be determined as follows:

RA-RNTI=1+s_id+14×t_id+14×80×f_id+14×80×8×ul_carrier_id

where s_id may be an index of a first OFDM symbol of the PRACH occasion (e.g., 0≤s_id<14), t_id may be an index of a first slot of the PRACH occasion in a system frame (e.g., 0≤t_id<80), f_id may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).

The wireless device may send/transmit the third message (e.g., Msg 3 1313), for example, based on (e.g., after or in response to) a successful reception of the second message (e.g., Msg 2 1312) (e.g., using resources identified in the Msg 2 1312). The third message (e.g., Msg 3 1313) may be used, for example, for contention resolution in the contention-based random-access procedure. A plurality of wireless devices may send/transmit the same preamble to a base station, and the base station may send/transmit an RAR that corresponds to a wireless device. Collisions may occur, for example, if the plurality of wireless device interpret the RAR as corresponding to themselves. Contention resolution (e.g., using the third message (e.g., Msg 3 1313) and the fourth message (e.g., Msg 4 1314)) may be used to increase the likelihood that the wireless device does not incorrectly use an identity of another the wireless device. The wireless device may comprise a device identifier in the third message (e.g., Msg 3 1313) (e.g., a C-RNTI if assigned, a TC RNTI comprised in the second message (e.g., Msg 2 1312), and/or any other suitable identifier), for example, to perform contention resolution.

The fourth message (e.g., Msg 4 1314) may be received, for example, based on (e.g., after or in response to) the sending/transmitting of the third message (e.g., Msg 3 1313). The base station may address the wireless on the PDCCH (e.g., the base station may send the PDCCH to the wireless device) using a C-RNTI, for example, If the C-RNTI was included in the third message (e.g., Msg 3 1313). The random-access procedure may be determined to be successfully completed, for example, if the unique C RNTI of the wireless device is detected on the PDCCH (e.g., the PDCCH is scrambled by the C-RNTI). fourth message (e.g., Msg 4 1314) may be received using a DL-SCH associated with a TC RNTI, for example, if the TC RNTI is comprised in the third message (e.g., Msg 3 1313) (e.g., if the wireless device is in an RRC idle (e.g., an RRC_IDLE) state or not otherwise connected to the base station). The wireless device may determine that the contention resolution is successful and/or the wireless device may determine that the random-access procedure is successfully completed, for example, if a MAC PDU is successfully decoded and a MAC PDU comprises the wireless device contention resolution identity MAC CE that matches or otherwise corresponds with the CCCH SDU sent/transmitted in third message (e.g., Msg 3 1313).

The wireless device may be configured with an SUL carrier and/or an NUL carrier. An initial access (e.g., random access) may be supported via an uplink carrier. A base station may configure the wireless device with multiple RACH configurations (e.g., two separate RACH configurations comprising: one for an SUL carrier and the other for an NUL carrier). For random access in a cell configured with an SUL carrier, the network may indicate which carrier to use (NUL or SUL). The wireless device may determine to use the SUL carrier, for example, if a measured quality of one or more reference signals (e.g., one or more reference signals associated with the NUL carrier) is lower than a broadcast threshold. Uplink transmissions of the random-access procedure (e.g., the first message (e.g., Msg 1 1311) and/or the third message (e.g., Msg 3 1313)) may remain on, or may be performed via, the selected carrier. The wireless device may switch an uplink carrier during the random-access procedure (e.g., between the Msg 1 1311 and the Msg 3 1313). The wireless device may determine and/or switch an uplink carrier for the first message (e.g., Msg 1 1311) and/or the third message (e.g., Msg 3 1313), for example, based on a channel clear assessment (e.g., a listen-before-talk).

FIG. 13B shows a two-step random access procedure. The two-step random access procedure may comprise a two-step contention-free random-access procedure. Similar to the four-step contention-based random-access procedure, a base station may, prior to initiation of the procedure, send/transmit a configuration message 1320 to the wireless device. The configuration message 1320 may be analogous in some respects to the configuration message 1310. The procedure shown in FIG. 13B may comprise transmissions of two messages: a first message (e.g., Msg 11321) and a second message (e.g., Msg 2 1322). The first message (e.g., Msg 1 1321) and the second message (e.g., Msg 2 1322) may be analogous in some respects to the first message (e.g., Msg 1 1311) and a second message (e.g., Msg 2 1312), respectively. The two-step contention-free random-access procedure may not comprise messages analogous to the third message (e.g., Msg 3 1313) and/or the fourth message (e.g., Msg 4 1314).

The two-step (e.g., contention-free) random access procedure may be configured/initiated for a beam failure recovery, other SI request, an SCell addition, and/or a handover. A base station may indicate, or assign to, the wireless device a preamble to be used for the first message (e.g., Msg 1 1321). The wireless device may receive, from the base station via a PDCCH and/or an RRC, an indication of the preamble (e.g., ra-PreambleIndex).

The wireless device may start a time window (e.g., ra-ResponseWindow) to monitor a PDCCH for the RAR, for example, based on (e.g., after or in response to) sending/transmitting the preamble. The base station may configure the wireless device with one or more beam failure recovery parameters, such as a separate time window and/or a separate PDCCH in a search space indicated by an RRC message (e.g., recoverySearchSpaceId). The base station may configure the one or more beam failure recovery parameters, for example, in association with a beam failure recovery request. The separate time window for monitoring the PDCCH and/or an RAR may be configured to start after sending/transmitting a beam failure recovery request (e.g., the window may start any quantity of symbols and/or slots after sending/transmitting the beam failure recovery request). The wireless device may monitor for a PDCCH transmission addressed to a Cell RNTI (C-RNTI) on the search space. During the two-step (e.g., contention-free) random access procedure, the wireless device may determine that a random-access procedure is successful, for example, based on (e.g., after or in response to) sending/transmitting first message (e.g., Msg 1 1321) and receiving a corresponding second message (e.g., Msg 2 1322). The wireless device may determine that a random-access procedure has successfully been completed, for example, if a PDCCH transmission is addressed to a corresponding C-RNTI. The wireless device may determine that a random-access procedure has successfully been completed, for example, if the wireless device receives an RAR comprising a preamble identifier corresponding to a preamble sent/transmitted by the wireless device and/or the RAR comprises a MAC sub-PDU with the preamble identifier. The wireless device may determine the response as an indication of an acknowledgement for an SI request.

FIG. 13C shows an example two-step random access procedure. Similar to the random-access procedures shown in FIGS. 13A and 13B, a base station may, prior to initiation of the procedure, send/transmit a configuration message 1330 to the wireless device. The configuration message 1330 may be analogous in some respects to the configuration message 1310 and/or the configuration message 1320. The procedure shown in FIG. 13C may comprise transmissions of multiple messages (e.g., two messages comprising: a first message (e.g., Msg A 1331) and a second message (e.g., Msg B 1332)).

Msg A 1320 may be sent/transmitted in an uplink transmission by the wireless device. Msg A 1320 may comprise one or more transmissions of a preamble 1341 and/or one or more transmissions of a transport block 1342. The transport block 1342 may comprise contents that are similar and/or equivalent to the contents of the third message (e.g., Msg 3 1313) (e.g., shown in FIG. 13A). The transport block 1342 may comprise UCI (e.g., an SR, a HARQ ACK/NACK, and/or the like). The wireless device may receive the second message (e.g., Msg B 1332), for example, based on (e.g., after or in response to) sending/transmitting the first message (e.g., Msg A 1331). The second message (e.g., Msg B 1332) may comprise contents that are similar and/or equivalent to the contents of the second message (e.g., Msg 2 1312) (e.g., an RAR shown in FIGS. 13A), the contents of the second message (e.g., Msg 2 1322) (e.g., an RAR shown in FIG. 13B) and/or the fourth message (e.g., Msg 4 1314) (e.g., shown in FIG. 13A).

The wireless device may start/initiate the two-step random access procedure (e.g., the two-step random access procedure shown in FIG. 13C) for a licensed spectrum and/or an unlicensed spectrum. The wireless device may determine, based on one or more factors, whether to start/initiate the two-step random access procedure. The one or more factors may comprise at least one of: a radio access technology in use (e.g., LTE, NR, and/or the like); whether the wireless device has a valid TA or not; a cell size; the RRC state of the wireless device; a type of spectrum (e.g., licensed vs. unlicensed); and/or any other suitable factors.

The wireless device may determine, based on two-step RACH parameters comprised in the configuration message 1330, a radio resource and/or an uplink transmit power for the preamble 1341 and/or the transport block 1342 (e.g., comprised in the first message (e.g., Msg A 1331)). The RACH parameters may indicate an MCS, a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the wireless device to determine a reception timing and a downlink channel for monitoring for and/or receiving second message (e.g., Msg B 1332).

The transport block 1342 may comprise data (e.g., delay-sensitive data), an identifier of the wireless device, security information, and/or device information (e.g., an International Mobile Subscriber Identity (IMSI)). The base station may send/transmit the second message (e.g., Msg B 1332) as a response to the first message (e.g., Msg A 1331). The second message (e.g., Msg B 1332) may comprise at least one of: a preamble identifier; a timing advance command; a power control command; an uplink grant (e.g., a radio resource assignment and/or an MCS); a wireless device identifier (e.g., a UE identifier for contention resolution); and/or an RNTI (e.g., a C-RNTI or a TC-RNTI). The wireless device may determine that the two-step random access procedure is successfully completed, for example, if a preamble identifier in the second message (e.g., Msg B 1332) corresponds to, or is matched to, a preamble sent/transmitted by the wireless device and/or the identifier of the wireless device in second message (e.g., Msg B 1332) corresponds to, or is matched to, the identifier of the wireless device in the first message (e.g., Msg A 1331) (e.g., the transport block 1342).

A wireless device and a base station may exchange control signaling (e.g., control information). The control signaling may be referred to as L1/L2 control signaling and may originate from the PHY layer (e.g., layer 1) and/or the MAC layer (e.g., layer 2) of the wireless device or the base station. The control signaling may comprise downlink control signaling sent/transmitted from the base station to the wireless device and/or uplink control signaling sent/transmitted from the wireless device to the base station.

The downlink control signaling may comprise at least one of: a downlink scheduling assignment; an uplink scheduling grant indicating uplink radio resources and/or a transport format; slot format information; a preemption indication; a power control command; and/or any other suitable signaling. The wireless device may receive the downlink control signaling in a payload sent/transmitted by the base station via a PDCCH. The payload sent/transmitted via the PDCCH may be referred to as downlink control information (DCI). The PDCCH may be a group common PDCCH (GC-PDCCH) that is common to a group of wireless devices. The GC-PDCCH may be scrambled by a group common RNTI.

A base station may attach one or more cyclic redundancy check (CRC) parity bits to DCI, for example, in order to facilitate detection of transmission errors. The base station may scramble the CRC parity bits with an identifier of a wireless device (or an identifier of a group of wireless devices), for example, if the DCI is intended for the wireless device (or the group of the wireless devices). Scrambling the CRC parity bits with the identifier may comprise Modulo-2 addition (or an exclusive-OR operation) of the identifier value and the CRC parity bits. The identifier may comprise a 16-bit value of an RNTI.

DCIs may be used for different purposes. A purpose may be indicated by the type of an RNTI used to scramble the CRC parity bits. DCI having CRC parity bits scrambled with a paging RNTI (P-RNTI) may indicate paging information and/or a system information change notification. The P-RNTI may be predefined as “FFFE” in hexadecimal. DCI having CRC parity bits scrambled with a system information RNTI (SI-RNTI) may indicate a broadcast transmission of the system information. The SI-RNTI may be predefined as “FFFF” in hexadecimal. DCI having CRC parity bits scrambled with a random access RNTI (RA-RNTI) may indicate a random-access response (RAR). DCI having CRC parity bits scrambled with a cell RNTI (C-RNTI) may indicate a dynamically scheduled unicast transmission and/or a triggering of PDCCH-ordered random access. DCI having CRC parity bits scrambled with a temporary cell RNTI (TC-RNTI) may indicate a contention resolution (e.g., a Msg 3 analogous to the Msg 3 1313 shown in FIG. 13A). Other RNTIs configured for a wireless device by a base station may comprise a Configured Scheduling RNTI (CS RNTI), a Transmit Power Control-PUCCH RNTI (TPC PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C RNTI), and/or the like.

A base station may send/transmit DCIs with one or more DCI formats, for example, depending on the purpose and/or content of the DCIs. DCI format 0_0 may be used for scheduling of a PUSCH in a cell. DCI format 0_0 may be a fallback DCI format (e.g., with compact DCI payloads). DCI format 0_1 may be used for scheduling of a PUSCH in a cell (e.g., with more DCI payloads than DCI format 0_0). DCI format 1_0 may be used for scheduling of a PDSCH in a cell. DCI format 1_0 may be a fallback DCI format (e.g., with compact DCI payloads). DCI format L1 may be used for scheduling of a PDSCH in a cell (e.g., with more DCI payloads than DCI format 1_0). DCI format 2_0 may be used for providing a slot format indication to a group of wireless devices. DCI format 21 may be used for informing/notifying a group of wireless devices of a physical resource block and/or an OFDM symbol where the group of wireless devices may assume no transmission is intended to the group of wireless devices. DCI format 2_2 may be used for transmission of a transmit power control (TPC) command for PUCCH or PUSCH. DCI format 2_3 may be used for transmission of a group of TPC commands for SRS transmissions by one or more wireless devices. DCI format(s) for new functions may be defined in future releases. DCI formats may have different DCI sizes, or may share the same DCI size.

The base station may process the DCI with channel coding (e.g., polar coding), rate matching, scrambling and/or QPSK modulation, for example, after scrambling the DCI with an RNTI. A base station may map the coded and modulated DCI on resource elements used and/or configured for a PDCCH. The base station may send/transmit the DCI via a PDCCH occupying a number of contiguous control channel elements (CCEs), for example, based on a payload size of the DCI and/or a coverage of the base station. The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

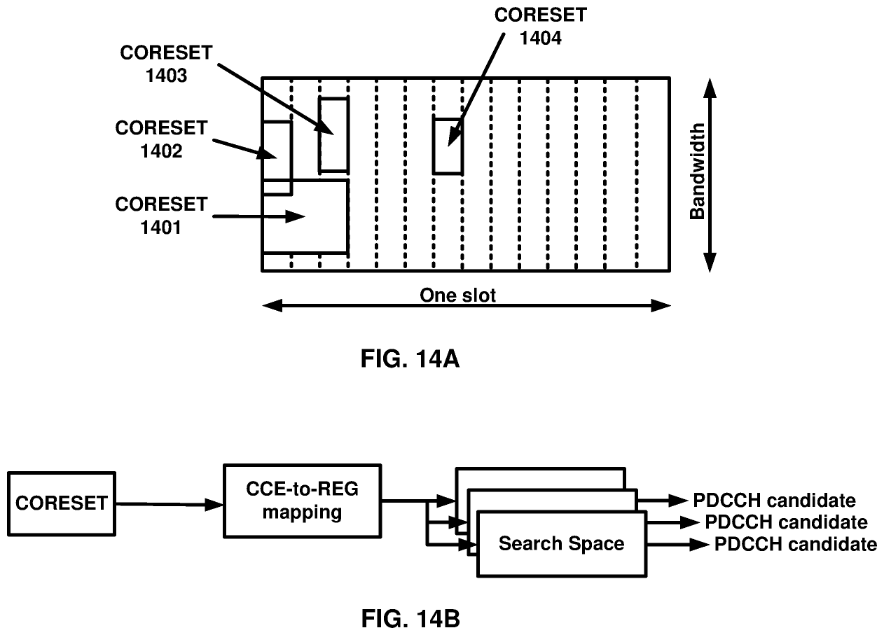

FIG. 14A shows an example of CORESET configurations. The CORESET configurations may be for a bandwidth part or any other frequency bands. The base station may send/transmit DCI via a PDCCH on one or more control resource sets (CORESETs). A CORESET may comprise a time-frequency resource in which the wireless device attempts/tries to decode DCI using one or more search spaces. The base station may configure a size and a location of the CORESET in the time-frequency domain. A first CORESET 1401 and a second CORESET 1402 may occur or may be set/configured at the first symbol in a slot. The first CORESET 1401 may overlap with the second CORESET 1402 in the frequency domain. A third CORESET 1403 may occur or may be set/configured at a third symbol in the slot. A fourth CORESET 1404 may occur or may be set/configured at the seventh symbol in the slot. CORESETs may have a different number of resource blocks in frequency domain.

FIG. 14B shows an example of a CCE-to-REG mapping. The CCE-to-REG mapping may be performed for DCI transmission via a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping (e.g., by an RRC configuration). A CORESET may be configured with an antenna port QCL parameter. The antenna port QCL parameter may indicate QCL information of a DM-RS for a PDCCH reception via the CORESET.

The base station may send/transmit, to the wireless device, one or more RRC messages comprising configuration parameters of one or more CORESETs and one or more search space sets. The configuration parameters may indicate an association between a search space set and a CORESET. A search space set may comprise a set of PDCCH candidates formed by CCEs (e.g., at a given aggregation level). The configuration parameters may indicate at least one of: a number of PDCCH candidates to be monitored per aggregation level; a PDCCH monitoring periodicity and a PDCCH monitoring pattern; one or more DCI formats to be monitored by the wireless device; and/or whether a search space set is a common search space set or a wireless device-specific search space set (e.g., a UE-specific search space set). A set of CCEs in the common search space set may be predefined and known to the wireless device. A set of CCEs in the wireless device-specific search space set (e.g., the UE-specific search space set) may be configured, for example, based on the identity of the wireless device (e.g., C-RNTI).

As shown in FIG. 14B, the wireless device may determine a time-frequency resource for a CORESET based on one or more RRC messages. The wireless device may determine a CCE-to-REG mapping (e.g., interleaved or non-interleaved, and/or mapping parameters) for the CORESET, for example, based on configuration parameters of the CORESET. The wireless device may determine a number (e.g., at most 10) of search space sets configured on/for the CORESET, for example, based on the one or more RRC messages. The wireless device may monitor a set of PDCCH candidates according to configuration parameters of a search space set. The wireless device may monitor a set of PDCCH candidates in one or more CORESETs for detecting one or more DCIs. Monitoring may comprise decoding one or more PDCCH candidates of the set of the PDCCH candidates according to the monitored DCI formats. Monitoring may comprise decoding DCI content of one or more PDCCH candidates with possible (or configured) PDCCH locations, possible (or configured) PDCCH formats (e.g., the number of CCEs, the number of PDCCH candidates in common search spaces, and/or the number of PDCCH candidates in the wireless device-specific search spaces) and possible (or configured) DCI formats. The decoding may be referred to as blind decoding. The wireless device may determine DCI as valid for the wireless device, for example, based on (e.g., after or in response to) CRC checking (e.g., scrambled bits for CRC parity bits of the DCI matching an RNTI value). The wireless device may process information comprised in the DCI (e.g., a scheduling assignment, an uplink grant, power control, a slot format indication, a downlink preemption, and/or the like).

The may send/transmit uplink control signaling (e.g., UCI) to a base station. The uplink control signaling may comprise HARQ acknowledgements for received DL-SCH transport blocks. The wireless device may send/transmit the HARQ acknowledgements, for example, based on (e.g., after or in response to) receiving a DL-SCH transport block. Uplink control signaling may comprise CSI indicating a channel quality of a physical downlink channel. The wireless device may send/transmit the CSI to the base station. The base station, based on the received CSI, may determine transmission format parameters (e.g., comprising multi-antenna and beamforming schemes) for downlink transmission(s). Uplink control signaling may comprise scheduling requests (SR). The wireless device may send/transmit an SR indicating that uplink data is available for transmission to the base station. The wireless device may send/transmit UCI (e.g., HARQ acknowledgements (HARQ-ACK), CSI report, SR, and the like) via a PUCCH or a PUSCH. The wireless device may send/transmit the uplink control signaling via a PUCCH using one of several PUCCH formats.

There may be multiple PUCCH formats (e.g., five PUCCH formats). A wireless device may determine a PUCCH format, for example, based on a size of UCI (e.g., a quantity/number of uplink symbols of UCI transmission and a number of UCI bits). PUCCH format 0 may have a length of one or two OFDM symbols and may comprise two or fewer bits. The wireless device may send/transmit UCI via a PUCCH resource, for example, using PUCCH format 0 if the transmission is over/via one or two symbols and the quantity/number of HARQ-ACK information bits with positive or negative SR (HARQ-ACK/SR bits) is one or two. PUCCH format 1 may occupy a number of OFDM symbols (e.g., between four and fourteen OFDM symbols) and may comprise two or fewer bits. The wireless device may use PUCCH format 1, for example, if the transmission is over/via four or more symbols and the number of HARQ-ACK/SR bits is one or two. PUCCH format 2 may occupy one or two OFDM symbols and may comprise more than two bits. The wireless device may use PUCCH format 2, for example, if the transmission is over/via one or two symbols and the quantity/number of UCI bits is two or more. PUCCH format 3 may occupy a number of OFDM symbols (e.g., between four and fourteen OFDM symbols) and may comprise more than two bits. The wireless device may use PUCCH format 3, for example, if the transmission is four or more symbols, the quantity/number of UCI bits is two or more, and the PUCCH resource does not comprise an orthogonal cover code (OCC). PUCCH format 4 may occupy a number of OFDM symbols (e.g., between four and fourteen OFDM symbols) and may comprise more than two bits. The wireless device may use PUCCH format 4, for example, if the transmission is four or more symbols, the quantity/number of UCI bits is two or more, and the PUCCH resource comprises an OCC.

The base station may send/transmit configuration parameters to the wireless device for a plurality of PUCCH resource sets, for example, using an RRC message. The plurality of PUCCH resource sets (e.g., up to four sets in NR, or up to any other quantity of sets in other systems) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a number (e.g. a maximum number) of UCI information bits the wireless device may send/transmit using one of the plurality of PUCCH resources in the PUCCH resource set. The wireless device may select one of the plurality of PUCCH resource sets, for example, based on a total bit length of the UCI information bits (e.g., HARQ-ACK, SR, and/or CSI) if configured with a plurality of PUCCH resource sets. The wireless device may select a first PUCCH resource set having a PUCCH resource set index equal to “0,” for example, if the total bit length of UCI information bits is two or fewer. The wireless device may select a second PUCCH resource set having a PUCCH resource set index equal to “1,” for example, if the total bit length of UCI information bits is greater than two and less than or equal to a first configured value. The wireless device may select a third PUCCH resource set having a PUCCH resource set index equal to “2,” for example, if the total bit length of UCI information bits is greater than the first configured value and less than or equal to a second configured value. The wireless device may select a fourth PUCCH resource set having a PUCCH resource set index equal to “3,” for example, if the total bit length of UCI information bits is greater than the second configured value and less than or equal to a third value (e.g., 1406, 1706, or any other quantity of bits).

The wireless device may determine a PUCCH resource from the PUCCH resource set for UCI (HARQ-ACK, CSI, and/or SR) transmission, for example, after determining a PUCCH resource set from a plurality of PUCCH resource sets. The wireless device may determine the PUCCH resource, for example, based on a PUCCH resource indicator in DCI (e.g., with DCI format 1_0 or DCI for 1_1) received on/via a PDCCH. An n-bit (e.g., a three-bit) PUCCH resource indicator in the DCI may indicate one of multiple (e.g., eight) PUCCH resources in the PUCCH resource set. The wireless device may send/transmit the UCI (HARQ-ACK, CSI and/or SR) using a PUCCH resource indicated by the PUCCH resource indicator in the DCI, for example, based on the PUCCH resource indicator.

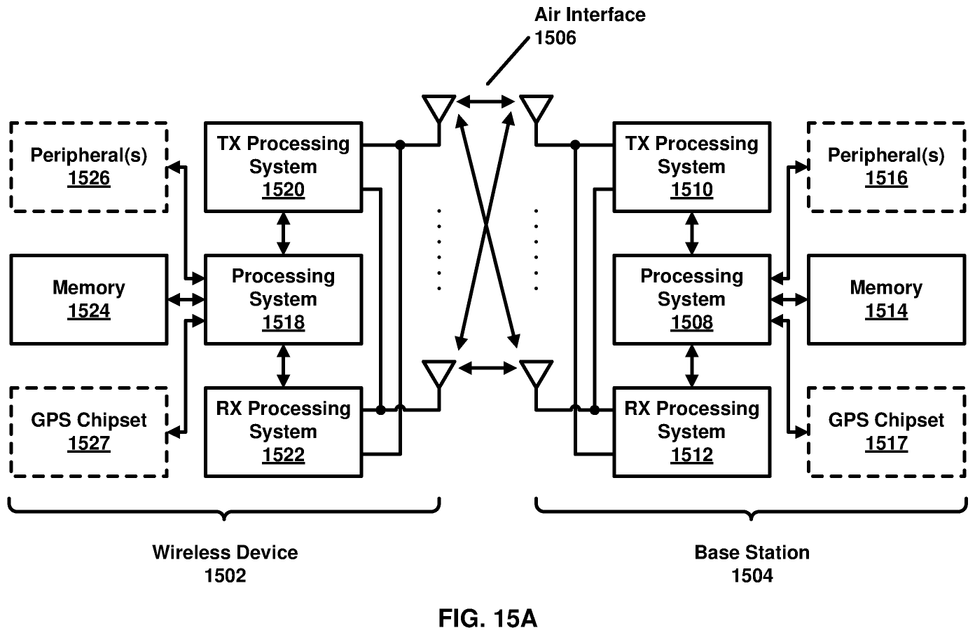

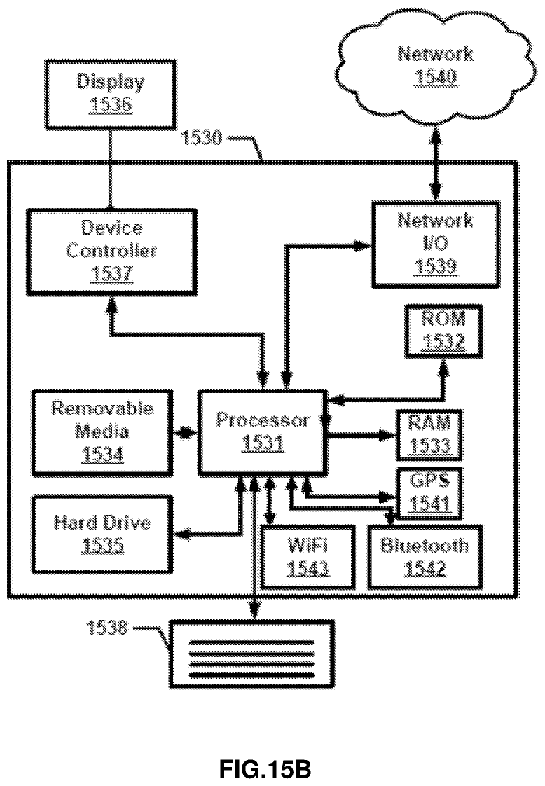

FIG. 15A shows example communications between a wireless device and a base station. A wireless device 1502 and a base station 1504 may be part of a communication network, such as the communication network 100 shown in FIG. 1A, the communication network 150 shown in FIG. 1B, or any other communication network. A communication network may comprise more than one wireless device and/or more than one base station, with substantially the same or similar configurations as those shown in FIG. 15A.

The base station 1504 may connect the wireless device 1502 to a core network (not shown) via radio communications over the air interface (or radio interface) 1506. The communication direction from the base station 1504 to the wireless device 1502 over the air interface 1506 may be referred to as the downlink. The communication direction from the wireless device 1502 to the base station 1504 over the air interface may be referred to as the uplink. Downlink transmissions may be separated from uplink transmissions, for example, using various duplex schemes (e.g., FDD, TDD, and/or some combination of the duplexing techniques).

For the downlink, data to be sent to the wireless device 1502 from the base station 1504 may be provided/transferred/sent to the processing system 1508 of the base station 1504. The data may be provided/transferred/sent to the processing system 1508 by, for example, a core network. For the uplink, data to be sent to the base station 1504 from the wireless device 1502 may be provided/transferred/sent to the processing system 1518 of the wireless device 1502. The processing system 1508 and the processing system 1518 may implement layer 3 and layer 2 OSI functionality to process the data for transmission. Layer 2 may comprise an SDAP layer, a PDCP layer, an RLC layer, and a MAC layer, for example, described with respect to FIG. 2A, FIG. 2B, FIG. 3, and FIG. 4A. Layer 3 may comprise an RRC layer, for example, described with respect to FIG. 2B.

The data to be sent to the wireless device 1502 may be provided/transferred/sent to a transmission processing system 1510 of base station 1504, for example, after being processed by the processing system 1508. The data to be sent to base station 1504 may be provided/transferred/sent to a transmission processing system 1520 of the wireless device 1502, for example, after being processed by the processing system 1518. The transmission processing system 1510 and the transmission processing system 1520 may implement layer 1 OSI functionality. Layer 1 may comprise a PHY layer, for example, described with respect to FIG. 2A, FIG. 2B, FIG. 3, and FIG. 4A. For transmit processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

A reception processing system 1512 of the base station 1504 may receive the uplink transmission from the wireless device 1502. The reception processing system 1512 of the base station 1504 may comprise one or more TRPs. A reception processing system 1522 of the wireless device 1502 may receive the downlink transmission from the base station 1504. The reception processing system 1522 of the wireless device 1502 may comprise one or more antenna panels. The reception processing system 1512 and the reception processing system 1522 may implement layer 1 OSI functionality. Layer 1 may include a PHY layer, for example, described with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

The base station 1504 may comprise multiple antennas (e.g., multiple antenna panels, multiple TRPs, etc.). The wireless device 1502 may comprise multiple antennas (e.g., multiple antenna panels, etc.). The multiple antennas may be used to perform one or more MIMO or multi-antenna techniques, such as spatial multiplexing (e.g., single-user MIMO or multi-user MIMO), transmit/receive diversity, and/or beamforming. The wireless device 1502 and/or the base station 1504 may have a single antenna.

The processing system 1508 and the processing system 1518 may be associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518, respectively, to carry out one or more of the functionalities (e.g., one or more functionalities described herein and other functionalities of general computers, processors, memories, and/or other peripherals). The transmission processing system 1510 and/or the reception processing system 1512 may be coupled to the memory 1514 and/or another memory (e.g., one or more non-transitory computer readable mediums) storing computer program instructions or code that may be executed to carry out one or more of their respective functionalities. The transmission processing system 1520 and/or the reception processing system 1522 may be coupled to the memory 1524 and/or another memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and/or the base station 1504 to operate in a wireless environment.

The processing system 1508 may be connected to one or more peripherals 1516. The processing system 1518 may be connected to one or more peripherals 1526. The one or more peripherals 1516 and the one or more peripherals 1526 may comprise software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive input data (e.g., user input data) from, and/or provide output data (e.g., user output data) to, the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 may be connected to a Global Positioning System (GPS) chipset 1517. The processing system 1518 may be connected to a Global Positioning System (GPS) chipset 1527. The GPS chipset 1517 and the GPS chipset 1527 may be configured to determine and provide geographic location information of the wireless device 1502 and the base station 1504, respectively.

FIG. 15B shows example elements of a computing device that may be used to implement any of the various devices described herein, including, for example, the base station 160A, 160B, 162A, 162B, 220, and/or 1504, the wireless device 106, 156A, 156B, 210, and/or 1502, or any other base station, wireless device, AMF, UPF, network device, or computing device described herein. The computing device 1530 may include one or more processors 1531, which may execute instructions stored in the random-access memory (RAM) 1533, the removable media 1534 (such as a Universal Serial Bus (USB) drive, compact disk (CD) or digital versatile disk (DVD), or floppy disk drive), or any other desired storage medium. Instructions may also be stored in an attached (or internal) hard drive 1535. The computing device 1530 may also include a security processor (not shown), which may execute instructions of one or more computer programs to monitor the processes executing on the processor 1531 and any process that requests access to any hardware and/or software components of the computing device 1530 (e.g., ROM 1532, RAM 1533, the removable media 1534, the hard drive 1535, the device controller 1537, a network interface 1539, a GPS 1541, a Bluetooth interface 1542, a WiFi interface 1543, etc.). The computing device 1530 may include one or more output devices, such as the display 1536 (e.g., a screen, a display device, a monitor, a television, etc.), and may include one or more output device controllers 1537, such as a video processor. There may also be one or more user input devices 1538, such as a remote control, keyboard, mouse, touch screen, microphone, etc. The computing device 1530 may also include one or more network interfaces, such as a network interface 1539, which may be a wired interface, a wireless interface, or a combination of the two. The network interface 1539 may provide an interface for the computing device 1530 to communicate with a network 1540 (e.g., a RAN, or any other network). The network interface 1539 may include a modem (e.g., a cable modem), and the external network 1540 may include communication links, an external network, an in-home network, a provider's wireless, coaxial, fiber, or hybrid fiber/coaxial distribution system (e.g., a DOCSIS network), or any other desired network. Additionally, the computing device 1530 may include a location-detecting device, such as a global positioning system (GPS) microprocessor 1541, which may be configured to receive and process global positioning signals and determine, with possible assistance from an external server and antenna, a geographic position of the computing device 1530.

The example in FIG. 15B may be a hardware configuration, although the components shown may be implemented as software as well. Modifications may be made to add, remove, combine, divide, etc. components of the computing device 1530 as desired. Additionally, the components may be implemented using basic computing devices and components, and the same components (e.g., processor 1531, ROM storage 1532, display 1536, etc.) may be used to implement any of the other computing devices and components described herein. For example, the various components described herein may be implemented using computing devices having components such as a processor executing computer-executable instructions stored on a computer-readable medium, as shown in FIG. 15B. Some or all of the entities described herein may be software based, and may co-exist in a common physical platform (e.g., a requesting entity may be a separate software process and program from a dependent entity, both of which may be executed as software on a common computing device).

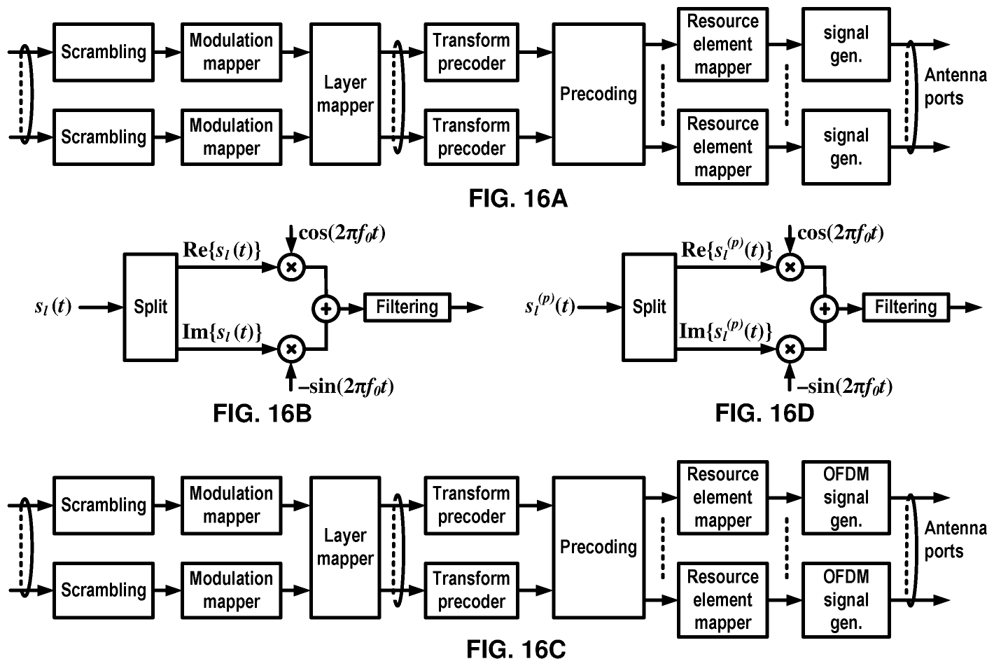

FIG. 16A shows an example structure for uplink transmission. Processing of a baseband signal representing a physical uplink shared channel may comprise/perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA), CP-OFDM signal for an antenna port, or any other signals; and/or the like. An SC-FDMA signal for uplink transmission may be generated, for example, if transform precoding is enabled. A CP-OFDM signal for uplink transmission may be generated, for example, if transform precoding is not enabled (e.g., as shown in FIG. 16A). These functions are examples and other mechanisms for uplink transmission may be implemented.

FIG. 16B shows an example structure for modulation and up-conversion of a baseband signal to a carrier frequency. The baseband signal may be a complex-valued SC-FDMA, CP-OFDM baseband signal (or any other baseband signals) for an antenna port and/or a complex-valued Physical Random Access Channel (PRACH) baseband signal. Filtering may be performed/employed, for example, prior to transmission.

FIG. 16C shows an example structure for downlink transmissions. Processing of a baseband signal representing a physical downlink channel may comprise/perform one or more functions. The one or more functions may comprise: scrambling of coded bits in a codeword to be sent/transmitted on/via a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are examples and other mechanisms for downlink transmission may be implemented.

FIG. 16D shows an example structure for modulation and up-conversion of a baseband signal to a carrier frequency. The baseband signal may be a complex-valued OFDM baseband signal for an antenna port or any other signal. Filtering may be performed/employed, for example, prior to transmission.

A wireless device may receive, from a base station, one or more messages (e.g. RRC messages) comprising configuration parameters of a plurality of cells (e.g., a primary cell, one or more secondary cells). The wireless device may communicate with at least one base station (e.g., two or more base stations in dual-connectivity) via the plurality of cells. The one or more messages (e.g. as a part of the configuration parameters) may comprise parameters of PHY, MAC, RLC, PCDP, SDAP, RRC layers for configuring the wireless device. The configuration parameters may comprise parameters for configuring PHY and MAC layer channels, bearers, etc. The configuration parameters may comprise parameters indicating values of timers for PHY, MAC, RLC, PCDP, SDAP, RRC layers, and/or communication channels.

A timer may begin running, for example, once it is started and continue running until it is stopped or until it expires. A timer may be started, for example, if it is not running or restarted if it is running. A timer may be associated with a value (e.g., the timer may be started or restarted from a value or may be started from zero and expire once it reaches the value). The duration of a timer may not be updated, for example, until the timer is stopped or expires (e.g., due to BWP switching). A timer may be used to measure a time period/window for a process. With respect to an implementation and/or procedure related to one or more timers or other parameters, it will be understood that there may be multiple ways to implement the one or more timers or other parameters. One or more of the multiple ways to implement a timer may be used to measure a time period/window for the procedure. A random-access response window timer may be used for measuring a window of time for receiving a random-access response. The time difference between two time stamps may be used, for example, instead of starting a random access response window timer and determine the expiration of the timer. A process for measuring a time window may be restarted, for example, if a timer is restarted. Other example implementations may be configured/provided to restart a measurement of a time window.

Wireless communications may use one or more parameters to indicate resources for communications between devices. Resources may be based on one or more parameters associated with time (e.g., time period, time slot, TDM, etc.), frequency (e.g., frequency range, bandwidth, BWP, etc.), power (e.g., transmission power), spatial (e.g., beam, spatial transmission filter, spatial reception filter, etc.), and/or code (transmission precoder, CDM, etc.), For example, a wireless device may receive a control message/command (e.g., DCI, MAC-CE) indicating activation of a (single) common/unified TCI state. A TCI state may correspond to at least one beam (e.g., one beam, two beams, and/or any quantity of beams) used for transmission and/or reception of wireless communications. A common/unified TCI state may correspond to at least one beam that is in common with (e.g., that is used for) transmission (e.g., wireless device transmission on an uplink, base station transmission on a downlink, or wireless device transmission on a sidelink) and reception of (e.g., wireless device reception on a downlink, base station reception on an uplink, or wireless device reception on a sidelink). A common/unified TCI state may correspond to at least one beam that is in common with one channel, or with a plurality of channels such as an uplink channel and a downlink channel (e.g., PUSCH and/or PDSCH for data transmission/reception, PUCCH and/or PDCCH for control information transmission/reception, etc.). In at least some wireless communications, a wireless device may apply/use the common/unified TCI state to/for transmission of an SRS via an SRS resource. The wireless device may send (e.g., transmit), via the SRS resource, the SRS using a spatial domain transmission filter that may be determined based on a reference signal indicated by the common/unified TCI state. The wireless device may send (e.g., transmit), via the SRS resource, the SRS with a transmission power that may be determined based on one or more power control parameters indicated by (or associated with or mapped to or included in) the common/unified TCI state.

A wireless device may apply/use the common/unified TCI state to/for reception of a CSI-RS via a CSI-RS resource. The wireless device may receive/measure, via the CSI-RS resource, the CSI-RS using a spatial domain reception filter that may be determined based on a reference signal indicated by the common/unified TCI state. The CSI-RS may be quasi co-located with the reference signal indicated by the common/unified TCI state. The CSI-RS may be quasi co-located with the reference signal indicated by the common/unified TCI state with respect to a quasi co-location type indicated by the common/unified TCI state.

For at least some wireless communications, activation of a (single) common/unified TCI state may not be efficient, for example, in a multi-TRP operation comprising at least a first TRP and a second TRP. Using/sharing/applying the same common/unified TCI state to/for first reference signals (e.g., SRS, CSI-RS) associated with the first TRP and second reference signals (e.g., SRS, CSI-RS) associated with the second TRP may not be efficient. For example, the first TRP and the second TRP may not be co-located and may be subject to different channel conditions, which may result in using one or more parameters for a plurality of TRPs that, while suitable/ideal for a particular TRP may not be suitable/ideal for each TRP of the plurality of TRPs (e.g., if the plurality of TRPs are not co-located or are not QCLed).

In at least some systems, a wireless device may receive one or more messages, such as a control message/command (e.g., DCI, MAC-CE), indicating activation of at least two common/unified TCI states. The at least two common/unified TCI states may comprise a first common/unified TCI state and a second common/unified TCI state. The wireless device may not have information indicating whether the first common/unified TCI state is associated with the first TRP or the second TRP. There may not be an explicit/implicit association between the first common/unified TCI state and the first TRP or the second TRP. Configuration parameter(s) may not indicate, for the first common/unified TCI state, a TRP index (or a CORESET pool index, or a common/unified TCI state index, and the like) indicating an association between the first common/unified TCI state and the first TRP or the second TRP. The wireless device may not have information indicating whether the second common/unified TCI state is associated with the first TRP or the second TRP. There may not be an explicit/implicit association between the second common/unified TCI state and the first TRP or the second TRP. Configuration parameter(s) may not indicate, for the second common/unified TCI state, a TRP index (or a CORESET pool index, or a common/unified TCI state index, and the like) indicating an association between the second common/unified TCI state and the first TRP or the second TRP.

In at least some systems, a wireless device may not have information indicating whether a reference signal (e.g., SRS, CSI-RS) is associated with the first TRP or the second TRP. The wireless device may not have information whether to apply the first common/unified TCI state or the second common/unified TCI state to transmission/reception of the reference signal via a reference signal resource (e.g., SRS resource, CSI-RS resource). This lack of information may lead to a beam misalignment between the wireless device and the base station. For example, the wireless device may apply/use the first common/unified TCI state to/for transmission/reception of the reference signal. The base station may (incorrectly) assume that the wireless device applies/uses the second common/unified TCI state to/for transmission/reception of the reference signal. This misalignment may lead to inaccurate measurement of the reference signal (e.g., SRS by the base station and CSI-RS by the wireless device). Inaccurate measurement of the reference signal may lead to inaccurate channel estimation resulting in wrong scheduling decisions (e.g., wrong scheduling parameter choice such as MCS, power control parameters, time-domain resources, frequency domain resources, etc.).

As described herein, beam management may be enhanced, for example, if at least two common/unified TCI states are activated. A wireless device may apply/use the first common/unified TCI state for transmission/reception of a reference signal via a reference signal resource. A reference signal resource set may comprise a reference signal resource. The first common/unified TCI state may be a first/starting/earliest TCI state that occurs first in a set/list/vector of at least two common/unified TCI states.

A wireless device may receive, via a CORESET, DCI scheduling/triggering transmission/reception of a reference signal. The DCI may comprise a field (e.g., TRP index or a CORESET pool index, or a common/unified TCI state index, and the like). The field may comprise/indicate a value. The value may indicate a common/unified TCI state among the at least two common/unified TCI states. The wireless device may apply/use the common/unified TCI state for transmission/reception of the reference signal via the reference signal resource.

A wireless device may receive, via a CORESET, DCI scheduling/triggering transmission/reception of the reference signal. The wireless device may monitor, for the DCI, PDCCH transmissions in the CORESET based on a common/unified TCI state among/of the at least two common/unified TCI states. The wireless device may apply/use the common/unified TCI state for transmission/reception of the reference signal

Configuration parameter(s) may indicate, for a reference signal resource (or the reference signal resource set comprising the reference signal resource), a field (e.g., TRP index or a CORESET pool index, or a common/unified TCI state index, and the like). The field may comprise/indicate a value. The value may indicate a common/unified TCI state among the at least two common/unified TCI states. The wireless device may apply/use the common/unified TCI state to transmission/reception of the reference signal via the reference signal resource. Examples described herein may result in advantages such as reduced beam misalignment, which may lead to reduced inaccurate channel measurements, reduced wrong scheduling decisions, and/or more efficient wireless communications.

A wireless device and a base station may use resources for wireless communications. A unified transmission configuration indicator (TCI) state may be indicated using a parameter, field, message, and/or signaling. The unified TCI state may be associated with a reference signal resource (or a reference signal resource set). The unified TCI state may be applied for communications, via a reference signal of the reference signal resource set, between the wireless device and the base station for which at least two unified TCI states may be activated, without requiring additional signaling to configure parameters for each communication.

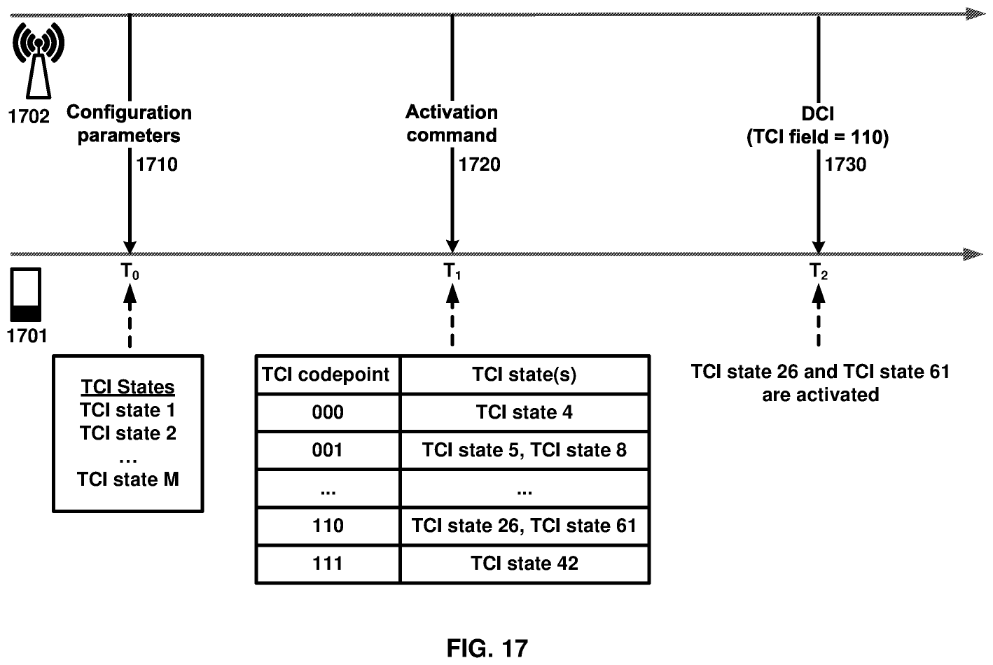

FIG. 17 shows an example TCI state update. The TCI state update may comprise a unified beam update. A wireless device 1701 may receive one or more messages (e.g., at time T₀). The wireless device 1701 may receive the one or more messages from a computing device 1702, which may comprise any computing device described herein (e.g., base station, relay node, wireless device, etc.). For example, the wireless device 1701 may receive the one or more messages from a base station. The wireless device 1701 may receive the one or more messages from a relay node. The wireless device 1701 may receive the one or more messages from another wireless device (e.g., TRP, vehicle, remote radio head, and the like). The one or more messages may comprise one or more configuration parameters (e.g., Configuration parameters at time T₀ in FIG. 17). The one or more configuration parameters may comprise RRC configuration parameter(s). The one or more configuration parameters may comprise RRC reconfiguration parameter(s).

One or more configuration parameters may be for a plurality of cells. The plurality of cells may comprise a cell. The cell may be, for example, a serving cell. At least one configuration parameter of the one or more configuration parameters may be for the cell. The cell may be a primary cell (PCell). The cell may be a secondary cell (SCell). The cell may be a secondary cell configured for/with a PUCCH (e.g., PUCCH SCell). The cell may be an unlicensed cell, for example, operating in an unlicensed band. The cell may be a licensed cell, for example, operating in a licensed band. The cell may operate in a first frequency range (FR1). The FR1 may comprise, for example, frequency bands below 6 GHz (or any other frequency or range of frequencies). The cell may operate in a second frequency range (FR2). The FR2 may comprise, for example, frequency bands from 24 GHz to 52.6 GHz (or any other frequency or range of frequencies). The cell may operate in a third frequency range (FR3). The FR3 may comprise, for example, frequency bands from 52.6 GHz to 71 GHz (or any other frequency or range of frequencies). The FR3 may comprise, for example, frequency bands starting from (or above) 52.6 GHz (or any other frequency).

A wireless device may perform uplink transmissions (e.g., PUSCH, PUCCH, SRS) via/of the cell in a first time and in a first frequency. The wireless device may perform downlink receptions (e.g., PDCCH, PDSCH) via/of the cell in a second time and in a second frequency. The cell may operate in a time-division duplex (TDD) mode. The first frequency and the second frequency may be the same, for example, in the TDD mode. The first time and the second time may be different, for example, in the TDD mode. The cell may operate in a frequency-division duplex (FDD) mode. The first frequency and the second frequency may be different, for example, in the FDD mode. The first time and the second time may be the same, for example, in the FDD mode. The cell may operate in a code-division multiplex (CDM) mode, for example, in which the first frequency and the second frequency may be the same or different, and or in which the first time and the second time may be the same or different. The cell may operate in a spatial-domain multiplex (SDM) mode, for example, in which the first frequency and the second frequency may be the same or different, and or in which the first time and the second time may be the same or different. The cell may operation in one or more of a TDD mode, an FDD mode, a CDM mode, and/or an SDM mode.

A wireless device may be an RRC mode of a plurality of RRC modes. For example, the wireless device may be in an RRC connected mode. The wireless device may be in an RRC idle mode. The wireless device may be in an RRC inactive mode.

A cell may comprise a plurality of BWPs. The plurality of BWPs may comprise one or more uplink BWPs comprising an uplink BWP of the cell. The plurality of BWPs may comprise one or more downlink BWPs comprising a downlink BWP of the cell.

A BWP of the plurality of BWPs may be in one of an active state and an inactive state. In the active state of a downlink BWP of the one or more downlink BWPs, the wireless device may monitor a downlink channel/signal (e.g., PDCCH, DCI, CSI-RS, PDSCH) on/for/via the downlink BWP. In the active state of a downlink BWP of the one or more downlink BWPs, the wireless device may receive a PDSCH on/via/for the downlink BWP. In the inactive state of a downlink BWP of the one or more downlink BWPs, the wireless device may not monitor a downlink channel/signal (e.g., PDCCH, DCI, CSI-RS, PDSCH) on/via/for the downlink BWP. In the inactive state of a downlink BWP of the one or more downlink BWPs, the wireless device may stop monitoring (or receiving) a downlink channel/signal (e.g., PDCCH, DCI, CSI-RS, PDSCH) on/via/for the downlink BWP. In the inactive state of a downlink BWP of the one or more downlink BWPs, the wireless device may not receive a PDSCH on/via/for the downlink BWP. In the inactive state of a downlink BWP of the one or more downlink BWPs, the wireless device may stop receiving a PDSCH on/via/for the downlink BWP.

In the active state of an uplink BWP of the one or more uplink BWPs, the wireless device may send (e.g., transmit) an uplink signal/channel (e.g., PUCCH, preamble, PUSCH, PRACH, SRS, etc.) on/via the uplink BWP. In the inactive state of an uplink BWP of the one or more uplink BWPs, the wireless device may not send (e.g., transmit) an uplink signal/channel (e.g., PUCCH, preamble, PUSCH, PRACH, SRS, etc.) on/via the uplink BWP.

A wireless device may activate the downlink BWP of the one or more downlink BWPs of the cell. Activating the downlink BWP may comprise setting (or switching to) the downlink BWP as an active downlink BWP of the cell. Activating the downlink BWP may comprise setting the downlink BWP in the active state. Activating the downlink BWP may comprise switching the downlink BWP from the inactive state to the active state.

A wireless device may activate the uplink BWP of the one or more uplink BWPs of the cell. Activating the uplink BWP may comprise that the wireless device sets (or switches to) the uplink BWP as an active uplink BWP of the cell. Activating the uplink BWP may comprise setting the uplink BWP in the active state. Activating the uplink BWP may comprise switching the uplink BWP from the inactive state to the active state.

One or more configuration parameters may be for the (active) downlink BWP of the cell. At least one configuration parameter of the one or more configuration parameters may be for the downlink BWP of the cell.

One or more configuration parameters may be for the (active) uplink BWP of the cell. At least one configuration parameter of the one or more configuration parameters may be for the uplink BWP of the cell. The one or more configuration parameters may indicate a subcarrier spacing (or a numerology) for the downlink BWP. The one or more configuration parameters may indicate a subcarrier spacing (or a numerology) for the uplink BWP.

A value of the subcarrier spacing (of the downlink BWP and/or the uplink BWP) may be/indicate, for example, 15 kHz (μ=0), or any other frequency or range of frequencies. A value of the subcarrier spacing may be/indicate, for example, 30 kHz (μ=1). A value of the subcarrier spacing may be/indicate, for example, 60 kHz (μ=2). A value of the subcarrier spacing may be/indicate, for example, 120 kHz (μ=3). A value of the subcarrier spacing may be/indicate, for example, 240 kHz (μ=4). A value of the subcarrier spacing may be/indicate, for example, 480 kHz (μ=5). A value of the subcarrier spacing may be/indicate, for example, 960 kHz (μ=6). For example, 480 kHz may be valid/applicable in FR3. For example, 960 kHz may be valid/applicable in FR3. For example, 240 kHz may be valid/applicable in FR3. For example, 120 kHz may be valid/applicable in FR3. Any frequency or range of frequencies may be valid/applicable to any FR(n) (e.g., p may be equal to any value).

One or more configuration parameters may indicate a plurality of control resource sets (CORESETS). The one or more configuration parameters may indicate the plurality of CORESETS for the (active) downlink BWP of the cell. The (active) downlink BWP may comprise the plurality of CORESETS.

One or more configuration parameters may indicate a plurality of CORESET indexes/identifiers/indicators (e.g., provided by a higher layer parameter ControlResourceSetId) for the plurality of CORESETS. Each CORESET of the plurality of CORESETS may be identified/indicated by a respective CORESET index of the plurality of CORESET indexes. A first CORESET of the plurality of CORESETS may be identified by a first CORESET index of the plurality of CORESET indexes. A second CORESET of the plurality of CORESETS may be identified by a second CORESET index of the plurality of CORESET indexes.

One or more configuration parameters may indicate a plurality of TCI states (e.g., provided by a higher layer parameter tci-StatesToAddModList in PDSCH_Config, PUSCH_Config, PDCCH_Config or PUCCH_Config, etc.). The one or more configuration parameters may be sent/received in one or more messages 1710, such as shown in FIG. 17 at time T₀. The one or more configuration parameters may indicate the plurality of TCI states, for example, for the downlink BWP of the cell. In FIG. 17, the plurality of TCI states may comprise TCI state 1, TCI state 2, . . . , TCI state M.

A quantity/number of the plurality of TCI states may be equal to, for example, 128 (e.g., M=128) or any other value. A quantity/number of the plurality of TCI states may be equal to, for example, 64 (e.g., M=64). A quantity/number of the plurality of TCI states may be equal to, for example, 32 (e.g., M=32). A quantity/number of the plurality of TCI states may be based on a capability of the wireless device. A wireless device may send (e.g., transmit) a capability message (e.g., a UE capability message) indicating a maximum quantity/number of TCI states. A quantity/number of the plurality of TCI states indicated by the one or more configuration parameters may be equal to or less than the maximum number of TCI states.

One or more configuration parameters may indicate a plurality of TCI state indexes/identifiers/indicators (e.g., provided by a higher layer parameter TCI-StateId) for the plurality of TCI states. Each TCI state of the plurality of TCI states may be identified/indicated by a respective TCI state index of the plurality of TCI state indexes. A first TCI state of the plurality of TCI states may be identified by a first TCI state index of the plurality of TCI state indexes. A second TCI state of the plurality of TCI states may be identified by a second TCI state index of the plurality of TCI state indexes.

A plurality of TCI states (or at least one TCI state of the plurality of TCI states) may be for (decoding) PDSCH transmissions/receptions of/for the cell. The one or more configuration parameters may indicate the plurality of TCI states (or the at least one TCI state of the plurality of TCI states) for decoding PDSCH transmissions/receptions of/for the downlink BWP of the cell. A TCI state of the plurality of TCI states may indicate a reference signal (e.g., by a SourceRs-Info) for quasi-colocation of/for DM-RS (or DM-RS antenna port(s)) of the PDSCH transmissions/receptions.

A plurality of TCI states (or at least one TCI state of the plurality of TCI states) may be for PDCCH transmissions/receptions of/for the cell. The one or more configuration parameters may indicate the plurality of TCI states (or the at least one TCI state of the plurality of TCI states) for PDCCH transmissions/receptions of/for the downlink BWP of the cell. A TCI state of the plurality of TCI states may indicate a reference signal for quasi-colocation of/for DM-RS (or DM-RS antenna port(s)) of the PDCCH transmissions/receptions.

A plurality of TCI states (or at least one TCI state of the plurality of TCI states) may be for CSI-RS transmissions/receptions of/for the cell. The one or more configuration parameters may indicate the plurality of TCI states (or the at least one TCI state of the plurality of TCI states) for CSI-RS transmissions/receptions of/for the downlink BWP of the cell. A TCI state of the plurality of TCI states may indicate a reference signal for quasi-colocation of/for CSI-RS transmissions/receptions.

A plurality of TCI states (or at least one TCI state of the plurality of TCI states) may be for transmission of uplink signals (e.g., UCI, dynamic grant PUSCH, configured uplink grant based PUSCH, SRS, PUCCH, transport block, SR, CSI, HARQ-ACK) of/for/on/via an uplink resource (e.g., PUSCH resource, PUCCH resource, SRS resource) of the cell. The one or more configuration parameters may indicate the plurality of TCI states (or the at least one TCI state of the plurality of TCI states) for transmission of the uplink signals of/for/on/via the uplink resource of the uplink BWP of the cell. A wireless device may determine, for transmission of uplink signals, a spatial domain transmission filter/beam based on a reference signal indicated by (or in) a TCI state of the plurality of TCI states.

A plurality of TCI state pools/groups may comprise a plurality of TCI states For example, two TCI state pools/groups may comprise a plurality of TCI states. A first TCI state pool of the two TCI state pools may comprise a plurality of downlink TCI states of the plurality of TCI states. A second TCI state pool of the two TCI state pools may comprise a plurality of uplink TCI states of the plurality of TCI states.

A (single) TCI state pool/group may comprise the plurality of TCI states. The plurality of TCI states may comprise/be a plurality of downlink TCI states. The plurality of TCI states may comprise/be a plurality of uplink TCI states.

A wireless device may apply/use the plurality of downlink TCI states for reception/decoding of transport blocks (or PDSCH transmissions/receptions). The wireless device may use the plurality of downlink TCI states, for example, for reception/decoding of transport blocks (or PDSCH transmissions/receptions) scheduled for the downlink BWP of the cell. The wireless device may use the plurality of downlink TCI states, for example, for reception of downlink signals (e.g., PDSCH transmission/reception, PDCCH transmission/reception, DCI, transport block, CSI-RS and the like) via the downlink BWP of the cell. For example, the wireless device may not use the plurality of downlink TCI states (or each TCI state of the plurality of downlink TCI states) for transmission of uplink signals (e.g., PUSCH transmissions, PUCCH transmissions, UCI, transport block, SRS and the like). A TCI state of the plurality of downlink TCI states may indicate/have/comprise a reference signal for quasi-colocation of/for DM-RS of downlink signals (e.g., PDSCH/PDCCH transmissions/receptions). The reference signal may be quasi co-located with the DM-RS of the downlink signals. The reference signal may be quasi co-located with the DM-RS of the downlink signals with respect to a quasi co-location type (e.g., QCL Type A, QCL Type B, QCL Type C, QCL Type D, QCL Type E, and the like). The TCI state may indicate/comprise/have, for the reference signal, the quasi co-location type. A TCI state of the plurality of downlink TCI states may indicate a reference signal for quasi-colocation of/for reception of downlink signals (e.g., CSI-RS). Each TCI state of the plurality of downlink TCI states may indicate a respective reference signal for quasi-colocation of/for DM-RS of downlink signals (e.g., PDSCH/PDCCH transmissions/receptions). Each TCI state of the plurality of downlink TCI states may indicate a respective reference signal for quasi-colocation of/for reception of downlink signals (e.g., CSI-RS).

A wireless device may apply/use the plurality of uplink TCI states for transmission of transport blocks (or PUSCH transmissions). The wireless device may use the plurality of uplink TCI states, for example, for transmission of transport blocks (or PUSCH transmissions) scheduled/configured for the uplink BWP of the cell. The wireless device may use the plurality of uplink TCI states, for example, for transmission of uplink signals (e.g., PUSCH transmissions, PUCCH transmissions, UCI, transport block, SRS and the like) via the uplink BWP of the cell. The wireless device may not use the plurality of uplink TCI states (or each TCI state of the plurality of uplink TCI states) for reception of downlink signals (e.g., PDSCH transmission/reception, PDCCH transmission/reception, DCI, transport block, CSI-RS and the like). The wireless device may determine a spatial domain transmission filter/beam based on a reference signal indicated by (or in) a TCI state of the plurality of uplink TCI states for transmission of uplink signals. The wireless device may determine, for transmission of uplink signals, a respective spatial domain transmission filter/beam based on a reference signal indicated by (or in) each TCI state of the plurality of uplink TCI states. The wireless device may determine a transmission power based on one or more power control parameters (e.g., target received power, closed-loop index, pathloss compensation factor, alpha, pathloss reference signal, and the like) indicated by (or included in or associated with or mapped to) a TCI state of the plurality of uplink TCI states for transmission of uplink signals. The wireless device may determine, for transmission of uplink signals, a respective transmission power based on one or more power control parameters indicated by (or included in or associated with or mapped to) each TCI state of the plurality of uplink TCI states.

A (single) TCI state pool/group may comprise the plurality of TCI states. The one or more configuration parameters may indicate a joint/common UL/DL TCI state mode and a separate UL/DL TCI state mode, for example, based on a number of TCI state pools. The one or more configuration parameters may indicate the joint/common UL/DL TCI state mode, for example, based on the one or more configuration parameters indicating the (single) TCI state pool/group. The one or more configuration parameters may indicate the separate UL/DL TCI state mode, for example, based on the one or more configuration parameters indicating the two TCI state pools/groups.

One or more configuration parameters may, for example, comprise a TCI type parameter indicating a joint/common UL/DL TCI state mode or a separate UL/DL TCI state mode. The TCI type parameter may be set to “joint” or “joint UL/DL TCI state” indicating the joint/common UL/DL TCI state mode. The TCI type parameter may be set to “separate” or “separate UL/DL TCI states” indicating the separate UL/DL TCI state mode.

A plurality of TCI states may be/comprise a plurality of common/joint TCI states (or a plurality of common/joint uplink and downlink TCI states). The wireless device may use the plurality of common/joint TCI states, for example, for reception of downlink signals (e.g., PDSCH, PDCCH, CSI-RS, DCI, transport block, and the like) via the downlink BWP of the cell. The wireless device may use the plurality of common/joint TCI states, for example, for transmission of uplink signals (e.g., PUSCH, PUCCH, UCI, transport block, SRS and the like) via the uplink BWP of the cell. The wireless device may use each TCI state of the plurality of common/joint TCI states, for example, for reception of downlink signals and for transmission of uplink signals. A TCI state of the plurality of TCI states (or the plurality of common/joint TCI states) may indicate a reference signal for quasi-colocation of/for DM-RS of downlink signals (e.g., PDSCH/PDCCH transmissions/receptions). A TCI state of the plurality of TCI states (or the plurality of common/joint TCI states) may indicate a reference signal for quasi-colocation of/for reception of downlink signals (e.g., CSI-RS). Each TCI state of the plurality of TCI states (or the plurality of common/joint TCI states) may indicate a respective reference signal for quasi-colocation of/for DM-RS of downlink signals (e.g., PDSCH/PDCCH transmissions/receptions). Each TCI state of the plurality of TCI states (or the plurality of common/joint TCI states) may indicate a respective reference signal for quasi-colocation of/for reception of downlink signals (e.g., CSI-RS). The wireless device may determine a spatial domain transmission filter/beam based on a reference signal indicated by (or in) a TCI state of the plurality of TCI states (or the plurality of common/joint TCI states) for transmission of uplink signals. The wireless device may determine, for transmission of uplink signals, a respective spatial domain transmission filter/beam based on a reference signal indicated by (or in) each TCI state of the plurality of TCI states (or the plurality of common/joint TCI states).

One or more configuration parameters may not indicate one or more TCI states for the downlink BWP of the cell. One or more TCI state parameters/configuration may be absent in the one or more configuration parameters. The one or more configuration parameters may not comprise the one or more TCI state parameters/configuration in/for the downlink BWP of the cell. The one or more configuration parameters may indicate a plurality of TCI states, for example, for a reference BWP (e.g., reference downlink BWP) of a reference cell. The plurality of cells may comprise the reference cell. The wireless device may apply/use the plurality of TCI states of (or associated with) the reference BWP of the reference cell to the downlink BWP of the cell. The one or more configuration parameters may indicate, for the cell (or the downlink BWP of the cell), the reference BWP of the reference cell to apply/use the plurality of TCI states of (or associated with) the reference BWP of the reference cell.

A wireless device may receive an activation command 1720 such as shown in FIG. 17. The activation command may be sent/received in one or more messages (e.g., DCI, MAC-CE, TCI States Activation/Deactivation for UE-specific MAC CE, Activation command at time T₁ in FIG. 17) indicating activation of a subset of the plurality of TCI states. The activation command may activate/select/indicate/update the subset of the plurality of TCI states. The subset of the plurality of TCI states may comprise/be, for example, one or more TCI states of the plurality of TCI states. The subset of the plurality of TCI states may comprise/be, for example, a first plurality of TCI states of the plurality of TCI states. For example, in FIG. 17, the subset of the plurality of TCI states are TCI state 4, TCI state 5, TCI state 8, TCI state 26, TCI state 61, and TCI state 42.

An activation command may comprise one or more fields indicating/comprising at least one TCI state index of/indicating/identifying the subset of the plurality of TCI states. The plurality of TCI state indexes may comprise the at least one TCI state index. Each TCI state of the subset of the plurality of TCI states may be identified/indicated by a respective TCI state index of the at least one TCI state index. The one or more fields may be set to a value (e.g., one) indicating activation of the subset of the plurality of TCI states. Based on the one or more fields that indicate the subset of the plurality of TCI states being set to the value, the wireless device may activate the subset of the plurality of TCI states. The wireless device may activate the subset of the plurality of TCI states, for example, based on the receiving the activation command activating/selecting/indicating/updating the subset of the plurality of TCI states.

A wireless device may map the subset of the plurality of TCI states to one or more TCI codepoints (e.g., 000, 001, . . . , 110, and 011 in TCI Codepoint in FIG. 17). The mapping the subset of the plurality of TCI states to the one or more TCI codepoints may comprise grouping the subset of the plurality of TCI states into/in the one or more TCI codepoints. Each TCI codepoint of the one or more TCI codepoints may comprise/indicate respective TCI state(s) of the subset of the plurality of TCI states. For example, in FIG. 17, TCI state 4 may be mapped to TCI codepoint 000; TCI state 5 and TCI state 8 may be mapped to TCI codepoint 001; TCI state 26 and TCI state 61 may be mapped to TCI codepoint 110; and TCI state 42 may be mapped to the TCI codepoint 111. Each TCI codepoint of the one or more TCI codepoints may be equal to a value of a TCI field in a DCI. The DCI may or may not schedule a transport block (e.g., PDSCH, PUSCH). The TCI field in the DCI may indicate (or be equal to) a TCI codepoint of the one or more TCI codepoints. The TCI codepoint may comprise/indicate at least one TCI state of the subset of the plurality of TCI states.

A TCI state of the subset of the plurality of TCI states may indicate a reference signal with/for a quasi co-location type (e.g., QCL Type A, QCL Type D). The TCI state may not comprise/indicate a BWP index/ID and/or a cell index/ID for the reference signal. The wireless device may assume that the reference signal is configured in the downlink BWP of the cell where the TCI state applies.

A subset of the plurality of TCI states may be for (decoding) PDSCH transmissions/receptions of/for the cell. The activation command may indicate activation of the subset of the plurality of TCI states for decoding PDSCH transmissions/receptions of/for the downlink BWP of the cell.

A subset of the plurality of TCI states may be for transmission of uplink signals (e.g., UCI, PUSCH, SRS, PUCCH, transport block, SR, CSI, HARQ-ACK) of/for/on/via an uplink resource (e.g., PUSCH resource, PUCCH resource, SRS resource) of the cell. The activation command may indicate activation of the subset of the plurality of TCI states for transmission of the uplink signals of/for/on/via the uplink resource of the uplink BWP of the cell.

A subset of the plurality of TCI states may be/comprise one or more downlink TCI states. The wireless device may use the one or more downlink TCI states for reception/decoding of transport blocks (or PDSCH transmissions/receptions). The wireless device may use the one or more downlink TCI states, for example, for reception/decoding of transport blocks (or PDSCH transmissions/receptions) scheduled/configured for the downlink BWP of the cell. The wireless device may use the one or more downlink TCI states, for example, for reception of downlink signals (e.g., PDSCH, PDCCH, DCI, CSI-RS, transport block, and the like) via the downlink BWP of the cell.

A subset of the plurality of TCI states may be/comprise one or more uplink TCI states. The wireless device may use the one or more uplink TCI states for transmission of transport blocks (or PUSCH transmissions). The wireless device may use the one or more uplink TCI states, for example, for transmission of transport blocks (or PUSCH transmissions) scheduled/configured for the uplink BWP of the cell. The wireless device may use the one or more uplink TCI states, for example, for transmission of uplink signals (e.g., PUSCH, PUCCH, UCI, transport block, SRS and the like) via the uplink BWP of the cell.

A subset of the plurality of TCI states may be/comprise one or more common/joint TCI states. The wireless device may use the one or more common/joint TCI states, for example, for reception of downlink signals (e.g., PDSCH, PDCCH, DCI, CSI-RS, transport block, and the like) via the downlink BWP of the cell. The wireless device may use the one or more common/joint TCI states, for example, for transmission of uplink signals (e.g., PUSCH, PUCCH, UCI, transport block, SRS and the like) via the uplink BWP of the cell. For example, the wireless device may use the one or more common/joint TCI states for reception of downlink signals via the downlink BWP of the cell and for transmission of uplink signals via the uplink BWP of the cell.

A wireless device may receive a downlink signal 1730 such as shown in FIG. 17. The downlink signal may be sent/received in one or more messages. The downlink signal may comprise date and/or control information (e.g., transport block, PDCCH/PDSCH transmission, CSI-RS, aperiodic CSI-RS, DCI, and the like). The wireless device may receive the downlink signal, for example, based on a TCI state of the subset of the plurality of TCI states. The wireless device may, for example, receive a DCI scheduling/triggering reception/transmission of the downlink signal. The DCI may, for example, indicate a dynamic uplink/downlink grant. The DCI may, for example, indicate an activation of a SPS PDSCH transmission. The wireless device may receive the downlink signal (e.g., transport block) for/of the SPS PDSCH transmission. The DCI may comprise a TCI field indicating the TCI state (or a TCI codepoint comprising/indicating the TCI state). The one or more configuration parameters may indicate/configure/schedule/trigger transmission/reception of the downlink signal (e.g., periodic CSI-RS, PDCCH/PDSCH transmission, and so on). The one or more configuration parameters may comprise/indicate a TCI field indicating the TCI state (or a TCI codepoint comprising/indicating the TCI state) for transmission/reception of the downlink signal.

Receiving the downlink signal based on the TCI state may comprise at least one DMRS antenna port of the downlink signal (e.g., PDSCH/PDCCH transmissions, transport block) being quasi co-located with a reference signal (e.g., CSI-RS, SS/PBCH block, SRS, PUCCH, and the like) indicated by the TCI state. The at least one DMRS antenna port of the downlink signal may be quasi co-located with the reference signal with respect to a quasi co-location type (e.g., QCL TypeA, QCL TypeB, QCL TypeC, QCL TypeD, and the like). The TCI state may indicate/comprise/have the quasi co-location type. The TCI state may comprise/have a reference signal index indicating/identifying the reference signal. The one or more configuration parameters may indicate, for the TCI state, the reference signal index.

Receiving the downlink signal based on the TCI state may comprise the downlink signal (e.g., CSI-RS, DM-RS) being quasi co-located with a reference signal (e.g., CSI-RS, SS/PBCH block, SRS, PUCCH, and the like) indicated by the TCI state. The downlink signal may be quasi co-located with the reference signal with respect to a quasi co-location type (e.g., QCL TypeA, QCL TypeB, QCL TypeC, QCL TypeD, and the like). The TCI state may indicate/comprise/have the quasi co-location type. The TCI state may comprise/have a reference signal index indicating/identifying the reference signal. The one or more configuration parameters may indicate, for the TCI state, the reference signal index.

Receiving the downlink signal based on the TCI state may comprise receiving the downlink signal with a spatial domain reception/receiving filter/beam that is used to receive the reference signal indicated by the TCI state. The spatial domain reception/receiving filter/beam used to receive the downlink signal may be same as (or substantially same as, x degrees apart, x=0, 1, 5, 10, and the like) a spatial domain reception/receiving filter/beam used to receive the reference signal.

A wireless device may send (e.g., transmit) an uplink signal (e.g., transport block, PUCCH/PUSCH transmission, SRS, aperiodic SRS, PUCCH, aperiodic PUCCH, UCI, and the like) based on a TCI state of the subset of the plurality of TCI states. The wireless device may, for example, receive a DCI scheduling/triggering transmission of the uplink signal. The DCI may, for example, indicate a dynamic uplink/downlink grant. The DCI may, for example, indicate an activation of a configured uplink grant (e.g., Type 2 configured uplink grant). The wireless device may send (e.g., transmit) the uplink signal (e.g., transport block) for/of the configured uplink grant. The DCI may comprise a TCI field indicating the TCI state (or a TCI codepoint comprising/indicating the TCI state). The one or more configuration parameters may indicate/configure/schedule/trigger transmission of the uplink signal (e.g., periodic SRS, PUCCH/PUSCH transmission, configured uplink grant, and so on). The one or more configuration parameters may comprise/indicate a TCI field indicating the TCI state (or a TCI codepoint comprising/indicating the TCI state) for transmission of the uplink signal. The one or more configuration parameters indicate, for a configured uplink grant (e.g., Type 1 configured uplink grant), the TCI state. The wireless device may send (e.g., transmit) the uplink signal (e.g., transport block) for/of the configured uplink grant (e.g., Type 1 configured uplink grant).

Sending (e.g., transmitting) the uplink signal based on the TCI state may comprise transmitting the uplink signal with a spatial domain transmitting/transmission filter/beam that is determined based on the reference signal (e.g., CSI-RS, SS/PBCH block, SRS, PUCCH) indicated by the TCI state. The spatial domain transmitting/transmission filter/beam used to transmit the uplink signal may be same as (or substantially same as, x degrees apart, x=0, 1, 5, 10, and the like) a spatial domain transmitting/transmission filter/beam used to transmit the reference signal (e.g., SRS, PUCCH). The spatial domain transmitting/transmission filter/beam used to transmit the uplink signal may be same as (or substantially same as, x degrees apart, x=0, 1, 5, 10, and the like) a spatial domain reception/receiving filter/beam used to receive the reference signal (e.g., CSI-RS, SS/PBCH block).

A wireless device may monitor, for a DCI, PDCCH transmissions in/via a CORESET based on a TCI state. The plurality of CORESETS may comprise the CORESET. The downlink BWP of the cell (or one or more CORESETS in the downlink BWP) may comprise the CORESET. The subset of the plurality of TCI states may comprise the TCI state. The subset of the TCI state may or may not comprise the TCI state. The wireless device may receive a second activation command indicating activation of the TCI state for the CORESET. The second activation command may or may not be same as the activation command (at time T₁ in FIG. 17). Monitoring the PDCCH transmissions in the CORESET based on the TCI state may comprise at least one DMRS antenna port of the PDCCH transmissions in the CORESET being quasi co-located with a reference signal (e.g., CSI-RS, SS/PBCH block, SRS, and the like) indicated by the TCI state. The at least one DMRS antenna port may be quasi co-located with the reference signal with respect to a quasi co-location type (e.g., QCL TypeA, QCL TypeB, QCL TypeC, QCL TypeD, and the like). The TCI state may indicate/comprise/have the quasi co-location type.

A quantity/number of the one or more TCI codepoints may be equal to one. The one or more TCI codepoints may be a (single) TCI codepoint. The (single) TCI codepoint may indicate at least two TCI states of the plurality of TCI states. The subset of the plurality of TCI states may be the at least two TCI states. The wireless device may not receive a DCI indicating activation of one or more TCI states among the at least two TCI states, for example, based on the number of the one or more TCI codepoints being equal to one. The wireless device may not receive a DCI indicating activation of one or more TCI states among the at least two TCI states, for example, based on the activation command indicating activation of the at least two TCI states.

A quantity/number of the one or more TCI codepoints may be greater than one. The wireless device may receive a DCI (e.g., DCI 1 at time T₂ in FIG. 17). The DCI may be, for example, a DCI format 1_1. The DCI may be, for example, a DCI format 1_2. The DCI may be, for example, a DCI format 1_x, where x=0, 1, 2 . . . . The DCI may be, for example, a DCI format 0_x, where x=0, 1, 2 . . . .

DCI may comprise a TCI field. The TCI field may indicate a TCI codepoint of the one or more TCI codepoints. A value of the TCI field (e.g., 110 in FIG. 17) may be, for example, equal to the TCI codepoint. The value of the TCI field may be, for example, indicate the TCI codepoint. The TCI codepoint (e.g., 110) may indicate/comprise at least two TCI states. The at least two TCI states may comprise a first TCI state and a second TCI state. For example, in FIG. 17, the first TCI state is the TCI state 26. The second TCI state is the TCI state 61. Any TCI codepoint may indicate/comprise any one or more TCI states (e.g., one TCI state, two TCI states, or any quantity of TCI states). The DCI may indicate activation of the at least two TCI states (or any other quantity of TCI states).

At least two TCI states may be/comprise at least two unified TCI states. The first TCI state may be/comprise a first unified TCI state. The second TCI state may be/comprise a second unified TCI state.

A first TCI state (e.g., TCI state 26) may be a first/starting/earliest/initial TCI state in a vector/set/list of the at least two TCI states. The first TCI state may be a first/starting/earliest element in a vector/set/list of the at least two TCI states. The first TCI state may be a first/starting/earliest TCI state among the at least two TCI states in (or indicated by) the TCI codepoint. A position/location of the first TCI state may be earliest/highest/lowest in the vector of the at least two TCI states. A position/location of the first TCI state may be earlier than (or before) a position/location of the second TCI state in the vector of the at least two TCI states. The first TCI state may occur first in a vector/set/list of the at least two TCI states. The first/starting/earliest TCI state (or the first TCI state) is TCI state 26, for example, if the vector of the at least two TCI states is equal to [TCI state 26, TCI state 61]. The first/starting/earliest TCI state (or the first TCI state) is TCI state 2, for example, if the vector of the at least two TCI states is equal to [TCI state 2, TCI state 1].

A second TCI state (e.g., TCI state 61) may be a second/second starting/second earliest TCI state in a vector/set/list of the at least two TCI states. The second TCI state may be a second/second starting/second earliest element in a vector/set/list of the at least two TCI states. The second TCI state may be a second/second starting/second earliest TCI state among the at least two TCI states in (or indicated by) the TCI codepoint. A position/location of the second TCI state may be the second earliest/second highest/second lowest in the vector of the at least two TCI states. A position/location of the first TCI state may be earlier than (or before) a position/location of the second TCI state in the vector of the at least two TCI states. A position/location of the second TCI state may be later than (e.g., after) a position/location of the first TCI state in the vector of the at least two TCI states. The second TCI state may occur second in a vector/set/list of the at least two TCI states. The second/second starting/second earliest TCI state (or the second TCI state) is TCI state 61, for example, if the vector of the at least two TCI states is equal to [TCI state 26, TCI state 61]. The second/second starting/second earliest TCI state (or the second TCI state) is TCI state 1, for example, if the vector of the at least two TCI states is equal to [TCI state 2, TCI state 1].

DCI may schedule transmission of a transport block (e.g., PDSCH, PUSCH). The DCI may comprise, for example, a downlink assignment indicating resource(s) for the transport block. The DCI may comprise, for example, an uplink grant/assignment indicating resource(s) for the transport block. The wireless device may send (e.g., transmit), via the resource(s), the transport block.

DCI may not schedule transmission of a transport block (e.g., PDSCH/PUSCH transmission). The DCI may not comprise, for example, a downlink assignment. The DCI may not comprise, for example, an uplink grant/assignment. A CRC for/of the DCI may be scrambled with an RNTI (e.g., CS-RNTI). An RV field of the DCI may be set to (or may indicate or may be equal to) one (e.g., all “1”s), for example, by the base station. A MCS field of the DCI may be set to (or may indicate or may be equal to) one (e.g., all “1”s), for example, by the base station. A new data indicator (NDI) field of the DCI may be set to (or may indicate or may be equal to) zero, for example, by the base station. A FDRA field of the DCI may be set to (or may indicate or may be equal to) zero (e.g., all “0”s), for example, for FDRA Type 0. A FDRA field of the DCI may be set to (or may indicate or may be equal to) one (e.g., all “1”s), for example, for FDRA Type 1. A FDRA field of the DCI may be set to (or may indicate or may be equal to) zero (e.g., all “0”s), for example, for dynamic switch.

A wireless device may send (e.g., transmit) an uplink signal (e.g., HARQ-ACK or a PUCCH with HARQ-ACK information) via a PUCCH resource. The wireless device may send (e.g., transmit) the uplink signal, for example, for the transport block scheduled by the DCI. The wireless device may send (e.g., transmit) the uplink signal, for example, for the DCI (e.g., if the DCI does not schedule transmission of a transport block).

A wireless device may apply (or start using) the at least two TCI states starting from a starting/initial/earliest/first slot that is/occurs, for example, after a number of symbols (e.g., Beam application time, MAC-CE activation time, 3Nₛₗₒₜ^{subframe,μ}) from/after a last/ending/latest symbol of the uplink signal (or the PUCCH with the HARQ-ACK information). The wireless device may apply (or start using) the at least two TCI states starting from the starting/initial/earliest/first slot that is at least the quantity/number of symbols (e.g., Beam application time, MAC-CE activation time) from/after the last/ending/latest symbol of the uplink signal. The starting/initial/earliest/first slot may occur at least the quantity/number of symbols from/after the last/ending/latest symbol of the uplink signal. The quantity/number of symbols (e.g., Beam application time) may be based on a capability of the wireless device. For example, the wireless device may send (e.g., transmit) a capability message (e.g., UE capability message) indicating the quantity/number of symbols. For example, the wireless device may send (e.g., transmit) a capability message (e.g., UE capability message) indicating a minimum and/or maximum quantity/number of symbols. The one or more configuration parameters (e.g., by RRC parameter beamAppTime) may indicate the quantity/number of symbols. The one or more configuration parameters (e.g., by RRC parameter beamAppTime) may indicate the quantity/number of symbols, for example, based on the minimum/maximum number of symbols. The quantity/number of symbols may be, for example, equal to or greater than the minimum and/or maximum quantity/number of symbols. The quantity/number of symbols may be, for example, equal to or less than the minimum and/or maximum quantity/number of symbols. The quantity/number of symbols may be, for example, based on the subcarrier spacing (e.g., p) of the downlink BWP. The quantity/number of symbols may be, for example, based on the subcarrier spacing (e.g., p) of the uplink BWP.

A wireless device may apply (or start using) the at least two TCI states indicated/activated by the activation command (e.g., DCI 1 at time T₁ in FIG. 17) starting from the starting/initial/earliest/first slot, for example, based on the number of the one or more TCI codepoints being equal to one.

A wireless device may apply (or start using) the at least two TCI states indicated/activated by the DCI (e.g., at time T₂ in FIG. 17) starting from the starting/initial/earliest/first slot, for example, based on the number of the one or more TCI codepoints being greater than one.

At least two TCI states may be/comprise at least two uplink TCI states. The plurality of uplink TCI states may comprise the at least two uplink TCI states. The first TCI state may be/comprise a first uplink TCI state of the at least two uplink TCI states. The second TCI state may be/comprise a second uplink TCI state of the at least two uplink TCI states. The wireless device may apply/use the at least two uplink TCI states, for example, for transmission of uplink signals (e.g., PUSCH transmissions, PUCCH transmissions, UCI, transport block, SRS and the like) via the uplink BWP of the cell.

Using/applying the at least two uplink TCI states for transmission of the uplink signals may comprise sending (e.g., transmitting) one or more first uplink signals (e.g., PUSCH transmissions, PUCCH transmissions, UCI, transport block, SRS and the like) with a first spatial domain transmission filter/beam that is determined based on a first reference signal indicated by the first uplink TCI state. The first spatial domain transmitting/transmission filter/beam may be, for example, same as (or substantially same as, x degrees apart, x=0, 1, 5, 10, and the like) a spatial domain reception/receiving filter/beam used to receive the first reference signal. The first spatial domain transmitting/transmission filter/beam may be, for example, the same as (or substantially same as, x degrees apart, x=0, 1, 5, 10, and the like) a spatial domain transmission/transmitting filter/beam used to send (e.g., transmit) the first reference signal. The using/applying the at least two uplink TCI states for transmission of the uplink signals may comprise sending (e.g., transmitting) the one or more first uplink signals with a first transmission power that is determined based on one or more first power control parameters (e.g., target received power, closed-loop index, pathloss compensation factor, alpha, pathloss reference signal, and the like) indicated by (or included in or associated with or mapped to) the first uplink TCI state. The uplink signals may comprise the one or more first uplink signals. The using/applying the at least two uplink TCI states for transmission of the uplink signals may comprise sending (e.g., transmitting) one or more second uplink signals (e.g., PUSCH transmissions, PUCCH transmissions, UCI, transport block, SRS and the like) with a second spatial domain transmission filter/beam that is determined based on a second reference signal indicated by the second uplink TCI state. The second spatial domain transmitting/transmission filter/beam may be, for example, same as (or substantially same as, x degrees apart, x=0, 1, 5, 10, and the like) a spatial domain reception/receiving filter/beam used to receive the second reference signal. The second spatial domain transmitting/transmission filter/beam may be, for example, same as (or substantially same as, x degrees apart, x=0, 1, 5, 10, and the like) a spatial domain transmission/transmitting filter/beam used to send (e.g., transmit) the second reference signal. The using/applying the at least two uplink TCI states for transmission of the uplink signals may comprise sending (e.g., transmitting) the one or more second uplink signals with a second transmission power that is determined based on one or more second power control parameters (e.g., target received power, closed-loop index, pathloss compensation factor, alpha, pathloss reference signal, and the like) indicated by (or included in or associated with or mapped to) the second uplink TCI state. The uplink signals may comprise the one or more second uplink signals.

At least two TCI states may be/comprise at least two downlink TCI states. The plurality of downlink TCI states may comprise the at least two downlink TCI states. The first TCI state may be/comprise a first downlink TCI state of the at least two downlink TCI states. The second TCI state may be/comprise a second downlink TCI state of the at least two downlink TCI states. The wireless device may apply/use the at least two downlink TCI states, for example, for reception of downlink signals (e.g., PDSCH transmission/reception, PDCCH transmission/reception, CSI-RS, DMRS and the like) via the downlink BWP of the cell.

Using/applying the at least two downlink TCI states for reception of the downlink signals may comprise receiving one or more first downlink signals (e.g., PDSCH, PDCCH, CSI-RS, DMRS and the like) with a first spatial domain reception/receiving filter/beam that is determined based on a first reference signal indicated by the first downlink TCI state. The first spatial domain reception/receiving filter/beam may be, for example, same as (or substantially same as, x degrees apart, x=0, 1, 5, 10, and the like) a spatial domain reception/receiving filter/beam used to receive the first reference signal. The first spatial domain reception/receiving filter/beam may be, for example, same as (or substantially same as, x degrees apart, x=0, 1, 5, 10, and the like) a spatial domain transmission/transmitting filter/beam used to send (e.g., transmit) the first reference signal. The downlink signals may comprise the one or more first downlink signals. The using/applying the at least two downlink TCI states for reception of the downlink signals may comprise receiving one or more second downlink signals (e.g., PDSCH, PDCCH, CSI-RS, DMRS and the like) with a second spatial domain reception/receiving filter/beam that is determined based on a second reference signal indicated by the second downlink TCI state. The second spatial domain reception/receiving filter/beam may be, for example, same as (or substantially same as, x degrees apart, x=0, 1, 5, 10, and the like) a spatial domain reception/receiving filter/beam used to receive the second reference signal. The second spatial domain reception/receiving filter/beam may be, for example, same as (or substantially same as, x degrees apart, x=0, 1, 5, 10, and the like) a spatial domain transmission/transmitting filter/beam used to send (e.g., transmit) the second reference signal. The downlink signals may comprise the one or more second downlink signals.

Using/applying the at least two downlink TCI states for reception of the downlink signals may comprise DM-RS (or DM-RS antenna port(s)) of one or more first downlink signals (e.g., PDSCH, PDCCH, CSI-RS, DMRS and the like) being quasi co-located with a first reference signal indicated by the first downlink TCI state. The DM-RS (or the DM-RS antenna port(s)) of one or more first downlink signals may be quasi co-located with the first reference signal with respect to a first quasi co-location type (e.g., QCL Type A, QCL Type B, QCL Type C, QCL Type D, QCL Type E, and the like) indicated by the first downlink TCI state. The using/applying the at least two downlink TCI states for reception of the downlink signals may comprise DM-RS (or DM-RS antenna port(s)) of one or more second downlink signals (e.g., PDSCH, PDCCH, CSI-RS, DMRS and the like) being quasi co-located with a second reference signal indicated by the second downlink TCI state. The DM-RS (or the DM-RS antenna port(s)) of one or more second downlink signals may be quasi co-located with the second reference signal with respect to a second quasi co-location type (e.g., QCL Type A, QCL Type B, QCL Type C, QCL Type D, QCL Type E, and the like) indicated by the second downlink TCI state.

Using/applying the at least two downlink TCI states for reception of the downlink signals may comprise one or more first downlink signals (e.g., CSI-RS, DMRS and the like) being quasi co-located with a first reference signal indicated by the first downlink TCI state. The one or more first downlink signals may be quasi co-located with the first reference signal with respect to a first quasi co-location type indicated by the first downlink TCI state. The using/applying the at least two downlink TCI states for reception of the downlink signals may comprise one or more second downlink signals (e.g., CSI-RS, DMRS and the like) being quasi co-located with a second reference signal indicated by the second downlink TCI state. The one or more second downlink signals may be quasi co-located with the second reference signal with respect to a second quasi co-location type indicated by the second downlink TCI state.

At least two TCI states may be/comprise at least two common/joint TCI states (or at least two common/joint uplink and downlink TCI states). The plurality of common/joint TCI states may comprise the at least two common/joint TCI states. The first TCI state may be/comprise a first common/joint TCI state of the at least two common/joint TCI states. The second TCI state may be/comprise a second common/joint TCI state of the at least two common/joint TCI states. The wireless device may apply/use the at least two common/joint TCI states, for example, for reception of downlink signals (e.g., PDSCH, PDCCH, CSI-RS, DMRS and the like) via the downlink BWP of the cell. The wireless device may apply/use the at least two common/joint TCI states, for example, for transmission of uplink signals (e.g., PUSCH, PUCCH, UCI, transport block, SRS and the like) via the uplink BWP of the cell. The wireless device may apply/use the at least two common/joint TCI states for reception of downlink signals and for transmission of uplink signals.

Using/applying the at least two common/joint TCI states for reception of the downlink signals may comprise receiving one or more first downlink signals (e.g., PDSCH, PDCCH, CSI-RS, DMRS and the like) with a first spatial domain reception/receiving filter/beam that is determined based on a first reference signal indicated by the first common/joint TCI state. The first spatial domain reception/receiving filter/beam may be, for example, same as (or substantially same as, x degrees apart, x=0, 1, 5, 10, and the like) a spatial domain reception/receiving filter/beam used to receive the first reference signal. The first spatial domain reception/receiving filter/beam may be, for example, same as (or substantially same as, x degrees apart, x=0, 1, 5, 10, and the like) a spatial domain transmission/transmitting filter/beam used to send (e.g., transmit) the first reference signal. The downlink signals may comprise the one or more first downlink signals. The using/applying the at least two common/joint TCI states for reception of the downlink signals may comprise receiving one or more second downlink signals (e.g., PDSCH, PDCCH, CSI-RS, DMRS and the like) with a second spatial domain reception/receiving filter/beam that is determined based on a second reference signal indicated by the second common/joint TCI state. The second spatial domain reception/receiving filter/beam may be, for example, same as (or substantially same as, x degrees apart, x=0, 1, 5, 10, and the like) a spatial domain reception/receiving filter/beam used to receive the second reference signal. The second spatial domain reception/receiving filter/beam may be, for example, same as (or substantially same as, x degrees apart, x=0, 1, 5, 10, and the like) a spatial domain transmission/transmitting filter/beam used to send (e.g., transmit) the second reference signal. The downlink signals may comprise the one or more second downlink signals.

Using/applying the at least two common/joint TCI states for reception of the downlink signals may comprise DMRS (or DM-RS antenna port(s)) of one or more first downlink signals (e.g., PDSCH, PDCCH, CSI-RS, DMRS and the like) being quasi co-located with a first reference signal indicated by the first common/joint TCI state. The DM-RS (or the DM-RS antenna port(s)) of one or more first downlink signals may be quasi co-located with the first reference signal with respect to a first quasi co-location type (e.g., QCL Type A, QCL Type B, QCL Type C, QCL Type D, QCL Type E, and the like) indicated by the first common/joint TCI state. The using/applying the at least two common/joint TCI states for reception of the downlink signals may comprise DMRS (or DM-RS antenna port(s)) of one or more second downlink signals (e.g., PDSCH, PDCCH, CSI-RS, DMRS and the like) being quasi co-located with a second reference signal indicated by the second common/joint TCI state. The DM-RS (or the DM-RS antenna port(s)) of one or more second downlink signals may be quasi co-located with the second reference signal with respect to a second quasi co-location type (e.g., QCL Type A, QCL Type B, QCL Type C, QCL Type D, QCL Type E, and the like) indicated by the second common/joint TCI state.

Using/applying the at least two common/joint TCI states for reception of the downlink signals may comprise one or more first downlink signals (e.g., CSI-RS, DMRS and the like) being quasi co-located with a first reference signal indicated by the first common/joint TCI state. The one or more first downlink signals may be quasi co-located with the first reference signal with respect to a first quasi co-location type indicated by the first common/joint TCI state. The using/applying the at least two common/joint TCI states for reception of the downlink signals may comprise one or more second downlink signals (e.g., CSI-RS, DMRS and the like) being quasi co-located with a second reference signal indicated by the second common/joint TCI state. The one or more second downlink signals may be quasi co-located with the second reference signal with respect to a second quasi co-location type indicated by the second common/joint TCI state.

Using/applying the at least two common/joint TCI states for transmission of the uplink signals may comprise sending (e.g., transmitting) one or more first uplink signals (e.g., PUSCH transmissions, PUCCH transmissions, UCI, transport block, SRS and the like) with a first spatial domain transmission filter/beam that is determined based on a first reference signal indicated by the first common/joint TCI state. The first spatial domain transmitting/transmission filter/beam may be, for example, same as (or substantially same as, x degrees apart, x=0, 1, 5, 10, and the like) a spatial domain reception/receiving filter/beam used to receive the first reference signal. The first spatial domain transmitting/transmission filter/beam may be, for example, same as (or substantially same as, x degrees apart, x=0, 1, 5, 10, and the like) a spatial domain transmission/transmitting filter/beam used to send (e.g., transmit) the first reference signal. The using/applying the at least two common/joint TCI states for transmission of the uplink signals may comprise sending (e.g., transmitting) the one or more first uplink signals with a first transmission power that is determined based on one or more first power control parameters (e.g., target received power, closed-loop index, pathloss compensation factor, alpha, pathloss reference signal, and the like) indicated by (or included in or associated with or mapped to) the first common/joint TCI state. The uplink signals may comprise the one or more first uplink signals.

Using/applying the at least two common/joint TCI states for transmission of the uplink signals may comprise sending (e.g., transmitting) one or more second uplink signals (e.g., PUSCH transmissions, PUCCH transmissions, UCI, transport block, SRS and the like) with a second spatial domain transmission filter/beam that is determined based on a second reference signal indicated by the second common/joint TCI state. The second spatial domain transmitting/transmission filter/beam may be, for example, same as (or substantially same as, x degrees apart, x=0, 1, 5, 10, and the like) a spatial domain reception/receiving filter/beam used to receive the second reference signal. The second spatial domain transmitting/transmission filter/beam may be, for example, same as (or substantially same as, x degrees apart, x=0, 1, 5, 10, and the like) a spatial domain transmission/transmitting filter/beam used to send (e.g., transmit) the second reference signal. The using/applying the at least two common/joint TCI states for transmission of the uplink signals may comprise sending (e.g., transmitting) the one or more second uplink signals with a second transmission power that is determined based on one or more second power control parameters (e.g., target received power, closed-loop index, pathloss compensation factor, alpha, pathloss reference signal, and the like) indicated by (or included in or associated with or mapped to) the second common/joint TCI state. The uplink signals may comprise the one or more second uplink signals.

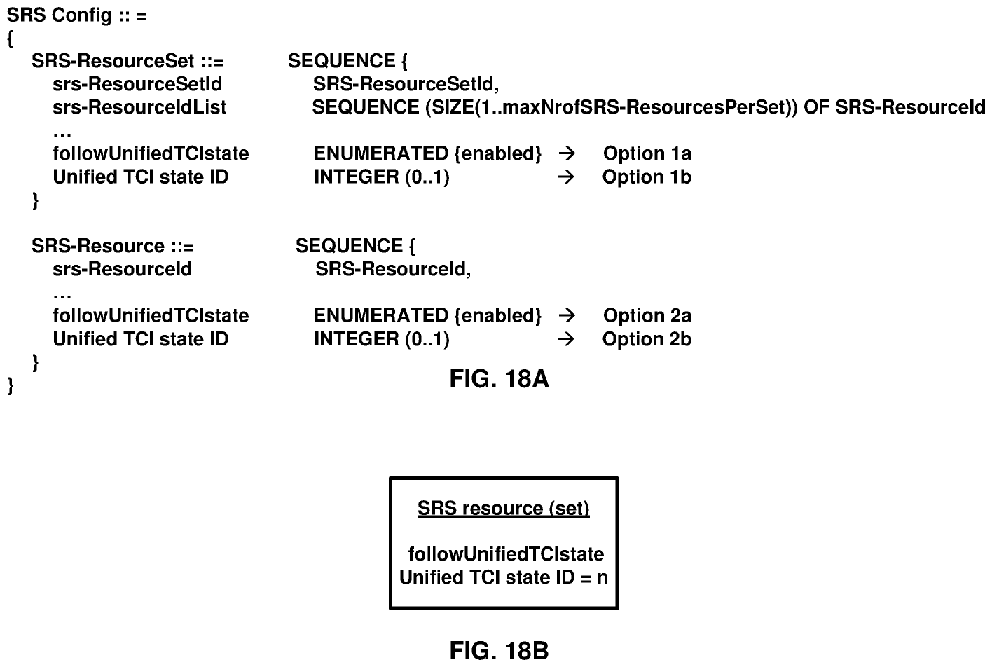

FIG. 18A and FIG. 18B show examples of parameters. The parameters may be used for a unified beam update. The one or more configuration parameters may be sent/received in one or more messages 1710 (e.g., at time T₀ in FIG. 17). The one or more parameters may indicate one or more SRS resource sets. The one or more configuration parameters may comprise one or more SRS configuration parameters (e.g., SRS Config in FIG. 18A) indicating the one or more SRS resource sets. The one or more SRS resource sets may comprise an SRS resource set (e.g., SRS resource set in FIG. 18B).

One or more configuration parameters may indicate a usage for the one or more SRS resource sets. The one or more configuration parameters may indicate a respective usage for each SRS resource set of the one or more SRS resource sets. The one or more configuration parameters may comprise a respective usage parameter for each SRS resource set of the one or more SRS resource sets. The usage may be, for example, ‘codebook’. The usage may be, for example, ‘non-codebook’. The usage may be, for example, ‘beam management’. The usage may be, for example, ‘antenna switching’. The usage may be for any one or more operations, such as any operation described herein.

One or more configuration parameters may indicate, for the SRS resource set, a usage. The usage may be set to, for example, ‘codebook’. The usage may be set to, for example, ‘non-codebook’. The usage may be set to, for example, ‘beam management’. The usage may be set to, for example, ‘antenna switching’. The usage may be for any one or more operations, such as any operation described herein.

One or more configuration parameters may indicate a resource type for the one or more SRS resource sets. The one or more configuration parameters may indicate a respective resource type for each SRS resource set of the one or more SRS resource sets. The one or more configuration parameters may comprise a respective resource type parameter for each SRS resource set of the one or more SRS resource sets. The resource type may be, for example, ‘aperiodic’. The resource type may be, for example, ‘periodic’. The resource type may be, for example, ‘semi-persistent’. The resource type may be for any one or more operations, such as any operation described herein.

One or more configuration parameters may indicate, for the SRS resource set, a resource type. The resource type may be set to, for example, ‘aperiodic’. The resource type may be set to, for example, ‘periodic’. The resource type may be set to, for example, ‘semi-persistent’. The resource type may be for any one or more operations, such as any operation described herein.

One or more configuration parameters may indicate respective SRS resource(s) for each SRS resource set of the one or more SRS resource sets (e.g., SRS-Resource in FIG. 18A). Each SRS resource set of the one or more SRS resource sets may comprise respective SRS resource(s). For example, the SRS resource set may comprise one or more SRS resources.

One or more configuration parameters may indicate a resource type for the one or more SRS resources in the SRS resource set. The one or more configuration parameters may indicate a respective resource type for each SRS resource of the one or more SRS resources. The one or more configuration parameters may comprise a respective resource type parameter for each SRS resource of the one or more SRS resources. The resource type may be, for example, ‘aperiodic. The resource type may be, for example, ‘periodic. The resource type may be, for example, ‘semi-persistent’. The resource type may be for any one or more operations, such as any operation described herein.

A quantity/number of the one or more SRS resource sets may be equal to a quantity/number of the at least two TCI states. A quantity/number of the one or more SRS resource sets may be less/smaller than a number of the at least two TCI states. A quantity/number of the one or more SRS resource sets may be greater/larger than a number of the at least two TCI states. For example, the quantity/number of the at least two TCI states may be equal to 2 (e.g., M=2, N=2). The quantity/number of the at least two TCI states may comprise/indicate/denote a number of TCI states indicated/comprised by (or included in) the at least two TCI states. The quantity/number of the one or more SRS resource sets may be greater than 2, or less than 2, or equal to 2.

One or more configuration parameters may comprise, for the SRS resource set, a parameter (e.g., ApplyTCI-State-UL-List, ApplyTCI-State-DL-List, ApplyTCI-State-List, Use-Indicated-TCI-State, Use-Indicated-UL-TCI-State, Use-Indicated-DL-TCI-State, Follow-Unified-TCI-State, Follow-Unified-UL-TCI-State, Follow-Unified-DL-TCI-State, and the like) indicating to apply/use a common/unified TCI state. The parameter may be set to ‘enabled’. For example, in FIG. 18A, the parameter may comprise ‘followUnifiedTCIstate’ in SRS-ResourceSet (e.g., Option 1a). For example, in FIG. 18B, the parameter may comprise ‘followUnifiedTCIstate’ in SRS resource set.

A parameter may indicate that the SRS resource set (e.g., SRS resource set in FIG. 18B) shares the same common/unified TCI state as UE-dedicated reception on PDSCH and for UE-dedicated reception on all or subset of CORESETS in the cell. The parameter may indicate that the SRS resource set shares the same common/unified TCI state as dynamic-grant/configured-grant based PUSCH transmissions via/of the cell and transmissions via PUCCH resources of the cell.

A wireless device may apply/use the common/unified TCI state for each SRS resource in the SRS resource set, for example, based on the one or more configuration parameters comprising, for the SRS resource set, the parameter. The wireless device may apply/use the common/unified TCI state for each SRS resource of the one or more SRS resources in the SRS resource set, for example, based on the one or more configuration parameters comprising, for the SRS resource set, the parameter that is set to ‘enabled’.

Configuring/Setting/Including/Indicating the parameter for the SRS resource set may reduce signaling overhead. The base station may not need to indicate/configure the parameter for each SRS resource of the one or more SRS resources in the SRS resource set. The one or more configuration parameters may not need to comprise the parameter for each SRS resource of the one or more SRS resources in the SRS resource set.

Configuring/Setting/Including/Indicating the parameter for the SRS resource set may reduce flexibility. Applying/using the common/unified TCI state for each SRS resource in the SRS resource set may reduce flexibility. The wireless device may not apply/use different TCI states for the one or more SRS resources in the SRS resource set. The wireless device may not apply/use a TCI state A for a first SRS resource and a TCI state B for a second SRS resource, where the TCI state A and the TCI state B are different. The one or more SRS resources in the SRS resource set may comprise the first SRS resource and the second SRS resource.

One or more configuration parameters may comprise, for an SRS resource (e.g., SRS resource in FIG. 18B) of the one or more SRS resources in the SRS resource set, a parameter (e.g., ApplyTCI-State-UL-List, ApplyTCI-State-DL-List, ApplyTCI-State-List, Use-Indicated-TCI-State, Use-Indicated-UL-TCI-State, Use-Indicated-DL-TCI-State, Follow-Unified-TCI-State, Follow-Unified-UL-TCI-State, Follow-Unified-DL-TCI-State, and the like) indicating to apply/use a common/unified TCI state. The parameter may be set to ‘enabled’. For example, in FIG. 18A, the parameter is ‘followUnifiedTCIstate’ in SRS-ResourceSet (e.g., Option 2a). For example, in FIG. 18B, the parameter may comprise ‘followUnifiedTCIstate’ in SRS resource.

A parameter may indicate that the SRS resource (e.g., SRS resource in FIG. 18B) shares the same common/unified TCI state as UE-dedicated reception on PDSCH and for wireless device-dedicated reception (e.g., UE-dedicated reception) on all or subset of CORESETS in the cell. The parameter may indicate that the SRS resource shares the same common/unified TCI state as dynamic-grant/configured-grant based PUSCH transmissions via/of the cell and transmissions via PUCCH resources of the cell.

A wireless device may apply/use the common/unified TCI state for the SRS resource in the SRS resource set, for example, based on the one or more configuration parameters comprising, for the SRS resource, the parameter. The wireless device may apply/use the common/unified TCI state for the SRS resource, for example, based on the one or more configuration parameters comprising, for the SRS resource, the parameter that is set to ‘enabled’.

Configuring/Setting/Including/Indicating the parameter for the SRS resource may increase flexibility. The wireless device may apply/use different TCI states for the one or more SRS resources in the SRS resource set. The one or more configuration parameters may not comprise, for a second SRS resource of the one or more SRS resources in the SRS resource set, the parameter. The wireless device may apply/use different TCI states for the SRS resource and the second SRS resource. This application/use of different TCI states may increase flexibility.

Configuring/Setting/Including/Indicating the parameter for the SRS resource may increase signaling overhead. The base station may indicate/configure the parameter for each SRS resource of the one or more SRS resources in the SRS resource set. The base station may indicate/configure the parameter for at least one SRS resource of the one or more SRS resources in the SRS resource set. The one or more configuration parameters may comprise the parameter for each SRS resource of the one or more SRS resources in the SRS resource set. The one or more configuration parameters may comprise the parameter for at least one SRS resource of the one or more SRS resources in the SRS resource set. This may increase the signaling overhead (e.g., RRC bit size).

One or more configuration parameters may comprise a resource type parameter for the SRS resource. The resource type may be, for example, ‘aperiodic’. The resource type may be, for example, ‘periodic’. The resource type may be, for example, ‘semi-persistent’.

As described herein, a wireless device may send (e.g., transmit), via an SRS resource of one or more SRS resources of/in an SRS resource set, an SRS. The wireless device may send (e.g., transmit), via the SRS resource, the SRS, for example, based on a TCI state of at least two TCI states. The TCI state may be, for example, a reference/default TCI state.

A wireless device may send (e.g., transmit), via the SRS resource, the SRS based on the TCI state, for example, based on (e.g., in response to) the one or more configuration parameters comprising, for the SRS resource set that comprises the SRS resource, a parameter. The wireless device may send (e.g., transmit), via the SRS resource, the SRS based on the TCI state, for example, based on (e.g., in response to) one or more configuration parameters comprising, for the SRS resource set that comprises the SRS resource, the parameter set to ‘enabled’.

A wireless device may send (e.g., transmit), via the SRS resource, the SRS based on the TCI state, for example, based on (e.g., in response to) the one or more configuration parameters comprising, for the SRS resource, the parameter. The wireless device may transmit, via the SRS resource, the SRS based on the TCI state, for example, based on (e.g., in response to) the one or more configuration parameters comprising, for the SRS resource, the parameter set to ‘enabled’.

A wireless device may select/determine, for transmission of the SRS via the SRS resource, the TCI state among the at least two TCI states. The wireless device may select/determine, for transmission of the SRS via the SRS resource, the TCI state as a reference/default TCI state. The wireless device may select/determine the TCI state among the at least two TCI states, for example, as a default/reference TCI state. The wireless device may select/determine the TCI state among the at least two TCI states, for example, based on the one or more configuration parameters comprising, for the SRS resource set that comprises the SRS resource, the parameter. The wireless device may select/determine the TCI state among the at least two TCI states, for example, based on the one or more configuration parameters comprising, for the SRS resource set that comprises the SRS resource, the parameter that is set to ‘enabled’. The wireless device may select/determine the TCI state among the at least two TCI states, for example, based on the one or more configuration parameters comprising, for the SRS resource, the parameter. The wireless device may select/determine the TCI state among the at least two TCI states, for example, based on the one or more configuration parameters comprising, for the SRS resource, the parameter that is set to ‘enabled’.

A wireless device may send (e.g., transmit), via the SRS resource, the SRS with a spatial domain transmitting/transmission filter/beam that is determined based on a reference signal indicated by the TCI state. The spatial domain transmitting/transmission filter/beam may be, for example, the same as (or substantially the same as, x degrees apart, x=0, 1, 5, 10, and the like) a spatial domain reception/receiving filter/beam used to receive the reference signal. The spatial domain transmitting/transmission filter/beam may be, for example, the same as (or substantially same as, x degrees apart, x=0, 1, 5, 10, and the like) a spatial domain transmission/transmitting filter/beam used to transmit the reference signal.

A wireless device may send (e.g., transmit), via the SRS resource, the SRS with a transmission power that is determined based on one or more power control parameters (e.g., target received power, closed-loop index, pathloss compensation factor, alpha, pathloss reference signal, and the like) indicated by (or included in or associated with or mapped to) the TCI state. The one or more configuration parameters may indicate, for the TCI state, the one or more power control parameters. The one or more configuration parameters may indicate, for the TCI state, a power control set indicating the one or more power control parameters. The one or more configuration parameters may indicate, for the TCI state, a power control set index/ID/identifier indicating the power control set.

A TCI state may be the first TCI state (e.g., TCI state 26). The wireless device may send (e.g., transmit), via the SRS resource, the SRS with a first spatial domain transmitting/transmission filter/beam that is determined based on a first reference signal indicated by the first TCI state. The wireless device may transmit, via the SRS resource, the SRS with a first transmission power that is determined based on one or more first power control parameters (e.g., target received power, closed-loop index, pathloss compensation factor, alpha, pathloss reference signal, and the like) indicated by (or included in or associated with or mapped to) the first TCI state.

A TCI state may be the second TCI state (e.g., TCI state 61). The wireless device may send (e.g., transmit), via the SRS resource, the SRS with a second spatial domain transmitting/transmission filter/beam that is determined based on a second reference signal indicated by the second TCI state. The wireless device may transmit, via the SRS resource, the SRS with a second transmission power that is determined based on one or more second power control parameters (e.g., target received power, closed-loop index, pathloss compensation factor, alpha, pathloss reference signal, and the like) indicated by (or included in or associated with or mapped to) the second TCI state.

A TCI state may not be associated with a TRP. The one or more configuration parameters may not indicate, for the TCI state, a field (e.g., Unified/Common/Joint TCI state index field, TRP index field, CORESET pool index field, and the like) indicating an association between the TCI state and a TRP. The TCI state may not be associated explicitly or implicitly with a TRP. This may reduce signaling overhead. The one or more configuration parameters may not need to comprise/indicate an association between the TCI state and a TRP (or a TRP index, CORESET pool index, Unified/Common/Joint TCI state index field, and the like). This may reduce RRC message size (or the size of the configuration parameters).

A TCI state may be a first/starting/earliest TCI state among the at least two TCI states. The TCI state may be the first/starting/earliest TCI state in a vector/set/list of the at least two TCI states. The TCI state may be a first/starting/earliest element in a vector/set/list of the at least two TCI states. The TCI state may be a first/starting/earliest TCI state among the at least two TCI states in (or indicated by) the TCI codepoint. A position/location of the TCI state may be earliest/highest/lowest in the vector of the at least two TCI states. The TCI state may occur first in a vector/set/list of the at least two TCI states. The TCI state is TCI state 26, for example, if the vector of the at least two TCI states is equal to [TCI state 26, TCI state 61]. The TCI state is TCI state 2, for example, if the vector of the at least two TCI states is equal to [TCI state 2, TCI state 1].

A TCI state may be the first TCI state (e.g., TCI state 26 in FIG. 17). The TCI state may be the first TCI state, for example, based on the first TCI state being the first/starting/earliest TCI state in the vector/set/list of the at least two TCI states.

A wireless device may send (e.g., transmit), via the SRS resource, the SRS based on the TCI state (or the first/starting/earliest TCI state), for example, based on (e.g., in response to) the TCI state being the first/starting/earliest TCI state in the vector/set/list of the at least two TCI states. A wireless device may select/determine the TCI state (or the first/starting/earliest TCI state) among the at least two TCI states, for example, based on the TCI state being the first/starting/earliest TCI state in the vector/set/list of the at least two TCI states.

A TCI state index of the first/starting/earliest TCI state may be lowest (or highest) among at least two TCI state indexes of the at least two TCI states. The first/starting/earliest TCI state may be identified by/with the TCI state index that is lowest (or highest) among the at least two TCI state indexes of the at least two TCI states. The plurality of TCI state indexes may comprise the at least two TCI state indexes. The at least two TCI state indexes may comprise the TCI state index of the first/starting/earliest TCI state. Each TCI state of the at least two TCI states may be indicated/identified by a respective TCI state index of the at least two TCI state indexes. For example, the first/starting/earliest TCI state may be the first TCI state (e.g., TCI state 26) based on a first TCI state index of the first TCI state being lower (or higher) than a second TCI state index of the second TCI state. For example, the first/starting/earliest TCI state may be the second TCI state (e.g., TCI state 61) based on a second TCI state index of the second TCI state being lower (or higher) than a first TCI state index of the first TCI state. The at least two TCI state indexes may comprise the first TCI state index and the second TCI state index.

A wireless device may send (e.g., transmit), via the SRS resource, the SRS based on the TCI state (or the first/starting/earliest TCI state), for example, based on (e.g., in response to) the TCI state index of the first/starting/earliest TCI state being lowest (or highest) among the at least two TCI state indexes of the at least two TCI states. A wireless device may select/determine the TCI state (or the first/starting/earliest TCI state) among the at least two TCI states, for example, based on the TCI state index of the first/starting/earliest TCI state being lowest (or highest) among the at least two TCI state indexes of the at least two TCI states.

Using the first/starting/earliest TCI state as a default/reference TCI state may reduce complexity of the wireless device. This use of a default/reference TCI state may provide advantages such as a reduce configuration message size (e.g., no need to indicate an association between the SRS resource (or the SRS resource set) and TCI state).

Using the first/starting/earliest TCI state as a default/reference TCI state may reduce flexibility. The wireless device may not use, for transmission of the SRS, the second/second starting/second earliest/last/latest TCI state in the vector/set/list of the at least two TCI states.

A wireless device may receive second DCI (e.g., DCI format 0-1, DCI format 1-1, DCI format 0-2, DCI format 1-2, and the like) triggering/indicating/scheduling transmission of the SRS resource. Second DCI may comprise an SRS request field. The SRS request field may trigger/indicate transmission of the SRS resource. The SRS request field may indicate the SRS resource set comprising the SRS resource. The one or more configuration parameters may indicate, for the SRS resource set, a value of/for an aperiodicSRS-ResourceTrigger parameter. A value of the SRS request field may indicate (or may be mapped to or may be equal to) the value of the aperiodicSRS-ResourceTrigger parameter.

A wireless device may send (e.g., transmit), via the SRS resource, the SRS, for example, based on receiving the second DCI triggering/indicating transmission of the SRS resource. The wireless device may transmit, via the SRS resource, the SRS, for example, based on receiving the second DCI with the SRS request field indicating the SRS resource set that comprises the SRS resource.

The second DCI may comprise a field (e.g., Unified/Common/Joint TCI state index field, TRP index field, CORESET pool index field, and the like) indicating the TCI state. A value of the field may indicate the TCI state. For example, a first value (e.g., 0) of the field may indicate the first TCI state (e.g., TCI state 26). The TCI state may be the first TCI state, for example, based on the value of the field being equal/set to the first value. The TCI state may be the first TCI state. For example, a second value (e.g., 1) of the field may indicate the second TCI state (e.g., TCI state 61). The TCI state may be the second TCI state, for example, based on the value of the field being equal to the second value.

A wireless device may send (e.g., transmit), via the SRS resource, the SRS based on the TCI state, for example, based on (e.g., in response to) the second DCI comprising the field that indicates the TCI state. The wireless device may select/determine the TCI state among the at least two TCI states, for example, based on the second DCI comprising the field that indicates the TCI state. This may increase flexibility. The second DCI may dynamically indicate, for transmission of the SRS via the SRS resource, the first TCI state or the second TCI state. This may increase the size of the second DCI. Adding the field into the second DCI may increase the size of the second DCI. Increased DCI size may reduce coverage.

A wireless device may receive, via a CORESET of the plurality of CORESETS, the second DCI. The wireless device may monitor, for the second DCI, PDCCH transmissions in the CORESET based on the TCI state. The wireless device may receive, via the CORESET, the second DCI based on the TCI state. For example, the wireless device may receive a MAC-CE indicating/activating the TCI state for the CORESET. The MAC-CE may or may not be the activation command at time T₁ in FIG. 17. The wireless device may start monitoring the CORESET based on the TCI state, for example, based on (e.g., in response to) receiving the DCI at time T₂ in FIG. 17.

A wireless device may monitor, for the second DCI, PDCCH transmissions in the CORESET based on the first TCI state and the second TCI state (or based on the at least two TCI states). The TCI state may be the first TCI state, for example, based on the first TCI state being the first/starting/earliest TCI state in the vector/set/list of the at least two TCI states (or of the first TCI state and the second TCI state).

A wireless device may send (e.g., transmit), via the SRS resource, the SRS based on the TCI state, for example, based on (e.g., in response to) receiving the second DCI via the CORESET monitored/activated with (or based on) the TCI state. The wireless device may transmit, via the SRS resource, the SRS based on the TCI state of the CORESET, for example, based on (e.g., in response to) the one or more configuration parameters indicating the joint/common UL/DL TCI state mode.

A wireless device may select/determine the TCI state among the at least two TCI states, for example, based on receiving the second DCI via the CORESET monitored/activated with (or based on) the TCI state. The wireless device may select/determine the TCI state of the CORESET, for example, based on the one or more configuration parameters indicating the joint/common UL/DL TCI state mode.

Using the TCI state of the CORESET as a default/reference TCI state may reduce complexity of the wireless device. This use of a default/reference TCI state may provide advantages such as reduced configuration message size (e.g., no need to indicate an association between the SRS resource (or the SRS resource set) and the TCI state). Using the TCI state of the CORESET as a default/reference TCI state may reduce flexibility. The wireless device may not use, for transmission of the SRS, a different TCI state from the TCI state.

One or more configuration parameters may indicate, for the SRS resource set, a field (e.g., Unified/Common/Joint TCI state index field, TRP index field, CORESET pool index field, and the like) indicating the TCI state. For example, in FIG. 18A, the field is ‘Unified TCI state ID’ in SRS-ResourceSet (e.g., Option 1b). For example, in FIG. 18B, the field is ‘Unified TCI state ID’ in SRS resource set. A value of the field (e.g., Unified TCI state ID in FIG. 18B) may indicate the TCI state. For example, a first value (e.g., n=0 in FIG. 18B) of the field may indicate the first TCI state (e.g., TCI state 26). The TCI state may be the first TCI state, for example, based on the value of the field being equal to/set to the first value. For example, a second value (e.g., n=1 in FIG. 18B) of the field may indicate the second TCI state (e.g., TCI state 61). The TCI state may be the second TCI state, for example, based on the value of the field being equal to/set to the second value.

A field (or the value of the field) may indicate whether to apply/use the first TCI state or the second TCI state for the SRS resource set. The field (or the value of the field) may indicate whether to apply/use the first TCI state or the second TCI state for the one or more SRS resources in the SRS resource set.

A wireless device may apply/use the TCI state for each SRS resource in the SRS resource set, for example, based on the one or more configuration parameters indicating, for the SRS resource set, the field. The wireless device may apply/use the TCI state for each SRS resource of the one or more SRS resources in the SRS resource set, for example, based on the one or more configuration parameters indicating, for the SRS resource set, the field with the value indicating the TCI state. Configuring/Setting/Including/Indicating the field for the SRS resource set may reduce signaling overhead. The base station may not indicate/configure the field for each SRS resource of the one or more SRS resources in the SRS resource set. The one or more configuration parameters may not comprise/indicate the field for each SRS resource of the one or more SRS resources in the SRS resource set.

Configuring/Setting/Including/Indicating the field for the SRS resource set may reduce flexibility. Applying/using the TCI state for each SRS resource in the SRS resource set may reduce flexibility. The wireless device may not apply/use different TCI states for the one or more SRS resources in the SRS resource set.

A wireless device may send (e.g., transmit), via the SRS resource, the SRS based on the TCI state, for example, based on (e.g., in response to) the one or more configuration parameters indicating, for the SRS resource set comprising the SRS resource, the field indicating the TCI state. The wireless device may transmit, via the SRS resource, the SRS based on the TCI state, for example, based on (e.g., in response to) the one or more configuration parameters indicating, for the SRS resource set comprising the SRS resource, the field with the value indicating the TCI state.

A wireless device may select/determine the TCI state among the at least two TCI states, for example, based on the one or more configuration parameters indicating, for the SRS resource set comprising the SRS resource, the field indicating the TCI state. The wireless device may select/determine the TCI state among the at least two TCI states, for example, based on the one or more configuration parameters indicating, for the SRS resource set comprising the SRS resource, the field with the value indicating the TCI state.

One or more configuration parameters may indicate, for each SRS resource set of the one or more SRS resource sets, a respective value of/for the field. The one or more configuration parameters may indicate, for a first SRS resource set of the one or more SRS resource sets, a first value of/for the field. The one or more configuration parameters may indicate, for a second SRS resource set of the one or more SRS resource sets, a second value of/for the field. The one or more configuration parameters may indicate, for a third SRS resource set of the one or more SRS resource sets, the second value of/for the field. The second SRS resource set and the third SRS resource set may share the same unified/common TCI state, for example, based on the one or more configuration parameters indicating the same value of the field for the second SRS resource set and the third SRS resource set.

One or more configuration parameters may indicate, for the SRS resource, a field (e.g., Unified/Common/Joint TCI state index field, TRP index field, CORESET pool index field, and the like) indicating the TCI state. For example, in FIG. 18A, the field may comprise ‘Unified TCI state ID’ in SRS-Resource (e.g., Option 2b). For example, in FIG. 18B, the field may comprise ‘Unified TCI state ID’ in SRS resource. A value of the field (e.g., Unified TCI state ID in FIG. 18B) may indicate the TCI state. For example, a first value (e.g., n=0 in FIG. 18B) of the field may indicate the first TCI state (e.g., TCI state 26). The TCI state may be the first TCI state. For example, a second value (e.g., n=1 in FIG. 18B) of the field may indicate the second TCI state (e.g., TCI state 61). The TCI state may be the second TCI state.

A field (or the value of the field) may indicate whether to apply/use the first TCI state or the second TCI state for the SRS resource. The field (or the value of the field) may indicate whether to apply/use the first TCI state or the second TCI state for the SRS resource.

A wireless device may apply/use the TCI state for the SRS resource in the SRS resource set, for example, based on the one or more configuration parameters indicating, for the SRS resource, the field. The wireless device may apply/use the TCI state for the SRS resource, for example, based on the one or more configuration parameters indicating, for the SRS resource, the field with the value indicating the TCI state.

Configuring/Setting/Including/Indicating the field for the SRS resource may increase flexibility. The wireless device may apply/use different TCI states for the one or more SRS resources in the SRS resource set. The one or more configuration parameters may not indicate, for a second SRS resource of the one or more SRS resources in the SRS resource set, the field. The wireless device may apply/use different TCI states for the SRS resource and the second SRS resource. This may increase flexibility. The one or more configuration parameters may indicate, for a second SRS resource of the one or more SRS resources in the SRS resource set, the field with a second value that is different from the value of the SRS resource. The wireless device may apply/use different TCI states for the SRS resource and the second SRS resource. This may increase flexibility.

Configuring/Setting/Including/Indicating the field for the SRS resource may increase signaling overhead. The base station may indicate/configure the field for each SRS resource of the one or more SRS resources in the SRS resource set. The base station may indicate/configure the field for at least one SRS resource of the one or more SRS resources in the SRS resource set. The one or more configuration parameters may comprise/indicate the field for each SRS resource of the one or more SRS resources in the SRS resource set. The one or more configuration parameters may comprise/indicate the field for at least one SRS resource of the one or more SRS resources in the SRS resource set. This may increase the signaling overhead (e.g., RRC bit size).

A wireless device may send (e.g., transmit), via the SRS resource, the SRS based on the TCI state, for example, based on (e.g., in response to) the one or more configuration parameters indicating, for the SRS resource, the field indicating the TCI state. The wireless device may transmit, via the SRS resource, the SRS based on the TCI state, for example, based on (e.g., in response to) the one or more configuration parameters indicating, for the SRS resource, the field with the value indicating the TCI state.

A wireless device may select/determine the TCI state among the at least two TCI states, for example, based on the one or more configuration parameters indicating, for the SRS resource, the field indicating the TCI state. The wireless device may select/determine the TCI state among the at least two TCI states, for example, based on the one or more configuration parameters indicating, for the SRS resource, the field with the value indicating the TCI state. The field (e.g., Unified/Common/Joint TCI state index field, TRP index field, CORESET pool index field, and the like) may be, for example, a 1-bit field. The field may be either 0 or 1, for example, based on the field being a 1-bit field.

One or more configuration parameters may not indicate, for the SRS resource set, a field (e.g., Unified/Common/Joint TCI state index field, TRP index field, CORESET pool index field, and the like). The field may be absent (or may not be present) in configuration of the SRS resource set. The field of the SRS resource set may be absent (or may not be present) in the one or more configuration parameters. The TCI state may be the first TCI state (e.g., TCI state 26), for example, based on the one or more configuration parameters not indicating, for the SRS resource set comprising the SRS resource, the field. The first TCI state may be a default/reference TCI state, for example, based on the one or more configuration parameters not indicating, for the SRS resource set, the field. The first TCI state may be the first/starting/earliest/initial TCI state in the vector/set/list of the at least two TCI states.

A wireless device may send (e.g., transmit), via the SRS resource, the SRS based on the TCI state, for example, based on (e.g., in response to) the one or more configuration parameters not indicating, for the SRS resource set comprising the SRS resource, the field. A wireless device may select/determine the TCI state among the at least two TCI states, for example, based on the one or more configuration parameters not indicating, for the SRS resource set comprising the SRS resource, the field.

One or more configuration parameters may not indicate, for the SRS resource, a field (e.g., Unified/Common/Joint TCI state index field, TRP index field, CORESET pool index field, and the like). The field may be absent (or may not be present) in configuration of the SRS resource. The field of the SRS resource may be absent (or may not be present) in the one or more configuration parameters. The TCI state may be the first TCI state (e.g., TCI state 26), for example, based on the one or more configuration parameters not indicating, for the SRS resource, the field. The first TCI state may be a default/reference TCI state, for example, based on the one or more configuration parameters not indicating, for the SRS resource, the field. The first TCI state may be the first/starting/earliest/initial TCI state in the vector/set/list of the at least two TCI states.

A wireless device may send (e.g., transmit), via the SRS resource, the SRS based on the TCI state, for example, based on (e.g., in response to) the one or more configuration parameters not indicating, for the SRS resource, the field. The wireless device may select/determine the TCI state among the at least two TCI states, for example, based on the one or more configuration parameters not indicating, for the SRS resource, the field.

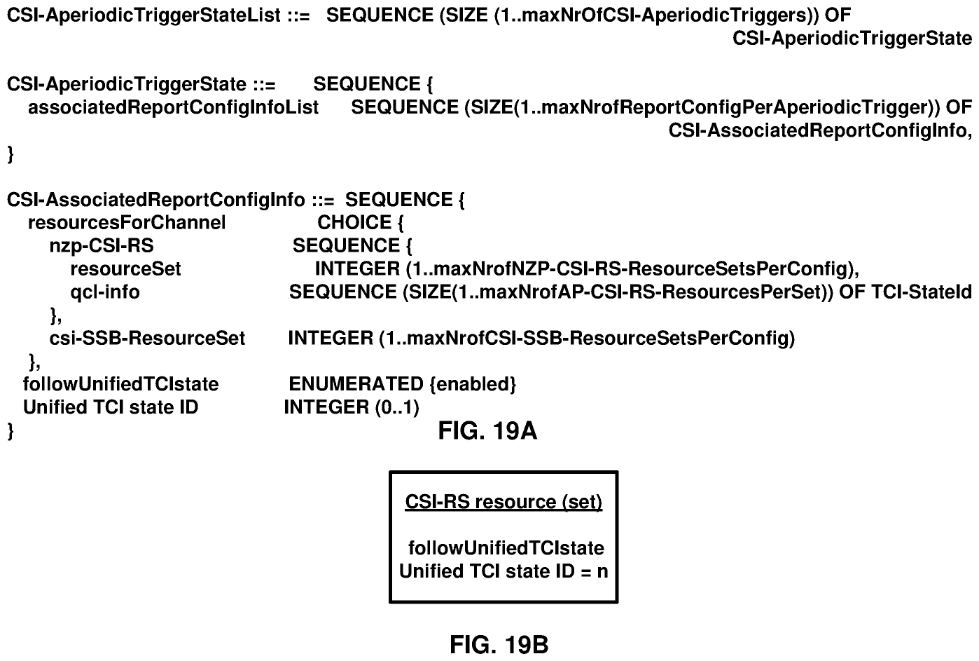

FIG. 19A and FIG. 19B show examples of parameters. The parameters may be used for a unified beam update. The one or more configuration parameters (at time T₀ in FIG. 17) may indicate one or more CSI trigger states (e.g., by a higher layer (RRC) parameter CSI-AperiodicTriggerStateList in FIG. 19A).

A wireless device may receive second DCI (e.g., DCI format 0-1, DCI format 1-1, DCI format 0-2, DCI format 1-2, and the like). The second DCI may indicate/trigger transmission of a CSI report. The CSI report may be, for example, an aperiodic CSI report. The CSI report may be, for example, a semi-persistent CSI report.

Second DCI may comprise a CSI request field. The CSI request field may indicate a CSI trigger state (e.g., CSI-AperiodicTriggerState in FIG. 19B) among the one or more CSI trigger states. The CSI trigger state may comprise/indicate one or more reference signal (RS) resource sets (e.g., CSI-RS resource sets, NZP-CSI-RS-ResourceSets, csi-SSB-ResourceSets, resourceSet in FIG. 19A). The one or more RS resource sets may comprise an RS resource set (e.g., CSI-RS resource set in FIG. 19B).

One or more configuration parameters may indicate respective RS resource(s) for each RS resource set of the one or more RS resource sets. Each RS resource set of the one or more RS resource sets may comprise respective RS resource(s). For example, the RS resource set may comprise one or more RS resources (e.g., CSI-RS resource, NZP-CSI-RS-Resource, SS/PBCH block, and the like).

One or more configuration parameters may comprise, for the RS resource set, a parameter (e.g., ApplyTCI-State-UL-List, ApplyTCI-State-DL-List, ApplyTCI-State-List, Use-Indicated-TCI-State, Use-Indicated-UL-TCI-State, Use-Indicated-DL-TCI-State, Follow-Unified-TCI-State, Follow-Unified-UL-TCI-State, Follow-Unified-DL-TCI-State, and the like) indicating to apply/use a common/unified TCI state. The parameter may be set to ‘enabled’. For example, in FIG. 19A, the parameter may comprise ‘followUnifiedTCIstate’ in CSI-AssociatedReportConfigInfo. For example, in FIG. 19B, the parameter may comprise ‘followUnifiedTCIstate’ in CSI-RS resource set.

A parameter may indicate that the RS resource set (e.g., CSI-RS resource set in FIG. 19B) shares the same common/unified TCI state as UE-dedicated reception on PDSCH and for UE-dedicated reception on all or subset of CORESETS in the cell. The parameter may indicate that the RS resource set shares the same common/unified TCI state as dynamic-grant/configured-grant based PUSCH transmissions via/of the cell and transmissions via PUCCH resources of the cell.

A wireless device may apply/use the common/unified TCI state for each RS resource in the RS resource set, for example, based on the one or more configuration parameters comprising, for the RS resource set, the parameter. The wireless device may apply/use the common/unified TCI state for each RS resource of the one or more RS resources in the RS resource set, for example, based on the one or more configuration parameters comprising, for the RS resource set, the parameter that is set to ‘enabled’. Configuring/Setting/Including/Indicating the parameter for the RS resource set may reduce signaling overhead. The base station may not need to indicate/configure the parameter for each RS resource of the one or more RS resources in the RS resource set. The one or more configuration parameters may not need to comprise the parameter for each RS resource of the one or more RS resources in the RS resource set. Configuring/Setting/Including/Indicating the parameter for the RS resource set may reduce flexibility. Applying/using the common/unified TCI state for each RS resource in the RS resource set may reduce flexibility. The wireless device may not apply/use different TCI states for the one or more RS resources in the RS resource set.

One or more configuration parameters may comprise, for an RS resource (e.g., CSI-RS resource in FIG. 19B) of the one or more RS resources in the RS resource set, a parameter (e.g., ApplyTCI-State-UL-List, ApplyTCI-State-DL-List, ApplyTCI-State-List, Use-Indicated-TCI-State, Use-Indicated-UL-TCI-State, Use-Indicated-DL-TCI-State, Follow-Unified-TCI-State, Follow-Unified-UL-TCI-State, Follow-Unified-DL-TCI-State, and the like) indicating to apply/use a common/unified TCI state. The parameter may be set to ‘enabled’. For example, in FIG. 19B, the parameter may comprise ‘followUnifiedTCIstate’ in CSI-RS resource.

A parameter may indicate that the RS resource shares the same common/unified TCI state as UE-dedicated reception on PDSCH and for UE-dedicated reception on all or subset of CORESETS in the cell. The parameter may indicate that the RS resource shares the same common/unified TCI state as dynamic-grant/configured-grant based PUSCH transmissions via/of the cell and transmissions via PUCCH resources of the cell.

A wireless device may apply/use the common/unified TCI state for the RS resource in the RS resource set, for example, based on the one or more configuration parameters comprising, for the RS resource, the parameter. The wireless device may apply/use the common/unified TCI state for the RS resource, for example, based on the one or more configuration parameters comprising, for the RS resource, the parameter that is set to ‘enabled’.

Configuring/Setting/Including/Indicating the parameter for the RS resource may increase flexibility. The wireless device may apply/use different TCI states for the one or more RS resources in the RS resource set. The one or more configuration parameters may not comprise, for a second RS resource of the one or more RS resources in the RS resource set, the parameter. The wireless device may apply/use different TCI states for the RS resource and the second RS resource. This application/use of different TCI states may increase flexibility.

Configuring/Setting/Including/Indicating the parameter for the RS resource may increase signaling overhead. A base station may indicate/configure the parameter for each RS resource of the one or more RS resources in the RS resource set. The base station may indicate/configure the parameter for at least one RS resource of the one or more RS resources in the RS resource set. The one or more configuration parameters may comprise the parameter for each RS resource of the one or more RS resources in the RS resource set. The one or more configuration parameters may comprise the parameter for at least one RS resource of the one or more RS resources in the RS resource set. This may increase the signaling overhead (e.g., RRC bit size).

A wireless device may receive, via the RS resource of the one or more RS resources of/in the RS resource set, a reference signal (e.g., CSI-RS, SS/PBCH block). The wireless device may receive, via the RS resource, the reference signal, for example, based on a TCI state of the at least two TCI states. The TCI state may be, for example, a reference/default TCI state.

A wireless device may receive, via the RS resource, the reference signal, for example, based on receiving the second DCI triggering/indicating transmission of the CSI report. The wireless device may receive, via the RS resource, the reference signal, for example, based on receiving the second DCI with the CSI request field indicating the RS resource set that comprises the RS resource.

A wireless device may receive, via the RS resource, the reference signal based on the TCI state, for example, based on (e.g., in response to) the one or more configuration parameters comprising, for the RS resource set that comprises the RS resource, the parameter. The wireless device may receive, via the RS resource, the reference signal based on the TCI state, for example, based on (e.g., in response to) the one or more configuration parameters comprising, for the RS resource set that comprises the RS resource, the parameter set to ‘enabled’.

A wireless device may receive, via the RS resource, the reference signal based on the TCI state, for example, based on (e.g., in response to) the one or more configuration parameters comprising, for the RS resource, the parameter. The wireless device may receive, via the RS resource, the reference signal based on the TCI state, for example, based on (e.g., in response to) the one or more configuration parameters comprising, for the RS resource, the parameter set to ‘enabled’.

A wireless device may select/determine, for reception of the reference signal via the RS resource, the TCI state among the at least two TCI states. The wireless device may select/determine, for reception of the reference signal via the RS resource, the TCI state as a reference/default TCI state. The wireless device may select/determine the TCI state among the at least two TCI states, for example, as a default/reference TCI state. The wireless device may select/determine the TCI state among the at least two TCI states, for example, based on the one or more configuration parameters comprising, for the RS resource set that comprises the RS resource, the parameter. The wireless device may select/determine the TCI state among the at least two TCI states, for example, based on the one or more configuration parameters comprising, for the RS resource set that comprises the RS resource, the parameter that is set to ‘enabled’. The wireless device may select/determine the TCI state among the at least two TCI states, for example, based on the one or more configuration parameters comprising, for the RS resource, the parameter. The wireless device may select/determine the TCI state among the at least two TCI states, for example, based on the one or more configuration parameters comprising, for the RS resource, the parameter that is set to ‘enabled’.

A reference signal received via the RS resource may be quasi co-located with a reference signal indicated by the TCI state. The reference signal received via the RS resource may be quasi co-located with the reference signal indicated by the TCI state, for example, with respect to a quasi co-location type (e.g., QCL TypeA, QCL TypeB, QCL TypeC, QCL TypeD, QCL TypeE and the like) indicated by the TCI state.

A wireless device may receive, via the RS resource, the reference signal with a spatial domain receiving/reception filter/beam that is determined based on a reference signal indicated by the TCI state. The spatial domain receiving/reception filter/beam used to receive the reference signal via the RS resource may be, for example, same as (or substantially same as, x degrees apart, x=0, 1, 5, 10, and the like) a spatial domain reception/receiving filter/beam used to receive the reference signal indicated by the TCI state. The spatial domain receiving/reception filter/beam used to receive the reference signal via the RS resource may be, for example, same as (or substantially same as, x degrees apart, x=0, 1, 5, 10, and the like) a spatial domain transmission/transmitting filter/beam used to send (e.g., transmit) the reference signal indicated by the TCI state.

A wireless device may measure, via the RS resource, a radio link quality (e.g., L1-RSRP, L3-RSRP, SINR, SNR, BLER, and the like) of the reference signal, for example, based on the TCI state. The wireless device may measure, via the RS resource, the radio link quality of the reference signal with the spatial domain receiving/reception filter/beam that is associated with the spatial domain reception/receiving filter/beam used to receive the reference signal indicated by the TCI state. The wireless device may send (e.g., transmit) the CSI report comprising/indicating the radio link quality of the reference signal.

A TCI state may be the first TCI state (e.g., TCI state 26). The spatial domain receiving/reception filter/beam used to receive the reference signal via the RS resource may be the first spatial domain receiving/reception filter/beam. The reference signal received via the RS resource may be the first reference signal indicated by the first TCI state.

A TCI state may be the second TCI state (e.g., TCI state 61). The spatial domain receiving/reception filter/beam used to receive the reference signal via the RS resource may be the second spatial domain receiving/reception filter/beam. The reference signal received via the RS resource may be the second reference signal indicated by the second TCI state.

A TCI state used to receive the reference signal via the RS resource may be determined based on one or more examples shown in FIG. 18A and FIG. 18B. The wireless device may receive, via the RS resource, the reference signal based on the TCI state, for example, based on (e.g., in response to) one or more examples shown in FIG. 18A and FIG. 18B. The TCI state may be a first/starting/earliest TCI state in a vector/set/list of the at least two TCI states.

Second DCI with the CSI request field may comprise a field (e.g., Unified/Common/Joint TCI state index field, TRP index field, CORESET pool index field, and the like) indicating the TCI state. A value of the field may indicate the TCI state. For example, a first value (e.g., 0) of the field may indicate the first TCI state (e.g., TCI state 26). The TCI state may be the first TCI state. For example, a second value (e.g., 1) of the field may indicate the second TCI state (e.g., TCI state 61). The TCI state may be the second TCI state. The wireless device may receive, via the RS resource, the reference signal based on the TCI state, for example, based on (e.g., in response to) the second DCI comprising the field that indicates the TCI state.

A wireless device may receive, via the RS resource, the reference signal based on the TCI state, for example, based on (e.g., in response to) receiving the second DCI via the CORESET monitored/activated with (or based on) the TCI state. The wireless device may receive, via the RS resource, the reference signal based on the TCI state of the CORESET, for example, based on (e.g., in response to) the one or more configuration parameters indicating the joint/common UL/DL TCI state mode.

One or more configuration parameters may indicate, for the RS resource set, a field (e.g., Unified/Common/Joint TCI state index field, TRP index field, CORESET pool index field, and the like) indicating the TCI state. For example, in FIG. 19A, the field is ‘Unified TCI state ID’. For example, in FIG. 19B, the field is ‘Unified TCI state ID’ in CSI-RS resource set. A value of the field (e.g., Unified TCI state ID in FIG. 19B) may indicate the TCI state. For example, a first value (e.g., n=0 in FIG. 19B) of the field may indicate the first TCI state (e.g., TCI state 26). The TCI state may be the first TCI state. For example, a second value (e.g., n=1 in FIG. 19B) of the field may indicate the second TCI state (e.g., TCI state 61). The TCI state may be the second TCI state.

A field (or the value of the field) may indicate whether to apply/use the first TCI state or the second TCI state for the RS resource set. The field (or the value of the field) may indicate whether to apply/use the first TCI state or the second TCI state for the one or more RS resources in the RS resource set.

A wireless device may apply/use the TCI state for each RS resource in the RS resource set, for example, based on the one or more configuration parameters indicating, for the RS resource set, the field. The wireless device may apply/use the TCI state for each RS resource of the one or more RS resources in the RS resource set, for example, based on the one or more configuration parameters indicating, for the RS resource set, the field with the value indicating the TCI state. Configuring/Setting/Including/Indicating the field for the RS resource set may reduce signaling overhead. The base station may not indicate/configure the field for each RS resource of the one or more RS resources in the RS resource set. The one or more configuration parameters may not comprise/indicate the field for each RS resource of the one or more RS resources in the RS resource set.

Configuring/Setting/Including/Indicating the field for the RS resource set may reduce flexibility. Applying/using the TCI state for each RS resource in the RS resource set may reduce flexibility. The wireless device may not apply/use different TCI states for the one or more RS resources in the RS resource set.

A wireless device may receive, via the RS resource, the reference signal based on the TCI state, for example, based on (e.g., in response to) the one or more configuration parameters indicating, for the RS resource set comprising the RS resource, the field indicating the TCI state. The wireless device may receive, via the RS resource, the reference signal based on the TCI state, for example, based on (e.g., in response to) the one or more configuration parameters indicating, for the RS resource set comprising the RS resource, the field with the value indicating the TCI state.

A wireless device may select/determine the TCI state among the at least two TCI states, for example, based on the one or more configuration parameters indicating, for the RS resource set comprising the RS resource, the field indicating the TCI state. The wireless device may select/determine the TCI state among the at least two TCI states, for example, based on the one or more configuration parameters indicating, for the RS resource set comprising the RS resource, the field with the value indicating the TCI state.

One or more configuration parameters may indicate, for the RS resource, a field (e.g., Unified/Common/Joint TCI state index field, TRP index field, CORESET pool index field, and the like) indicating the TCI state. For example, in FIG. 19B, the field is ‘Unified TCI state ID’ in CSI-RS resource. A value of the field (e.g., Unified TCI state ID in FIG. 19B) may indicate the TCI state. For example, a first value (e.g., n=0 in FIG. 19B) of the field may indicate the first TCI state (e.g., TCI state 26). The TCI state may be the first TCI state. For example, a second value (e.g., n=1 in FIG. 19B) of the field may indicate the second TCI state (e.g., TCI state 61). The TCI state may be the second TCI state.

The field (or the value of the field) may indicate whether to apply/use the first TCI state or the second TCI state for the RS resource. The field (or the value of the field) may indicate whether to apply/use the first TCI state or the second TCI state for the RS resource.

A wireless device may apply/use the TCI state for the RS resource in the RS resource set, for example, based on the one or more configuration parameters indicating, for the RS resource, the field. The wireless device may apply/use the TCI state for the RS resource, for example, based on the one or more configuration parameters indicating, for the RS resource, the field with the value indicating the TCI state.

Configuring/Setting/Including/Indicating the field for the RS resource may increase flexibility. The wireless device may apply/use different TCI states for the one or more RS resources in the RS resource set. The one or more configuration parameters may not indicate, for a second RS resource of the one or more RS resources in the RS resource set, the field. The wireless device may apply/use different TCI states for the RS resource and the second RS resource. This may increase flexibility. The one or more configuration parameters may indicate, for a second RS resource of the one or more RS resources in the RS resource set, the field with a second value that is different from the value of the RS resource. The wireless device may apply/use different TCI states for the RS resource and the second RS resource. This application/use of different TCI states may increase flexibility.

Configuring/Setting/Including/Indicating the field for the RS resource may increase signaling overhead. The base station may indicate/configure the field for each RS resource of the one or more RS resources in the RS resource set. The base station may indicate/configure the field for at least one RS resource of the one or more RS resources in the RS resource set. The one or more configuration parameters may comprise/indicate the field for each RS resource of the one or more RS resources in the RS resource set. The one or more configuration parameters may comprise/indicate the field for at least one RS resource of the one or more RS resources in the RS resource set. This may increase the signaling overhead (e.g., RRC bit size).

A wireless device may receive, via the RS resource, the reference signal based on the TCI state, for example, based on (e.g., in response to) the one or more configuration parameters indicating, for the RS resource, the field indicating the TCI state. The wireless device may receive, via the RS resource, the reference signal based on the TCI state, for example, based on (e.g., in response to) the one or more configuration parameters indicating, for the RS resource, the field with the value indicating the TCI state.

A wireless device may select/determine the TCI state among the at least two TCI states, for example, based on the one or more configuration parameters indicating, for the RS resource, the field indicating the TCI state. The wireless device may select/determine the TCI state among the at least two TCI states, for example, based on the one or more configuration parameters indicating, for the RS resource, the field with the value indicating the TCI state. The field (e.g., Unified/Common/Joint TCI state index field, TRP index field, CORESET pool index field, and the like) may be, for example, a 1-bit field. The field may be either 0 or 1, for example, based on the field being a 1-bit field.

One or more configuration parameters may not indicate, for the RS resource set, a field (e.g., Unified/Common/Joint TCI state index field, TRP index field, CORESET pool index field, and the like). The field may be absent (or may not be present) in configuration of the RS resource set. The field of the RS resource set may be absent (or may not be present) in the one or more configuration parameters. The TCI state may be the first TCI state (e.g., TCI state 26), for example, based on the one or more configuration parameters not indicating, for the RS resource set comprising the RS resource, the field. The first TCI state may be a default/reference TCI state, for example, based on the one or more configuration parameters not indicating, for the RS resource set, the field. The first TCI state may be the first/starting/earliest/initial TCI state in the vector/set/list of the at least two TCI states.

A wireless device may receive, via the RS resource, the reference signal based on the TCI state, for example, based on (e.g., in response to) the one or more configuration parameters not indicating, for the RS resource set comprising the RS resource, the field. The wireless device may select/determine the TCI state among the at least two TCI states, for example, based on the one or more configuration parameters not indicating, for the RS resource set comprising the RS resource, the field.

One or more configuration parameters may not indicate, for the RS resource set, a quasi co-location information (e.g., qcl-info in FIG. 19A). The quasi co-location information may be absent (or may not be present) in configuration of the RS resource set. The quasi co-location information of the RS resource set may be absent (or may not be present) in the one or more configuration parameters.

A wireless device may receive, via the RS resource, the reference signal based on the TCI state, for example, based on (e.g., in response to) the one or more configuration parameters not indicating, for the RS resource set comprising the RS resource, the quasi co-location information. The wireless device may select/determine the TCI state among the at least two TCI states, for example, based on the one or more configuration parameters not indicating, for the RS resource set comprising the RS resource, the quasi co-location information.

One or more configuration parameters may not indicate, for the RS resource, a field (e.g., Unified/Common/Joint TCI state index field, TRP index field, CORESET pool index field, and the like). The field may be absent (or may not be present) in configuration of the RS resource. The field of the RS resource may be absent (or may not be present) in the one or more configuration parameters. The TCI state may be the first TCI state (e.g., TCI state 26), for example, based on the one or more configuration parameters not indicating, for the RS resource, the field. The first TCI state may be a default/reference TCI state, for example, based on the one or more configuration parameters not indicating, for the RS resource, the field. The first TCI state may be the first/starting/earliest/initial TCI state in the vector/set/list of the at least two TCI states.

A wireless device may receive, via the RS resource, the reference signal based on the TCI state, for example, based on (e.g., in response to) the one or more configuration parameters not indicating, for the RS resource, the field. The wireless device may select/determine the TCI state among the at least two TCI states, for example, based on the one or more configuration parameters not indicating, for the RS resource, the field.

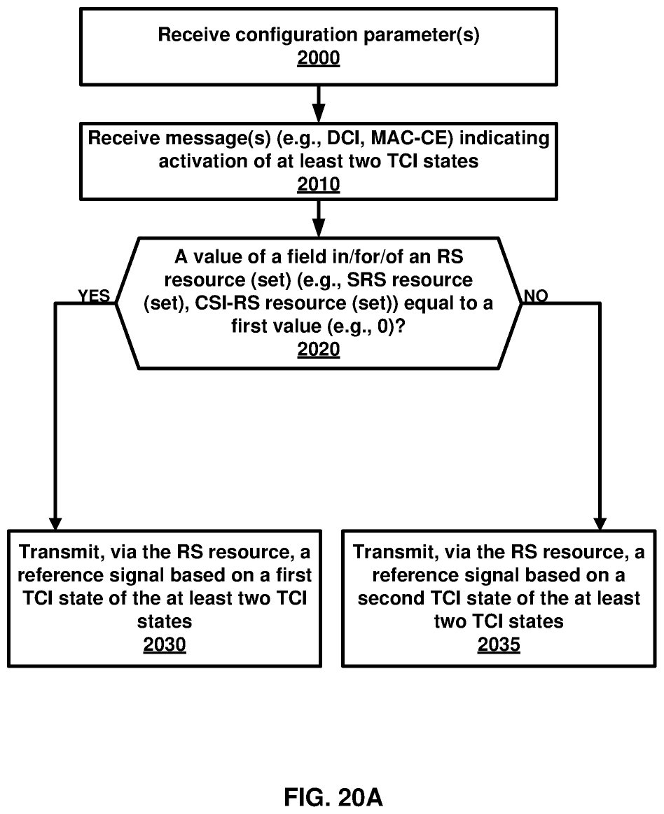

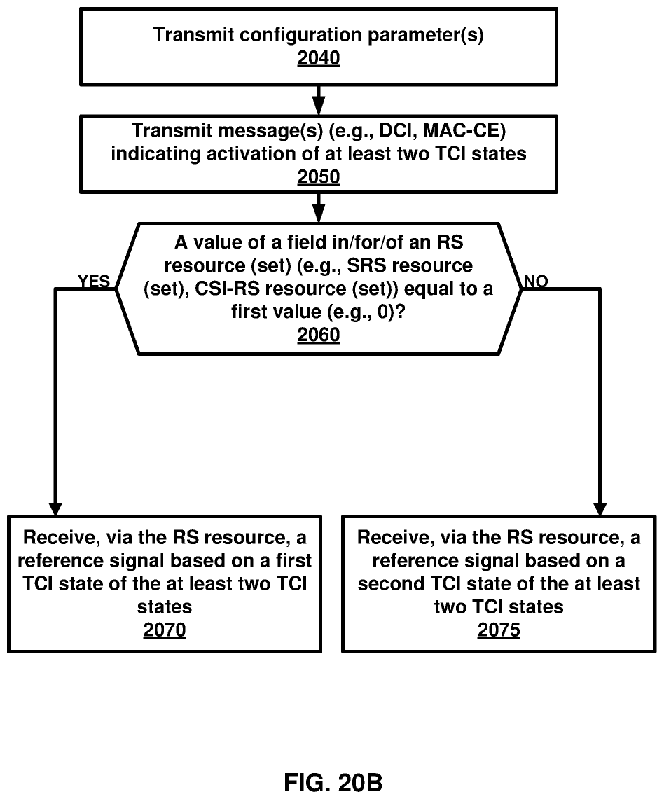

FIG. 20A and FIG. 20B show example methods of using an indication of a TCI state. The method may comprise a unified beam update. At step 2000, a wireless device may receive, for example, from a base station, one or more messages comprising one or more configuration parameters for a cell. Step 2000 in FIG. 20A may correspond to step 1710 described with respect to FIG. 17. At step 2040, the base station may send (e.g., transmit), for example, to the wireless device, the one or more messages comprising the one or more configuration parameters. Step 2040 in FIG. 20A may correspond to step 1710 described with respect to FIG. 17. The one or more configuration parameters may indicate a plurality of TCI states. For example, the one or more configuration parameters may indicate, for an uplink BWP of the cell, the plurality of TCI states. For example, the one or more configuration parameters may indicate, for a downlink BWP of the cell, the plurality of TCI states.

The wireless device may activate (or set) the uplink BWP as an active uplink BWP of the cell. The wireless device may activate (or set) the downlink BWP as an active downlink BWP of the cell. For example, the base station may send (e.g., transmit) one or more messages (e.g., DCI, MAC-CE, RRC message) indicating an activation of at least two states. The one or more messages may indicate an activation of the uplink BWP. and/or indicating an activation of the downlink BWP.

The plurality of TCI states may comprise a plurality of joint/downlink TCI states (or joint uplink/downlink TCI states). The plurality of TCI states may comprise a plurality of uplink TCI states. The plurality of TCI states may comprise a plurality of downlink TCI states.

At step 2010, the wireless device may receive one or more messages indicating activation of at least two TCI states. Step 2010 in FIG. 20A may correspond to step 1720 described with respect to FIG. 17. For example, the wireless device may receive an activation command (e.g., MAC-CE, DCI) indicating activation of a subset of the plurality of TCI states. At step 2050, the base station may send (e.g., transmit) the one or more messages indicating activation of at least two TCI states. Step 2050 in FIG. 20A may correspond to step 1720 described with respect to FIG. 17. For example, the base station may send (e.g., transmit) the activation command indicating activation of the subset of the plurality of TCI states.

The wireless device may map the subset of the plurality of TCI states to one or more TCI codepoints. Each TCI codepoint of the one or more TCI codepoints may indicate respective TCI state(s) of the subset of the plurality of TCI states. The base station may map the subset of the plurality of TCI states to the one or more TCI codepoints.

The wireless device may receive a control message/command (e.g., DCI, MAC-CE) indicating activation of at least two transmission configuration indicator (TCI) states (e.g., at step 2010). The subset of the plurality of TCI states may comprise the at least two TCI states. The base station may send (e.g., transmit) the control message/command (e.g., at step 2050).

The control message (e.g., DCI) may comprise a TCI field indicating the at least two TCI states. A TCI codepoint of the one or more TCI codepoints may indicate/comprise the at least two TCI states. The TCI field may indicate the TCI codepoint. At step 2020, the wireless device may determine a value of a field in/for/of an RS resource (set) (e.g., SRS resource (set), CSI-RS resource (set)). The field may comprise the TCI field. The value may comprise/indicate the TCI codepoint. The value may comprise, and/or may be indicated by, a bit (e.g., 0 or 1). The wireless device may determine whether the value is equal to a first value (e.g., 0, or 1). At step 2060, the base station may determine whether the value is equal to a first value (e.g., 0 or 1). The control message may be, for example, the activation command (e.g., at step 2010 and/or at step 2050).

The at least two TCI states may be the subset of the plurality of TCI states. The one or more TCI codepoints may be/comprise a single TCI codepoint. The at least two TCI states may be/comprise at least two joint/common/unified TCI states. The at least two TCI states may be/comprise at least two joint/common/unified uplink and downlink TCI states. The at least two TCI states may be/comprise at least two joint/common/unified uplink TCI states. The at least two TCI states may be/comprise at least two uplink TCI states. The at least two TCI states may be/comprise at least two joint/common/unified downlink TCI states. The at least two TCI states may be/comprise at least two downlink TCI states.

The wireless device may send (e.g., transmit), via a reference signal resource, a reference signal based on a TCI state of the at least two TCI states. For example, at step 2030, the wireless device may send (e.g., transmit), via a reference signal source, a reference signal based on a first TCI state of the at least two TCI states, for example, if the value of the field is equal to a first value (e.g., equal to 0). At step 2035, the wireless device may send (e.g., transmit), via a reference signal source, a reference signal based on a second TCI state of the at least two TCI states, for example, if the value of the field is not equal to the first value (e.g., is not equal to 0) and/or is equal to a second value (e.g., is equal to 1). The base station may receive, via the reference signal resource, the reference signal based on the TCI state of the at least two TCI states. For example, at step 2070, the base station may receive, via the reference signal resource, the reference signal based on a first TCI state of the at least two TCI states, for example, if the value of the field is equal to a first value (e.g., equal to 0). At step 2075, the base station may receive, via the reference signal resource, the reference signal based on a second TCI state of the at least two TCI states, for example, if the value of the field is not equal to the first value (e.g., not equal to 0) and/or if equal to a second value (e.g., is equal to 1).

A reference signal resource may be, for example, an SRS resource. The reference signal may be, for example, an SRS. A reference signal resource set (e.g., SRS resource set) may comprise the reference signal resource. The wireless device may apply/use the TCI state for transmission of the reference signal via the reference signal resource. The base station may apply/use the TCI state for reception of the reference signal via the reference signal resource. Applying/using the TCI state for transmission of the reference signal via the reference signal resource may comprise sending (e.g., transmitting), via the reference signal resource, the reference signal with (or based on) a spatial domain transmission filter that is determined based on a reference signal indicated by the TCI state. Applying/using the TCI state for transmission of the reference signal via the reference signal resource may comprise the reference signal received via the reference signal resource being quasi co-located with a reference signal indicated by the TCI state. Applying/using the TCI state for transmission of the reference signal via the reference signal resource may comprise transmitting, via the reference signal resource, the reference signal with (or based on) a transmission power that is determined based on one or more power control parameters indicated by (or associated with or mapped to or included in) the TCI state. The one or more configuration parameters may indicate, for the TCI state, a power control parameter set comprising the one or more power control parameters. Applying/using the TCI state for reception of the reference signal via the reference signal resource may comprise receiving, via the reference signal resource, the reference signal with (or based on) a spatial domain reception filter that is determined, for example, based on the reference signal indicated by the TCI state.

The wireless device may receive/measure, via a reference signal resource, a reference signal based on a TCI state of the at least two TCI states. The base station may send (e.g., transmit), via the reference signal resource, the reference signal based on the TCI state of the at least two TCI states. The reference signal resource may be, for example, an CSI-RS resource. The reference signal may be, for example, a CSI-RS. A reference signal resource set (e.g., CSI-RS resource set) may comprise the reference signal resource. The wireless device may apply/use the TCI state for reception of the reference signal via the reference signal resource. The base station may apply/use the TCI state for transmission of the reference signal via the reference signal resource. Applying/using the TCI state for reception of the reference signal via the reference signal resource may comprise receiving, via the reference signal resource, the reference signal with (or based on) a spatial domain reception filter that is determined based on a reference signal indicated by the TCI state. Applying/using the TCI state for reception of the reference signal via the reference signal resource may comprise the reference signal received via the reference signal resource being quasi co-located with a reference signal indicated by the TCI state. Applying/using the TCI state for transmission of the reference signal via the reference signal resource may comprise sending (e.g., transmitting), via the reference signal resource, the reference signal with (or based on) a spatial domain transmitting/transmission filter that is determined based on the reference signal indicated by the TCI state.

The one or more configuration parameters may comprise/indicate, for the reference signal resource set (or the reference signal resource), a parameter (e.g., ApplyTCI-State-UL-List, ApplyTCI-State-DL-List, ApplyTCI-State-List, Use-Indicated-TCI-State, Use-Indicated-UL-TCI-State, Use-Indicated-DL-TCI-State, Follow-Unified-TCI-State, Follow-Unified-UL-TCI-State, Follow-Unified-DL-TCI-State, and the like) indicating to apply/use a common/unified TCI state. The parameter may be set to ‘enabled’. The wireless device may transmit/receive, via the reference signal resource, the reference signal based on the TCI state, for example, based on (e.g., in response to) the one or more configuration parameters comprising/indicating, for the reference signal resource set (or the reference signal resource), the parameter. The base station may transmit/receive, via the reference signal resource, the reference signal based on the TCI state, for example, based on (e.g., in response to) the one or more configuration parameters comprising/indicating, for the reference signal resource set (or the reference signal resource), the parameter.

A TCI state may be a first/earliest/starting TCI state that occurs first in a list/vector/set of the at least two TCI states. The wireless device may receive a second DCI triggering transmission of the reference signal (e.g., SRS) via the reference signal resource (e.g., SRS resource). The base station may send (e.g., transmit) the second DCI triggering reception of the reference signal.

The wireless device may receive second DCI triggering reception of the reference signal (e.g., CSI-RS) via the reference signal resource (e.g., CSI-RS resource). The base station may send (e.g., transmit) the second DCI triggering transmission of the reference signal (e.g., CSI-RS) via the reference signal resource (e.g., CSI-RS resource).

The reference signal may be, for example, an aperiodic reference signal. The one or more configuration parameters may indicate, for the reference signal, aperiodic. The second DCI may be, for example, different from the control message. The second DCI may be, for example, the same as the control message.

Second DCI may comprise a field (e.g., Unified/Common/Joint TCI state index field, TRP index field, CORESET pool index field, and the like) comprising/with a value indicating the TCI state. The TCI state may be a first TCI state of the at least two TCI states based on the value being equal to a first value (e.g., 0). The TCI state may be a second TCI state of the at least two TCI states based on the value being equal to a second value (e.g., 1).

One or more configuration parameters may indicate, for the reference signal resource set, a field (e.g., Unified/Common/Joint TCI state index field, TRP index field, CORESET pool index field, and the like) comprising/with a value indicating the TCI state. One or more configuration parameters may indicate, for the reference signal resource, a field (e.g., Unified/Common/Joint TCI state index field, TRP index field, CORESET pool index field, and the like) with a value indicating the TCI state.

The TCI state may be a first TCI state of the at least two TCI states based on the value of the field being equal to a first value (e.g., 0). The TCI state may be a second TCI state of the at least two TCI states based on the value of the field being equal to a second value (e.g., 1). The field may be, for example, a 1-bit field.

One or more configuration parameters may not indicate, for the reference signal resource (or for the reference signal resource set), a field (e.g., Unified/Common/Joint TCI state index field, TRP index field, CORESET pool index field, and the like). The TCI state may be a first/earliest/starting TCI state that occurs first in a list/vector/set of the at least two TCI states, for example, based on the one or more configuration parameters not indicating, for the reference signal resource (or for the reference signal resource set), the field.

The TCI state may not be associated with a TRP. The one or more configuration parameters may not indicate, for the TCI state, a field (e.g., Unified/Common/Joint TCI state index field, TRP index field, CORESET pool index field, and the like) indicating an association between the TCI state and a TRP. The TCI state may not be associated explicitly or implicitly with a TRP. This may reduce signaling overhead. The one or more configuration parameters may not need to comprise/indicate an association between the TCI state and a TRP (or a TRP index, CORESET pool index, Unified/Common/Joint TCI state index field, and the like). This may reduce RRC message size (or the size of the configuration parameters).

Each TCI state of the at least two TCI states may not be associated with a TRP. The one or more configuration parameters may not indicate, for each TCI state of the at least two TCI states, a field (e.g., Unified/Common/Joint TCI state index field, TRP index field, CORESET pool index field, and the like) indicating an association with a TRP. Each TCI state of the at least two TCI states may not be associated explicitly or implicitly with a TRP. This may reduce signaling overhead. The one or more configuration parameters may not need to comprise/indicate an association between each TCI state of the at least two TCI states and a respective TRP (or a TRP index, CORESET pool index, Unified/Common/Joint TCI state index field, and the like). This may reduce RRC message size (or the size of the configuration parameters).

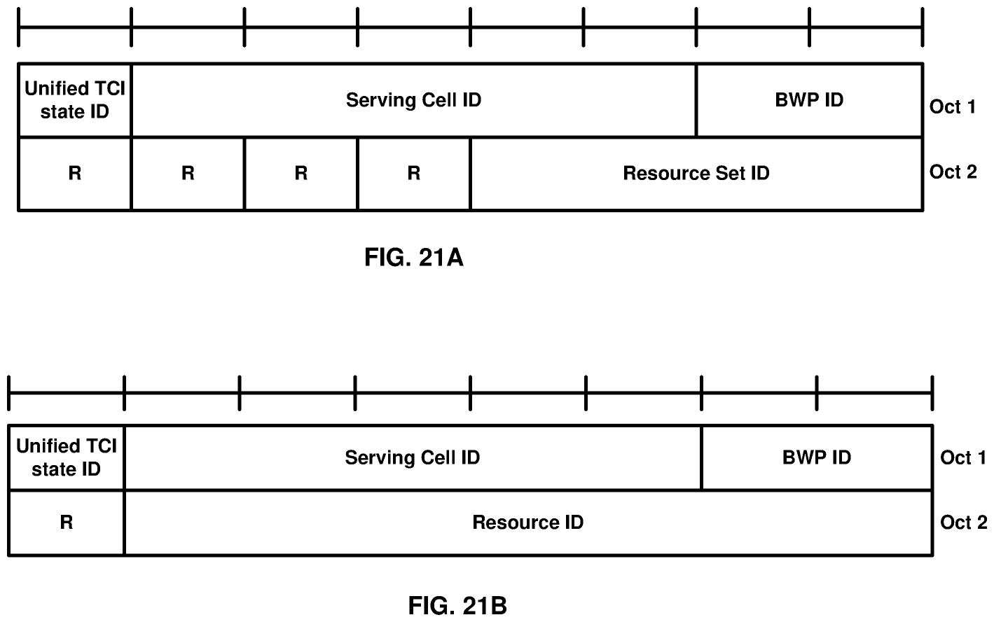

FIG. 21A and FIG. 21B show examples of activation commands. The activation commands may be used in a unified beam update. One or more configuration parameters may indicate, for the reference signal resource set, a field (e.g., Unified/Common/Joint TCI state index field, TRP index field, CORESET pool index field, and the like) with a first value (e.g., n=0, n=1 in FIG. 18B). The first value of the field may indicate a first TCI state of the at least two TCI states.

The one or more configuration parameters may indicate, for the reference signal resource, a field (e.g., Unified/Common/Joint TCI state index field, TRP index field, CORESET pool index field, and the like) with a first value (e.g., n=0, n=1 in FIG. 18B). The first value of the field may indicate a first TCI state of the at least two TCI states. The first TCI indicated by the first value of the field state may be the first TCI state (e.g., TCI state 26 in FIG. 17), for example, if the first value is equal to 0 (e.g., n=0). The first TCI state indicated by the first value of the field may be the second TCI state (e.g., TCI state 61 in FIG. 17), for example, if the first value is equal to 1 (e.g., n=1).

A wireless device may apply/use the first TCI state for transmission of the reference signal (e.g., SRS) via the reference signal resource (e.g., SRS resource) in the reference signal resource set (e.g., SRS resource set). The base station may apply/use the first TCI state for reception of the reference signal (e.g., SRS) via the reference signal resource (e.g., SRS resource) in the reference signal resource set (e.g., SRS resource set).

The wireless device may apply/use the first TCI state for reception of the reference signal (e.g., CSI-RS) via the reference signal resource (e.g., CSI-RS resource) in the reference signal resource set (e.g., CSI-RS resource set, NZP CSI-RS resource set, and the like). The base station may apply/use the first TCI state for transmission of the reference signal (e.g., CSI-RS) via the reference signal resource (e.g., CSI-RS resource) in the reference signal resource set (e.g., CSI-RS resource set, NZP CSI-RS resource set, and the like).

The wireless device may transmit/receive, via the reference signal resource in the reference signal resource set, the reference signal based on the first TCI state indicated by the first value of the field. The base station may transmit/receive, via the reference signal resource in the reference signal resource set, the reference signal based on the first TCI state indicated by the first value of the field.

The wireless device may transmit/receive, via the reference signal resource, the reference signal based on the first TCI state, for example, based on (e.g., in response to) the one or more configuration parameters indicating, for the reference signal resource set comprising the reference signal resource, the field with the first value indicating the first TCI state. The wireless device may transmit/receive, via the reference signal resource, the reference signal based on the first TCI state, for example, based on (e.g., in response to) the one or more configuration parameters indicating, for the reference signal resource, the field with the first value indicating the first TCI state. A base station may transmit/receive, via the reference signal resource, the reference signal based on the first TCI state, for example, based on (e.g., in response to) the one or more configuration parameters indicating, for the reference signal resource set comprising the reference signal resource (or for the reference signal resource), the field with the first value indicating the first TCI state.

A wireless device may receive an activation command (e.g., MAC-CE, DCI, Unified TCI state ID update MAC-CE, and the like). The activation command may comprise one or more fields. The base station may send (e.g., transmit) the activation command. A first field of the one or more fields may comprise a serving cell index (e.g., Serving Cell ID in FIG. 21A and FIG. 21B) indicating/identifying the cell. A second field of the one or more fields may comprise a BWP index (e.g., BWP ID in FIG. 21A and FIG. 21B). The BWP index may indicate/identify, for example, the uplink BWP of the cell. The BWP index may indicate/identify, for example, the downlink BWP of the cell.

A third field of the one or more fields may comprise a reference signal resource set index (e.g., Resource Set ID in FIG. 21A) indicating/identifying the reference signal resource set. The one or more configuration parameters may indicate, for the reference signal resource set, the reference signal resource set index. A size/length of the third field may be equal to m bits (e.g., m=2, m=4, m=5, m=6, m=7 bits, and so on).

A third field of the one or more fields may comprise a reference signal resource index (e.g., Resource ID in FIG. 21B) indicating/identifying the reference signal resource. The one or more configuration parameters may indicate, for the reference signal resource, the reference signal resource index. A size/length of the third field may be equal to m bits (e.g., m=2, m=4, m=5, m=6, m=7 bits, m=8 bits, and so on).

A fourth field (e.g., Unified TCI State ID in FIG. 21A) of the one or more fields may indicate a second value for/of the field (e.g., Unified/Common/Joint TCI state index field, TRP index field, CORESET pool index field, and the like) of the reference signal resource set (e.g., in FIG. 21A). A fourth field (e.g., Unified TCI State ID in FIG. 21B) of the one or more fields may indicate a second value for/of the field (e.g., Unified/Common/Joint TCI state index field, TRP index field, CORESET pool index field, and the like) of the reference signal resource (e.g., in FIG. 21B).

A size/length of the fourth field may be 1 bit. The size/length of the fourth field may be 1 bit, for example, based on a transmission/reception of the reference signal being associated with a single TRP. The transmission/reception of the reference signal may not be repeated to/from multiple TRPs (e.g., no multi-TRP reference signal repetition). The wireless device may perform transmission/reception of the reference signal to the first TRP only. The wireless device may perform transmission/reception of the reference signal to the second TRP only. 1-bit for the size/length of the fourth field may be enough to indicate these two cases (e.g., first TRP only, second TRP only).

“R” fields in FIG. 21A and FIG. 21B may denote/be/comprise reserved bits. The second value of the field may indicate a second TCI state of the at least two TCI states. The second TCI state indicated by the second value of the field may be the first TCI state (e.g., TCI state 26), for example, if the second value is equal to 0 (e.g., n=0). The second TCI state indicated by the second value of the field may be the second TCI state (e.g., TCI state 61), for example, if the second value is equal to 1 (e.g., n=1).

A wireless device may replace/update the first value of the field with the second value, for example, based on receiving the activation command indicating the second value for/of the field. The base station may replace/update the first value of the field with the second value, for example, based on sending (e.g., transmitting) the activation command indicating the second value for/of the field.

A wireless device may apply/use the second TCI state indicated by the second value of the field for transmission of a second reference signal (e.g., SRS) via the reference signal resource (e.g., SRS resource) in the reference signal resource set (e.g., SRS resource set). The wireless device may apply/use the second TCI state for transmission of the second reference signal, for example, based on the replacing/updating the first value of the field with the second value indicating the second TCI state.

A base station may apply/use the second TCI state indicated by the second value of the field for reception of the second reference signal (e.g., SRS) via the reference signal resource (e.g., SRS resource) in the reference signal resource set (e.g., SRS resource set). The base station may apply/use the second TCI state for reception of the second reference signal, for example, based on the replacing/updating the first value of the field with the second value indicating the second TCI state.

A wireless device may apply/use the second TCI state indicated by the second value of the field for reception of a second reference signal (e.g., CSI-RS) via the reference signal resource (e.g., CSI-RS resource) in the reference signal resource set (e.g., CSI-RS resource set, NZP CSI-RS resource set, and the like). The wireless device may apply/use the second TCI state for reception of the second reference signal, for example, based on the replacing/updating the first value of the field with the second value indicating the second TCI state.

A base station may apply/use the second TCI state indicated by the second value of the field for transmission of the second reference signal (e.g., CSI-RS) via the reference signal resource (e.g., CSI-RS resource) in the reference signal resource set (e.g., CSI-RS resource set, NZP CSI-RS resource set, and the like). The base station may apply/use the second TCI state for transmission of the second reference signal, for example, based on the replacing/updating the first value of the field with the second value indicating the second TCI state.

A second reference signal may be, for example, same as the reference signal. The second reference signal may be, for example, different from the reference signal. A wireless device may transmit/receive, via the reference signal resource in the reference signal resource set, the second reference signal based on the second TCI state, for example, based on (e.g., in response to) receiving the activation command indicating, for the reference signal resource set comprising the reference signal resource, the field with the second value that indicates the second TCI state. The wireless device may transmit/receive, via the reference signal resource in the reference signal resource set, the second reference signal based on the second TCI state, for example, based on (e.g., in response to) receiving the activation command indicating, for the reference signal resource set comprising the reference signal resource, the second value of/of the field. The second value of the field may indicate the second TCI state. The wireless device may transmit/receive, via the reference signal resource in the reference signal resource set, the second reference signal based on the second TCI state, for example, based on (e.g., in response to) the activation command indicating, for the reference signal resource set comprising the reference signal resource, the field with the second value that indicates the second TCI state. The wireless device may transmit/receive, via the reference signal resource in the reference signal resource set, the second reference signal based on the second TCI state, for example, based on (e.g., in response to) the activation command indicating, for the reference signal resource set comprising the reference signal resource, the second value of/for the field. The second value may indicate the second TCI state.

A wireless device may transmit/receive, via the reference signal resource in the reference signal resource set, the second reference signal based on the second TCI state, for example, based on (e.g., in response to) receiving the activation command indicating, for the reference signal resource, the field with the second value that indicates the second TCI state. The wireless device may transmit/receive, via the reference signal resource, the second reference signal based on the second TCI state, for example, based on (e.g., in response to) receiving the activation command indicating, for the reference signal resource, the second value of/of the field. The second value of the field may indicate the second TCI state. The wireless device may transmit/receive, via the reference signal resource, the second reference signal based on the second TCI state, for example, based on (e.g., in response to) the activation command indicating, for the reference signal resource, the field with the second value that indicates the second TCI state. The wireless device may transmit/receive, via the reference signal resource, the second reference signal based on the second TCI state, for example, based on (e.g., in response to) the activation command indicating, for the reference signal resource, the second value of/for the field. The second value may indicate the second TCI state.

A base station may transmit/receive, via the reference signal resource in the reference signal resource set, the second reference signal based on the second TCI state. The base station may transmit/receive, via the reference signal resource in the reference resource set, the second reference signal based on the second TCI state, for example, based on (e.g., in response to) sending (e.g., transmitting) the activation command indicating, for the reference signal resource (or for the reference signal resource set), the field with the second value that indicates the second TCI state.

Indicating/Updating a first value of the field (e.g., of the reference signal resource or the reference signal resource set) by configuration parameters may reduce flexibility. The base station may not have information indicating whether the reference signal resource (or the reference signal resource set) should be associated with a first TRP or a second TRP if the base station sends (e.g., transmits) the one or more configuration parameters. If the wireless device moves closer to the first TRP or to the second TRP, the base station may need to transmit reconfiguration parameters to update the first value of the field. This may increase latency. There is a need to update the first value of the field dynamically (e.g., MAC-CE, DCI).

A base station may send (e.g., transmit) an activation command (e.g., MAC-CE, DCI) updating the first value of the field by a second value. The second value may indicate the first TCI state, for example, if the wireless device is closer to the first TRP. The second value may indicate the second TCI state, for example, if the wireless device is closer to the second TRP. This may increase flexibility as TCI state for transmission/reception of a reference signal (e.g., SRS, CSI-RS) via a reference signal resource (e.g., SRS resource, CSI-RS resource) may change dynamically.

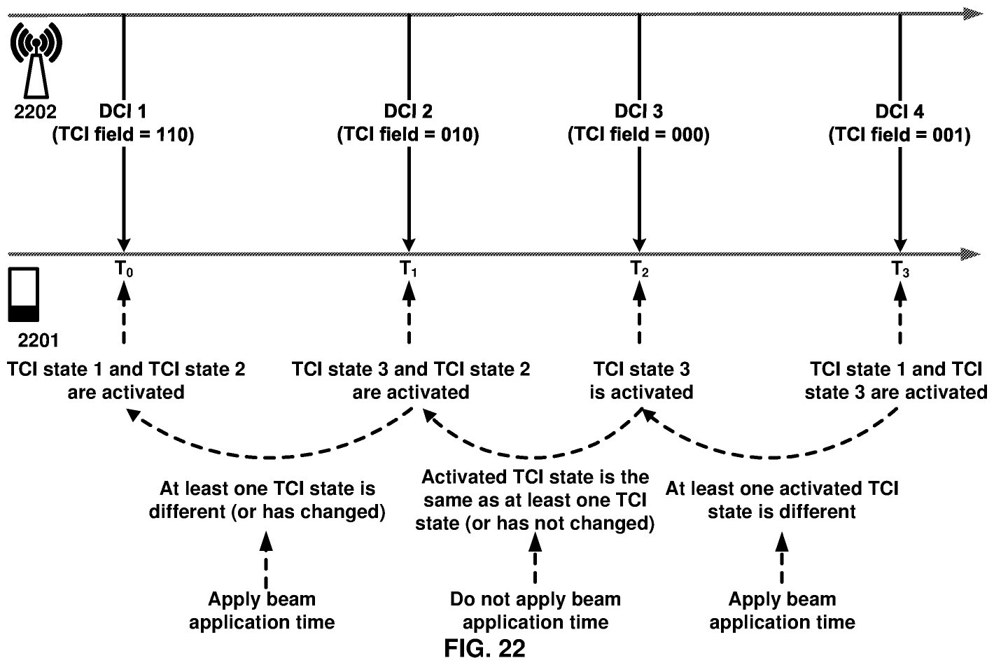

FIG. 22 shows an example using a TCI field. The TCI field may be used in a unified beam update. A wireless device 2201 may receive first DCI (e.g., DCI 1 at time T₀). The wireless device 2201 may receive the first DCI from a base station 2202. The base station 2202 may send (e.g., transmit) the first DCI. The first DCI may comprise a TCI field. The TCI field may indicate a first TCI codepoint of the one or more TCI codepoints. A value of the TCI field (e.g., 110 in FIG. 22) may be, for example, equal to the first TCI codepoint. The value of the TCI field may be, for example, indicate the first TCI codepoint. The first TCI codepoint (e.g., 110) may indicate/comprise at least two TCI states (e.g., TCI state 1 and TCI state 2 in FIG. 22). The first DCI may indicate activation of the at least two TCI states. The wireless device may apply (or start using) the at least two TCI states as described in FIG. 17.

The wireless device 2201 may receive second DCI (e.g., DCI 2 at time T₁). The wireless device 2201 may receive the second DCI from the base station 2202. The base station 2202 may send (e.g., transmit) the second DCI. The second DCI may comprise a TCI field. The TCI field may indicate a second TCI codepoint of the one or more TCI codepoints. A value of the TCI field (e.g., 010 in FIG. 22) may be, for example, equal to the second TCI codepoint. The value of the TCI field may be, for example, indicate the second TCI codepoint. The second TCI codepoint (e.g., 010) may indicate/comprise at least two TCI states (e.g., TCI state 3 and TCI state 2 in FIG. 22). The second DCI may indicate activation of the at least two TCI states.

The wireless device may send (e.g., transmit) an uplink signal (e.g., HARQ-ACK or a PUCCH with HARQ-ACK information) via a PUCCH resource. The wireless device may transmit the uplink signal, for example, for a transport block scheduled by the second DCI. The wireless device may transmit the uplink signal, for example, for the second DCI (e.g., if the second DCI does not schedule transmission of a transport block).

At least two TCI states activated by the second DCI may be the same as the at least two TCI states activated by the first DCI. For example, the at least two TCI states activated by the first DCI may be a first TCI state (e.g., TCI state 1) and a second TCI state (e.g., TCI state 2). The at least two TCI states activated by the second DCI may be the first TCI state (e.g., TCI state 1) and the second TCI state (e.g., TCI state 2). The wireless device may apply/use the at least two TCI states activated by the second DCI without a beam application time. There is no need for a beam application time, for example, if the at least two TCI states activated by the second DCI are the same as the at least two TCI states activated by the first DCI.

A wireless device may not need to apply (or start using) the at least two TCI states activated by the second DCI starting from a starting/initial/earliest/first slot that is/occurs, for example, after a quantity/number of symbols (e.g., Beam application time, MAC-CE activation time, 3Nₛₗₒₜ^{subframe,μ}) from/after a last/ending/latest symbol of the uplink signal (or the PUCCH with the HARQ-ACK information). The wireless device may not need to apply (or start using) the at least two TCI states activated by the second DCI starting from the starting/initial/earliest/first slot that is at least the quantity/number of symbols (e.g., Beam application time, MAC-CE activation time) from/after the last/ending/latest symbol of the uplink signal.

A wireless device may keep applying/using the at least two TCI states activated by the second DCI, for example, after receiving the second DCI. The wireless device may keep applying/using the at least two TCI states activated by the second DCI before sending (e.g., transmitting) the uplink signal (e.g., HARQ-ACK or a PUCCH with HARQ-ACK information) via the PUCCH resource.

At least one TCI state of the at least two TCI states activated by the second DCI may be different from the at least two TCI states activated by the first DCI. The at least one TCI state of the at least two TCI states activated by the second DCI may be different from each TCI state of the at least two TCI states activated by the first DCI. For example, the at least two TCI states activated by the first DCI may be a first TCI state (e.g., TCI state 1) and a second TCI state (e.g., TCI state 2). The at least two TCI states activated by the second DCI may be a third TCI state (e.g., TCI state 3) and the second TCI state (e.g., TCI state 2).

At least two TCI states activated by the second DCI may be different from the at least two TCI states activated by the first DCI. Each TCI state of the at least two TCI states activated by the second DCI may be different from each TCI state of the at least two TCI states activated by the first DCI. For example, the at least two TCI states activated by the first DCI may be a first TCI state (e.g., TCI state 1) and a second TCI state (e.g., TCI state 2). The at least two TCI states activated by the second DCI may be a third TCI state (e.g., TCI state 3) and a fourth TCI state (e.g., TCI state 4).

A wireless device may apply/use the at least two TCI states activated by the second DCI with (or based on) a beam application time. There may be a need for a beam application time, for example, if the at least one TCI state of the at least two TCI states activated by the second DCI is different from the at least two TCI states activated by the first DCI. There may be a need for a beam application time, for example, if the at least two TCI states activated by the second DCI are different from the at least two TCI states activated by the first DCI.

A wireless device may apply (or start using) the at least two TCI states activated by the second DCI starting from a starting/initial/earliest/first slot that is/occurs, for example, after a quantity/number of symbols (e.g., Beam application time, MAC-CE activation time, 3Nₛₗₒₜ^{subframe,μ}) from/after a last/ending/latest symbol of the uplink signal (or the PUCCH with the HARQ-ACK information). The wireless device may apply (or start using) the at least two TCI states activated by the second DCI starting from the starting/initial/earliest/first slot that is at least the quantity/number of symbols (e.g., Beam application time, MAC-CE activation time) from/after the last/ending/latest symbol of the uplink signal. The starting/initial/earliest/first slot may occur at least the number of symbols from/after the last/ending/latest symbol of the uplink signal.

A wireless device may apply (or start using) the at least two TCI states activated by the second DCI starting from the starting/initial/earliest/first slot, for example, based on the at least one TCI state of the at least two TCI states activated by the second DCI being different from the at least two TCI states activated by the first DCI. The wireless device may apply (or start using) the at least two TCI states activated by the second DCI starting from the starting/initial/earliest/first slot, for example, based on the at least two TCI states activated by the second DCI being different from the at least two TCI states activated by the first DCI.

A wireless device 2201 may receive third DCI (e.g., DCI 3 at time T₂). The wireless device 2201 may receive the third DCI from the base station 2202. The base station 2202 may send (e.g., transmit) the third DCI. The third DCI may comprise a TCI field. The TCI field may indicate a third TCI codepoint of the one or more TCI codepoints. A value of the TCI field (e.g., 000 in FIG. 22) may be, for example, equal to the third TCI codepoint. The value of the TCI field may be, for example, indicate the third TCI codepoint. The third TCI codepoint (e.g., 000) may indicate/comprise a TCI state (e.g., TCI state 3 in FIG. 22). The third DCI may indicate activation of the TCI state. The third TCI codepoint may indicate a single TCI state (e.g., a single UL TCI state or a single DL TCI state, or a single joint/common TCI state, and the like).

A wireless device may send (e.g., transmit) an uplink signal (e.g., HARQ-ACK or a PUCCH with HARQ-ACK information) via a PUCCH resource. The wireless device may transmit the uplink signal, for example, for a transport block scheduled by the third DCI. The wireless device may transmit the uplink signal, for example, for the third DCI (e.g., if the third DCI does not schedule transmission of a transport block).

A TCI state activated by the third DCI may be the same as one of the at least two TCI states activated by the second DCI. For example, the at least two TCI states activated by the second DCI may be a third TCI state (e.g., TCI state 3) and a second TCI state (e.g., TCI state 2). The TCI state activated by the third DCI may be the third TCI state (e.g., TCI state 3). The wireless device may apply/use the TCI state activated by the third DCI without a beam application time. There may be no need for a beam application time, for example, if the TCI state activated by the third DCI is the same as the one of the at least two TCI states activated by the second DCI.

A wireless device may not need to apply (or start using) the TCI state activated by the third DCI starting from a starting/initial/earliest/first slot that is/occurs, for example, after a quantity/number of symbols (e.g., Beam application time, MAC-CE activation time, 3Nₛₗₒₜ^{subframe,μ}) from/after a last/ending/latest symbol of the uplink signal (or the PUCCH with the HARQ-ACK information) associated with the third DCI. The wireless device may not need to apply (or start using) the TCI state activated by the third DCI starting from the starting/initial/earliest/first slot that is at least the quantity/number of symbols (e.g., Beam application time, MAC-CE activation time) from/after the last/ending/latest symbol of the uplink signal.

A wireless device may keep applying/using the TCI state activated by the third DCI, for example, after receiving the third DCI. The wireless device may keep applying/using the TCI state activated by the third DCI before sending (e.g., transmitting) the uplink signal (e.g., HARQ-ACK or a PUCCH with HARQ-ACK information) via the PUCCH resource associated with the third DCI.

A TCI state activated by the third DCI may be different from the at least two TCI states activated by the second DCI. The TCI state activated by the third DCI may be different from each TCI state of the at least two TCI states activated by the second DCI. For example, the at least two TCI states activated by the second DCI may be a first TCI state (e.g., TCI state 1) and a second TCI state (e.g., TCI state 2). The TCI state activated by the third DCI may be a third TCI state (e.g., TCI state 3).

A wireless device may apply/use the TCI state activated by the third DCI with (or based on) a beam application time. There is a need for a beam application time, for example, if the TCI state activated by the third DCI is different from the at least two TCI states activated by the second DCI. There is a need for a beam application time, for example, if the TCI state activated by the third DCI is different from each TCI state of the at least two TCI states activated by the second DCI.

A wireless device may apply (or start using) the TCI state activated by the third DCI starting from a starting/initial/earliest/first slot that is/occurs, for example, after a quantity/number of symbols (e.g., Beam application time, MAC-CE activation time, 3Nₛₗₒₜ^{subframe,μ}) from/after a last/ending/latest symbol of the uplink signal (or the PUCCH with the HARQ-ACK information) associated with the third DCI. The wireless device may apply (or start using) the TCI state activated by the third DCI starting from the starting/initial/earliest/first slot that is at least the quantity/number of symbols (e.g., Beam application time, MAC-CE activation time) from/after the last/ending/latest symbol of the uplink signal. The starting/initial/earliest/first slot may occur at least the number of symbols from/after the last/ending/latest symbol of the uplink signal.

A wireless device may apply (or start using) the TCI state activated by the third DCI starting from the starting/initial/earliest/first slot, for example, based on the TCI state activated by the third DCI being different from the at least two TCI states activated by the second DCI. The wireless device may apply (or start using) the TCI state activated by the third DCI starting from the starting/initial/earliest/first slot, for example, based on the TCI state activated by the third DCI being different from each TCI state of the at least two TCI states activated by the second DCI.

A wireless device 2201 may receive fourth DCI (e.g., DCI 4 at time T₃). The wireless device 2201 may receive the fourth DCI from the base station 2202. The base station 2202 may send (e.g., transmit) the fourth DCI. The fourth DCI may comprise a TCI field. The TCI field may indicate a fourth TCI codepoint of the one or more TCI codepoints. A value of the TCI field (e.g., 001 in FIG. 22) may be, for example, equal to the fourth TCI codepoint. The value of the TCI field may be, for example, indicate the fourth TCI codepoint. The fourth TCI codepoint (e.g., 001) may indicate/comprise at least two TCI states (e.g., TCI state 1 and TCI state 3 in FIG. 22). The fourth DCI may indicate activation of the at least two TCI states.

A wireless device may send (e.g., transmit) an uplink signal (e.g., HARQ-ACK or a PUCCH with HARQ-ACK information) via a PUCCH resource. The wireless device may transmit the uplink signal, for example, for a transport block scheduled by the fourth DCI. The wireless device may transmit the uplink signal, for example, for the fourth DCI (e.g., if the fourth DCI does not schedule transmission of a transport block).

At least one TCI state of the at least two TCI states activated by the fourth DCI may be different from the TCI state activated by the third DCI. For example, the at least two TCI states activated by the fourth DCI may be a first TCI state (e.g., TCI state 1) and a third TCI state (e.g., TCI state 3). The TCI state activated by the third DCI may be the third TCI state (e.g., TCI state 3). The first TCI state may be different from the third TCI state.

Each TCI state of the at least two TCI states activated by the fourth DCI may be different from the TCI state activated by the third DCI. For example, the at least two TCI states activated by the fourth DCI may be a first TCI state (e.g., TCI state 1) and a third TCI state (e.g., TCI state 3). The TCI state activated by the third DCI may be a second TCI state (e.g., TCI state 2). The first TCI state may be different from the second TCI state. The third TCI state may be different from the second TCI state.

A wireless device may apply/use the at least two TCI states activated by the fourth DCI with (or based on) a beam application time. There is a need for a beam application time, for example, if the at least one TCI state of the at least two TCI states activated by the fourth DCI is different from the TCI state activated by the third DCI. There is a need for a beam application time, for example, if each TCI state of at least two TCI states activated by the fourth DCI is different from the TCI state activated by the third DCI.

A wireless device may apply (or start using) the at least two TCI states activated by the fourth DCI starting from a starting/initial/earliest/first slot that is/occurs, for example, after a quantity/number of symbols (e.g., Beam application time, MAC-CE activation time, 3Nₛₗₒₜ^{subframe,μ}) from/after a last/ending/latest symbol of the uplink signal (or the PUCCH with the HARQ-ACK information) associated with the fourth DCI. The wireless device may apply (or start using) the at least two TCI states activated by the fourth DCI starting from the starting/initial/earliest/first slot that is at least the quantity/number of symbols (e.g., Beam application time, MAC-CE activation time) from/after the last/ending/latest symbol of the uplink signal. The starting/initial/earliest/first slot may occur at least the number of symbols from/after the last/ending/latest symbol of the uplink signal.

A wireless device may apply (or start using) the at least two TCI states activated by the fourth DCI starting from the starting/initial/earliest/first slot, for example, based on the at least one TCI state of the at least two TCI states activated by the fourth DCI being different from the TCI state activated by the third DCI. The wireless device may apply (or start using) the at least two TCI states activated by the fourth DCI starting from the starting/initial/earliest/first slot, for example, based on each TCI state of the at least two TCI states activated by the fourth DCI being different from the TCI state activated by the third DCI. The wireless device may apply (or start using) the at least two TCI states activated by the fourth DCI starting from the starting/initial/earliest/first slot, for example, based on the fourth DCI indicating activation of more than one TCI state and the third DCI indicating activation of a single TCI state.

In at least some wireless communications, a wireless device may apply/use the common/unified TCI state to/for transmission of an uplink signal (e.g., HARQ-ACK, SR, CSI report, PUCCH transmission, UCI, and the like) via a PUCCH resource. The wireless device may send (e.g., transmit), via the PUCCH resource, the uplink signal using/with a spatial domain transmission filter that may be determined based on a reference signal indicated by the common/unified TCI state. The wireless device may send (e.g., transmit), via the PUCCH resource, the uplink signal using/with a transmission power that may be determined based on one or more power control parameters indicated by (or associated with or mapped to or included in) the common/unified TCI state.

For at least some wireless communications, activation of the (single) common/unified TCI state may not be efficient, for example, in a multi-TRP operation comprising at least a first TRP and a second TRP. Using/sharing/applying the same common/unified TCI state for transmission of an uplink signal via a first PUCCH resource associated with the first TRP and for transmission of an uplink signal via a second PUCCH resource associated with the second TRP may not be efficient. For example, the first TRP and the second TRP may not be co-located and may be subject to different channel conditions, which may result in using one or more parameters for a plurality of TRPs that, while suitable/ideal for a particular TRP, may not be suitable/ideal for each TRP of the plurality of TRPs (e.g., if the plurality of TRPs are not co-located or are not QCLed).

In at least some systems, a wireless device may receive one or more messages, such as a control message/command (e.g., DCI, MAC-CE), indicating activation of at least two common/unified TCI states. The at least two common/unified TCI states may comprise a first common/unified TCI state and a second common/unified TCI state. The wireless device may not have information indicating whether the first common/unified TCI state is associated with the first TRP or the second TRP. There may not be an explicit/implicit association between the first common/unified TCI state and the first TRP or the second TRP. Configuration parameter(s) may not indicate, for the first common/unified TCI state, a TRP index (or a CORESET pool index, or a common/unified TCI state index, and the like) indicating an association between the first common/unified TCI state and the first TRP or the second TRP. The wireless device may not have information indicating whether the second common/unified TCI state is associated with the first TRP or the second TRP. There may not be an explicit/implicit association between the second common/unified TCI state and the first TRP or the second TRP. Configuration parameter(s) may not indicate, for the second common/unified TCI state, a TRP index (or a CORESET pool index, or a common/unified TCI state index, and the like) indicating an association between the second common/unified TCI state and the first TRP or the second TRP.

In at least some systems, a wireless device may not have information indicating whether a PUCCH resource is associated with the first TRP or the second TRP. The wireless device may not have information whether to apply/use the first common/unified TCI state and/or the second common/unified TCI state to transmission/reception of an uplink signal via the PUCCH resource. This lack of information may lead to a beam misalignment between the wireless device and the base station. For example, the wireless device may apply/use the first common/unified TCI state to/for transmission/reception of the uplink signal via the PUCCH resource. The base station may (incorrectly) assume that the wireless device applies/uses the second common/unified TCI state to/for transmission/reception of the uplink signal via the PUCCH resource. This may misalignment may lead to missing of the uplink signal via the PUCCH resource by the base station. This may result in retransmissions, increased latency of the communication, and/or increased power consumption at the base station and/or the wireless device.

As described herein, beam management may be enhanced, for example, if at least two common/unified TCI states are activated. A wireless device may apply/use the first common/unified TCI state for transmission of an uplink signal via the PUCCH resource. A PUCCH resource group may comprise the PUCCH resource. The first common/unified TCI state may be a first/starting/earliest TCI state that occurs first in a set/list/vector of the at least two common/unified TCI states.

A wireless device may receive, via a CORESET, DCI scheduling/triggering transmission of the uplink signal via the PUCCH resource. The DCI may comprise a field (e.g., TRP index or a CORESET pool index, or a common/unified TCI state index, and the like). The field may comprise/indicate a value. The value may indicate common/unified TCI state(s) among the at least two common/unified TCI states. The wireless device may apply/use the common/unified TCI state(s) for transmission of the uplink signal via the PUCCH resource.

A PUCCH resource may be configured/indicated with/by a quantity/number of repetitions. The wireless device may apply/use both of the at least two common/unified TCI states to transmission of the uplink signal via the PUCCH resource. The wireless device may repeat transmission of the uplink signal via the PUCCH resource. The wireless device may send (e.g., transmit) one or more first repetitions of the uplink signal via the PUCCH resource, for example, based on the first common/unified TCI state. The wireless device may send (e.g., transmit) one or more second repetitions of the uplink signal via the PUCCH resource, for example, based on the second common/unified TCI state.

A wireless device may receive, via a CORESET, DCI scheduling/triggering transmission/reception of the uplink signal via the PUCCH resource. The wireless device may monitor, for the DCI, PDCCH transmissions in the CORESET based on common/unified TCI state(s) among/of the at least two common/unified TCI states. The wireless device may apply/use the common/unified TCI state(s) for transmission of the uplink signal via the PUCCH resource.

Configuration parameter(s) may indicate, for a PUCCH resource (or the PUCCH resource group comprising the PUCCH resource), a field (e.g., TRP index or a CORESET pool index, or a common/unified TCI state index, and the like). The field may comprise/indicate a value. The value may indicate common/unified TCI state(s) among the at least two common/unified TCI states. For example, a first value of the field may indicate a first common/unified TCI state among the at least two common/unified TCI states. A second value of the field may indicate a second common/unified TCI state among the at least two common/unified TCI states. A third value of the field may indicate the first common/unified TCI state and the second common/unified TCI state. The wireless device may apply/use the (indicated) common/unified TCI state(s) to transmission of the uplink signal via the PUCCH resource. Examples described herein may result in advantages such as reduced beam misalignment, which may lead to reduced retransmissions, reduced latency/delay, reduced power consumption, and/or more efficient wireless communications.

A wireless device and a base station may use resources for wireless communications. One or more unified transmission configuration indicator (TCI) state(s) may be indicated using a parameter, field, message, and/or signaling. The unified TCI state(s) may be associated with physical uplink control channel (PUCCH) resource (or a PUCCH resource group). The unified TCI state(s) may be applied for communications, via the PUCCH resource, between the wireless device and the base station for which at least two unified TCI states may be activated, without requiring additional signaling to configure parameters for each communication.

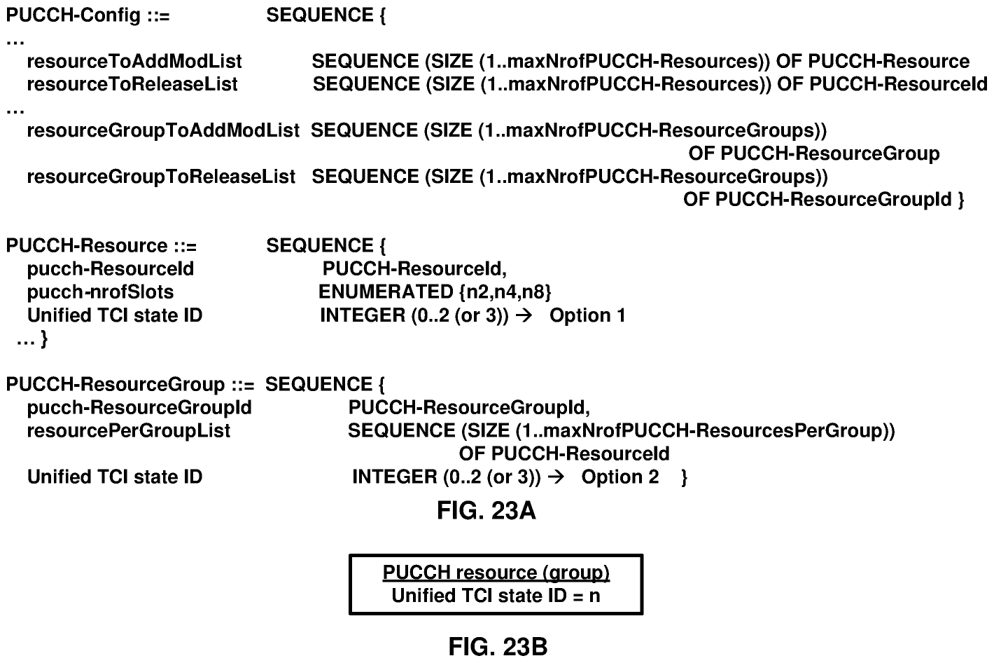

FIG. 23A and FIG. 23B show examples of parameters. The parameters may be used for a unified beam update. One or more configuration parameters (at time T₀ in FIG. 17) may indicate one or more PUCCH resource groups (e.g., by a higher layer parameter resourceGroupToAddModList). The one or more configuration parameters may comprise one or more PUCCH configuration parameters (e.g., PUCCH Config in FIG. 23A) indicating the one or more PUCCH resource groups (e.g., PUCCH-ResourceGroup in FIG. 23A). The one or more PUCCH resource groups may comprise a PUCCH resource group (e.g., PUCCH resource group in FIG. 23B).

One or more configuration parameters (at time T₀ in FIG. 17) may indicate a plurality of PUCCH resources (e.g., by a higher layer parameter resourceToAddModList). The one or more PUCCH configuration parameters (e.g., PUCCH Config in FIG. 23A) may indicate the plurality of PUCCH resources (e.g., PUCCH-Resource in FIG. 23A). The active uplink BWP of the cell may comprise the plurality of PUCCH resources.

One or more configuration parameters may indicate, for each PUCCH resource group of the one or more PUCCH resource groups, respective PUCCH resource(s) of the plurality of PUCCH resources (e.g., by a higher layer parameter resourcePerGroupList). Each PUCCH resource group of the one or more PUCCH resource groups may comprise respective PUCCH resource(s) of the plurality of PUCCH resources. For example, the PUCCH resource group may comprise one or more PUCCH resources of the plurality of PUCCH resources.

A quantity/number of the one or more PUCCH resource groups may be equal to a quantity/number of the at least two TCI states. A quantity/number of the one or more PUCCH resource groups may be less/smaller than a quantity/number of the at least two TCI states. A quantity/number of the one or more PUCCH resource groups may be greater/larger than a quantity/number of the at least two TCI states. For example, the quantity/number of the at least two TCI states may be equal to 2 (e.g., M=2, N=2) or any other value. The quantity/number of the at least two TCI states may comprise/denote a number of TCI states indicated/comprised by (or included in) the at least two TCI states. The quantity/number of the one or more PUCCH resource groups may be greater than 2, or less than 2, or equal to 2. One or more configuration parameters may comprise, for the PUCCH resource group, a parameter (e.g., ApplyTCI-State-UL-List, ApplyTCI-State-DL-List, ApplyTCI-State-List, Use-Indicated-TCI-State, Use-Indicated-UL-TCI-State, Use-Indicated-DL-TCI-State, Follow-Unified-TCI-State, Follow-Unified-UL-TCI-State, Follow-Unified-DL-TCI-State, and the like) indicating to apply/use a common/unified TCI state. The parameter may be set to ‘enabled’.

A parameter may indicate that the PUCCH resource group (e.g., PUCCH resource group in FIG. 23B) shares the same common/unified TCI state as wireless-device-dedicated reception (e.g., UE-dedicated reception) on PDCCH/PDSCH and for wireless-device-dedicated reception (e.g., UE-dedicated reception) on all or subset of CORESETS in the cell. The parameter may indicate that the PUCCH resource group (e.g., PUCCH resource group in FIG. 23B) shares the same common/unified TCI state as dynamic-grant/configured-grant based PUSCH transmissions via/of the cell and transmissions via PUCCH resources of the cell.

A wireless device may apply/use the common/unified TCI state for each PUCCH resource of the one or more PUCCH resources in the PUCCH resource group, for example, based on the one or more configuration parameters comprising, for the PUCCH resource group, the parameter. The wireless device may apply/use the common/unified TCI state for each PUCCH resource of the one or more PUCCH resources in the PUCCH resource group, for example, based on the one or more configuration parameters comprising, for the PUCCH resource group, the parameter that is set to ‘enabled’.

Configuring/Setting/Including/Indicating the parameter for the PUCCH resource group may reduce signaling overhead. The base station may not need to indicate/configure the parameter for each PUCCH resource of the one or more PUCCH resources in the PUCCH resource group. The one or more configuration parameters may not need to comprise the parameter for each PUCCH resource of the one or more PUCCH resources in the PUCCH resource group. Configuring/Setting/Including/Indicating the parameter for the PUCCH resource group may reduce flexibility. Applying/using the common/unified TCI state for each PUCCH resource in the PUCCH resource group may reduce flexibility. The wireless device may not apply/use different TCI states for the one or more PUCCH resources in the PUCCH resource group. The wireless device may not apply/use a TCI state A for a first PUCCH resource and a TCI state B for a second PUCCH resource, where the TCI state A and the TCI state B are different. The one or more PUCCH resources in the PUCCH resource group may comprise the first PUCCH resource and the second PUCCH resource.

One or more configuration parameters may comprise, for a PUCCH resource (e.g., PUCCH resource in FIG. 23B) of the one or more PUCCH resources in the PUCCH resource group, a parameter (e.g., ApplyTCI-State-UL-List, ApplyTCI-State-DL-List, ApplyTCI-State-List, Use-Indicated-TCI-State, Use-Indicated-UL-TCI-State, Use-Indicated-DL-TCI-State, Follow-Unified-TCI-State, Follow-Unified-UL-TCI-State, Follow-Unified-DL-TCI-State, and the like) indicating to apply/use a common/unified TCI state. The parameter may be set to ‘enabled’.

A parameter may indicate that the PUCCH resource (e.g., PUCCH resource in FIG. 23B) shares the same common/unified TCI state as wireless-device-dedicated reception (e.g., UE-dedicated reception) on PDSCH and for wireless-device-dedicated reception (e.g., UE-dedicated reception) on all or subset of CORESETS in the cell. The parameter may indicate that the PUCCH resource (e.g., PUCCH resource in FIG. 23B) shares the same common/unified TCI state as dynamic-grant/configured-grant based PUSCH transmissions via/of the cell and transmissions via PUCCH resources of the cell.

A wireless device may apply/use the common/unified TCI state for the PUCCH resource in the PUCCH resource group, for example, based on the one or more configuration parameters comprising, for the PUCCH resource, the parameter. The wireless device may apply/use the common/unified TCI state for the PUCCH resource, for example, based on the one or more configuration parameters comprising, for the PUCCH resource, the parameter that is set to ‘enabled’.

Configuring/Setting/Including/Indicating the parameter for the PUCCH resource may increase flexibility. The wireless device may apply/use different TCI states for the one or more PUCCH resources in the PUCCH resource group. The one or more configuration parameters may not comprise, for a second PUCCH resource of the one or more PUCCH resources in the PUCCH resource group, the parameter. The wireless device may apply/use different TCI states for the PUCCH resource and the second PUCCH resource. This application/use of different TCI states may increase flexibility. For example, the wireless device may apply/use a TCI state A for a first PUCCH resource and a TCI state B for a second PUCCH resource, where the TCI state A and the TCI state B are different. The one or more PUCCH resources in the PUCCH resource group may comprise the first PUCCH resource and the second PUCCH resource. Configuring/Setting/Including/Indicating the parameter for the PUCCH resource may increase signaling overhead. A base station may indicate/configure the parameter for each PUCCH resource of the one or more PUCCH resources in the PUCCH resource group. The base station may indicate/configure the parameter for at least one PUCCH resource of the one or more PUCCH resources in the PUCCH resource group. The one or more configuration parameters may comprise the parameter for each PUCCH resource of the one or more PUCCH resources in the PUCCH resource group. The one or more configuration parameters may comprise the parameter for at least one PUCCH resource of the one or more PUCCH resources in the PUCCH resource group. This may increase the signaling overhead (e.g., RRC bit size).

As described herein, a wireless device may send (e.g., transmit), via the PUCCH resource of the one or more PUCCH resources of/in the PUCCH resource group, an uplink signal. The wireless device may send (e.g., transmit), via the PUCCH resource, the uplink signal, for example, based on at least one TCI state of the at least two TCI states.

An uplink signal may comprise, for example, HARQ-ACK information. The uplink signal may comprise, for example, an SR. The uplink signal may comprise, for example, a CSI report. The uplink signal may comprise, for example, uplink control information (UCI). The at least one TCI state may be, for example, at least one reference/default TCI state.

A wireless device may apply/use the at least one TCI state for transmission of the uplink signal via the PUCCH resource. The wireless device may apply/use the at least one TCI state for transmission of the uplink signal via the PUCCH resource, for example, based on the receiving the DCI (e.g., at time T₂ in FIG. 17).

A wireless device may send (e.g., transmit), via the PUCCH resource, the uplink signal based on the at least one TCI state, for example, based on (e.g., in response to) the one or more configuration parameters comprising, for the PUCCH resource group that comprises the PUCCH resource, the parameter. The wireless device may send (e.g., transmit), via the PUCCH resource, the uplink signal based on the at least one TCI state, for example, based on (e.g., in response to) the one or more configuration parameters comprising, for the PUCCH resource group that comprises the PUCCH resource, the parameter set to ‘enabled’.

A wireless device may send (e.g., transmit), via the PUCCH resource, the uplink signal based on the at least one TCI state, for example, based on (e.g., in response to) the one or more configuration parameters comprising, for the PUCCH resource, the parameter. The wireless device may send (e.g., transmit), via the PUCCH resource, the uplink signal based on the at least one TCI state, for example, based on (e.g., in response to) the one or more configuration parameters comprising, for the PUCCH resource, the parameter set to ‘enabled’.

A wireless device may select/determine, for transmission of the uplink signal via the PUCCH resource, the at least one TCI state among the at least two TCI states. The wireless device may select/determine, for transmission of the uplink signal via the PUCCH resource, the at least one TCI state as reference/default TCI state(s). The wireless device may select/determine the at least one TCI state among the at least two TCI states, for example, as default/reference TCI state(s). The wireless device may select/determine the at least one TCI state among the at least two TCI states, for example, based on the one or more configuration parameters comprising, for the PUCCH resource group that comprises the PUCCH resource, the parameter. The wireless device may select/determine the at least one TCI state among the at least two TCI states, for example, based on the one or more configuration parameters comprising, for the PUCCH resource group that comprises the PUCCH resource, the parameter that is set to ‘enabled’. The wireless device may select/determine the at least one TCI state among the at least two TCI states, for example, based on the one or more configuration parameters comprising, for the PUCCH resource, the parameter. The wireless device may select/determine the at least one TCI state among the at least two TCI states, for example, based on the one or more configuration parameters comprising, for the PUCCH resource, the parameter that is set to ‘enabled’.

A wireless device may send (e.g., transmit), via the PUCCH resource, the uplink signal using/with at least one spatial domain transmitting/transmission filter/beam that is determined based on the at least one TCI state. The wireless device may send (e.g., transmit), via the PUCCH resource, the uplink signal using/with a respective spatial domain transmitting/transmission filter/beam, of the at least one spatial domain transmitting/transmission filter/beam, that may be determined based on each TCI state of the at least one TCI state. The wireless device may send (e.g., transmit), via the PUCCH resource, the uplink signal using/with a respective spatial domain transmitting/transmission filter/beam, of the at least one spatial domain transmitting/transmission filter/beam, that may be determined based on a reference signal indicated by each TCI state of the at least one TCI state. The wireless device may determine each spatial domain transmitting/transmission filter/beam of the at least one spatial domain transmitting/transmission filter/beam, for example, based on a respective TCI state of the at least one TCI state. The wireless device may determine each spatial domain transmitting/transmission filter/beam of the at least one spatial domain transmitting/transmission filter/beam, for example, based on a reference signal indicated by a respective TCI state of the at least one TCI state.

At least one TCI state may be/comprise a TCI state. The wireless device may send (e.g., transmit), via the PUCCH resource, the uplink signal using/with a spatial domain transmitting/transmission filter/beam that may be determined based on a reference signal indicated by the TCI state. The spatial domain transmitting/transmission filter/beam may be, for example, the same as (or substantially same as, x degrees apart, x=0, 1, 5, 10, and the like) a spatial domain reception/receiving filter/beam used to receive the reference signal. The spatial domain transmitting/transmission filter/beam may be, for example, the same as (or substantially same as, x degrees apart, x=0, 1, 5, 10, and the like) a spatial domain transmission/transmitting filter/beam used to transmit the reference signal.

A wireless device may send (e.g., transmit), via the PUCCH resource, the uplink signal using/with at least one transmission power that may be determined based on the at least one TCI state. The wireless device may send (e.g., transmit), via the PUCCH resource, the uplink signal with a respective transmission power, of the at least one transmission power, that is determined based on each TCI state of the at least one TCI state. The wireless device may send (e.g., transmit), via the PUCCH resource, the uplink signal using/with a respective transmission power, of the at least one transmission power, that may be determined based on one or more power control parameters (e.g., target received power, closed-loop index, pathloss compensation factor, alpha, pathloss reference signal, and the like) indicated by (or included in or associated with or mapped to) each TCI state of the at least one TCI state. The wireless device may determine each transmission power of the at least one transmission power, for example, based on a respective TCI state of the at least one TCI state. The wireless device may determine each transmission power of the at least one transmission power, for example, based on one or more power control parameters indicated by (or included in or associated with or mapped to) a respective TCI state of the at least one TCI state.

At least one TCI state may be/comprise a TCI state. The wireless device may send (e.g., transmit), via the PUCCH resource, the uplink signal using/with a transmission power that may be determined based on one or more power control parameters (e.g., target received power, closed-loop index, pathloss compensation factor, alpha, pathloss reference signal, and the like) indicated by (or included in or associated with or mapped to) the TCI state. The one or more configuration parameters may indicate, for the TCI state, the one or more power control parameters. The one or more configuration parameters may indicate, for the TCI state, a power control set indicating the one or more power control parameters. The one or more configuration parameters may indicate, for the TCI state, a power control set index/ID/identifier indicating the power control set.

At least one TCI state may be/comprise the first TCI state (e.g., TCI state 26). The wireless device may send (e.g., transmit), via the PUCCH resource, the uplink signal based on the first TCI state. The wireless device may send (e.g., transmit), via the PUCCH resource, the uplink signal using/with a first spatial domain transmitting/transmission filter/beam that may be determined based on a first reference signal indicated by the first TCI state. The wireless device may send (e.g., transmit), via the PUCCH resource, the uplink signal using/with a first transmission power that may be determined based on one or more first power control parameters (e.g., target received power, closed-loop index, pathloss compensation factor, alpha, pathloss reference signal, and the like) indicated by (or included in or associated with or mapped to) the first TCI state.

The at least one TCI state may be/comprise the second TCI state (e.g., TCI state 61). The wireless device may send (e.g., transmit), via the PUCCH resource, the uplink signal based on the second TCI state. The wireless device may send (e.g., transmit), via the PUCCH resource, the uplink signal using/with a second spatial domain transmitting/transmission filter/beam that may be determined based on a second reference signal indicated by the second TCI state. The wireless device may send (e.g., transmit), via the PUCCH resource, the uplink signal using/with a second transmission power that may be determined based on one or more second power control parameters (e.g., target received power, closed-loop index, pathloss compensation factor, alpha, pathloss reference signal, and the like) indicated by (or included in or associated with or mapped to) the second TCI state.

The at least one TCI state may be/comprise the first TCI state (e.g., TCI state 26) and the second TCI state (e.g., TCI state 61). The at least one TCI state may be the at least two TCI states comprising the first TCI state and the second TCI state. The wireless device may send (e.g., transmit), via the PUCCH resource, the uplink signal based on the at least two TCI states. The wireless device may send (e.g., transmit), via the PUCCH resource, the uplink signal using/with the first spatial domain transmitting/transmission filter/beam that may be determined based on the first reference signal indicated by the first TCI state. The wireless device may send (e.g., transmit), via the PUCCH resource, the uplink signal using/with the second spatial domain transmitting/transmission filter/beam that may be determined based on the second reference signal indicated by the second TCI state. The wireless device may send (e.g., transmit), via the PUCCH resource, one or more first repetitions of the uplink signal using/with the first spatial domain transmitting/transmission filter/beam. The wireless device may send (e.g., transmit), via the PUCCH resource, one or more second repetitions of the uplink signal using/with the second spatial domain transmitting/transmission filter/beam. The wireless device may send (e.g., transmit), via the PUCCH resource, the uplink signal using/with the first transmission power that may be determined based on the one or more first power control parameters indicated by (or included in or associated with or mapped to) the first TCI state. The wireless device may send (e.g., transmit), via the PUCCH resource, the uplink signal using/with the second transmission power that may be determined based on the one or more second power control parameters indicated by (or included in or associated with or mapped to) the second TCI state. The wireless device may send (e.g., transmit), via the PUCCH resource, the one or more first repetitions of the uplink signal using/with the first transmission power. The wireless device may send (e.g., transmit), via the PUCCH resource, the one or more second repetitions of the uplink signal using/with the second transmission power.

The at least one TCI state may not be associated with a TRP. The one or more configuration parameters may not indicate, for the at least one TCI state, a field (e.g., Unified/Common/Joint TCI state index field, TRP index field, CORESET pool index field, and the like) indicating an association between the at least one TCI state and a TRP. The at least one TCI state may not be associated explicitly or implicitly with a TRP. This lack of indication and/or association may reduce signaling overhead. The one or more configuration parameters may not need to comprise/indicate an association between the at least one TCI state and a TRP (or a TRP index, CORESET pool index, Unified/Common/Joint TCI state index field, and the like). This lack of comprising/indicating an association may reduce RRC message size (and/or may reduce the size of the configuration parameters).

Each TCI state of the at least one TCI state may not be associated with a TRP. The one or more configuration parameters may not indicate, for each TCI state of the at least one TCI state, a field (e.g., Unified/Common/Joint TCI state index field, TRP index field, CORESET pool index field, and the like) indicating an association between a TCI state and a TRP. Each TCI state of the at least one TCI state may not be associated explicitly or implicitly with a TRP. This lack of indication/association may reduce signaling overhead. The one or more configuration parameters may not need to comprise/indicate an association between each TCI state of the at least one TCI state and a TRP (or a TRP index, CORESET pool index, Unified/Common/Joint TCI state index field, and the like). This lack of comprising/indicating an association may reduce RRC message size (or the size of the configuration parameters).

The at least one TCI state may be a first/starting/earliest TCI state among the at least two TCI states. The at least one TCI state may be the first/starting/earliest TCI state in a vector/set/list of the at least two TCI states. The at least one TCI state may be a first/starting/earliest element in a vector/set/list of the at least two TCI states. The at least one TCI state may be a first/starting/earliest TCI state among the at least two TCI states in (or indicated by) the TCI codepoint. A position/location of the at least one TCI state (or the first/starting/earliest TCI state) may be earliest/highest/lowest in the vector of the at least two TCI states. The at least one TCI state (or the first/starting/earliest TCI state) may occur first in a vector/set/list of the at least two TCI states. The at least one TCI state is TCI state 26, for example, if the vector of the at least two TCI states is equal to [TCI state 26, TCI state 61]. The at least one TCI state is TCI state 2, for example, if the vector of the at least two TCI states is equal to [TCI state 2, TCI state 1].

The at least one TCI state may be the first TCI state (e.g., TCI state 26 in FIG. 17). The at least one TCI state may be the first TCI state, for example, based on the first TCI state being the first/starting/earliest TCI state in the vector/set/list of the at least two TCI states.

A wireless device may send (e.g., transmit), via the PUCCH resource, the uplink signal based on the at least one TCI state (or the first/starting/earliest TCI state), for example, based on (e.g., in response to) the at least one TCI state (or the first/starting/earliest TCI state) being the first/starting/earliest TCI state in the vector/set/list of the at least two TCI states. A wireless device may select/determine the at least one TCI state (or the first/starting/earliest TCI state) among the at least two TCI states, for example, based on the at least one TCI state being the first/starting/earliest TCI state in the vector/set/list of the at least two TCI states.

A TCI state index of the first/starting/earliest TCI state may be lowest (or highest) among at least two TCI state indexes of the at least two TCI states. The first/starting/earliest TCI state may be indicated/identified by/with the TCI state index that may be lowest (or highest) among the at least two TCI state indexes of the at least two TCI states. The plurality of TCI state indexes may comprise the at least two TCI state indexes. The at least two TCI state indexes may comprise the TCI state index of the first/starting/earliest TCI state. Each TCI state of the at least two TCI states may be indicated/identified by a respective TCI state index of the at least two TCI state indexes. For example, the first/starting/earliest TCI state may be the first TCI state (e.g., TCI state 26) based on a first TCI state index of the first TCI state being lower (or higher) than a second TCI state index of the second TCI state. For example, the first/starting/earliest TCI state may be the second TCI state (e.g., TCI state 61) based on a second TCI state index of the second TCI state being lower (or higher) than a first TCI state index of the first TCI state. The at least two TCI state indexes may comprise the first TCI state index and the second TCI state index.

A wireless device may send (e.g., transmit), via the PUCCH resource, the uplink signal based on the at least one TCI state (or the first/starting/earliest TCI state), for example, based on (e.g., in response to) the TCI state index of the first/starting/earliest TCI state being lowest (or highest) among the at least two TCI state indexes of the at least two TCI states. A wireless device may select/determine the at least one TCI state (or the first/starting/earliest TCI state), among the at least two TCI states, for example, based on the TCI state index of the first/starting/earliest TCI state being lowest (or highest) among the at least two TCI state indexes of the at least two TCI states.

Using the first/starting/earliest TCI state as a default/reference TCI state may reduce complexity of the wireless device. This use as a default/reference TCI state may reduce configuration message size (e.g., there may not be a need to indicate an association between the PUCCH resource (or the PUCCH resource group) and the at least one TCI state).

Using the first/starting/earliest TCI state as a default/reference TCI state may reduce flexibility. The wireless device may not use, for transmission of the uplink signal, the second/second starting/second earliest/last/latest TCI state in the vector/set/list of the at least two TCI states.

One or more configuration parameters may not indicate, for the PUCCH resource, a repetition. The one or more configuration parameters may not comprise, for the PUCCH resource, a repetition parameter (e.g., pucch-nrofSlots in FIG. 23A, nrofSlots, and the like) indicating a quantity/number of repetitions.

A wireless device may send (e.g., transmit), via the PUCCH resource, the uplink signal based on the at least one TCI state (or the first/starting/earliest TCI state), for example, based on (e.g., in response to) the one or more configuration parameters not indicating, for the PUCCH resource, a repetition. The wireless device may send (e.g., transmit), via the PUCCH resource, the uplink signal based on the at least one TCI state (or the first/starting/earliest TCI state), for example, based on (e.g., in response to) the one or more configuration parameters not comprising, for the PUCCH resource, the repetition parameter indicating a number of repetitions.

A wireless device may select/determine the at least one TCI state among the at least two TCI states, for example, based on the one or more configuration parameters not indicating, for the PUCCH resource, a repetition. The wireless device may select/determine the at least one TCI state among the at least two TCI states, for example, based on the one or more configuration parameters not comprising, for the PUCCH resource, the repetition parameter indicating a number of repetitions.

One or more configuration parameters may indicate, for the PUCCH resource, a repetition. The one or more configuration parameters may comprise, for the PUCCH resource, a repetition parameter (e.g., pucch-nrofSlots in FIG. 23A, nrofSlots, and the like) indicating a number of repetitions. The quantity/number of repetitions may be, for example, equal to one.

A wireless device may send (e.g., transmit), via the PUCCH resource, the uplink signal based on the at least one TCI state (or the first/starting/earliest TCI state), for example, based on (e.g., in response to) the one or more configuration parameters comprising, for the PUCCH resource, the repetition parameter indicating the quantity/number of repetitions that may be equal to one. The wireless device may send (e.g., transmit), via the PUCCH resource, the uplink signal based on the at least one TCI state (or the first/starting/earliest TCI state), for example, based on (e.g., in response to) the one or more configuration parameters indicating, for the PUCCH resource, the quantity/number of repetitions that may be equal to one.

A wireless device may select/determine the at least one TCI state (or the first/starting/earliest TCI state) among the at least two TCI states, for example, based on the one or more configuration parameters comprising, for the PUCCH resource, the repetition parameter indicating the quantity/number of repetitions that may be equal to one. The wireless device may select/determine the at least one TCI state among the at least two TCI states, for example, based on the one or more configuration parameters indicating, for the PUCCH resource, the quantity/number of repetitions that may be equal to one.

One or more configuration parameters may indicate, for the PUCCH resource, a repetition. The one or more configuration parameters may comprise, for the PUCCH resource, a repetition parameter (e.g., pucch-nrofSlots in FIG. 23A, nrofSlots, and the like) indicating a quantity/number of repetitions. The quantity/number of repetitions may be, for example, greater/larger than one. The quantity/number of repetitions may be, for example, 2, 4, or 8, and so on (e.g., any value).

The at least one TCI state may be the at least two TCI states, for example, based on the quantity/number of repetitions being greater/larger than one. The wireless device may send (e.g., transmit), via the PUCCH resource, the uplink signal based on the at least two TCI states, for example, based on (e.g., in response to) the one or more configuration parameters comprising, for the PUCCH resource, the repetition parameter indicating the number of repetitions that is greater/larger than one. The wireless device may send (e.g., transmit), via the PUCCH resource, the uplink signal based on the at least two TCI states, for example, based on (e.g., in response to) the one or more configuration parameters indicating, for the PUCCH resource, the number of repetitions that is greater/larger than one.

A wireless device may select/determine, for transmission of the uplink signal via the PUCCH resource, the at least two TCI states, for example, based on the one or more configuration parameters comprising, for the PUCCH resource, the repetition parameter indicating the quantity/number of repetitions that is greater/larger than one. The wireless device may select/determine, for transmission of the uplink signal via the PUCCH resource, the at least two TCI states, for example, based on the one or more configuration parameters indicating, for the PUCCH resource, the quantity/number of repetitions that is greater/larger than one.

A wireless device may receive/detect second DCI (e.g., DCI format 0-1, DCI format 1-1, DCI format 0-2, DCI format 1-2, and the like) triggering/indicating/scheduling transmission of the uplink signal via the PUCCH resource. The second DCI may, for example, schedule a PDSCH transmission (e.g., transport block). The second DCI may, for example, indicate an SPS PDSCH release. The second DCI may, for example, indicate an SCell dormancy. The second DCI may, for example, indicate one or more unified/common TCI states.

An uplink signal may comprise, for example, an HARQ-ACK information bit/feedback. The HARQ-ACK information bit/feedback may comprise, for example, for the second DCI. The HARQ-ACK information bit/feedback may comprise, for example, for the PDSCH transmission. The HARQ-ACK information bit/feedback may comprise, for example, for confirmation of reception/detection of the second DCI. The second DCI may, for example, indicate the PUCCH resource. The second DCI may, for example, comprise a PUCCH resource (PRI) indicator field indicating the PUCCH resource. A wireless device may send (e.g., transmit), via the PUCCH resource, the uplink signal, for example, based on receiving the second DCI triggering/indicating transmission of the uplink signal via the PUCCH resource.

The second DCI may comprise a field (e.g., Unified/Common/Joint TCI state index field, TRP index field, CORESET pool index field, and the like) indicating the at least one TCI state. A value of the field may indicate the at least one TCI state. For example, a first value (e.g., 00) of the field may indicate the first TCI state (e.g., TCI state 26). The at least one TCI state may be the first TCI state, for example, based on the value of the field being equal/set to the first value. For example, a second value (e.g., 01) of the field may indicate the second TCI state (e.g., TCI state 61). The at least one TCI state may be the second TCI state, for example, based on the value of the field being equal to the second value. For example, a third value (e.g., 10) of the field may indicate the first TCI state (e.g., TCI state 26) and the second TCI state (e.g., TCI state 61). The at least one TCI state may be the first TCI state and the second TCI state, for example, based on the value of the field being equal to the third value. For example, a fourth value (e.g., 11) of the field may indicate the first TCI state (e.g., TCI state 26) and the second TCI state (e.g., TCI state 61). The at least one TCI state may be the first TCI state and the second TCI state, for example, based on the value of the field being equal to the fourth value.

A wireless device may send (e.g., transmit), via the PUCCH resource, the uplink signal based on the at least one TCI state, for example, based on (e.g., in response to) the second DCI comprising the field that indicates the at least one TCI state. A wireless device may select/determine the at least one TCI state among the at least two TCI states, for example, based on the second DCI comprising the field that indicates the at least one TCI state. This may increase flexibility. The second DCI may dynamically indicate, for transmission of the uplink signal via the PUCCH resource, the first TCI state and/or the second TCI state. This indication may increase the size of the second DCI. Adding the field into the second DCI may increase the size of the second DCI. Increased DCI size may reduce coverage.

As described herein a wireless device may receive, via a CORESET of the plurality of CORESETS, second DCI. The wireless device may monitor, for the second DCI, PDCCH transmissions in the CORESET based on the at least one TCI state. The wireless device may receive, via the CORESET, the second DCI based on the at least one TCI state. For example, the wireless device may receive a MAC-CE indicating/activating the at least one TCI state for the CORESET. The MAC-CE may or may not be the activation command at time T₁ in FIG. 17. The wireless device may start monitoring the CORESET based on the at least one TCI state, for example, based on (e.g., in response to) receiving the DCI at time T₂ in FIG. 17.

The at least one TCI state may be the first TCI state. The wireless device may monitor, for the second DCI, PDCCH transmissions in the CORESET based on the first TCI state. The at least one TCI state may be the second TCI state. The wireless device may monitor, for the second DCI, PDCCH transmissions in the CORESET based on the second TCI state. The at least one TCI state may be the first TCI state and the second TCI state. The wireless device may monitor, for the second DCI, PDCCH transmissions in the CORESET based on the first TCI state and the second TCI state.

A wireless device may monitor, for the second DCI, PDCCH transmissions in the CORESET based on the first TCI state and the second TCI state (or based on the at least two TCI states). The wireless device may receive, via the CORESET, the second DCI based on the at least two TCI states. For example, the wireless device may receive a MAC-CE indicating/activating the at least two TCI states for the CORESET. The MAC-CE may or may not be the activation command at time T₁ in FIG. 17. The wireless device may start monitoring the CORESET based on the at least two TCI states, for example, based on (e.g., in response to) receiving the DCI at time T₂ in FIG. 17. The at least one TCI state may be the first TCI state, for example, based on the first TCI state being the first/starting/earliest TCI state in the vector/set/list of the at least two TCI states (or of the first TCI state and the second TCI state).

A wireless device may send (e.g., transmit), via the PUCCH resource, the uplink signal based on the at least one TCI state, for example, based on (e.g., in response to) receiving the second DCI via the CORESET monitored/activated with (or based on) the at least one TCI state. The wireless device may send (e.g., transmit), via the PUCCH resource, the uplink signal based on the at least one TCI state of the CORESET, for example, based on (e.g., in response to) the one or more configuration parameters indicating the joint/common UL/DL TCI state mode.

A wireless device may select/determine the at least one TCI state among the at least two TCI states, for example, based on receiving the second DCI via the CORESET monitored/activated with (or based on) the at least one TCI state. The wireless device may select/determine the at least one TCI state of the CORESET, for example, based on the one or more configuration parameters indicating the joint/common UL/DL TCI state mode.

Using the at least one TCI state of the CORESET as default/reference TCI state(s) may reduce complexity of the wireless device. This may reduce configuration message size (e.g., no need to indicate an association between the PUCCH resource (or the PUCCH resource group) and the at least one TCI state).

Using the at least one TCI state of the CORESET as default/reference TCI state(s) may reduce flexibility. The wireless device may not use, for transmission of the uplink signal, a different TCI state from the at least one TCI state.

One or more configuration parameters may indicate, for the PUCCH resource group, a field (e.g., Unified/Common/Joint TCI state index field, TRP index field, CORESET pool index field, and the like) indicating the at least one TCI state. For example, in FIG. 23A, the field may comprise ‘Unified TCI state ID’ in PUCCH-ResourceGroup (e.g., Option 2). For example, in FIG. 23B, the field is ‘Unified TCI state ID’ in PUCCH resource group. A value of the field (e.g., Unified TCI state ID in FIG. 23B) may indicate the at least one TCI state.

A field (or the value of the field) may indicate whether to apply/use the first TCI state and/or the second TCI state for the PUCCH resource group. The field (or the value of the field) may indicate whether to apply/use the first TCI state and/or the second TCI state for the one or more PUCCH resources in the PUCCH resource group.

A wireless device may apply/use the at least one TCI state for each PUCCH resource in the PUCCH resource group, for example, based on the one or more configuration parameters indicating, for the PUCCH resource group, the field. The wireless device may apply/use the at least one TCI state for each PUCCH resource of the one or more PUCCH resources in the PUCCH resource group, for example, based on the one or more configuration parameters indicating, for the PUCCH resource group, the field comprising/with the value indicating the at least one TCI state. Configuring/Setting/Including/Indicating the field for the PUCCH resource group may reduce signaling overhead. The base station may not indicate/configure the field for each PUCCH resource of the one or more PUCCH resources in the PUCCH resource group. The one or more configuration parameters may not comprise/indicate the field for each PUCCH resource of the one or more PUCCH resources in the PUCCH resource group.

Configuring/Setting/Including/Indicating the field for the PUCCH resource group may reduce flexibility. Applying/using the at least one TCI state for each PUCCH resource in the PUCCH resource group may reduce flexibility. The wireless device may not apply/use different TCI states for the one or more PUCCH resources in the PUCCH resource group.

A wireless device may send (e.g., transmit), via the PUCCH resource, the uplink signal based on the at least one TCI state, for example, based on (e.g., in response to) the one or more configuration parameters indicating, for the PUCCH resource group comprising the PUCCH resource, the field indicating the at least one TCI state. The wireless device may send (e.g., transmit), via the PUCCH resource, the uplink signal based on the at least one TCI state, for example, based on (e.g., in response to) the one or more configuration parameters indicating, for the PUCCH resource group comprising the PUCCH resource, the field comprising/with the value indicating the at least one TCI state.

A wireless device may select/determine, for transmission of the uplink signal via the PUCCH resource, the at least one TCI state among the at least two TCI states, for example, based on the one or more configuration parameters indicating, for the PUCCH resource group comprising the PUCCH resource, the field indicating the at least one TCI state. The wireless device may select/determine the at least one TCI state among the at least two TCI states, for example, based on the one or more configuration parameters indicating, for the PUCCH resource group comprising the PUCCH resource, the field comprising/with the value indicating the at least one TCI state.

One or more configuration parameters may indicate, for each PUCCH resource group of the one or more PUCCH resource groups, a respective value of/for the field. The one or more configuration parameters may indicate, for a first PUCCH resource group of the one or more PUCCH resource groups, a first value of/for the field. The one or more configuration parameters may indicate, for a second PUCCH resource group of the one or more PUCCH resource groups, a second value of/for the field. The one or more configuration parameters may indicate, for a third PUCCH resource group of the one or more PUCCH resource groups, the second value of/for the field. The one or more configuration parameters may indicate, for a fourth PUCCH resource group of the one or more PUCCH resource groups, a third value of/for the field. The second PUCCH resource group and the third PUCCH resource group may share the same unified/common TCI state(s), for example, based on the one or more configuration parameters indicating the same value of the field for the second PUCCH resource group and the third PUCCH resource group.

One or more configuration parameters may indicate, for the PUCCH resource, a field (e.g., Unified/Common/Joint TCI state index field, TRP index field, CORESET pool index field, and the like) indicating the at least one TCI state. For example, in FIG. 23A, the field may comprise ‘Unified TCI state ID’ in PUCCH-Resource (e.g., Option 1). For example, in FIG. 23B, the field may comprise ‘Unified TCI state ID’ in PUCCH resource. A value of the field (e.g., Unified TCI state ID in FIG. 23B) may indicate the at least one TCI state.

A field (and/or the value of the field) may indicate whether to apply/use the first TCI state or the second TCI state for the PUCCH resource. The field (and/or the value of the field) may indicate whether to apply/use the first TCI state and/or the second TCI state for the PUCCH resource.

A wireless device may apply/use the at least one TCI state for the PUCCH resource in the PUCCH resource group, for example, based on the one or more configuration parameters indicating, for the PUCCH resource, the field. The wireless device may apply/use the at least one TCI state for the PUCCH resource, for example, based on the one or more configuration parameters indicating, for the PUCCH resource, the field with the value indicating the at least one TCI state.

Configuring/Setting/Including/Indicating the field for the PUCCH resource may increase flexibility. The wireless device may apply/use different TCI states for the one or more PUCCH resources in the PUCCH resource group. The one or more configuration parameters may not indicate, for a second PUCCH resource of the one or more PUCCH resources in the PUCCH resource group, the field. The wireless device may apply/use different TCI states for the PUCCH resource and the second PUCCH resource. This application/use of different TCI states may increase flexibility. The one or more configuration parameters may indicate, for a second PUCCH resource of the one or more PUCCH resources in the PUCCH resource group, the field with a second value that is different from the value of the PUCCH resource. The wireless device may apply/use different TCI states for the PUCCH resource and the second PUCCH resource. This application/use of different TCI states may increase flexibility.

Configuring/Setting/Including/Indicating the field for the PUCCH resource may increase signaling overhead. A base station may indicate/configure the field for each PUCCH resource of the one or more PUCCH resources in the PUCCH resource group. The base station may indicate/configure the field for at least one PUCCH resource of the one or more PUCCH resources in the PUCCH resource group. The one or more configuration parameters may comprise/indicate the field for each PUCCH resource of the one or more PUCCH resources in the PUCCH resource group. The one or more configuration parameters may comprise/indicate the field for at least one PUCCH resource of the one or more PUCCH resources in the PUCCH resource group. This operation may increase the signaling overhead (e.g., RRC bit size).

A wireless device may send (e.g., transmit), via the PUCCH resource, the uplink signal based on the at least one TCI state, for example, based on (e.g., in response to) the one or more configuration parameters indicating, for the PUCCH resource, the field indicating the at least one TCI state. The wireless device may send (e.g., transmit), via the PUCCH resource, the uplink signal based on the at least one TCI state, for example, based on (e.g., in response to) the one or more configuration parameters indicating, for the PUCCH resource, the field with the value indicating the at least one TCI state.

A wireless device may select/determine, for transmission of the uplink signal via the PUCCH resource, the at least one TCI state among the at least two TCI states, for example, based on the one or more configuration parameters indicating, for the PUCCH resource, the field indicating the at least one TCI state. The wireless device may select/determine the at least one TCI state among the at least two TCI states, for example, based on the one or more configuration parameters indicating, for the PUCCH resource, the field with the value indicating the at least one TCI state.

A field (e.g., Unified/Common/Joint TCI state index field, TRP index field, CORESET pool index field, and the like) may be, for example, a 2-bits field. The field may be either 00, 01, 10 or 11, for example, based on the field being a 2-bits field. The field may be a 2-bits field, for example, if a multi-TRP uplink (e.g., PUSCH, PUCCH) repetition is enabled/configured. The field may be a 2-bit field, for example, based on the one or more configuration parameters indicating a multi-TRP uplink (e.g., PUSCH, PUCCH) repetition. The one or more configuration parameters may indicate, for example, at least two SRS resource sets to indicate the multi-TRP uplink repetition. The one or more configuration parameters may indicate, for example, more than one repetition for the PUCCH resource to indicate the multi-TRP uplink repetition. The one or more configuration parameters may indicate codebook, for example, for each SRS resource set of the at least two SRS resource sets. The one or more configuration parameters may indicate non-codebook, for example, for each SRS resource set of the at least two SRS resource sets.

A field (e.g., Unified/Common/Joint TCI state index field, TRP index field, CORESET pool index field, and the like) may be, for example, a 1-bit field. The field may be either 0, or 1, for example, based on the field being a 1-bit field. The field may be a 1-bit field, for example, if a multi-TRP uplink (e.g., PUSCH, PUCCH) repetition is not enabled/configured. The field may be a 1-bit field, for example, based on the one or more configuration parameters not indicating a multi-TRP uplink (e.g., PUSCH, PUCCH) repetition.

A first value (e.g., n=00 or n=0 in FIG. 23B) of the field (e.g., of the PUCCH resource or the PUCCH resource group) may indicate the first TCI state (e.g., TCI state 26). The at least one TCI state may be the first TCI state, for example, based on the value of the field being equal to/set to the first value. The wireless device may send (e.g., transmit), via the PUCCH resource, the uplink signal based on the first TCI state. The wireless device may send (e.g., transmit), via the PUCCH resource, the uplink signal with a first spatial domain transmitting/transmission filter/beam that is determined based on a first reference signal indicated by the first TCI state. The wireless device may send (e.g., transmit), via the PUCCH resource, the uplink signal with a first transmission power that is determined based on one or more first power control parameters (e.g., target received power, closed-loop index, pathloss compensation factor, alpha, pathloss reference signal, and the like) indicated by (or included in or associated with or mapped to) the first TCI state.

A second value (e.g., n=01 or n=1 in FIG. 23B) of the field (e.g., of the PUCCH resource or the PUCCH resource group) may indicate the second TCI state (e.g., TCI state 61). The at least one TCI state may be the second TCI state, for example, based on the value of the field being equal to/set to the second value. The wireless device may send (e.g., transmit), via the PUCCH resource, the uplink signal based on the second TCI state. The wireless device may send (e.g., transmit), via the PUCCH resource, the uplink signal with a second spatial domain transmitting/transmission filter/beam that is determined based on a second reference signal indicated by the second TCI state. The wireless device may send (e.g., transmit), via the PUCCH resource, the uplink signal with a second transmission power that is determined based on one or more second power control parameters (e.g., target received power, closed-loop index, pathloss compensation factor, alpha, pathloss reference signal, and the like) indicated by (or included in or associated with or mapped to) the second TCI state.

A third value (e.g., n=10 in FIG. 23B) of the field (e.g., of the PUCCH resource or the PUCCH resource group) may indicate the first TCI state (e.g., TCI state 26) and the second TCI state (e.g., TCI state 61). The at least one TCI state may be the first TCI state and the second TCI state, for example, based on the value of the field being equal to/set to the third value. The wireless device may send (e.g., transmit), via the PUCCH resource, the uplink signal based on the at least two TCI states. The wireless device may send (e.g., transmit), via the PUCCH resource, the uplink signal with the first spatial domain transmitting/transmission filter/beam that is determined based on the first reference signal indicated by the first TCI state. The wireless device may send (e.g., transmit), via the PUCCH resource, the uplink signal with the second spatial domain transmitting/transmission filter/beam that is determined based on the second reference signal indicated by the second TCI state. The wireless device may send (e.g., transmit), via the PUCCH resource, one or more first repetitions of the uplink signal with the first spatial domain transmitting/transmission filter/beam. The wireless device may send (e.g., transmit), via the PUCCH resource, one or more second repetitions of the uplink signal with the second spatial domain transmitting/transmission filter/beam. The wireless device may send (e.g., transmit), via the PUCCH resource, the uplink signal with the first transmission power that is determined based on the one or more first power control parameters indicated by (or included in or associated with or mapped to) the first TCI state. The wireless device may send (e.g., transmit), via the PUCCH resource, the uplink signal with the second transmission power that is determined based on the one or more second power control parameters indicated by (or included in or associated with or mapped to) the second TCI state. The wireless device may send (e.g., transmit), via the PUCCH resource, the one or more first repetitions of the uplink signal with the first transmission power. The wireless device may send (e.g., transmit), via the PUCCH resource, the one or more second repetitions of the uplink signal with the second transmission power. The wireless device may send (e.g., transmit), via the PUCCH resource, a first/starting/earliest/initial repetition of the uplink signal with the first spatial domain transmitting/transmission filter/beam, for example, based on the value of the field being equal to/set to the third value. The wireless device may send (e.g., transmit), via the PUCCH resource, a first/starting/earliest/initial repetition of the uplink signal with the first transmission power, for example, based on the value of the field being equal to/set to the third value. The wireless device may send (e.g., transmit), via the PUCCH resource, repetitions of the uplink signal with spatial domain transmission filters in an order (e.g., of the first spatial domain transmitting/transmission filter/beam, the first spatial domain transmitting/transmission filter/beam, the second spatial domain transmitting/transmission filter/beam, and/or the second spatial domain transmitting/transmission filter/beam), for example, based on the one or more configuration parameters indicating sequential beam mapping. The wireless device may send (e.g., transmit), via the PUCCH resource, repetitions of the uplink signal with spatial domain transmission filters in an order (e.g., of the first spatial domain transmitting/transmission filter/beam, the second spatial domain transmitting/transmission filter/beam, the first spatial domain transmitting/transmission filter/beam, and/or the second spatial domain transmitting/transmission filter/beam), for example, based on the one or more configuration parameters indicating cyclic beam mapping. The wireless device may send (e.g., transmit), via the PUCCH resource, repetitions of the uplink signal with transmission powers in an order (e.g., of the first transmission power, the first transmission power, the second transmission power, and/or the second transmission power), for example, based on the one or more configuration parameters indicating sequential beam mapping. The wireless device may transmit, via the PUCCH resource, repetitions of the uplink signal with transmission powers in an order (e.g., of the first transmission power, the second transmission power, the first transmission power, and/or the second transmission power), for example, based on the one or more configuration parameters indicating cyclic beam mapping.

A fourth value (e.g., n=11 in FIG. 23B) of the field (e.g., of the PUCCH resource or the PUCCH resource group) may indicate the first TCI state (e.g., TCI state 26) and the second TCI state (e.g., TCI state 61). The at least one TCI state may be the first TCI state and the second TCI state, for example, based on the value of the field being equal to/set to the fourth value. The wireless device may send (e.g., transmit), via the PUCCH resource, the uplink signal based on the at least two TCI states. The wireless device may send (e.g., transmit), via the PUCCH resource, the uplink signal with the first spatial domain transmitting/transmission filter/beam that is determined based on the first reference signal indicated by the first TCI state. The wireless device may send (e.g., transmit), via the PUCCH resource, the uplink signal with the second spatial domain transmitting/transmission filter/beam that is determined based on the second reference signal indicated by the second TCI state. The wireless device may send (e.g., transmit), via the PUCCH resource, one or more first repetitions of the uplink signal with the first spatial domain transmitting/transmission filter/beam. The wireless device may send (e.g., transmit), via the PUCCH resource, one or more second repetitions of the uplink signal with the second spatial domain transmitting/transmission filter/beam. The wireless device may send (e.g., transmit), via the PUCCH resource, the uplink signal with the first transmission power that is determined based on the one or more first power control parameters indicated by (or included in or associated with or mapped to) the first TCI state. The wireless device may send (e.g., transmit), via the PUCCH resource, the uplink signal with the second transmission power that is determined based on the one or more second power control parameters indicated by (or included in or associated with or mapped to) the second TCI state. The wireless device may send (e.g., transmit), via the PUCCH resource, the one or more first repetitions of the uplink signal with the first transmission power. The wireless device may send (e.g., transmit), via the PUCCH resource, the one or more second repetitions of the uplink signal with the second transmission power. The wireless device may send (e.g., transmit), via the PUCCH resource, a first/starting/earliest/initial repetition of the uplink signal with the second spatial domain transmitting/transmission filter/beam, for example, based on the value of the field being equal to/set to the fourth value. The wireless device may send (e.g., transmit), via the PUCCH resource, a first/starting/earliest/initial repetition of the uplink signal with the second transmission power, for example, based on the value of the field being equal to/set to the fourth value. The wireless device may send (e.g., transmit), via the PUCCH resource, repetitions of the uplink signal with spatial domain transmission filters in an order (e.g., of the second spatial domain transmitting/transmission filter/beam, the second spatial domain transmitting/transmission filter/beam, the first spatial domain transmitting/transmission filter/beam, and/or the first spatial domain transmitting/transmission filter/beam), for example, based on the one or more configuration parameters indicating sequential beam mapping. The wireless device may send (e.g., transmit), via the PUCCH resource, repetitions of the uplink signal with spatial domain transmission filters in an order (e.g., of the second spatial domain transmitting/transmission filter/beam, the first spatial domain transmitting/transmission filter/beam, the second spatial domain transmitting/transmission filter/beam, and/or the first spatial domain transmitting/transmission filter/beam), for example, based on the one or more configuration parameters indicating cyclic beam mapping. The wireless device may send (e.g., transmit), via the PUCCH resource, repetitions of the uplink signal with transmission powers in an order (e.g., of the second transmission power, the second transmission power, the first transmission power, and/or the first transmission power), for example, based on the one or more configuration parameters indicating sequential beam mapping. The wireless device may send (e.g., transmit), via the PUCCH resource, repetitions of the uplink signal with transmission powers in an order (e.g., of the second transmission power, the first transmission power, the second transmission power, and/or the first transmission power), for example, based on the one or more configuration parameters indicating cyclic beam mapping.

The field may increase flexibility for wireless communications. A base station may indicate the first TCI state and/or the second TCI state for the one or more PUCCH resources or the one or more PUCCH resource groups. The field may not be dynamic based on the one or more configuration parameters indicating/configuring the field. The base station may need to send (e.g., transmit) reconfiguration parameters updating the value of the field, for example, if the wireless device moves. This updating may increase the latency.

As described herein, one or more configuration parameters may not indicate, for a PUCCH resource group, a field (e.g., Unified/Common/Joint TCI state index field, TRP index field, CORESET pool index field, and the like). The field may be absent (or may not be indicated/identified as present) in configuration of the PUCCH resource group. The field of the PUCCH resource group may be absent (or may not be indicated/identified as present) in the one or more configuration parameters. The at least one TCI state may be the first TCI state (e.g., TCI state 26), for example, based on the one or more configuration parameters not indicating, for the PUCCH resource group comprising the PUCCH resource, the field. The first TCI state may be a default/reference TCI state, for example, based on the one or more configuration parameters not indicating, for the PUCCH resource group, the field. The first TCI state may be the first/starting/earliest/initial TCI state in the vector/set/list of the at least two TCI states.

A wireless device may send (e.g., transmit), via the PUCCH resource, an uplink signal based on the at least one TCI state, for example, based on (e.g., in response to) the one or more configuration parameters not indicating, for the PUCCH resource group comprising the PUCCH resource, the field. The wireless device may select/determine, for transmission of the uplink signal via the PUCCH resource, the at least one TCI state among the at least two TCI states, for example, based on the one or more configuration parameters not indicating, for the PUCCH resource group comprising the PUCCH resource, the field.

The one or more configuration parameters may not indicate, for the PUCCH resource, a field (e.g., Unified/Common/Joint TCI state index field, TRP index field, CORESET pool index field, and the like). The field may be absent (or may not be indicated/identified as present) in configuration of the PUCCH resource. The field of the PUCCH resource may be absent (or may not be indicated/identified as present) in the one or more configuration parameters. The at least one TCI state may be the first TCI state (e.g., TCI state 26), for example, based on the one or more configuration parameters not indicating, for the PUCCH resource, the field. The first TCI state may be a default/reference TCI state, for example, based on the one or more configuration parameters not indicating, for the PUCCH resource, the field. The first TCI state may be the first/starting/earliest/initial TCI state in the vector/set/list of the at least two TCI states.

A wireless device may send (e.g., transmit), via the PUCCH resource, the uplink signal based on the at least one TCI state, for example, based on (e.g., in response to) the one or more configuration parameters not indicating, for the PUCCH resource, the field. A wireless device may select/determine, for transmission of the uplink signal via the PUCCH resource, the at least one TCI state among the at least two TCI states, for example, based on the one or more configuration parameters not indicating, for the PUCCH resource, the field.

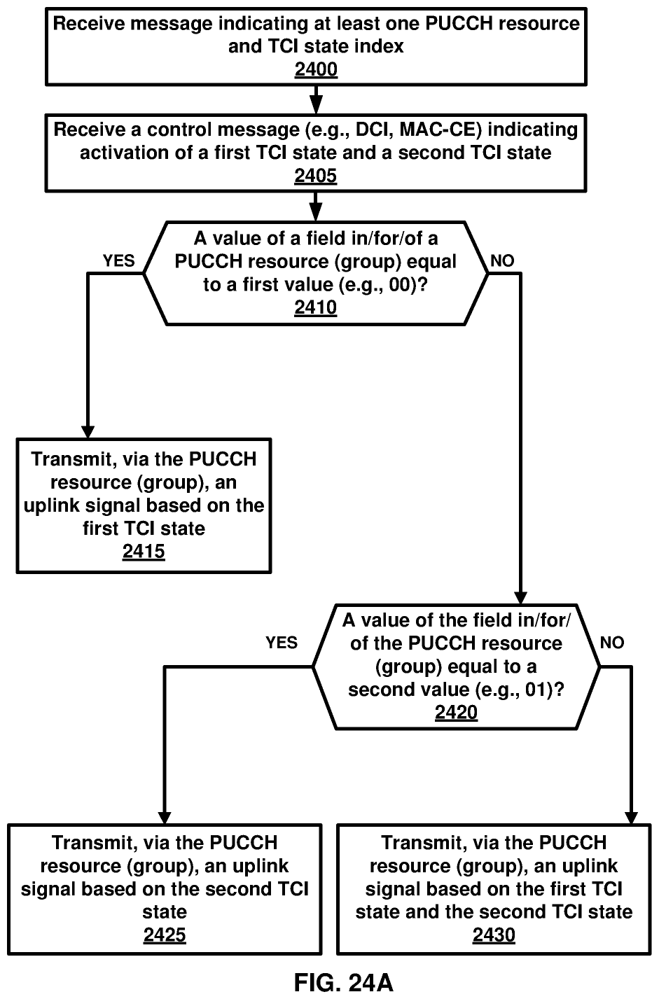

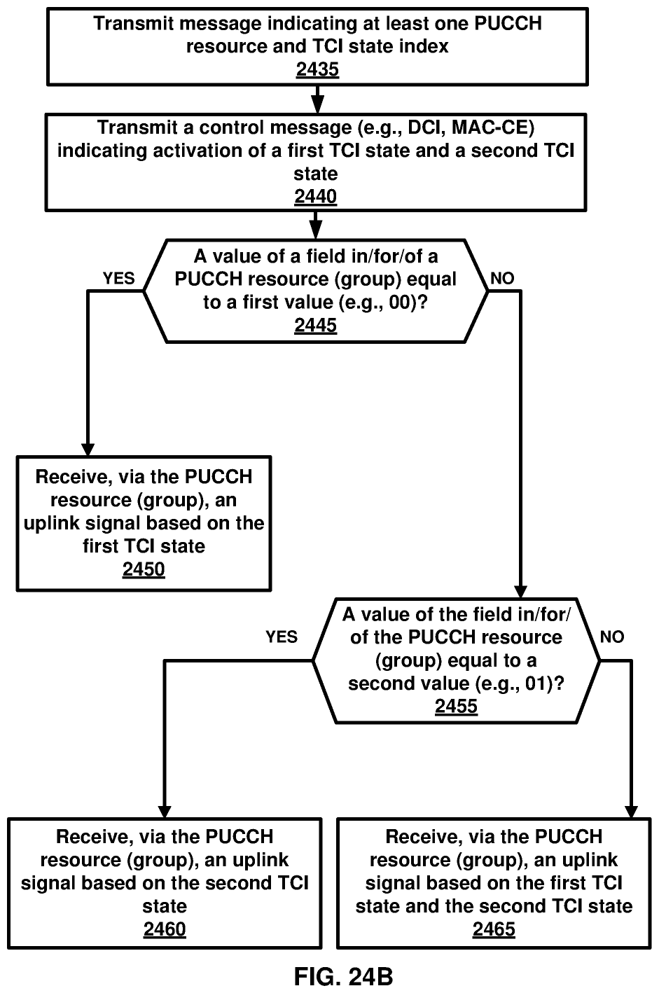

FIG. 24A and FIG. 24B show example methods of using an indication of a TCI state. The indication of the TCI state may be used for a unified beam update. At step 2400, a wireless device may receive (e.g., from a base station) one or more messages comprising one or more configuration parameters for a cell. At step 2435, the base station may send (e.g., transmit), to a wireless device, the one or more messages comprising the one or more configuration parameters. The one or more configuration parameters may indicate a plurality of TCI states. For example, the one or more configuration parameters may indicate, for an uplink BWP of the cell, the plurality of TCI states. For example, the one or more configuration parameters may indicate, for a downlink BWP of the cell, the plurality of TCI states. The one or more messages may comprise indication(s) of: at least one PUCCH resource and/or a plurality of TCI states (e.g., comprising at least a first TCI state and a second TCI state).

The wireless device may activate (or set) the uplink BWP as an active uplink BWP of the cell. The wireless device may activate (or set) the downlink BWP as an active downlink BWP of the cell. For example, the base station may send (e.g., transmit) a downlink message (e.g., DCI, MAC-CE, RRC message) indicating the activation of the uplink BWP. For example, the base station may send (e.g., transmit) a downlink message (e.g., DCI, MAC-CE, RRC message) indicating the activation of the downlink BWP.

The plurality of TCI states may comprise a plurality of joint/downlink TCI states (or joint uplink/downlink TCI states). The plurality of TCI states may comprise a plurality of uplink TCI states. The plurality of TCI states may comprise a plurality of downlink TCI states.

At step 2405, the wireless device may receive a control message. For example, the wireless device may receive an activation command (e.g., MAC-CE, DCI) indicating activation of a subset (e.g., a first TCI state and a second TCI state) of the plurality of TCI states. At step 2440, the base station may send (e.g., transmit) the activation command indicating activation of the subset of the plurality of TCI states.

The wireless device may map the subset of the plurality of TCI states to one or more TCI codepoints. Each TCI codepoint of the one or more TCI codepoints may indicate respective TCI state(s) of the subset of the plurality of TCI states. The base station may map the subset of the plurality of TCI states to the one or more TCI codepoints.

At step 2405, the wireless device may receive a control message/command (e.g., DCI, MAC-CE) indicating activation of at least two transmission configuration indicator (TCI) states. The subset of the plurality of TCI states may comprise the at least two TCI states. At step 2440, the base station may send (e.g., transmit) the control message/command.

The control message (e.g., DCI) may comprise a TCI field indicating the at least two TCI states. A TCI codepoint of the one or more TCI codepoints may indicate/comprise the at least two TCI states. The TCI field may indicate the TCI codepoint.

The control message may be, for example, the activation command. The at least two TCI states may be the subset of the plurality of TCI states. The one or more TCI codepoints may be/comprise a single TCI codepoint.

The at least two TCI states may be/comprise at least two joint/common/unified TCI states. The at least two TCI states may be/comprise at least two joint/common/unified uplink and downlink TCI states. The at least two TCI states may be/comprise at least two joint/common/unified uplink TCI states. The at least two TCI states may be/comprise at least two uplink TCI states. The at least two TCI states may be/comprise at least two joint/common/unified downlink TCI states. The at least two TCI states may be/comprise at least two downlink TCI states.

At step 2410, the wireless device may determine a value of a field in/for/of a PUCCH resource (and/or PUCCH resource group). At step 2445, the base station may determine a value of a field in/for/of a PUCCH resource (and/or PUCCH resource group). The wireless device and/or the base station may determine whether the value is equal to a first value (e.g., 00, 11, or any other value). At step 2415, at step 2425, and/or at step 2430, the wireless device may send (e.g., transmit), via a PUCCH resource, an uplink signal (e.g., HARQ-ACK, SR, CSI report, UCI, and the like) based on at least one TCI state of the at least two TCI states. At step 2415, the wireless device may send (e.g., transmit), via a PUCCH resource, an uplink signal (e.g., HARQ-ACK, SR, CSI report, UCI, and the like) based on the first TCI state of the at least two TCI states, for example, if the value of the field is equal to a first value (e.g., equal to 00). At step 2420, the wireless device may determine a value of the field in/for/of the PUCCH resource (and/or PUCCH resource group). At step 2420, the wireless device may determine whether the value is equal to a second value (e.g., 01, 10, or any other value). At step 2455, the base station may determine whether the value is equal to a second value (e.g., 01, 10, or any other value). At step 2425, the wireless device may send (e.g., transmit), via a PUCCH resource, an uplink signal (e.g., HARQ-ACK, SR, CSI report, UCI, and the like) based on the second TCI state of the at least two TCI states, for example, if the value of the field is equal to a second value (e.g., equal to 01). At step 2430, the wireless device may send (e.g., transmit), via a PUCCH resource, an uplink signal (e.g., HARQ-ACK, SR, CSI report, UCI, and the like) based on the first TCI state and the second TCI state of the at least two TCI states, for example, if the value of the field is not equal to a second value (or is equal to a value different from the second value).

At step 2450, at step 2460, and/or at step 2465, the base station may receive, via the PUCCH resource, the uplink signal based on the at least one TCI state of the at least two TCI states. At step 2450, the base station may receive, via a PUCCH resource, an uplink signal (e.g., HARQ-ACK, SR, CSI report, UCI, and the like) based on the first TCI state of the at least two TCI states, for example, if the value of the field is equal to a first value (e.g., equal to 00). At step 2460, the base station may receive, via a PUCCH resource, an uplink signal (e.g., HARQ-ACK, SR, CSI report, UCI, and the like) based on the second TCI state of the at least two TCI states, for example, if the value of the field is equal to a second value (e.g., equal to 01, 10, or any other value). At step 2465, the base station may receive, via a PUCCH resource, an uplink signal (e.g., HARQ-ACK, SR, CSI report, UCI, and the like) based on the first TCI state and the second TCI state of the at least two TCI states, for example, if the value of the field is not equal to the second value (and/or if the value of the field is equal to a value different from the second value).

A PUCCH resource group may comprise the PUCCH resource. The uplink BWP may comprise the PUCCH resource. The one or more configuration parameters may indicate, for the uplink BWP, the PUCCH resource (or the PUCCH resource group).

The wireless device may apply/use the at least one TCI state for transmission of the uplink signal via the PUCCH resource. Applying/using the at least one TCI state for transmission of the uplink signal via the PUCCH resource may comprise sending (e.g., transmitting), via the PUCCH resource, the uplink signal with (or based on) at least one spatial domain transmission filter that is determined based on the at least one TCI state. The wireless device may determine each spatial domain transmission filter of the at least one spatial domain transmission filter, for example, based on a respective TCI state of the at least one TCI state. The wireless device may determine each spatial domain transmission filter of the at least one spatial domain transmission filter, for example, based on a reference signal indicated by a respective TCI state of the at least one TCI state. Applying/using the at least one TCI state for transmission of the uplink signal via the PUCCH resource may comprise transmitting, via the PUCCH resource, the uplink signal using/with (or based on) at least one transmission power that is determined based on the at least one TCI state. The wireless device may determine each transmission power of the at least one transmission power, for example, based on a respective TCI state of the at least one TCI state. The wireless device may determine each transmission power of the at least one transmission power, for example, based on one or more power control parameters indicated by (or associated with or mapped to or included in) by a respective TCI state of the at least one TCI state. The one or more configuration parameters may indicate, for each TCI state of the at least one TCI state, a respective power control parameter set comprising the one or more power control parameters.

The base station may apply/use the at least one TCI state for reception of the uplink signal via the PUCCH resource. Applying/using the at least one TCI state for reception of the uplink signal via the PUCCH resource may comprise receiving, via the PUCCH resource, the uplink signal using/with (or based on) at least one spatial domain reception/receiving filter that is determined based on the at least one TCI state. The base station may determine each spatial domain reception filter of the at least one spatial domain reception filter, for example, based on a respective TCI state of the at least one TCI state. The base station may determine each spatial domain reception filter of the at least one spatial domain reception filter, for example, based on a reference signal indicated by a respective TCI state of the at least one TCI state.

The one or more configuration parameters may comprise/indicate, for the PUCCH resource group (or the PUCCH resource), a parameter (e.g., ApplyTCI-State-UL-List, ApplyTCI-State-DL-List, ApplyTCI-State-List, Use-Indicated-TCI-State, Use-Indicated-UL-TCI-State, Use-Indicated-DL-TCI-State, Follow-Unified-TCI-State, Follow-Unified-UL-TCI-State, Follow-Unified-DL-TCI-State, and the like) indicating to apply/use a common/unified TCI state. The parameter may be set to ‘enabled’. The wireless device may send (e.g., transmit), via the PUCCH resource, the uplink signal based on the at least one TCI state, for example, based on (e.g., in response to) the one or more configuration parameters comprising/indicating, for the PUCCH resource group (or the PUCCH resource), the parameter. The base station may receive, via the PUCCH resource, the uplink signal based on the at least one TCI state, for example, based on (e.g., in response to) the one or more configuration parameters comprising/indicating, for the PUCCH resource group (or the PUCCH resource), the parameter.

The at least one TCI state may be a first/earliest/starting TCI state that occurs first in a list/vector/set of the at least two TCI states. The wireless device may receive a second DCI triggering transmission of the uplink signal (e.g., HARQ-ACK) via the PUCCH resource. The base station may send (e.g., transmit) the second DCI triggering transmission of the uplink signal (e.g., HARQ-ACK) via the PUCCH resource.

The second DCI may be, for example, different from the control message. The second DCI may be, for example, the same as the control message. The second DCI may comprise a field (e.g., Unified/Common/Joint TCI state index field, TRP index field, CORESET pool index field, and the like). The field may comprise a value indicating the at least one TCI state. The least one TCI state may be a first TCI state of the at least two TCI states based on the value being equal to a first value (e.g., 00, or 0). The least one TCI state may be a second TCI state of the at least two TCI states based on the value being equal to a second value (e.g., 01 or 1). The least one TCI state may be the first TCI state and the second TCI state based on the value being equal to a third value (e.g., 10). The least one TCI state may be the first TCI state and the second TCI state based on the value being equal to a fourth value (e.g., 11).

The one or more configuration parameters may indicate, for the PUCCH resource group, a field (e.g., Unified/Common/Joint TCI state index field, TRP index field, CORESET pool index field, and the like) with a value indicating the at least one TCI state. The one or more configuration parameters may indicate, for the PUCCH resource, a field (e.g., Unified/Common/Joint TCI state index field, TRP index field, CORESET pool index field, and the like) comprising/with a value indicating the at least one TCI state.

The least one TCI state may be a first TCI state of the at least two TCI states based on the value being equal to a first value (e.g., 00, or 0). The least one TCI state may be a second TCI state of the at least two TCI states based on the value being equal to a second value (e.g., 01 or 1). The least one TCI state may be the first TCI state and the second TCI state based on the value being equal to a third value (e.g., 10). The least one TCI state may be the first TCI state and the second TCI state based on the value being equal to a fourth value (e.g., 11). The field may be, for example, a 2 bits field (or a field of any quantity of bits).

The one or more configuration parameters may not indicate, for the PUCCH resource (or for the PUCCH resource group), a field (e.g., Unified/Common/Joint TCI state index field, TRP index field, CORESET pool index field, and the like). The at least one TCI state may be a first/earliest/starting TCI state that occurs first in a list/vector/set of the at least two TCI states, for example, based on the one or more configuration parameters not indicating, for the PUCCH resource (or for the PUCCH resource group), the field.

The at least one TCI state may not be associated with a TRP. The one or more configuration parameters may not indicate, for the at least one TCI state, a field (e.g., Unified/Common/Joint TCI state index field, TRP index field, CORESET pool index field, and the like) indicating an association between the at least one TCI state and a TRP. The at least one TCI state may not be associated explicitly or implicitly with a TRP. This lack of association may reduce signaling overhead. The one or more configuration parameters may not need to comprise/indicate an association between the at least one TCI state and a TRP (or a TRP index, CORESET pool index, Unified/Common/Joint TCI state index field, and the like). This configuration may reduce RRC message size (and/or may reduce the size of the configuration parameters).

Each TCI state of the at least one TCI state may not be associated with a TRP. The one or more configuration parameters may not indicate, for each TCI state of the at least one TCI state, a field (e.g., Unified/Common/Joint TCI state index field, TRP index field, CORESET pool index field, and the like) indicating an association with a TRP. Each TCI state of the at least one TCI state may not be associated explicitly or implicitly with a TRP. This may reduce signaling overhead. The one or more configuration parameters may not need to comprise/indicate an association between each TCI state of the at least one TCI state and a respective TRP (or a TRP index, CORESET pool index, Unified/Common/Joint TCI state index field, and the like). This configuration may reduce RRC message size (and/or may reduce the size of the configuration parameters).

Each TCI state of the at least two TCI states may not be associated with a TRP. The one or more configuration parameters may not indicate, for each TCI state of the at least two TCI states, a field (e.g., Unified/Common/Joint TCI state index field, TRP index field, CORESET pool index field, and the like) indicating an association with a TRP. Each TCI state of the at least two TCI states may not be associated explicitly or implicitly with a TRP. This lack of association may reduce signaling overhead. The one or more configuration parameters may not need to comprise/indicate an association between each TCI state of the at least two TCI states and a respective TRP (or a TRP index, CORESET pool index, Unified/Common/Joint TCI state index field, and the like). This may configuration reduce RRC message size (and/or may reduce the size of the configuration parameters).

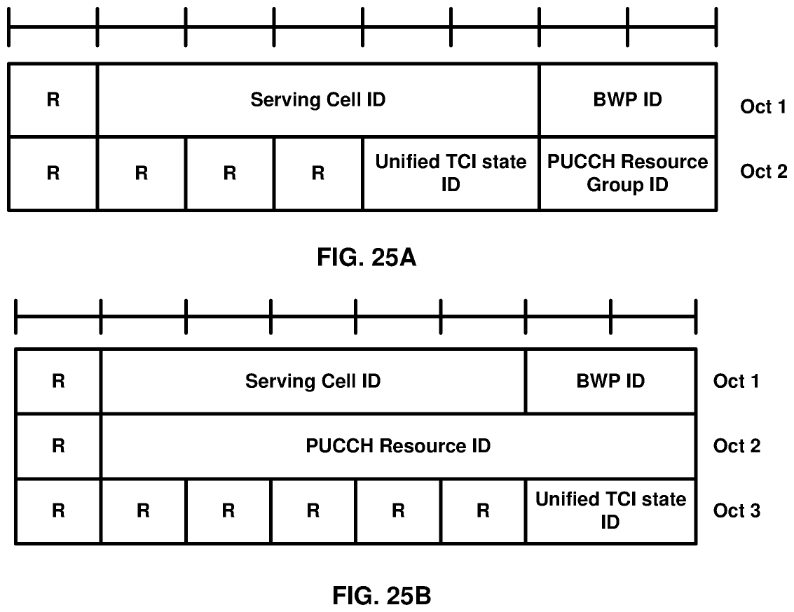

FIG. 25A and FIG. 25B show examples of activation commands. The activation commands may be used in a unified beam update. One or more configuration parameters may indicate, for the PUCCH resource group, a field (e.g., Unified/Common/Joint TCI state index field, TRP index field, CORESET pool index field, and the like) with a first value (e.g., n=00, n=01, n=10, or n=11 in FIG. 23B). The first value of the field may indicate at least one first TCI state of the at least two TCI states.

The one or more configuration parameters may indicate, for the PUCCH resource, a field (e.g., Unified/Common/Joint TCI state index field, TRP index field, CORESET pool index field, and the like) with a first value (e.g., n=00, n=01, n=10, or n=11 in FIG. 23B). The first value of the field may indicate at least one first TCI state of the at least two TCI states.

The at least one first TCI state indicated by the first value of the field may be the first TCI state (e.g., TCI state 26), for example, if the first value is equal to 00 (e.g., n=00 or n=0). The at least one first TCI state indicated by the first value of the field may be the second TCI state (e.g., TCI state 61), for example, if the first value is equal to 01 (e.g., n=01 or n=1). The at least one first TCI state indicated by the first value of the field may be the first TCI state (e.g., TCI state 26) and the second TCI state (e.g., TCI state 61), for example, if the first value is equal to 10 (e.g., n=10). The at least one first TCI state indicated by the first value of the field may be the first TCI state (e.g., TCI state 26) and the second TCI state (e.g., TCI state 61), for example, if the first value is equal to 11 (e.g., n=11). Any value may be assigned to/associated with any TCI state.

A wireless device may send (e.g., transmit), via the PUCCH resource in the PUCCH resource group, a first uplink signal (e.g., HARQ-ACK, SR, CSI report, UCI, and the like) based on the at least one first TCI state, for example, based on (e.g., in response to) the one or more configuration parameters indicating, for the PUCCH resource group comprising the PUCCH resource, the field with the first value that indicates the at least one first TCI state. The wireless device may apply/use the at least one first TCI state for transmission of the first uplink signal via the PUCCH resource in the PUCCH resource group.

The wireless device may send (e.g., transmit), via the PUCCH resource, a first uplink signal (e.g., HARQ-ACK, SR, CSI report, UCI, and the like) based on the at least one first TCI state, for example, based on (e.g., in response to) the one or more configuration parameters indicating, for the PUCCH resource, the field with the first value that indicates the at least one first TCI state. The wireless device may apply/use the at least one first TCI state for transmission of the first uplink signal via the PUCCH resource.

The base station may receive, via the PUCCH resource in the PUCCH resource group, the first uplink signal (e.g., HARQ-ACK, SR, CSI report, UCI, and the like) based on the at least one first TCI state, for example, based on (in response to) the one or more configuration parameters indicating, for the PUCCH resource group comprising the PUCCH resource (or for the PUCCH resource), the field with the first value that indicates the at least one first TCI state. The base station may apply/use the at least one first TCI state for reception of the first uplink signal via the PUCCH resource in the PUCCH resource group.

The wireless device may receive an activation command (e.g., MAC-CE, DCI, Unified TCI state ID update MAC-CE, and the like). The activation command may comprise one or more fields. The base station may send (e.g., transmit) the activation command.

A first field of the one or more fields may comprise a serving cell index (e.g., Serving Cell ID in FIG. 25A and FIG. 25B) indicating/identifying the cell. A second field of the one or more fields may comprise a BWP index (e.g., BWP ID in FIG. 25A and FIG. 25B). The BWP may indicate/identify, for example, the uplink BWP of the cell. The BWP may indicate/identify, for example, the downlink BWP of the cell.

A third field of the one or more fields may comprise a PUCCH resource group index (e.g., PUCCH Resource Group ID in FIG. 25A) indicating/identifying the PUCCH resource group. The one or more configuration parameters may indicate, for the PUCCH resource group, the PUCCH resource group index. A third field of the one or more fields may comprise a PUCCH resource index (e.g., PUCCH Resource ID in FIG. 25B) indicating/identifying the PUCCH resource. The one or more configuration parameters may indicate, for the PUCCH resource, the PUCCH resource index.

A fourth field (e.g., Unified TCI State ID in FIG. 25A) of the one or more fields may indicate/comprise a second value for/of the field (e.g., Unified/Common/Joint TCI state index field, TRP index field, CORESET pool index field, and the like) of the PUCCH resource group (e.g., in FIG. 25A). A fourth field (e.g., Unified TCI State ID in FIG. 25B) of the one or more fields may indicate/comprise a second value for/of the field (e.g., Unified/Common/Joint TCI state index field, TRP index field, CORESET pool index field, and the like) of the PUCCH resource (e.g., in FIG. 25B). A size/length of the fourth field may be 2 bits (or any quantity of bits). The size/length of the fourth field may be 2 bits, for example, based on a PUCCH transmission being able to be repeated among multiple TRPs (e.g., multi-TRP PUCCH repetition). The wireless device may perform the PUCCH transmission to the first TRP only. The wireless device may perform the PUCCH transmission to the second TRP only. The wireless device may perform the PUCCH transmission to the first TRP and the second TRP. The wireless device may perform the PUCCH transmission to the first TRP and the second TRP, starting with the first TRP for the repetitions. The wireless device may perform the PUCCH transmission to the first TRP and the second TRP, starting with the second TRP for the repetitions. 1-bit for the size/length of the fourth field may not be enough to indicate these cases (e.g., first TRP only, second TRP only, both the first TRP and the second TRP).

A size/length of the fourth field may be 1 bit. The size/length of the fourth field may be 1 bit, for example, based on a PUCCH transmission not being able to be repeated among multiple TRPs (e.g., multi-TRP PUCCH repetition). The wireless device may perform the PUCCH transmission to the first TRP only. The wireless device may perform the PUCCH transmission to the second TRP only. The wireless device may not perform the PUCCH transmission to the first TRP and the second TRP. 1-bit for the size/length of the fourth field may be enough to indicate these cases (e.g., first TRP only, second TRP only).

“R” fields in FIG. 25A and FIG. 25B may denote/be/comprise reserved bits. The second value of the field may indicate at least one second TCI state of the at least two TCI states. For example, the at least one second TCI state indicated by the second value of the field may be the first TCI state (e.g., TCI state 26), for example, if the second value is equal to 00 (e.g., n=00 or n=0). The at least one second TCI state indicated by the second value of the field may be the second TCI state (e.g., TCI state 61), for example, if the second value is equal to 01 (e.g., n=01 or n=1). The at least one second TCI state indicated by the second value of the field may be the first TCI state (e.g., TCI state 26) and the second TCI state (e.g., TCI state 61), for example, if the second value is equal to 10 (e.g., n=10). The at least one second TCI state indicated by the second value of the field may be the first TCI state (e.g., TCI state 26) and the second TCI state (e.g., TCI state 61), for example, if the second value is equal to 11 (e.g., n=11).

The wireless device may replace/update the first value of the field with the second value, for example, based on receiving the activation command indicating the second value for/of the field. The base station may replace/update the first value of the field with the second value, for example, based on sending (e.g., transmitting) the activation command indicating the second value for/of the field.

The wireless device may send (e.g., transmit), via the PUCCH resource in the PUCCH resource group, a second uplink signal (e.g., HARQ-ACK, SR, CSI report, UCI, and the like) based on the at least one second TCI state indicated by the second value of the field. The wireless device may send (e.g., transmit), via the PUCCH resource in the PUCCH resource group, the second uplink signal based on the at least one second TCI state, for example, based on (in response to) replacing/updating the first value of the field with the second value.

The wireless device may send (e.g., transmit), via the PUCCH resource in the PUCCH resource group, the second uplink signal based on the at least one second TCI state, for example, based on (e.g., in response to) receiving the activation command indicating, for the PUCCH resource group comprising the PUCCH resource, the field with the second value that indicates the at least one second TCI state. The wireless device may send (e.g., transmit), via the PUCCH resource in the PUCCH resource group, the second uplink signal based on the at least one second TCI state, for example, based on (e.g., in response to) receiving the activation command indicating, for the PUCCH resource group comprising the PUCCH resource, the second value of/of the field. The second value of the field may indicate the at least one second TCI state. The wireless device may send (e.g., transmit), via the PUCCH resource in the PUCCH resource group, the second uplink signal based on the at least one second TCI state, for example, based on (e.g., in response to) the activation command indicating, for the PUCCH resource group comprising the PUCCH resource, the field with the second value that indicates the at least one second TCI state. The wireless device may send (e.g., transmit), via the PUCCH resource in the PUCCH resource group, the second uplink signal based on the at least one second TCI state, for example, based on (e.g., in response to) the activation command indicating, for the PUCCH resource group comprising the PUCCH resource, the second value of/for the field. The second value may indicate the at least one second TCI state.

The wireless device may send (e.g., transmit), via the PUCCH resource in the PUCCH resource group, the second uplink signal based on the at least one second TCI state, for example, based on (e.g., in response to) receiving the activation command indicating, for the PUCCH resource, the field with the second value that indicates the at least one second TCI state. The wireless device may send (e.g., transmit), via the PUCCH resource, the second uplink signal based on the at least one second TCI state, for example, based on (e.g., in response to) receiving the activation command indicating, for the PUCCH resource, the second value of/of the field. The second value of the field may indicate the at least one second TCI state. The wireless device may send (e.g., transmit), via the PUCCH resource, the second uplink signal based on the at least one second TCI state, for example, based on (e.g., in response to) the activation command indicating, for the PUCCH resource, the field with the second value that indicates the at least one second TCI state. The wireless device may send (e.g., transmit), via the PUCCH resource, the second uplink signal based on the at least one second TCI state, for example, based on (e.g., in response to) the activation command indicating, for the PUCCH resource, the second value of/for the field. The second value may indicate the at least one second TCI state.

The base station may receive, via the PUCCH resource in the PUCCH resource group, the second uplink signal (e.g., HARQ-ACK, SR, CSI report, UCI, and the like) based on the at least one second TCI state indicated by the second value of the field. The base station may receive, via the PUCCH resource in the PUCCH resource group, the second uplink signal based on the at least one second TCI state, for example, based on (e.g., in response to) replacing/updating the first value of the field with the second value. The base station may receive, via the PUCCH resource in the PUCCH resource group, the second uplink signal based on the at least one second TCI state, for example, based on (e.g., in response to) sending (e.g., transmitting) the activation command indicating, for the PUCCH resource group comprising the PUCCH resource (or for the PUCCH resource), the field with the second value that indicates the at least one second TCI state.

Indicating/Updating a first value of the field (e.g., of the PUCCH resource or the PUCCH resource group) by configuration parameters may reduce flexibility. The base station may not have information indicating whether the PUCCH resource should be associated with a first TRP or a second TRP or both the first TRP and the second TRP, for example, if the base station sends (e.g., transmits) the one or more configuration parameters. The base station may need to send (e.g., transmit) reconfiguration parameters to update the first value of the field, for example, if the wireless device moves closer to the first TRP or to the second TRP or to the cell-edge. This operation may increase latency. As described herein, the first value of the field may be updated dynamically (e.g., MAC-CE, DCI), which may provide advantages such as reducing latency.

A base station may send (e.g., transmit) an activation command (e.g., MAC-CE, DCI) updating the first value of the field by a second value. The second value of the field may indicate the first TCI state, for example, if the wireless device is closer to the first TRP. The second value of the field may indicate the second TCI state, for example, if the wireless device is closer to the second TRP. The second value of the field may indicate the first TCI state and the second TCI state, for example, if the wireless device is close to the cell-edge. This operation may increase flexibility as TCI state(s) for transmission of an uplink signal via the PUCCH resource may change dynamically.

In at least some wireless communications, a wireless device may receive a control message/command (e.g., DCI, MAC-CE) indicating activation of a (single) common/unified TCI state. At least some wireless devices may apply/use the common/unified TCI state to monitor (e.g., for PDCCH transmissions/receptions) a CORESET of a downlink BWP of a cell. The wireless device may monitor, via the CORESET, for PDCCH transmissions/receptions using/with a spatial domain reception/receiving filter that may be determined based on a reference signal indicated by the common/unified TCI state. DMRS antenna port(s) of the PDCCH transmissions/receptions may be quasi co-located with a reference signal indicated by the common/unified TCI state. The wireless device may determine/estimate channel properties (e.g., Doppler spread, Doppler shift, delay spread, average delay, and the like) of the PDCCH transmissions/receptions based on a reference signal indicated by the common/unified TCI state. Activation of the (single) common/unified TCI state may not be efficient in a multi-TRP operation comprising a first TRP and a second TRP. Using/sharing/applying the same common/unified TCI state for monitoring of a first CORESET associated with the first TRP and/or for monitoring of a second CORESET associated with the second TRP may not be efficient. For example, the first TRP and the second TRP may not be co-located and/or may be subject to different channel conditions, which may result in using one or more parameters for a plurality of TRPs that, while suitable/ideal for a particular TRP, may not be suitable/ideal for each TRP of the plurality of TRPs (e.g., if the plurality of TRPs are not co-located or are not QCLed).

In at least some systems, a wireless device may receive one or more messages, such as a control message/command (e.g., DCI, MAC-CE), indicating activation of at least two common/unified TCI states. The at least two common/unified TCI states may comprise a first common/unified TCI state and a second common/unified TCI state. The wireless device may not have information indicating whether the first common/unified TCI state is associated with the first TRP or the second TRP. There may not be an explicit/implicit association between the first common/unified TCI state and the first TRP or the second TRP. Configuration parameter(s) may not indicate, for the first common/unified TCI state, a TRP index (or a CORESET pool index, or a common/unified TCI state index, and the like) indicating an association between the first common/unified TCI state and the first TRP or the second TRP. The wireless device may not have information indicating whether the second common/unified TCI state is associated with the first TRP or the second TRP. There may not be an explicit/implicit association between the second common/unified TCI state and the first TRP or the second TRP. Configuration parameter(s) may not indicate, for the second common/unified TCI state, a TRP index (or a CORESET pool index, or a common/unified TCI state index, and the like) indicating an association between the second common/unified TCI state and the first TRP or the second TRP. The wireless device may not have information on whether a CORESET is associated with the first TRP or the second TRP. The wireless device may not have information whether to apply/use the first common/unified TCI state and/or the second common/unified TCI state to monitor the CORESET. This may lead to a beam misalignment between the wireless device and the base station. For example, the wireless device may apply/use the first common/unified TCI state to monitor the CORESET for PDCCH transmissions/receptions. The base station may assume/determine that the wireless device applies/uses the second common/unified TCI state to monitor the CORESET for PDCCH transmissions/receptions. This operation may lead to missing of the PDCCH transmissions/receptions by the wireless device. The wireless device may not receive/detect DCIs sent (e.g., transmitted) by a base station via/in the CORESET. This lack of receiving/detection may result in retransmissions, increased latency of the communication, and/or increased power consumption at the base station and/or at the wireless device.

As described herein, enhanced beam management may be achieved, for example, if at least two common/unified TCI states are activated. For example, a wireless device may apply/use the first common/unified TCI state to monitor the CORESET. A wireless device may determine whether to monitor a CORESET with a first TCI state or a second TCI state based on one or more indications. For example, a CORESET may be activated with two TCI states to support PDCCH repetition among multiple TRPs, such as if a single frequency network (SFN) is configured. The wireless device may determine which of two TCI states to monitor (e.g., a first unified/joint TCI state or a second unified/joint TCI state) based on a field and/or applying a default rule. The wireless device may use a value of a first field (e.g., a 1-bit field) of a configuration parameter in a message (e.g., an RRC message) to indicate using a first TCI state (e.g., value of 0) or using a second TCI state (e.g., value of 1), for example, if SFN is not configured such that only one TCI state may be used. The wireless device may use a value of a second field (e.g., a 2-bit field) in a message (e.g., an RRC message) to indicate using a first TCI state, (e.g., value of 00), a second TCI state (e.g., value of 01), or both the first TCI state and the second TCI state (e.g., value of 10 or 11), for example, if SFN is configured such that one or both TCI states may be used. A default rule may be applied if both the first field and the second field are absent, such that the wireless device may apply the first TCI state (or second TCI state) as a default rule. The first TCI state (e.g., first common/unified TCI state) may be a first/starting/earliest TCI state that occurs first in a set/list/vector of the at least two common/unified TCI states. By using the first and/or second field, and/or by applying a default rule, a wireless device and a base station may improve alignment for wireless communications by using the same TCI states.

A wireless device and a base station may use resources for wireless communications. One or more unified transmission configuration indicator (TCI) state(s) may be indicated using a parameter, field, message, and/or signaling. The unified TCI state(s) may be associated with control resource set (CORESET). The unified TCI state(s) may be applied for communications, via the CORESET, between the wireless device and the base station for which at least two unified TCI states may be activated, without requiring additional signaling to configure parameters for each communication.

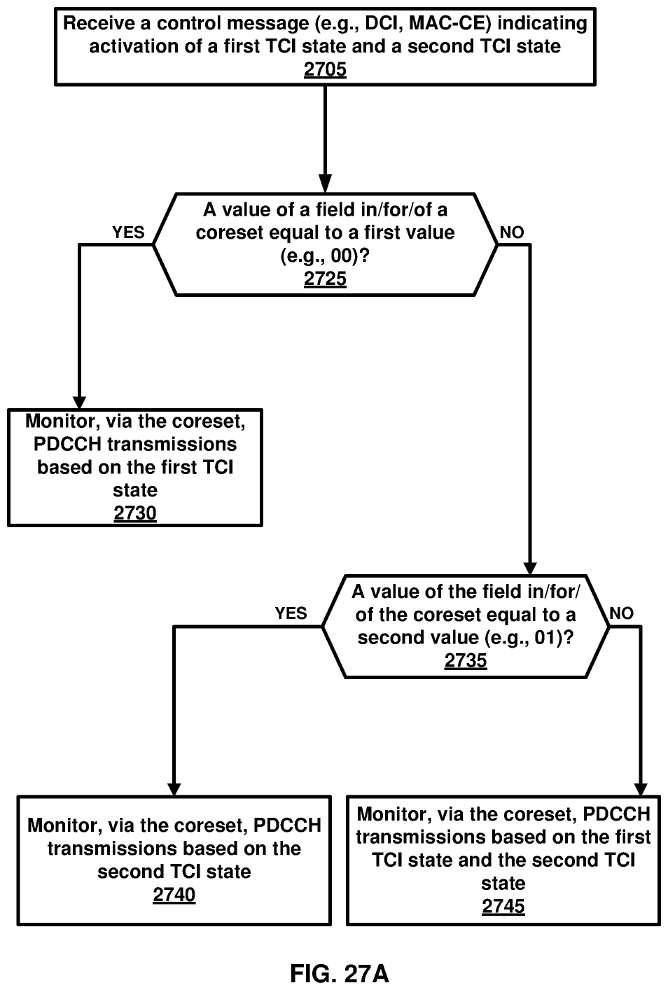

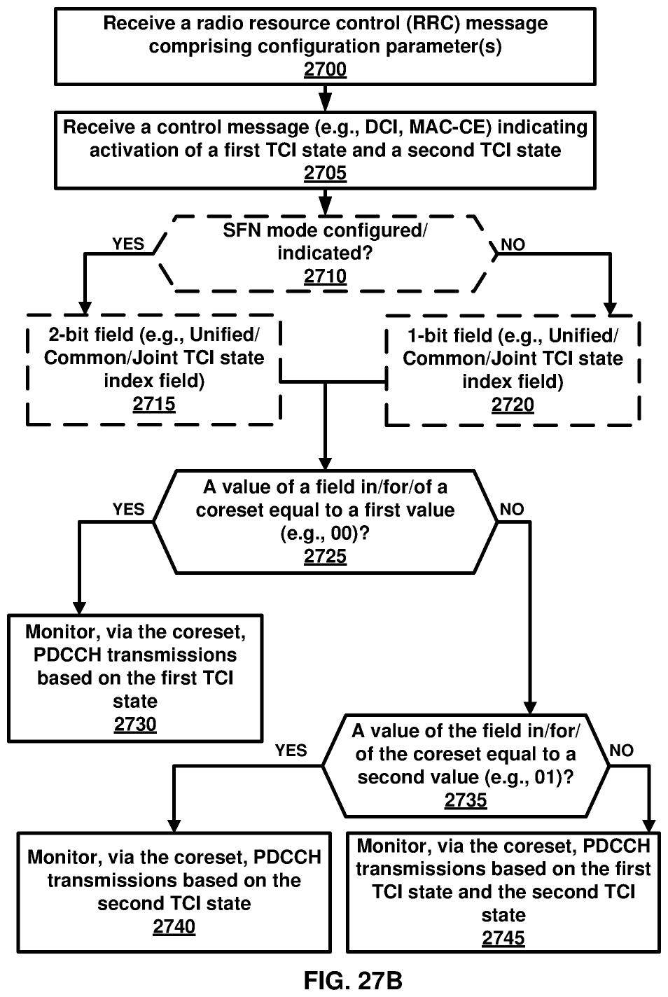

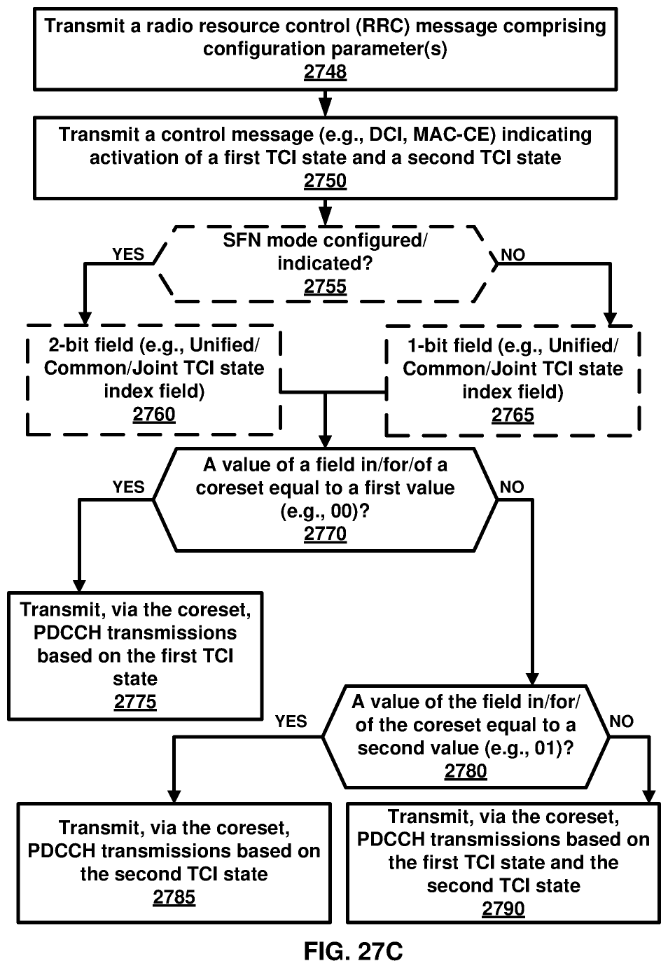

FIG. 27A, FIG. 27B, and FIG. 27C show example methods of using an indication of a TCI state. One or more configuration parameter(s) may be received (e.g., at step 2700) by a wireless device (and/or transmitted by a base station, such as at step 2748) that may indicate (e.g., for a CORESET), a single frequency network (SFN) mode (e.g., which may be determined at optional step 2710 and/or at optional step 2755). The one or more configuration parameters may be received in a radio resource control (RRC) message. For example, one or more configuration parameter(s) received by the wireless device (e.g., at step 2700) may indicate an SFN mode (e.g., sfn-PDCCH) for a downlink BWP of a cell (or for a cell). In the SFN mode, the wireless device may apply/use both of the at least two common/unified TCI states to monitor the CORESET (e.g., at optional step 2715 and/or at optional step 2760).

One or more configuration parameter(s) received by the wireless device may indicate (e.g., for the CORESET) a field (e.g., TRP index or a CORESET pool index, or a common/unified TCI state index, and the like) comprising a value (e.g., determined/indicated at step 2725 and/or at step 2770). The value may indicate common/unified TCI state(s) among the at least two common/unified TCI states. For example, a first value (e.g., 00) of the field may indicate a first common/unified TCI state among the at least two common/unified TCI states (e.g., “YES” result from step 2725 and/or from step 2770). A second value (e.g., 01) of the field may indicate a second common/unified TCI state among the at least two common/unified TCI states (e.g., “YES” result from step 2735 and/or from step 2780). A third value (e.g., 10 or 11) of the field may indicate the first common/unified TCI state and the second common/unified TCI state (e.g., “NO” result from step 2735 and/or from step 2780). The wireless device may apply/use the (indicated) common/unified TCI state(s) to monitor the CORESET (e.g., at step 2730, step 2740, or step 2745) for transmission from a base station (e.g., at step 2775, step 2785, or step 2790). The field may be any quantity of bits. For example, the field may be 2 bits if the SFN mode is configured/indicated (e.g., at optional step 2715 and/or at optional step 2760). The field may be 1 bit, for example, if the SFN mode is not configured/indicated (e.g., at optional step 2720 and/or at optional step 2765). As described herein, reduced beam misalignment may be achieved, which may lead to advantages such as reduced retransmissions, reduced latency/delay, and/or reduced power consumption.

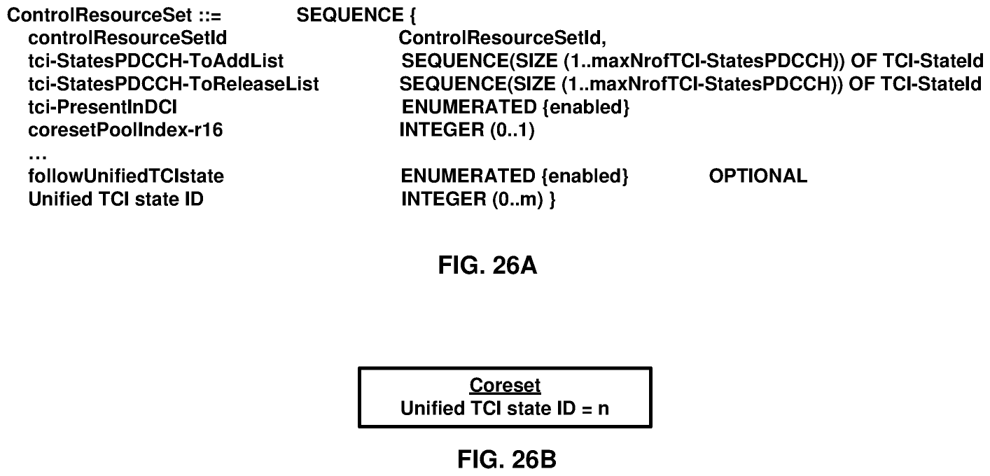

FIG. 26A and FIG. 26B show examples of parameters. The parameters may be used for a unified beam update. One or more configuration parameters may indicate one or more control resource sets (CORESETS). The one or more configuration parameters may indicate the one or more CORESETS for the (active) downlink BWP of the cell. The (active) downlink BWP may comprise the one or more CORESETS. The one or more configuration parameters may comprise one or more PDCCH configuration parameters (e.g., PDCCH-Config) indicating the one or more CORESETS (e.g., by a higher layer parameter ControlResourceSet in FIG. 26A).

The one or more configuration parameters may indicate one or more CORESET indexes/identifiers/indicators (e.g., provided by a higher layer parameter ControlResourceSetId in FIG. 26A) for the one or more CORESETS. Each CORESET of the one or more CORESETS may be identified/indicated by a respective CORESET index of the one or more CORESET indexes. A first CORESET of the one or more CORESETS may be identified/indicated by a first CORESET index of the one or more CORESET indexes. A second CORESET of the one or more CORESETS may be identified/indicated by a second CORESET index of the one or more CORESET indexes.

A quantity/number of the one or more CORESETS may be equal to a number of the at least two TCI states. A quantity/number of the one or more CORESETS may be less/smaller than a number of the at least two TCI states. A quantity/number of the one or more CORESETS may be greater/larger than a number of the at least two TCI states. For example, the quantity/number of the at least two TCI states may be equal to 2 (e.g., M=2, N=2). The quantity/number of the at least two TCI states may comprise/denote a quantity/number of TCI states indicated/comprised by (or included in) the at least two TCI states. The quantity/number of the one or more CORESETS may be greater than 2, or less than 2, or equal to 2.

One or more configuration parameters may indicate, for the downlink BWP of the cell, a plurality of search space sets (e.g., by a higher layer parameter SearchSpace). For example, the one or more configuration parameters may indicate, for the cell, a plurality of search space sets (e.g., by a higher layer parameter SearchSpace).

One or more configuration parameters may indicate a plurality of search space set indexes/identifiers (e.g., provided by a higher layer parameter searchSpaceId) for the plurality of search space sets. Each search space set of the plurality of search space sets may be identified/indicated by a respective search space set index of the plurality of search space set indexes. A first search space set of the plurality of search space sets may be identified/indicated by a first search space set index of the plurality of search space set indexes. A second search space set of the plurality of search space sets may be identified/indicated by a second search space set index of the plurality of search space set indexes.

A search space set of the plurality of search space sets may be associated with (e.g., linked to) a CORESET of the plurality of CORESETS. The one or more configuration parameters may indicate the CORESET (and/or a CORESET index of the CORESET) for the search space set (e.g., provided by a higher layer parameter controlResourceSetId in the higher layer parameter SearchSpace). The association (e.g., the linkage) may be one-to-one. The association being one-to-one may comprise the search space set associated with (e.g., linked to) the CORESET not being associated (e.g., linked to) a second CORESET that is different from the CORESET. The one or more CORESETS may comprise the second CORESET.

A wireless device may monitor (e.g., for DCI) PDCCH transmissions/receptions in/via a CORESET of the one or more CORESETS. The monitoring (e.g., for DCI) the PDCCH transmissions/receptions in the CORESET may comprise monitoring, for DCI, PDCCH candidate(s) in PDCCH monitoring occasion(s) for/of (or associated with) a search space set associated with (e.g., linked to) the CORESET. The plurality of search space sets may comprise the search space set. Based on the search space set being associated with (e.g., linked to) the CORESET, the wireless device may monitor, for a DCI, PDCCH candidate(s) in PDCCH monitoring occasion(s) for/of the search space set in the CORESET. Based on the search space set being associated with (or linked to) the CORESET, the wireless device may monitor, for a DCI, PDCCH transmissions/receptions for the search space set in the CORESET.

A wireless device may monitor (e.g., for DCI) downlink control channels in/via a CORESET of the one or more CORESETS. The monitoring (e.g., for the DCI) the downlink control channels in the CORESET may comprise monitoring, for DCI, one or more PDCCH candidates in one or more PDCCH monitoring occasions for/of one or more search space sets associated with the CORESET. The plurality of search space sets may comprise the one or more search space sets. The wireless device may monitor, for the DCI, respective PDCCH candidate(s) of the one or more PDCCH candidates in each PDCCH monitoring occasion of the one or more PDCCH monitoring occasions. The one or more configuration parameters may indicate, for the one or more search space sets, the one or more PDCCH candidates. The one or more configuration parameters may indicate, for each search space set of the one or more search space sets, respective PDCCH candidate(s) of the one or more PDCCH candidates. The wireless device may determine the one or more PDCCH monitoring occasions of the one or more search space sets based on one or more search space set configuration parameters (e.g., IE SearchSpace) of the one or more configuration parameters. The one or more search space set configuration parameters may indicate one or more PDCCH monitoring periodicities (e.g., monitoringSlotPeriodicityAndOffset) for the one or more search space sets. The one or more search space set configuration parameters may indicate a respective PDCCH monitoring periodicity of the one or more PDCCH monitoring periodicities for each search space set of the one or more search space sets. The wireless device may determine the one or more PDCCH monitoring occasions, for example, based on the one or more PDCCH monitoring periodicities. The one or more search space set configuration parameters may indicate PDCCH monitoring symbols (e.g., monitoringSymbolsWithinSlot) for the one or more search space sets. The one or more search space set configuration parameters may indicate respective PDCCH monitoring symbol(s) of the PDCCH monitoring symbols (e.g., monitoringSymbolsWithinSlot) for each search space set of the one or more search space sets. The wireless device may determine the one or more PDCCH monitoring occasions, for example, based on the PDCCH monitoring symbols.

One or more configuration parameters may indicate the one or more CORESET indexes for the plurality of search space sets (e.g., provided by a higher layer parameter controlResourceSetId in the higher layer parameter SearchSpace). Each search space set of the plurality of search space sets may be associated with (or linked to) a respective CORESET of the one or more CORESETS. The one or more configuration parameters may indicate, for the first search space set, the first CORESET index of the first CORESET. The one or more configuration parameters may indicate the first CORESET index of the first CORESET in a CORESET index field (e.g., provided by a higher layer parameter controlResourceSetId in the higher layer parameter SearchSpace) of the first search space set. Based on the one or more configuration parameters indicating the first CORESET index of the first CORESET for the first search space set, the first search space set may be associated with (e.g., linked to) the first CORESET. The one or more configuration parameters may indicate, for the second search space set, the first CORESET index of the first CORESET. The one or more configuration parameters may indicate the first CORESET index of the first CORESET in a CORESET index field (e.g., provided by a higher layer parameter controlResourceSetId in the higher layer parameter SearchSpace) of the second search space set. Based on the one or more configuration parameters indicating the first CORESET index of the first CORESET for the second search space set, the second search space set may be associated with (e.g., linked to) the first CORESET. The one or more configuration parameters may indicate the second CORESET index of the second CORESET for the first search space set. Based on the one or more configuration parameters indicating the second CORESET index of the second CORESET for the first search space set, the first search space set may be associated with (e.g., linked to) the second CORESET. The one or more configuration parameters may indicate the second CORESET index of the second CORESET for the second search space set. Based on the one or more configuration parameters indicating the second CORESET index of the second CORESET for the second search space set, the second search space set may be associated with (e.g., linked to) the second CORESET.

One or more first search space sets of the plurality of search space sets may be common search space (CSS) set(s). The one or more configuration parameters may comprise, for the one or more first search space sets, a search space type parameter (e.g., searchSpaceType) that is equal/set to ‘CSS’ (or ‘common’). The one or more configuration parameters may comprise, for each search space set of the one or more first search space sets, a search space type parameter that is equal/set to ‘CSS’. The one or more configuration parameters may comprise, for each search space set of the one or more first search space sets, a respective search space type parameter that is equal/set to ‘CSS’. The CSS set(s) may comprise Type0-PDCCH CSS set (configured by pdcch-ConfigSIB1 in MIB or by searchSpaceSIB1 in PDCCH-ConfigCommon or by searchSpaceZero in PDCCH-ConfigCommon). The wireless device may monitor, for a DCI format with CRC scrambled by a SI-RNTI, PDCCH transmissions/receptions in the Type0-PDCCH CSS set. The CSS set(s) may comprise Type0A-PDCCH CSS set (configured by searchSpaceOtherSystemInformation in PDCCH-ConfigCommon). The wireless device may monitor, for a DCI format with CRC scrambled by a SI-RNTI, PDCCH transmissions/receptions in the Type0A-PDCCH CSS set. The CSS set(s) may comprise Type1-PDCCH CSS set (configured by ra-SearchSpace in PDCCH-ConfigCommon). The wireless device may monitor, for a DCI format with CRC scrambled by a RA-RNTI, MsgB-RNTI, or a TC-RNTI, PDCCH transmissions/receptions in the Type1-PDCCH CSS set. The CSS set(s) may comprise Type2-PDCCH CSS set (configured by pagingSearchSpace in PDCCH-ConfigCommon). The wireless device may monitor, for a DCI format with CRC scrambled by a P-RNTI, PDCCH transmissions/receptions in the Type2-PDCCH CSS set.

One or more parameters may comprise one or more CSS sets. In at least some examples, the CSS set(s) may not comprise Type3-PDCCH CSS set (configured by SearchSpace in PDCCH-Config with searchSpaceType=common). The wireless device may monitor, for a DCI format with CRC scrambled by an RNTI, PDCCH transmissions/receptions in the Type3-PDCCH CSS set. The RNTI may comprise at least one of: INT-RNTI, SFI-RNTI, TPC-PUSCH-RNTI, TPC-PUCCH-RNTI, TPC-SRS-RNTI, or CI-RNTI. The RNTI may be may comprise at least one of C-RNTI, MCS-C-RNTI, CS-RNTI(s), or PS-RNTI. The RNTI may be C-RNTI, MCS-C-RNTI, CS-RNTI(s), or PS-RNTI (e.g., if the cell is a primary cell).

One or more second search space sets of the plurality of search space sets may be user specific search space (USS) set(s). The one or more configuration parameters may comprise, for the one or more second search space sets, a search space type parameter (e.g., searchSpaceType) that is equal/set to ‘USS’ (or ‘ue-specific)’. The one or more configuration parameters may comprise, for each search space set of the one or more second search space sets, a search space type parameter that is equal/set to ‘USS. The one or more configuration parameters may comprise, for each search space set of the one or more second search space sets, a respective search space type parameter that is equal/set to ‘USS’. A wireless device may monitor, for a DCI format with CRC scrambled by an RNTI, PDCCH transmissions/receptions in a USS set. The USS set(s) may comprise the USS set. The RNTI may be, for example, C-RNTI, MCS-C-RNTI, SP-CSI-RNTI, CS-RNTI(s), SL-RNTI, SL-CS-RNTI, or SL Semi-Persistent Scheduling V-RNTI.

One or more search space sets of the plurality of search space sets may be associated with (or linked to) a CORESET (e.g., Coreset in FIG. 26B) of the one or more CORESETS. The CORESET may be indicated/identified by a CORESET index of the one or more CORESET indexes. The one or more configuration parameters may indicate the CORESET (or the CORESET index of the CORESET) for the one or more search space sets. The one or more configuration parameters may indicate, for the CORESET, the one or more search space sets. The wireless device may monitor, for DCI, one or more PDCCH candidates in the CORESET. The wireless device may monitor, for the DCI, the one or more PDCCH candidates in one or more PDCCH monitoring occasions for/of the one or more search space sets. The one or more PDCCH monitoring occasions may be associated with the one or more search space sets. Each PDCCH monitoring occasion of the one or more PDCCH monitoring occasions may be associated with a respective search space set of the one or more search space sets. Each search space set of the one or more search space sets may be associated with respective PDCCH monitoring occasion(s) of the one or more PDCCH monitoring occasions. The one or more configuration parameters may indicate, for the one or more search space sets, the one or more PDCCH candidates. The one or more configuration parameters may indicate, for each search space set of the one or more search space sets, respective PDCCH candidate(s) of the one or more PDCCH candidates.

The one or more configuration parameters may comprise, for the CORESET (e.g., Coreset in FIG. 26B), a parameter (e.g., ApplyTCI-State-UL-List, ApplyTCI-State-DL-List, ApplyTCI-State-List, Use-Indicated-TCI-State, Use-Indicated-UL-TCI-State, Use-Indicated-DL-TCI-State, Follow-Unified-TCI-State, Follow-Unified-UL-TCI-State, Follow-Unified-DL-TCI-State, and the like) indicating to apply/use common/unified TCI state(s). The parameter may be set to ‘enabled’. For example, in FIG. 26A, the parameter may comprise ‘followUnifiedTCIstate’ in ControlResourceSet.

The parameter may indicate that the CORESET shares the same common/unified TCI state(s) as wireless-device-dedicated reception (e.g., UE-dedicated reception) on PDCCH/PDSCH and for wireless-device-dedicated reception (e.g., UE-dedicated reception) on the one or more CORESETS or subset of the one or more CORESETS in the cell. The parameter may indicate that the CORESET shares the same common/unified TCI state(s) as dynamic-grant/configured-grant based PUSCH transmissions via/of the cell and transmissions via PUCCH resources of the cell.

The one or more configuration parameters may comprise, for the CORESET, the parameter (or the parameter set to ‘enabled’), for example, based on the one or more search space sets associated with the CORESET being CSS set(s). The CSS set(s) may comprise at least one of: Type0-PDCCH CSS set, Type0A-PDCCH CSS set, Type1-PDCCH CSS set, and Type2-PDCCH CSS set. The CSS set(s) may not comprise a Type3-PDCCH CSS set. The one or more configuration parameters may comprise, for the CORESET, the parameter, for example, based on each search space set of the one or more search space sets associated with the CORESET being a CSS set. The one or more configuration parameters may comprise, for the CORESET, the parameter, for example, based on each search space set of the one or more search space sets associated with the CORESET being a CSS set other than a Type3-PDCCH CSS set. The CSS set(s) may comprise the CSS set. The one or more configuration parameters may comprise, for the CORESET, the parameter, for example, based on each search space set of the one or more search space sets associated with the CORESET being a respective CSS set. The one or more configuration parameters may comprise, for the CORESET, the parameter, for example, based on each search space set of the one or more search space sets associated with the CORESET being a respective CSS set other than a Type3-PDCCH CSS set. The one or more configuration parameters may comprise, for the one or more search space sets, a search space type parameter (e.g., searchSpaceType) that is equal/set to ‘CSS’ (or ‘common’). The one or more configuration parameters may comprise, for each search space set of the one or more search space sets, a search space type parameter that is equal/set to ‘CSS’. The one or more configuration parameters may comprise, for each search space set of the one or more search space sets, a respective search space type parameter that is equal/set to ‘CSS’.

The one or more configuration parameters may comprise, for the CORESET, the parameter (or the parameter set to ‘enabled’), for example, based on at least one search space set of the one or more search space sets associated with the CORESET being a CSS set. The one or more configuration parameters may comprise, for the CORESET, the parameter, for example, based on at least one search space set of the one or more search space sets being a CSS set other than a Type3-PDCCH CSS set. The CSS set may comprise/be at least one of: Type0-PDCCH CSS set, Type0A-PDCCH CSS set, Type1-PDCCH CSS set, and Type2-PDCCH CSS set. The CSS set may, for example, not comprise a Type3-PDCCH CSS set. The one or more configuration parameters may comprise, for the at least one search space set, a search space type parameter (e.g., searchSpaceType) that is equal/set to ‘CSS’ (or ‘common’). The one or more configuration parameters may comprise, for each search space set of the at least one search space set, a search space type parameter that is equal/set to ‘CSS’. The one or more configuration parameters may comprise, for each search space set of the at least one search space set, a respective search space type parameter that is equal/set to ‘CSS’.

A wireless device may apply/use the common/unified TCI state(s) for the CORESET, for example, based on the one or more configuration parameters comprising, for the CORESET, the parameter. The wireless device may apply/use the common/unified TCI state(s) for the CORESET, for example, based on the one or more configuration parameters comprising, for the CORESET, the parameter that is set to ‘enabled’.

The one or more configuration parameters may not comprise, for the CORESET (e.g., Coreset in FIG. 26B), the parameter (e.g., ApplyTCI-State-UL-List, ApplyTCI-State-DL-List, ApplyTCI-State-List, Use-Indicated-TCI-State, Use-Indicated-UL-TCI-State, Use-Indicated-DL-TCI-State, Follow-Unified-TCI-State, Follow-Unified-UL-TCI-State, Follow-Unified-DL-TCI-State, and the like) indicating to apply/use a common/unified TCI state. The one or more configuration parameters may comprise, for the CORESET (e.g., Coreset in FIG. 26B), the parameter. The parameter may be set to ‘disabled’ (and/or may not be set to ‘enabled’).

The one or more configuration parameters may not comprise the parameter (or may comprise the parameter not set to ‘enabled’) for the CORESET, for example, based on the one or more search space sets associated with the CORESET being USS set(s) and/or Type3-PDCCH CSS set(s). Each search space set of the one or more search space sets may be a USS set or a Type3-PDCCH CSS set. The one or more configuration parameters may not comprise, for the CORESET, the parameter, for example, based on each search space set of the one or more search space sets associated with the CORESET being an USS set or a Type3-PDCCH CSS set. The USS set(s) may comprise the USS set. The one or more configuration parameters may not comprise, for the CORESET, the parameter, for example, based on each search space set of the one or more search space sets being a respective USS set or a Type3-PDCCH CSS set. The one or more configuration parameters may comprise, for the one or more search space sets, a search space type parameter (e.g., searchSpaceType) that is equal/set to ‘USS’ (or ‘ue-specific’) or ‘CSS’ for Type3-PDCCH CSS set. The one or more configuration parameters may comprise, for each search space set of the one or more search space sets, a search space type parameter that is equal/set to ‘USS’ or ‘CSS’ for Type3-PDCCH CSS set. The one or more configuration parameters may comprise, for each search space set of the one or more search space sets, a respective search space type parameter that is equal/set to ‘USS’ or ‘CSS’ for Type3-PDCCH CSS set.

The one or more configuration parameters may not comprise the parameter (or may comprise the parameter not set to ‘enabled’) for the CORESET, for example, based on at least one search space set of the one or more search space sets associated with the CORESET being a USS set or a Type3-PDCCH CSS set. Each search space set of the at least one search space set may be a USS set or a Type3-PDCCH CSS set. The one or more configuration parameters may not comprise, for the CORESET, the parameter, for example, based on each search space set of the at least one search space set being a USS set or a Type3-PDCCH CSS set. The one or more configuration parameters may not comprise, for the CORESET, the parameter, for example, based on each search space set of the at least one search space set being a respective USS set or a Type3-PDCCH CSS set. The one or more configuration parameters may comprise, for the at least one search space set, a search space type parameter (e.g., searchSpaceType) that is equal/set to ‘USS’ (or ‘ue-specific’) or ‘CSS’ for Type3-PDCCH CSS set. The one or more configuration parameters may comprise, for each search space set of the at least one search space set, a search space type parameter that is equal/set to ‘USS’ or ‘CSS’ for Type3-PDCCH CSS set. The one or more configuration parameters may comprise, for each search space set of the at least one search space set, a respective search space type parameter that is equal/set to ‘USS’ or ‘CSS’ for Type3-PDCCH CSS set.

A wireless device may apply/use the common/unified TCI state(s) for the CORESET, for example, based on the one or more search space sets associated with the CORESET being USS set(s) and/or Type3-PDCCH CSS set(s). The wireless device may apply/use the common/unified TCI state(s) for the CORESET, for example, based on each search space set of the one or more search space sets associated with the CORESET being a USS set or a Type3-PDCCH CSS set. The wireless device may apply/use the common/unified TCI state(s) for the CORESET, for example, based on each search space set of the one or more search space sets being a respective USS set or a Type3-PDCCH CSS set. The wireless device may apply/use the common/unified TCI state(s) for the CORESET, for example, based on at least one search space set of the one or more search space sets associated with the CORESET being a USS set or a Type3-PDCCH CSS set.

A wireless device may monitor, via/in the CORESET (e.g., Coreset in FIG. 26B), PDCCH transmission(s)/reception(s). The wireless device may monitor, via/in the CORESET (e.g., Coreset in FIG. 26B), downlink control channels. The wireless device may monitor, for a first DCI, the PDCCH transmission(s) via the CORESET. The wireless device may monitor, via/in the CORESET, the PDCCH transmission(s), for example, based on at least one TCI state of the at least two TCI states. The wireless device may receive, via/in the CORESET, the first DCI. The wireless device may receive, via/in the CORESET, a PDCCH transmission/reception with/carrying the first DCI. The PDCCH transmission(s)/reception(s) may comprise the PDCCH transmission/reception. The wireless device may receive, via/in the CORESET, the first DCI, for example, based on the at least one TCI state of the at least two TCI states. The at least one TCI state may be, for example, at least one reference/default TCI state.

A wireless device may apply/use the at least one TCI state for the CORESET. The wireless device may apply/use the at least one TCI state for the CORESET, for example, based on the receiving the DCI (e.g., at time T₂ in FIG. 17). Applying/using the at least one TCI state for the CORESET may comprise monitoring, via the CORESET, the PDCCH transmission(s)/reception(s) based on the at least one TCI state. Applying/using the at least one TCI state for the CORESET may comprise receiving, via the CORESET, the first DCI based on the at least one TCI state.

A wireless device may monitor, via/in the CORESET, the PDCCH transmission(s) based on the at least one TCI state, for example, based on (e.g., in response to) the one or more configuration parameters comprising, for the CORESET, the parameter. The wireless device may monitor, via/in the CORESET, the PDCCH transmission(s) based on the at least one TCI state, for example, based on (e.g., in response to) the one or more configuration parameters comprising, for the CORESET, the parameter set to ‘enabled’.

A wireless device may receive, via/in the CORESET, the first DCI based on the at least one TCI state, for example, based on (e.g., in response to) the one or more configuration parameters comprising, for the CORESET, the parameter. The wireless device may receive, via/in the CORESET, the first DCI based on the at least one TCI state, for example, based on (e.g., in response to) the one or more configuration parameters comprising, for the CORESET, the parameter set to ‘enabled’.

A wireless device may monitor, via/in the CORESET, the PDCCH transmission(s) based on the at least one TCI state, for example, based on (e.g., in response to) the one or more search space sets associated with the CORESET being USS set(s) and/or Type3-PDCCH CSS set(s). The wireless device may monitor, via/in the CORESET, the PDCCH transmission(s) based on the at least one TCI state, for example, based on (e.g., in response to) each search space set of the one or more search space sets associated with the CORESET being a USS set or a Type3-PDCCH CSS set. The wireless device may monitor, via/in the CORESET, the PDCCH transmission(s) based on the at least one TCI state, for example, based on (e.g., in response to) at least one search space set of the one or more search space sets associated with the CORESET being a USS set or a Type3-PDCCH CSS set.

A wireless device may receive, via/in the CORESET, the first DCI based on the at least one TCI state, for example, based on (e.g., in response to) the one or more search space sets associated with the CORESET being USS set(s) and/or Type3-PDCCH CSS set(s). The wireless device may receive, via/in the CORESET, the first DCI based on the at least one TCI state, for example, based on (e.g., in response to) each search space set of the one or more search space sets associated with the CORESET being a USS set or a Type3-PDCCH CSS set. The wireless device may receive, via/in the CORESET, the first DCI based on the at least one TCI state, for example, based on (e.g., in response to) at least one search space set of the one or more search space sets associated with the CORESET being a USS set or a Type3-PDCCH CSS set.

A wireless device may select/determine, for monitoring of/via/in the CORESET (or for monitoring the PDCCH transmission(s) via the CORESET), the at least one TCI state among the at least two TCI states. The wireless device may select/determine, for monitoring of the CORESET, the at least one TCI state as reference/default TCI state(s). The wireless device may select/determine the at least one TCI state among the at least two TCI states, for example, as default/reference TCI state(s).

A wireless device may select/determine, for reception of the first DCI via/in the CORESET, the at least one TCI state among the at least two TCI states. The wireless device may select/determine, for reception of the first DCI via the CORESET, the at least one TCI state as reference/default TCI state(s). The wireless device may select/determine the at least one TCI state among the at least two TCI states, for example, as default/reference TCI state(s).

A wireless device may select/determine the at least one TCI state among the at least two TCI states, for example, based on the one or more configuration parameters comprising, for the CORESET, the parameter. The wireless device may select/determine the at least one TCI state among the at least two TCI states, for example, based on the one or more configuration parameters comprising, for the CORESET, the parameter that is set to ‘enabled’. The wireless device may select/determine the at least one TCI state among the at least two TCI states, for example, based on the one or more search space sets associated with the CORESET being USS set(s) and/or Type3-PDCCH CSS set(s). The wireless device may select/determine the at least one TCI state among the at least two TCI states, for example, based on each search space set of the one or more search space sets associated with the CORESET being a USS set or a Type3-PDCCH CSS set. The wireless device may select/determine the at least one TCI state among the at least two TCI states, for example, based on at least one search space set of the one or more search space sets associated with the CORESET being a USS set or a Type3-PDCCH CSS set.

A wireless device may monitor, via the CORESET, the PDCCH transmission(s)/reception(s) with at least one spatial domain receiving/reception filter/beam that is determined based on the at least one TCI state. The wireless device may monitor, via the CORESET, the PDCCH transmission(s) with a respective spatial domain receiving/reception filter/beam, of the at least one spatial domain receiving/reception filter/beam, that is determined based on each TCI state of the at least one TCI state. The wireless device may monitor, via the CORESET, the PDCCH transmission(s) with a respective spatial domain receiving/reception filter/beam, of the at least one spatial domain receiving/reception filter/beam, that is determined based on a reference signal indicated by each TCI state of the at least one TCI state.

A wireless device may receive, via the CORESET, the first DCI with/using the at least one spatial domain receiving/reception filter/beam that is determined based on the at least one TCI state. The wireless device may receive, via the CORESET, the first DCI with a respective spatial domain receiving/reception filter/beam, of the at least one spatial domain receiving/reception filter/beam, that is determined based on each TCI state of the at least one TCI state. The wireless device may receive, via the CORESET, the first DCI with a respective spatial domain receiving/reception filter/beam, of the at least one spatial domain receiving/reception filter/beam, that is determined based on a reference signal indicated by each TCI state of the at least one TCI state.

A wireless device may determine each spatial domain receiving/reception filter/beam of the at least one spatial domain receiving/reception filter/beam, for example, based on a respective TCI state of the at least one TCI state. The wireless device may determine each spatial domain receiving/reception filter/beam of the at least one spatial domain receiving/reception filter/beam, for example, based on a reference signal indicated by a respective TCI state of the at least one TCI state.

DM-RS antenna port(s) of the PDCCH transmission(s)/reception(s) via the CORESET may be quasi co-located with at least one reference signal indicated by the at least one TCI state. The DM-RS antenna port(s) of the PDCCH transmission(s)/reception(s) may be quasi co-located with the at least one reference signal with respect to at least one quasi co-location type (e.g., QCL Type A, QCL Type B, QCL Type C, QCL Type D, QCL Type E, and the like) indicated by the at least one TCI state. Each reference signal of the at least one reference signal may be indicated by a respective TCI state of the at least one TCI state. Each quasi co-location type of the at least one quasi co-location type may be indicated by a respective TCI state of the at least one TCI state. The DM-RS antenna port(s) of the PDCCH transmission(s)/reception(s) via the CORESET may be quasi co-located with a respective reference signal, of the at least one reference signal, indicated by each TCI state of the at least one TCI state.

DM-RS antenna port(s) of the PDCCH transmission/reception with/carrying the first DCI via the CORESET may be quasi co-located with at least one reference signal indicated by the at least one TCI state. The DM-RS antenna port(s) of the PDCCH transmission/reception with/carrying the first DCI may be quasi co-located with the at least one reference signal with respect to at least one quasi co-location type (e.g., QCL Type A, QCL Type B, QCL Type C, QCL Type D, QCL Type E, and the like) indicated by the at least one TCI state. Each reference signal of the at least one reference signal may be indicated by a respective TCI state of the at least one TCI state. Each quasi co-location type of the at least one quasi co-location type may be indicated by a respective TCI state of the at least one TCI state. The DM-RS antenna port(s) of the PDCCH transmission/reception with/carrying the first DCI via the CORESET may be quasi co-located with a respective reference signal, of the at least one reference signal, indicated by each TCI state of the at least one TCI state.

The at least one TCI state may be the first TCI state (e.g., TCI state 26). The first TCI state may indicate a first reference signal (e.g., CSI-RS, SS/PBCH block). The first TCI state may indicate a first quasi co-location type (e.g., QCL Type A/B/C/D/E, and so on). The wireless device may monitor the PDCCH transmission(s)/reception(s) in/via the CORESET based on the first TCI state. The wireless device may receive, via the CORESET, the first DCI based on the first TCI state. The wireless device may monitor, via the CORESET, the PDCCH transmission(s)/reception(s) with/using a first spatial domain receiving/reception filter/beam that is determined based on the first reference signal. The wireless device may receive, via the CORESET, the first DCI with/using a first spatial domain receiving/reception filter/beam that is determined based on the first reference signal. DM-RS antenna port(s) of the PDCCH transmission(s)/reception(s) via the CORESET may be quasi co-located with the first reference signal. The DM-RS antenna port(s) of the PDCCH transmission(s)/reception(s) via the CORESET may be quasi co-located with the first reference signal with respect to the first quasi co-location type. DM-RS antenna port(s) of each PDCCH transmission/reception of the PDCCH transmission(s)/reception(s) may be quasi co-located with the first reference signal. The DM-RS antenna port(s) of each PDCCH transmission/reception of the PDCCH transmission(s)/reception(s) may be quasi co-located with the first reference signal with respect to the first quasi co-location type. DM-RS antenna port(s) of the PDCCH transmission/reception carrying/with the first DCI via the CORESET may be quasi co-located with the first reference signal. The DM-RS antenna port(s) of the PDCCH transmission/reception may be quasi co-located with the first reference signal with respect to the first quasi co-location type.

The at least one TCI state may be the second TCI state (e.g., TCI state 61). The second TCI state may indicate a second reference signal (e.g., CSI-RS, SS/PBCH block). The second TCI state may indicate a second quasi co-location type (e.g., QCL Type A/B/C/D/E, and so on). The wireless device may monitor the PDCCH transmission(s)/reception(s) in/via the CORESET based on the second TCI state. The wireless device may receive, via the CORESET, the first DCI based on the second TCI state. The wireless device may monitor, via the CORESET, the PDCCH transmission(s)/reception(s) with/using a second spatial domain receiving/reception filter/beam that is determined based on the second reference signal. The wireless device may receive, via the CORESET, the first DCI with/using a second spatial domain receiving/reception filter/beam that is determined based on the second reference signal. DM-RS antenna port(s) of the PDCCH transmission(s)/reception(s) via the CORESET may be quasi co-located with the second reference signal. The DM-RS antenna port(s) of the PDCCH transmission(s)/reception(s) via the CORESET may be quasi co-located with the second reference signal with respect to the second quasi co-location type. DM-RS antenna port(s) of each PDCCH transmission/reception of the PDCCH transmission(s)/reception(s) may be quasi co-located with the second reference signal. The DM-RS antenna port(s) of each PDCCH transmission/reception of the PDCCH transmission(s)/reception(s) may be quasi co-located with the second reference signal with respect to the second quasi co-location type. DM-RS antenna port(s) of the PDCCH transmission/reception carrying/with the first DCI via the CORESET may be quasi co-located with the second reference signal. The DM-RS antenna port(s) of the PDCCH transmission/reception may be quasi co-located with the second reference signal with respect to the second quasi co-location type.

The at least one TCI state may be the first TCI state (e.g., TCI state 26) and the second TCI state (e.g., TCI state 61). The first TCI state may indicate a first reference signal (e.g., CSI-RS, SS/PBCH block). The first TCI state may indicate a first quasi co-location type (e.g., QCL Type A/B/C/D/E, and so on). The second TCI state may indicate a second reference signal (e.g., CSI-RS, SS/PBCH block). The second TCI state may indicate a second quasi co-location type (e.g., QCL Type A/B/C/D/E, and so on). The wireless device may monitor the PDCCH transmission(s)/reception(s) in/via the CORESET based on the first TCI state and the second TCI state. The wireless device may receive, via the CORESET, the first DCI based on the first TCI state and the second TCI state.

A wireless device may monitor, via the CORESET, the PDCCH transmission(s)/reception(s) with/using a first spatial domain receiving/reception filter/beam that is determined based on the first reference signal. The wireless device may monitor, via the CORESET, the PDCCH transmission(s)/reception(s) with/using a second spatial domain receiving/reception filter/beam that is determined based on the second reference signal. The wireless device may monitor, via the CORESET, the PDCCH transmission(s)/reception(s) with/using the first spatial domain receiving/reception filter/beam and the second spatial domain receiving/reception filter/beam. The wireless device may receive, via the CORESET, the first DCI with/using a first spatial domain receiving/reception filter/beam that is determined based on the first reference signal. The wireless device may receive, via the CORESET, the first DCI with/using a second spatial domain receiving/reception filter/beam that is determined based on the second reference signal. The wireless device may receive, via the CORESET, the first DCI with/using the first spatial domain receiving/reception filter/beam and the second spatial domain receiving/reception filter/beam.

DM-RS antenna port(s) of the PDCCH transmission(s)/reception(s) via the CORESET may be quasi co-located with the first reference signal. The DM-RS antenna port(s) of the PDCCH transmission(s)/reception(s) via the CORESET may be quasi co-located with the second reference signal. The DM-RS antenna port(s) of the PDCCH transmission(s)/reception(s) via the CORESET may be quasi co-located with the first reference signal and the second reference signal. The DM-RS antenna port(s) of the PDCCH transmission(s)/reception(s) via the CORESET may be quasi co-located with the first reference signal with respect to the first quasi co-location type. The DM-RS antenna port(s) of the PDCCH transmission(s)/reception(s) via the CORESET may be quasi co-located with the second reference signal with respect to the second quasi co-location type. The DM-RS antenna port(s) of the PDCCH transmission(s)/reception(s) via the CORESET may be quasi co-located with the first reference signal with respect to the first quasi co-location type and with the second reference signal with respect to the second quasi co-location type.

DM-RS antenna port(s) of each PDCCH transmission/reception of the PDCCH transmission(s)/reception(s) may be quasi co-located with the first reference signal. The DM-RS antenna port(s) of each PDCCH transmission/reception of the PDCCH transmission(s)/reception(s) may be quasi co-located with the second reference signal. The DM-RS antenna port(s) of each PDCCH transmission/reception of the PDCCH transmission(s)/reception(s) may be quasi co-located with the first reference signal and the second reference signal. The DM-RS antenna port(s) of each PDCCH transmission/reception of the PDCCH transmission(s)/reception(s) may be quasi co-located with the first reference signal with respect to the first quasi co-location type. The DM-RS antenna port(s) of each PDCCH transmission/reception of the PDCCH transmission(s)/reception(s) may be quasi co-located with the second reference signal with respect to the second quasi co-location type. The DM-RS antenna port(s) of each PDCCH transmission/reception of the PDCCH transmission(s)/reception(s) may be quasi co-located with the first reference signal with respect to the first quasi co-location type and with the second reference signal with respect to the second quasi co-location type.

DM-RS antenna port(s) of the PDCCH transmission/reception carrying/with the first DCI via the CORESET may be quasi co-located with the first reference signal. The DM-RS antenna port(s) of the PDCCH transmission/reception may be quasi co-located with the first reference signal with respect to the first quasi co-location type. The DM-RS antenna port(s) of the PDCCH transmission/reception carrying/with the first DCI via the CORESET may be quasi co-located with the second reference signal. The DM-RS antenna port(s) of the PDCCH transmission/reception may be quasi co-located with the second reference signal with respect to the second quasi co-location type. The DM-RS antenna port(s) of the PDCCH transmission/reception carrying/with the first DCI via the CORESET may be quasi co-located with the first reference signal and the second reference signal. The DM-RS antenna port(s) of the PDCCH transmission/reception may be quasi co-located with the first reference signal with respect to the first quasi co-location type and with the second reference signal with respect to the second quasi co-location type.

The at least one TCI state may not be associated with a TRP. The one or more configuration parameters may not indicate, for the at least one TCI state, a field (e.g., Unified/Common/Joint TCI state index field, TRP index field, CORESET pool index field, and the like) indicating an association between the at least one TCI state and a TRP. The at least one TCI state may not be associated explicitly or implicitly with a TRP. This lack of association may reduce signaling overhead. The one or more configuration parameters may not need to comprise/indicate an association between the at least one TCI state and a TRP (or a TRP index, CORESET pool index, Unified/Common/Joint TCI state index field, and the like). This may reduce RRC message size (or the size of the configuration parameters).

Each TCI state of the at least one TCI state may not be associated with a TRP. The one or more configuration parameters may not indicate, for each TCI state of the at least one TCI state, a field (e.g., Unified/Common/Joint TCI state index field, TRP index field, CORESET pool index field, and the like) indicating an association between a TCI state and a TRP. Each TCI state of the at least one TCI state may not be associated explicitly or implicitly with a TRP. This may reduce signaling overhead. The one or more configuration parameters may not need to comprise/indicate an association between each TCI state of the at least one TCI state and a TRP (or a TRP index, CORESET pool index, Unified/Common/Joint TCI state index field, and the like). This may reduce RRC message size (or the size of the configuration parameters).

The at least one TCI state may be a first/starting/earliest TCI state among the at least two TCI states. The at least one TCI state may be the first/starting/earliest TCI state in a vector/set/list of the at least two TCI states. The at least one TCI state may be a first/starting/earliest element in a vector/set/list of the at least two TCI states. The at least one TCI state may be a first/starting/earliest TCI state among the at least two TCI states in (or indicated by) the TCI codepoint. A position/location of the at least one TCI state (or the first/starting/earliest TCI state) may be earliest/highest/lowest in the vector of the at least two TCI states. The at least one TCI state (or the first/starting/earliest TCI state) may occur first in a vector/set/list of the at least two TCI states. The at least one TCI state is TCI state 26, for example, if the vector of the at least two TCI states is equal to [TCI state 26, TCI state 61]. The at least one TCI state is TCI state 2, for example, if the vector of the at least two TCI states is equal to [TCI state 2, TCI state 1].

The at least one TCI state may be the first TCI state (e.g., TCI state 26 in FIG. 17). The at least one TCI state may be the first TCI state, for example, based on the first TCI state being the first/starting/earliest TCI state in the vector/set/list of the at least two TCI states.

A wireless device may monitor, via the CORESET, the PDCCH transmission(s)/reception(s) based on the at least one TCI state (or the first/starting/earliest TCI state), for example, based on (e.g., in response to) the at least one TCI state (or the first/starting/earliest TCI state) being the first/starting/earliest TCI state in the vector/set/list of the at least two TCI states. The wireless device may receive, via the CORESET, the first DCI based on the at least one TCI state (or the first/starting/earliest TCI state), for example, based on (e.g., in response to) the at least one TCI state (or the first/starting/earliest TCI state) being the first/starting/earliest TCI state in the vector/set/list of the at least two TCI states.

A wireless device may select/determine, for monitoring of the CORESET (or for monitoring PDCCH transmission(s) via the CORESET), the at least one TCI state (or the first/starting/earliest TCI state) among the at least two TCI states, for example, based on the at least one TCI state being the first/starting/earliest TCI state in the vector/set/list of the at least two TCI states. The wireless device may select/determine, for reception of the first DCI via the CORESET, the at least one TCI state among the at least two TCI states, for example, based on the at least one TCI state being the first/starting/earliest TCI state in the vector/set/list of the at least two TCI states.

A TCI state index of the first/starting/earliest TCI state may be lowest (or highest) among at least two TCI state indexes of the at least two TCI states. The first/starting/earliest TCI state may be identified by/with the TCI state index that is lowest (or highest) among the at least two TCI state indexes of the at least two TCI states. The plurality of TCI state indexes may comprise the at least two TCI state indexes. The at least two TCI state indexes may comprise the TCI state index of the first/starting/earliest TCI state. Each TCI state of the at least two TCI states may be indicated/identified by a respective TCI state index of the at least two TCI state indexes. For example, the first/starting/earliest TCI state may be the first TCI state (e.g., TCI state 26) based on a first TCI state index of the first TCI state being lower (or higher) than a second TCI state index of the second TCI state. For example, the first/starting/earliest TCI state may be the second TCI state (e.g., TCI state 61) based on a second TCI state index of the second TCI state being lower (or higher) than a first TCI state index of the first TCI state. The at least two TCI state indexes may comprise the first TCI state index and the second TCI state index.

A wireless device may monitor, via the CORESET, the PDCCH transmission(s)/reception(s) based on the at least one TCI state (or the first/starting/earliest TCI state), for example, based on (e.g., in response to) the TCI state index of the first/starting/earliest TCI state being lowest (or highest) among the at least two TCI state indexes of the at least two TCI states. The wireless device may receive, via the CORESET, the first DCI based on the at least one TCI state (or the first/starting/earliest TCI state), for example, based on (e.g., in response to) the TCI state index of the first/starting/earliest TCI state being lowest (or highest) among the at least two TCI state indexes of the at least two TCI states.

A wireless device may select/determine, for monitoring of the CORESET (or for monitoring PDCCH transmission(s) via the CORESET), the at least one TCI state (or the first/starting/earliest TCI state) among the at least two TCI states, for example, based on the TCI state index of the first/starting/earliest TCI state being lowest (or highest) among the at least two TCI state indexes of the at least two TCI states. The wireless device may select/determine, for reception of the first DCI via the CORESET, the at least one TCI state among the at least two TCI states, for example, based on the TCI state index of the first/starting/earliest TCI state being lowest (or highest) among the at least two TCI state indexes of the at least two TCI states.

Using the first/starting/earliest TCI state as a default/reference TCI state may reduce complexity of the wireless device. This operation may reduce configuration message size (e.g., no need to indicate an association between the CORESET and the at least one TCI state).

Using the first/starting/earliest TCI state as a default/reference TCI state may reduce flexibility. A wireless device may not use, for monitoring of the CORESET, the second/second starting/second earliest/last/latest TCI state in the vector/set/list of the at least two TCI states.

The one or more configuration parameters may not indicate an SFN scheme/mode. The one or more configuration parameters may not comprise an SFN parameter (e.g., sfnSchemePdcch, sfnSchemePdsch) indicating an SFN scheme. The one or more configuration parameters may not indicate an SFN scheme, for example, for downlink control channels (e.g., PDCCH). The one or more configuration parameters may not comprise an SFN parameter, for example, for the downlink BWP of the cell. The one or more configuration parameters may not indicate an SFN scheme, for example, for the downlink BWP.

The at least one TCI state may be the first TCI state (e.g., TCI state 26 in FIG. 17). The at least one TCI state may be the first TCI state, for example, based on the one or more configuration parameters not indicating an SFN scheme/mode.

The at least one TCI state may be the first/starting/earliest TCI state. The at least one TCI state may be the first/starting/earliest TCI state, for example, based on the one or more configuration parameters not indicating an SFN scheme/mode.

A wireless device may monitor (e.g., via the CORESET) the PDCCH transmission(s)/reception(s) based on the first/starting/earliest TCI state, for example, based on (e.g., in response to) the one or more configuration parameters not indicating an SFN scheme/mode. The wireless device may receive, via the CORESET, the first DCI based on the first/starting/earliest TCI state, for example, based on (e.g., in response to) the one or more configuration parameters not indicating an SFN scheme/mode.

A wireless device may select/determine (e.g., for monitoring of the CORESET) the first/starting/earliest TCI state, for example, based on the one or more configuration parameters not indicating an SFN scheme/mode. The wireless device may select/determine, for reception of the first DCI via the CORESET, the first/starting/earliest TCI state among the at least two TCI states, for example, based on the one or more configuration parameters not indicating an SFN scheme/mode.

A wireless device may monitor (e.g., via the CORESET) the PDCCH transmission(s)/reception(s) based on the first/starting/earliest TCI state, for example, based on (e.g., in response to) the one or more search space sets associated with the CORESET being CSS set(s). The wireless device may receive, via the CORESET, the first DCI based on the first/starting/earliest TCI state, for example, based on (e.g., in response to) the one or more search space sets associated with the CORESET being CSS set(s).

A wireless device may monitor (e.g., via the CORESET) the PDCCH transmission(s)/reception(s) based on the first/starting/earliest TCI state, for example, based on (e.g., in response to) each search space set of the one or more search space sets associated with the CORESET being a CSS set. The wireless device may receive, via the CORESET, the first DCI based on the first/starting/earliest TCI state, for example, based on (e.g., in response to) each search space set of the one or more search space sets associated with the CORESET being a CSS set.

A wireless device may monitor (e.g., via the CORESET) the PDCCH transmission(s)/reception(s) based on the first/starting/earliest TCI state, for example, based on (e.g., in response to) each search space set of the one or more search space sets associated with the CORESET being a CSS set other than a Type3-PDCCH CSS set. The wireless device may receive, via the CORESET, the first DCI based on the first/starting/earliest TCI state, for example, based on (e.g., in response to) each search space set of the one or more search space sets associated with the CORESET being a CSS set other than a Type3-PDCCH CSS set.

A wireless device may monitor (e.g., via the CORESET) the PDCCH transmission(s)/reception(s) based on the first/starting/earliest TCI state, for example, based on (e.g., in response to) at least one search space set of the one or more search space sets associated with the CORESET being a CSS set. The wireless device may receive, via the CORESET, the first DCI based on the first/starting/earliest TCI state, for example, based on (e.g., in response to) at least one search space set of the one or more search space sets associated with the CORESET being a CSS set.

A wireless device may monitor (e.g., via the CORESET) the PDCCH transmission(s)/reception(s) based on the first/starting/earliest TCI state, for example, based on (e.g., in response to) at least one search space set of the one or more search space sets being a CSS set other than a Type3-PDCCH CSS set. The wireless device may receive, via the CORESET, the first DCI based on the first/starting/earliest TCI state, for example, based on (e.g., in response to) at least one search space set of the one or more search space sets being a CSS set other than a Type3-PDCCH CSS set.

A wireless device may select/determine (e.g., for monitoring of the CORESET) the first/starting/earliest TCI state, for example, based on the one or more search space sets associated with the CORESET being CSS set(s). The wireless device may select/determine, for reception of the first DCI via the CORESET, the first/starting/earliest TCI state among the at least two TCI states, for example, based on the one or more search space sets associated with the CORESET being CSS set(s).

The wireless device may select/determine (e.g., for monitoring of the CORESET) the first/starting/earliest TCI state, for example, based on to each search space set of the one or more search space sets associated with the CORESET being a CSS set. The wireless device may select/determine, for reception of the first DCI via the CORESET, the first/starting/earliest TCI state among the at least two TCI states, for example, based on to each search space set of the one or more search space sets associated with the CORESET being a CSS set.

The wireless device may select/determine (e.g., for monitoring of the CORESET) the first/starting/earliest TCI state, for example, based on each search space set of the one or more search space sets associated with the CORESET being a CSS set other than a Type3-PDCCH CSS set. The wireless device may select/determine, for reception of the first DCI via the CORESET, the first/starting/earliest TCI state among the at least two TCI states, for example, based on each search space set of the one or more search space sets associated with the CORESET being a CSS set other than a Type3-PDCCH CSS set.

A wireless device may select/determine (e.g., for monitoring of the CORESET) the first/starting/earliest TCI state, for example, based on at least one search space set of the one or more search space sets associated with the CORESET being a CSS set. The wireless device may select/determine, for reception of the first DCI via the CORESET, the first/starting/earliest TCI state among the at least two TCI states, for example, based on at least one search space set of the one or more search space sets associated with the CORESET being a CSS set.

A wireless device may select/determine (e.g., for monitoring of the CORESET) the first/starting/earliest TCI state, for example, based on at least one search space set of the one or more search space sets being a CSS set other than a Type3-PDCCH CSS set. The wireless device may select/determine, for reception of the first DCI via the CORESET, the first/starting/earliest TCI state among the at least two TCI states, for example, based on at least one search space set of the one or more search space sets being a CSS set other than a Type3-PDCCH CSS set.

The one or more configuration parameters may indicate an SFN scheme/mode. The one or more configuration parameters may comprise an SFN parameter (e.g., sfnSchemePdcch, sfnSchemePdsch) indicating the SFN scheme. The one or more configuration parameters may indicate the SFN scheme, for example, for downlink control channels (e.g., PDCCH). The one or more configuration parameters may indicate the SFN scheme, for example, for downlink shared channels (e.g., PDSCH). The one or more configuration parameters may comprise the SFN parameter, for example, for the downlink BWP of the cell. The one or more configuration parameters may indicate the SFN scheme, for example, for the downlink BWP. The SFN parameter may indicate scheme 1 (sfnSchemeA) or TRP-based pre-compensation (sfnSchemeB).

The at least one TCI state may be the at least two TCI states, for example, based on the one or more configuration parameters indicating the SFN scheme. The wireless device may monitor, via the CORESET, the PDCCH transmission(s)/reception(s) based on the at least two TCI states, for example, based on (e.g., in response to) the one or more configuration parameters indicating the SFN scheme. The wireless device may receive, via the CORESET, the first DCI based on the at least two TCI states, for example, based on (e.g., in response to) the one or more configuration parameters indicating the SFN scheme.

A wireless device may select/determine (e.g., for monitoring of the CORESET) the at least two TCI states, for example, based on the one or more configuration parameters indicating the SFN scheme. The wireless device may select/determine, for reception of the first DCI via the CORESET, the at least two TCI states, for example, based on the one or more configuration parameters indicating the SFN scheme.

The at least one TCI state may be the at least two TCI states, for example, based on the one or more search space sets associated with the CORESET being USS set(s) and/or Type3-PDCCH CSS set(s). The wireless device may monitor, via the CORESET, the PDCCH transmission(s)/reception(s) based on the at least two TCI states, for example, based on (e.g., in response to) the one or more search space sets associated with the CORESET being USS set(s) and/or Type3-PDCCH CSS set(s). The wireless device may receive, via the CORESET, the first DCI based on the at least two TCI states, for example, based on (e.g., in response to) the one or more search space sets associated with the CORESET being USS set(s) and/or Type3-PDCCH CSS set(s).

The at least one TCI state may be the at least two TCI states, for example, based on each search space set of the one or more search space sets associated with the CORESET being a USS set or a Type3-PDCCH CSS set. The wireless device may monitor, via the CORESET, the PDCCH transmission(s)/reception(s) based on the at least two TCI states, for example, based on (e.g., in response to) each search space set of the one or more search space sets associated with the CORESET being a USS set or a Type3-PDCCH CSS set. The wireless device may receive, via the CORESET, the first DCI based on the at least two TCI states, for example, based on (e.g., in response to) each search space set of the one or more search space sets associated with the CORESET being a USS set or a Type3-PDCCH CSS set.

The at least one TCI state may be the at least two TCI states, for example, based on at least one search space set of the one or more search space sets associated with the CORESET being a USS set or a Type3-PDCCH CSS set. The wireless device may monitor, via the CORESET, the PDCCH transmission(s)/reception(s) based on the at least two TCI states, for example, based on (e.g., in response to) at least one search space set of the one or more search space sets associated with the CORESET being a USS set or a Type3-PDCCH CSS set. The wireless device may receive, via the CORESET, the first DCI based on the at least two TCI states, for example, based on (e.g., in response to) at least one search space set of the one or more search space sets associated with the CORESET being a USS set or a Type3-PDCCH CSS set.

The one or more configuration parameters may indicate, for the CORESET, a field (e.g., Unified/Common/Joint TCI state index field, TRP index field, CORESET pool index field, and the like) indicating the at least one TCI state. For example, in FIG. 26A, the field is ‘Unified TCI state ID’ in ControlResourceSet. For example, in FIG. 26B, the field is ‘Unified TCI state ID’ in Coreset. A value of the field (e.g., Unified TCI state ID in FIG. 26B) may indicate the at least one TCI state. The field (or the value of the field) may indicate whether to apply/use the first TCI state and/or the second TCI state for the CORESET.

A wireless device may apply/use the at least one TCI state for the CORESET, for example, based on the one or more configuration parameters indicating, for CORESET, the field. The wireless device may apply/use the at least one TCI state for the CORESET, for example, based on the one or more configuration parameters indicating, for the CORESET, the field with the value indicating the at least one TCI state. Applying/using the at least one TCI state for the CORESET may comprise monitoring, via the CORESET, the PDCCH transmission(s)/reception(s) based on the at least one TCI state.

A wireless device may monitor (e.g., via the CORESET) the PDCCH transmission(s)/reception(s) based on the at least one TCI state, for example, based on (e.g., in response to) the one or more configuration parameters indicating, for the CORESET, the field indicating the at least one TCI state. The wireless device may monitor, via the CORESET, the PDCCH transmission(s)/reception(s) based on the at least one TCI state, for example, based on (e.g., in response to) the one or more configuration parameters indicating, for the CORESET, the field with the value indicating the at least one TCI state.

A wireless device may receive (e.g., via the CORESET) the first DCI based on the at least one TCI state, for example, based on (e.g., in response to) the one or more configuration parameters indicating, for the CORESET, the field indicating the at least one TCI state. The wireless device may receive, via the CORESET, the first DCI based on the at least one TCI state, for example, based on (e.g., in response to) the one or more configuration parameters indicating, for the CORESET, the field with the value indicating the at least one TCI state.

A wireless device may select/determine (e.g., for monitoring of the CORESET) the at least one TCI state among the at least two TCI states, for example, based on the one or more configuration parameters indicating, for the CORESET, the field indicating the at least one TCI state. The wireless device may select/determine the at least one TCI state among the at least two TCI states, for example, based on the one or more configuration parameters indicating, for the CORESET, the field with the value indicating the at least one TCI state.

A wireless device may select/determine (e.g., for reception of the first DCI via the CORESET) the at least one TCI state among the at least two TCI states, for example, based on the one or more configuration parameters indicating, for the CORESET, the field indicating the at least one TCI state. The wireless device may select/determine the at least one TCI state among the at least two TCI states, for example, based on the one or more configuration parameters indicating, for the CORESET, the field with the value indicating the at least one TCI state.

The one or more configuration parameters may indicate, for each CORESET of the one or more CORESETS, a respective value of/for the field. The one or more configuration parameters may indicate, for a first CORESET of the one or more CORESETS, a first value of/for the field. The one or more configuration parameters may indicate, for a second CORESET of the one or more CORESETS, a second value of/for the field. The one or more configuration parameters may indicate, for a third CORESET of the one or more CORESETS, the second value of/for the field. The one or more configuration parameters may indicate, for a fourth CORESET of the one or more CORESETS, a third value of/for the field. The second CORESET and the third CORESET may share the same unified/common TCI state(s), for example, based on the one or more configuration parameters indicating the same value of the field for the second CORESET and the third CORESET.

The field (e.g., Unified/Common/Joint TCI state index field, TRP index field, CORESET pool index field, and the like) may be, for example, a 2-bit field (and/or a field comprising any quantity of bits). The field may be 00, 01, 10 or 11, for example, based on the field being a 2-bit field (e.g., m=2 or m=3 in FIG. 26A). The field may be a 2-bit field, for example, if a multi-TRP downlink (e.g., PDSCH, PDCCH) repetition is enabled/configured. The field may be a 2-bit field, for example, based on the one or more configuration parameters indicating a multi-TRP downlink repetition. The one or more configuration parameters may indicate, for example, the SFN scheme to indicate the multi-TRP downlink repetition. The field may be a 2-bit field, for example, based on the one or more configuration parameters indicating the SFN scheme.

The field (e.g., Unified/Common/Joint TCI state index field, TRP index field, CORESET pool index field, and the like) may be, for example, a 1-bit field. The field may be either 0 or 1, for example, based on the field being a 1-bit field (e.g., m=1 in FIG. 26A). The field may be a 1-bit field, for example, if a multi-TRP downlink (e.g., PDSCH, PDCCH) repetition is not enabled/configured. The field may be a 1-bit field, for example, based on the one or more configuration parameters not indicating a multi-TRP downlink (e.g., PDSCH, PDCCH) repetition. The field may be a 1-bit field, for example, based on the one or more configuration parameters not indicating an SFN scheme (e.g., sfnSchemePdcch, sfnSchemePdsch, sfnSchemeA, sfnSchemeB).

A first value (e.g., n=00 or n=0 in FIG. 26B) of the field may indicate the first TCI state (e.g., TCI state 26). The at least one TCI state may be the first TCI state, for example, based on the value of the field being equal to/set to the first value. The first TCI state may indicate a first reference signal (e.g., CSI-RS, SS/PBCH block). The first TCI state may indicate a first quasi co-location type (e.g., QCL Type A/B/C/D/E, and so on). The wireless device may monitor, via the CORESET, the PDCCH transmission(s)/reception(s) based on the first TCI state. The wireless device may receive, via the CORESET, the first DCI based on the first TCI state. The wireless device may monitor, via the CORESET, the PDCCH transmission(s)/reception(s) with a first spatial domain receiving/reception filter/beam that is determined based on the first reference signal. The wireless device may receive, via the CORESET, the first DCI with a first spatial domain receiving/reception filter/beam that is determined based on the first reference signal. DM-RS antenna port(s) of the PDCCH transmission(s)/reception(s) via the CORESET may be quasi co-located with the first reference signal with respect to the first quasi co-location type. DM-RS antenna port(s) of each PDCCH transmission/reception of the PDCCH transmission(s)/reception(s) may be quasi co-located with the first reference signal with respect to the first quasi co-location type. DM-RS antenna port(s) of the PDCCH transmission/reception carrying/with the first DCI may be quasi co-located with the first reference signal with respect to the first quasi co-location type.

A second value (e.g., n=01 or n=1 in FIG. 26B) of the field may indicate the second TCI state (e.g., TCI state 61). The at least one TCI state may be the second TCI state, for example, based on the value of the field being equal to/set to the second value. The second TCI state may indicate a second reference signal (e.g., CSI-RS, SS/PBCH block). The second TCI state may indicate a second quasi co-location type (e.g., QCL Type A/B/C/D/E, and so on). The wireless device may monitor, via the CORESET, the PDCCH transmission(s)/reception(s) based on the second TCI state. The wireless device may receive, via the CORESET, the first DCI based on the second TCI state. The wireless device may monitor, via the CORESET, the PDCCH transmission(s)/reception(s) with a second spatial domain receiving/reception filter/beam that is determined based on the second reference signal. The wireless device may receive, via the CORESET, the first DCI with a second spatial domain receiving/reception filter/beam that is determined based on the second reference signal. DM-RS antenna port(s) of the PDCCH transmission(s)/reception(s) via the CORESET may be quasi co-located with the second reference signal with respect to the second quasi co-location type. DM-RS antenna port(s) of each PDCCH transmission/reception of the PDCCH transmission(s)/reception(s) may be quasi co-located with the second reference signal with respect to the second quasi co-location type. DM-RS antenna port(s) of the PDCCH transmission/reception carrying/with the first DCI may be quasi co-located with the second reference signal with respect to the second quasi co-location type.

A third value (e.g., n=10 in FIG. 26B) of the field may indicate the first TCI state (e.g., TCI state 26) and the second TCI state (e.g., TCI state 61). The at least one TCI state may be the first TCI state and the second TCI state, for example, based on the value of the field being equal to/set to the third value. The first TCI state may indicate a first reference signal (e.g., CSI-RS, SS/PBCH block). The first TCI state may indicate a first quasi co-location type (e.g., QCL Type A/B/C/D/E, and so on). The second TCI state may indicate a second reference signal (e.g., CSI-RS, SS/PBCH block). The second TCI state may indicate a second quasi co-location type (e.g., QCL Type AB/C/D/E, and so on).

A wireless device may monitor (e.g., via the CORESET) the PDCCH transmission(s)/reception(s) based on the first TCI state and the second TCI state. The wireless device may receive, via the CORESET, the first DCI based on the first TCI state and the second TCI state. The wireless device may monitor, via the CORESET, the PDCCH transmission(s)/reception(s) with a first spatial domain receiving/reception filter/beam that is determined based on the first reference signal and with a second spatial domain receiving/reception filter/beam that is determined based on the second reference signal. The wireless device may receive, via the CORESET, the first DCI with a first spatial domain receiving/reception filter/beam that is determined based on the first reference signal and with a second spatial domain receiving/reception filter/beam that is determined based on the second reference signal. DM-RS antenna port(s) of the PDCCH transmission(s)/reception(s) via the CORESET may be quasi co-located with the first reference signal with respect to the first quasi co-location type and with the second reference signal with respect to the second quasi co-location type. DM-RS antenna port(s) of each PDCCH transmission/reception of the PDCCH transmission(s)/reception(s) may be quasi co-located with the first reference signal with respect to the first quasi co-location type and with the second reference signal with respect to the second quasi co-location type. DM-RS antenna port(s) of the PDCCH transmission/reception carrying/with the first DCI may be quasi co-located with the first reference signal with respect to the first quasi co-location type and with the second reference signal with respect to the second quasi co-location type.

Monitoring a first PDCCH transmission/reception in a first CORESET based on a first TCI state and a second TCI state may comprise at least one first DM-RS antenna port of the first PDCCH transmission/reception in the first CORESET being quasi co-located with a first reference signal indicated by the first TCI state and at least one second DM-RS antenna port of the first PDCCH transmission/reception in the first CORESET being quasi co-located with a second reference signal indicated by the second TCI state. The at least one first DM-RS antenna port of the first PDCCH transmission/reception may be quasi co-located with the first reference signal with respect to a first quasi co-location type indicated by the first TCI state. The at least one second DM-RS antenna port of the first PDCCH transmission/reception may be quasi co-located with the second reference signal with respect to a second quasi co-location type indicated by the second TCI state. The at least one first DM-RS antenna port and the at least one second DM-RS antenna port may be, for example, the same. The at least one first DM-RS antenna port and the at least one second DM-RS antenna port may be, for example, different. The one or more CORESETS may comprise the first CORESET.

A fourth value (e.g., n=11 in FIG. 26B) of the field may indicate the first TCI state (e.g., TCI state 26) and the second TCI state (e.g., TCI state 61). The at least one TCI state may be the first TCI state and the second TCI state, for example, based on the value of the field being equal to/set to the fourth value.

The field may increase the flexibility. The base station may indicate the first TCI state and/or the second TCI state for the CORESET. The field may not be dynamic based on the one or more configuration parameters indicating/configuring the field. The base station may need to send (e.g., transmit) reconfiguration parameters updating the value of the field, for example, if the wireless device moves. This may increase the latency.

The one or more configuration parameters may not indicate, for the CORESET, a field (e.g., Unified/Common/Joint TCI state index field, TRP index field, CORESET pool index field, and the like). The field may be absent (and/or may not be present) in configuration of the CORESET. The field of the CORESET may be absent (or may not be present) in the one or more configuration parameters. The at least one TCI state may be the first TCI state (e.g., TCI state 26), for example, based on the one or more configuration parameters not indicating, for the CORESET, the field. The first TCI state may be a default/reference TCI state, for example, based on the one or more configuration parameters not indicating, for the CORESET, the field. The first TCI state may be the first/starting/earliest/initial TCI state in the vector/set/list of the at least two TCI states.

A wireless device may monitor, via the CORESET, the PDCCH transmission(s)/reception(s) based on the at least one TCI state, for example, based on (e.g., in response to) the one or more configuration parameters not indicating, for the CORESET, the field. The wireless device may receive, via the CORESET, the first DCI based on the at least one TCI state, for example, based on (e.g., in response to) the one or more configuration parameters not indicating, for the CORESET, the field.

A wireless device may select/determine, for monitoring of the CORESET, the at least one TCI state among the at least two TCI states, for example, based on the one or more configuration parameters not indicating, for the CORESET, the field. The wireless device may select/determine, for reception of the first DCI via the CORESET, the at least one TCI state among the at least two TCI states, for example, based on the one or more configuration parameters not indicating, for the CORESET, the field.

Referring back to FIG. 27A, FIG. 27B, and FIG. 27C, the indication of a TCI state may be for a unified beam update. For example, at step 2700, a wireless device may receive, for example, from a base station, one or more messages comprising one or more configuration parameters for a cell. At step 2705, the wireless device may receive a control message (e.g., DCI, MAC-CE) indicating activation of: a first TCI state and/or a second TCI state. At step 2750, the base station may send (e.g., transmit), to the wireless device, the one or more messages comprising the one or more configuration parameters (e.g., at step 2748) and the control message (e.g., at step 2750). The one or more configuration parameters may indicate a plurality of TCI states. For example, the one or more configuration parameters may indicate, for an uplink BWP of the cell, the plurality of TCI states. For example, the one or more configuration parameters may indicate, for a downlink BWP of the cell, the plurality of TCI states.

The wireless device may activate (or set) the uplink BWP as an active uplink BWP of the cell. The wireless device may activate (or set) the downlink BWP as an active downlink BWP of the cell. For example, the base station may send (e.g., transmit) a downlink message (e.g., DCI, MAC-CE, RRC message) indicating the activation of the uplink BWP. For example, the base station may transmit a downlink message (e.g., DCI, MAC-CE, RRC message) indicating the activation of the downlink BWP.

The plurality of TCI states may comprise a plurality of joint/downlink TCI states (and/or joint uplink/downlink TCI states). The plurality of TCI states may comprise a plurality of uplink TCI states. The plurality of TCI states may comprise a plurality of downlink TCI states.

The wireless device may receive an activation command (e.g., MAC-CE, DCI) indicating activation of a subset of the plurality of TCI states (e.g., at step 2705). The base station may send (e.g., transmit) the activation command indicating activation of the subset of the plurality of TCI states (e.g., at step 2750).

The wireless device may map the subset of the plurality of TCI states to one or more TCI codepoints. Each TCI codepoint of the one or more TCI codepoints may indicate respective TCI state(s) of the subset of the plurality of TCI states. The base station may map the subset of the plurality of TCI states to the one or more TCI codepoints.

The wireless device may receive a control message/command (e.g., DCI, MAC-CE) indicating activation of at least two transmission configuration indicator (TCI) states (e.g., at step 2705). The subset of the plurality of TCI states may comprise the at least two TCI states. The base station may send (e.g., transmit) the control message/command (e.g., at step 2750).

The control message (e.g., DCI) may comprise a TCI field indicating the at least two TCI states. A TCI codepoint of the one or more TCI codepoints may indicate/comprise the at least two TCI states. The TCI field may indicate the TCI codepoint.

The control message may be, for example, the activation command. The at least two TCI states may be the subset of the plurality of TCI states. The one or more TCI codepoints may be/comprise a single TCI codepoint.

The at least two TCI states may be/comprise at least two joint/common/unified TCI states. The at least two TCI states may be/comprise at least two joint/common/unified uplink and downlink TCI states. The at least two TCI states may be/comprise at least two joint/common/unified uplink TCI states. The at least two TCI states may be/comprise at least two uplink TCI states. The at least two TCI states may be/comprise at least two joint/common/unified downlink TCI states. The at least two TCI states may be/comprise at least two downlink TCI states.

The wireless device may monitor, for a first DCI, PDCCH transmission(s)/reception(s) in/via a CORESET based on at least one TCI state of the at least two TCI states (e.g., at step 2730, step 2740, and/or step 2745). The base station may send (e.g., transmit), via the CORESET, the first DCI based on the at least one TCI state of the at least two TCI states (e.g., at step 2775, step 2785, and/or step 2790). The downlink BWP may comprise the CORESET. The one or more configuration parameters may indicate, for the downlink BWP, the CORESET. The wireless device may receive, via the CORESET, the first DCI based on the at least one TCI state of the at least two TCI states. The wireless device may receive, via the CORESET, a PDCCH transmission/reception with/carrying the first DCI based on the at least one TCI state of the at least two TCI states. The PDCCH transmission(s)/reception(s) may comprise the PDCCH transmission/reception with/carrying the first DCI.

At step 2730, the wireless device may monitor, via the CORESET, PDCCH transmissions based on the first TCI state of the at least two TCI states, for example, if the value of the field is equal to a first value (e.g., equal to 00). At step 2735, the value of the field may be equal to a second value (e.g., equal to 01) or not equal to either the first value (e.g., 00) or the second value (e.g., 01), such that it may be equal to a third value (e.g., 10 or 11). At step 2740, the wireless device may monitor, via the CORESET, PDCCH transmissions based on the second TCI state of the at least two TCI states, for example, if the value of the field is equal to a second value (e.g., equal to 01). At step 2745, the wireless device may monitor, via the CORESET, PDCCH transmissions based on the first TCI state and the second TCI state of the at least two TCI states, for example, if the value of the field is not equal to a second value (e.g., 01) or the first value (e.g., 00), such that the value may be equal to a third value (e.g., 10 or 11).

At step 2775, the base station may send (e.g., transmit), via the CORESET, PDCCH transmissions based on the first TCI state of the at least two TCI states, for example, if the value of the field is equal to a first value (e.g., equal to 00). At step 2780, the value of the field may be equal to a second value (e.g., equal to 01) or not equal to either the first value (e.g., 00) or the second value (e.g., 01), such that it may be equal to a third value (e.g., 10 or 11). At step 2785, the base station may send (e.g., transmit), via the CORESET, PDCCH transmissions based on the second TCI state of the at least two TCI states, for example, if the value of the field is equal to a second value (e.g., equal to 01). At step 2790, the base station may send (e.g., transmit), via the CORESET, PDCCH transmissions based on the first TCI state and the second TCI state of the at least two TCI states, for example, if the value of the field is not equal to a second value (e.g., 01) or the first value (e.g., 00), such that the value may be equal to a third value (e.g., 10 or 11).

A wireless device may apply/use at least one TCI state for monitoring of a CORESET (and/or for monitoring PDCCH transmission(s)/reception(s) via the CORESET) (e.g., at step 2730, step 2740, and/or step 2745). The wireless device may apply/use the at least one TCI state for reception of the first DCI via the CORESET. Applying/using the at least one TCI state for monitoring of the CORESET may comprise monitoring, via the CORESET, the PDCCH transmission(s)/reception(s) with (or based on) at least one spatial domain receiving/reception filter that is determined based on the at least one TCI state. Applying/using the at least one TCI state for reception of the first DCI via the CORESET may comprise receiving, via the CORESET, the first DCI with/using (or based on) at least one spatial domain receiving/reception filter that is determined based on the at least one TCI state. The wireless device may determine each spatial domain receiving/reception filter of the at least one spatial domain receiving/reception filter, for example, based on a respective TCI state of the at least one TCI state. The wireless device may determine each spatial domain receiving/reception filter of the at least one spatial domain receiving/reception filter, for example, based on a reference signal indicated by a respective TCI state of the at least one TCI state. Applying/using the at least one TCI state for monitoring the PDCCH transmission(s)/reception(s) in/via the CORESET may comprise DM-RS antenna port(s) of the PDCCH transmission(s)/reception(s) being quasi co-located with at least one reference signal indicated by the at least one TCI state. Applying/using the at least one TCI state for reception of the first DCI via the CORESET may comprise DM-RS antenna port(s) of the PDCCH transmission with/carrying the first DCI being quasi co-located with at least one reference signal indicated by the at least one TCI state. Each TCI state of the at least one TCI state may indicate a respective reference signal of the at least one reference signal.

A base station may apply/use the at least one TCI state for transmission of the first DCI via the CORESET (e.g., at step 2775, step 2785, and/or step 2790). The base station may apply/use the at least one TCI state for the PDCCH transmission(s) via the CORESET. Applying/using the at least one TCI state for transmission of the first DCI via the CORESET may comprise sending (e.g., transmitting), via the CORESET, the first DCI with (or based on) at least one spatial domain transmitting/transmission filter that is determined based on the at least one TCI state. The base station may determine each spatial domain transmitting/transmission filter of the at least one spatial domain transmitting/transmission filter, for example, based on a respective TCI state of the at least one TCI state. The base station may determine each spatial domain transmitting/transmission filter of the at least one spatial domain transmitting/transmission filter, for example, based on a reference signal indicated by a respective TCI state of the at least one TCI state.

The one or more configuration parameters may comprise/indicate, for the CORESET, a parameter (e.g., ApplyTCI-State-UL-List, ApplyTCI-State-DL-List, ApplyTCI-State-List, Use-Indicated-TCI-State, Use-Indicated-UL-TCI-State, Use-Indicated-DL-TCI-State, Follow-Unified-TCI-State, Follow-Unified-UL-TCI-State, Follow-Unified-DL-TCI-State, and the like) indicating to apply/use common/unified TCI state(s). The parameter may be set to ‘enabled’. The wireless device may monitor, via the CORESET, the PDCCH transmission(s)/reception(s) based on the at least one TCI state, for example, based on (e.g., in response to) the one or more configuration parameters comprising/indicating, for the CORESET, the parameter. The wireless device may receive, via the CORESET, the first DCI based on the at least one TCI state, for example, based on (e.g., in response to) the one or more configuration parameters comprising/indicating, for the CORESET, the parameter. The base station may send (e.g., transmit), via the CORESET, the first DCI based on the at least one TCI state, for example, based on (e.g., in response to) the one or more configuration parameters comprising/indicating, for the CORESET, the parameter.

The one or more configuration parameters may comprise, for the CORESET, the parameter (or the parameter set to ‘enabled’), for example, based on one or more search space sets associated with the CORESET being CSS set(s). The one or more configuration parameters may comprise, for the CORESET, the parameter (or the parameter set to ‘enabled’), for example, based on each search space set of one or more search space sets associated with the CORESET being a CSS set other than a Type3-PDCCH CSS set. The one or more configuration parameters may comprise, for the CORESET, the parameter (or the parameter set to ‘enabled’), for example, based on at least one search space set of one or more search space sets associated with the CORESET being a CSS set other than a Type3-PDCCH CSS set.

The wireless device may monitor, via the CORESET, the PDCCH transmission(s)/reception(s) based on the at least one TCI state, for example, based on (e.g., in response to) one or more search space sets associated with the CORESET being USS set(s) and/or Type3-PDCCH CSS set(s). The wireless device may monitor, via the CORESET, the PDCCH transmission(s)/reception(s) based on the at least one TCI state, for example, based on (e.g., in response to) each search space set of one or more search space sets associated with the CORESET being an USS set or a Type3-PDCCH CSS set. The wireless device may monitor, via the CORESET, the PDCCH transmission(s)/reception(s) based on the at least one TCI state, for example, based on (e.g., in response to) at least one search space set of one or more search space sets associated with the CORESET being an USS set or a Type3-PDCCH CSS set.

The wireless device may receive, via the CORESET, the first DCI based on the at least one TCI state, for example, based on (e.g., in response to) one or more search space sets associated with the CORESET being USS set(s) and/or Type3-PDCCH CSS set(s). The wireless device may receive, via the CORESET, the first DCI based on the at least one TCI state, for example, based on (e.g., in response to) each search space set of one or more search space sets associated with the CORESET being an USS set or a Type3-PDCCH CSS set. The wireless device may receive, via the CORESET, the first DCI based on the at least one TCI state, for example, based on (e.g., in response to) at least one search space set of one or more search space sets associated with the CORESET being an USS set or a Type3-PDCCH CSS set.

The at least one TCI state may be a first/earliest/starting TCI state that occurs first in a list/vector/set of the at least two TCI states. The at least one TCI state may be the first/starting/earliest TCI state, for example, based on the one or more configuration parameters not indicating an SFN scheme/mode.

The at least one TCI state may be the first/starting/earliest TCI state, for example, based on one or more search space sets associated with the CORESET being CSS set(s). The at least one TCI state may be the first/starting/earliest TCI state, for example, based on each search space set of the one or more search space sets associated with the CORESET being a CSS set. The at least one TCI state may be the first/starting/earliest TCI state, for example, based on each search space set of the one or more search space sets associated with the CORESET being a CSS set other than a Type3-PDCCH CSS set. The at least one TCI state may be the first/starting/earliest TCI state, for example, based on at least one search space set of one or more search space sets associated with the CORESET being a CSS set. The at least one TCI state may be the first/starting/earliest TCI state, for example, based on at least one search space set of one or more search space sets associated with the CORESET being a CSS set other than a Type3-PDCCH CSS set.

The at least one TCI state may be the at least two TCI states, for example, based on the one or more configuration parameters indicating an SFN scheme (e.g., at optional steps 2710, 2715, 2720; and/or at optional steps 2755, 2760, 2765). The one or more configuration parameters may comprise an SFN parameter (e.g., sfnSchemePdcch, sfnSchemePdsch) indicating the SFN scheme (e.g., at optional step 2715 and/or at optional step 2760). The SFN parameter may indicate scheme 1 (sfnSchemeA) or TRP-based pre-compensation (sfnSchemeB).

The at least one TCI state may be the at least two TCI states, for example, based on one or more search space sets associated with the CORESET being USS set(s) and/or Type3-PDCCH CSS set(s). The at least one TCI state may be the at least two TCI states, for example, based on each search space set of one or more search space sets associated with the CORESET being a USS set or a Type3-PDCCH CSS set.

The one or more configuration parameters may indicate, for the CORESET, a field (e.g., Unified/Common/Joint TCI state index field, TRP index field, CORESET pool index field, and the like) comprising a value indicating the at least one TCI state.

The one or more configuration parameters may not indicate an SFN scheme/mode (e.g., at optional step 2720 and/or at optional step 2765). The field may be a 1-bit field, for example, based on the one or more configuration parameters not indicating an SFN scheme/mode. The at least one TCI state may be a first TCI state of the at least two TCI states based on the value of the field being equal to a first value (e.g., 0) (e.g., “YES” result from step 2725 and/or “YES” result from step 2770). The least one TCI state may be a second TCI state of the at least two TCI states based on the value of the field being equal to a second value (e.g., 1) (e.g., “YES” result from step 2735 and/or “YES” result from step 2780).

The one or more configuration parameters may indicate an SFN scheme/mode (e.g., “YES” result from step 2710 and/or “YES” result from step 2755). The one or more configuration parameters may comprise an SFN parameter (e.g., sfnSchemePdcch, sfnSchemePdsch) indicating the SFN scheme. The SFN parameter may indicate scheme 1 (sfnSchemeA) or TRP-based pre-compensation (sfnSchemeB). The field may be a 2-bit field, for example, based on the one or more configuration parameters indicating the SFN scheme/mode. The least one TCI state may be a first TCI state of the at least two TCI states based on the value of the field being equal to a first value (e.g., 00) (e.g., “YES” result from step 2725 and/or “YES” result from step 2770). The least one TCI state may be a second TCI state of the at least two TCI states based on the value of the field being equal to a second value (e.g., 01) (e.g., “YES” result from step 2735 and/or “YES” result from step 2780). The least one TCI state may be the first TCI state and the second TCI state based on the value of the field being equal to a third value (e.g., 10) (e.g., “NO” result from step 2735 and/or “NO” result from step 2780). For example, the least one TCI state may be the first TCI state and the second TCI state based on the value of the field being equal to a fourth value (e.g., 11) (e.g., “NO” result from step 2735 and/or “NO” result from step 2780).

The one or more configuration parameters may not indicate, for the CORESET, a field (e.g., Unified/Common/Joint TCI state index field, TRP index field, CORESET pool index field, and the like). The at least one TCI state may be a first/earliest/starting TCI state that occurs first in a list/vector/set of the at least two TCI states, for example, based on the one or more configuration parameters not indicating, for the CORESET, the field.

The at least one TCI state may not be associated with a TRP. The one or more configuration parameters may not indicate, for the at least one TCI state, a field (e.g., Unified/Common/Joint TCI state index field, TRP index field, CORESET pool index field, and the like) indicating an association between the at least one TCI state and a TRP. The at least one TCI state may not be associated explicitly or implicitly with a TRP. This lack of association may reduce signaling overhead. The one or more configuration parameters may not need to comprise/indicate an association between the at least one TCI state and a TRP (or a TRP index, CORESET pool index, Unified/Common/Joint TCI state index field, and the like). This operation may reduce RRC message size (or the size of the configuration parameters).

Each TCI state of the at least one TCI state may not be associated with a TRP. The one or more configuration parameters may not indicate, for each TCI state of the at least one TCI state, a field (e.g., Unified/Common/Joint TCI state index field, TRP index field, CORESET pool index field, and the like) indicating an association with a TRP. Each TCI state of the at least one TCI state may not be associated explicitly or implicitly with a TRP. This may reduce signaling overhead. The one or more configuration parameters may not need to comprise/indicate an association between each TCI state of the at least one TCI state and a respective TRP (or a TRP index, CORESET pool index, Unified/Common/Joint TCI state index field, and the like). This configuration may reduce RRC message size (and/or the size of the configuration parameters).

Each TCI state of the at least two TCI states may not be associated with a TRP. The one or more configuration parameters may not indicate, for each TCI state of the at least two TCI states, a field (e.g., Unified/Common/Joint TCI state index field, TRP index field, CORESET pool index field, and the like) indicating an association with a TRP. Each TCI state of the at least two TCI states may not be associated explicitly or implicitly with a TRP. This may reduce signaling overhead. The one or more configuration parameters may not need to comprise/indicate an association between each TCI state of the at least two TCI states and a respective TRP (or a TRP index, CORESET pool index, Unified/Common/Joint TCI state index field, and the like). This configuration may reduce RRC message size (and/or the size of the configuration parameters).

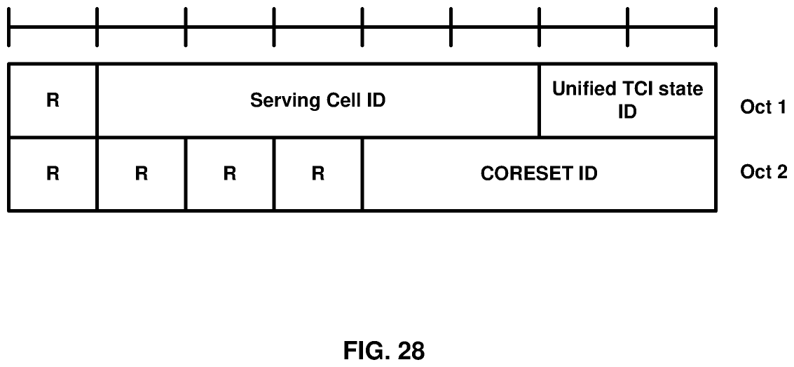

FIG. 28 shows an example activation command. The activation command may be used for a unified beam update. One or more configuration parameters may indicate, for the CORESET, a field (e.g., Unified/Common/Joint TCI state index field, TRP index field, CORESET pool index field, and the like) with a first value (e.g., n=00, n=01, n=10, or n=11 in FIG. 26B). The first value of the field may indicate at least one first TCI state of the at least two TCI states.

The at least one first TCI state indicated by the first value of the field may be the first TCI state (e.g., TCI state 26), for example, if the first value is equal to 00 (e.g., n=00 or n=0). The at least one first TCI state indicated by the first value of the field may be the second TCI state (e.g., TCI state 61), for example, if the first value is equal to 01 (e.g., n=01 or n=1). The at least one first TCI state indicated by the first value of the field may be the first TCI state (e.g., TCI state 26) and the second TCI state (e.g., TCI state 61), for example, if the first value is equal to 10 (e.g., n=10). The at least one first TCI state indicated by the first value of the field may be the first TCI state (e.g., TCI state 26) and the second TCI state (e.g., TCI state 61), for example, if the first value is equal to 11 (e.g., n=11).

A wireless device may monitor, via the CORESET, first PDCCH transmission(s)/reception(s) based on the at least one first TCI state, for example, based on (e.g., in response to) the one or more configuration parameters indicating, for the CORESET, the field with the first value that indicates the at least one first TCI state. The wireless device may apply/use the at least one first TCI state for monitoring of the CORESET (or for monitoring of the first PDCCH transmission(s)/reception(s) via the CORESET). The wireless device may monitor, for a first DCI, the first PDCCH transmission(s)/reception(s) via the CORESET. The wireless device may receive, via the CORESET, the first DCI based on the at least one first TCI state, for example, based on (e.g., in response to) the one or more configuration parameters indicating, for the CORESET, the field with the first value that indicates the at least one first TCI state. The base station may send (e.g., transmit), via the CORESET, the first DCI based on the at least one first TCI state, for example, based on (e.g., in response to) the one or more configuration parameters indicating, for the CORESET, the field with the first value that indicates the at least one first TCI state.

A wireless device may receive an activation command (e.g., MAC-CE, DCI, Unified TCI state ID update MAC-CE, and the like). The activation command may comprise one or more fields. The base station may send (e.g., transmit) the activation command.

A first field of the one or more fields may comprise a serving cell index (e.g., Serving Cell ID in FIG. 28) indicating/identifying the cell. A second field of the one or more fields may comprise a CORESET index (e.g., CORESET ID in FIG. 28) indicating/identifying the CORESET. The one or more configuration parameters may indicate, for the CORESET, the CORESET index. The one or more CORESET indexes may comprise the CORESET index. A size/length of the second field may be equal to k bits (e.g., k=2 bits, k=4 bits, k=5 bits, k=6 bits, and so on).

A third field (e.g., Unified TCI State ID in FIG. 28) of the one or more fields may indicate/comprise a second value for/of the field (e.g., Unified/Common/Joint TCI state index field, TRP index field, CORESET pool index field, and the like) of the CORESET (e.g., in FIG. 28) indicated by the second field of the activation command. A size/length of the third field may be, for example, 2 bits (or any other quantity of bits). The size/length of the third field may be 2 bits, for example, based on the one or more configuration parameters indicating the SFN scheme. A size/length of the third field may be, for example, 1 bit. The size/length of the third field may be 1 bit, for example, based on the one or more configuration parameters not indicating an SFN scheme. “R” fields in FIG. 28 may denote/be/comprise reserved bits. The second value of the field may indicate at least one second TCI state of the at least two TCI states.

The at least one second TCI state indicated by the second value of the field may be the first TCI state (e.g., TCI state 26), for example, if the second value is equal to 00 (e.g., n=00 or n=0). The at least one second TCI state indicated by the second value of the field may be the second TCI state (e.g., TCI state 61), for example, if the second value is equal to 01 (e.g., n=01 or n=1). The at least one second TCI state indicated by the second value of the field may be the first TCI state (e.g., TCI state 26) and the second TCI state (e.g., TCI state 61), for example, if the second value is equal to 10 (e.g., n=10). The at least one second TCI state indicated by the second value of the field may be the first TCI state (e.g., TCI state 26) and the second TCI state (e.g., TCI state 61), for example, if the second value is equal to 11 (e.g., n=11).

A wireless device may replace/update the first value of the field with the second value, for example, based on receiving the activation command indicating the second value for/of the field. The wireless device may monitor, via the CORESET, second PDCCH transmission(s)/reception(s) based on the at least one second TCI state indicated by the second value of the field, for example, based on (e.g., in response to) the receiving the activation command indicating the second value for/of the field. The wireless device may monitor, via the CORESET, second PDCCH transmission(s)/reception(s) based on the at least one second TCI state indicated by the second value of the field, for example, based on (e.g., in response to) replacing/updating the first value of the field with the second value. The wireless device may apply/use the at least one second TCI state for monitoring of the CORESET (or for monitoring of the second PDCCH transmission(s)/reception(s) via the CORESET). The wireless device may apply/use the at least one second TCI state for monitoring of the CORESET, for example, based on (e.g., in response to) the receiving the activation command indicating the second value for/of the field. The wireless device may apply/use the at least one second TCI state for monitoring of the CORESET, for example, based on (e.g., in response to) replacing/updating the first value of the field with the second value. The wireless device may monitor, for a second DCI, the second PDCCH transmission(s)/reception(s) via the CORESET. The wireless device may receive, via the CORESET, the second DCI based on the at least one second TCI state, for example, based on (e.g., in response to) the receiving the activation command indicating the second value for/of the field. The base station may send (e.g., transmit), via the CORESET, the second DCI based on the at least one second TCI state, for example, based on (e.g., in response to) sending (e.g., transmitting) the activation command indicating the second value for/of the field. The second value for/of the field may indicate the at least one second TCI state.

Indicating/Updating a first value of the field (e.g., of the CORESET) by configuration parameters may reduce flexibility. The base station may not have information as to whether the CORESET should be associated with a first TRP or a second TRP or both the first TRP and the second TRP, for example, if the base station sends (e.g., transmits) the one or more configuration parameters. The base station may need to send (e.g., transmit) reconfiguration parameters to update the first value of the field, for example, if the wireless device moves closer to the first TRP or to the second TRP or to the cell-edge. This operation may increase latency. As described herein, advantages may be achieved by updating the first value of the field dynamically (e.g., via MAC-CE, via DCI, etc.).

A base station may send (e.g., transmit) an activation command (e.g., MAC-CE, DCI) updating the first value of the field by a second value. The activation command may be used to dynamically update the first value of the field to a second value. The second value of the field may indicate the first TCI state, for example, if the wireless device is closer to the first TRP. The second value of the field may indicate the second TCI state, for example, if the wireless device is closer to the second TRP. The second value of the field may indicate the first TCI state and the second TCI state, for example, if the wireless device is close to a cell-edge. This may increase flexibility as TCI state(s) for monitoring of a CORESET (or monitoring of downlink control channels via a CORESET) may change dynamically.

In at least some wireless communications, a wireless device may receive a control message/command (e.g., DCI, MAC-CE) indicating activation of a (single) common/unified TCI state. At least some wireless devices may apply/use the common/unified TCI state to/for transmission/reception of a transport block (e.g., PUSCH transmission, PDSCH reception). For example, a wireless device may transmit/receive the transport block with a spatial domain transmission filter that is determined based on a reference signal indicated by the common/unified TCI state. The wireless device may send (e.g., transmit) the transport block using a transmission power that may be determined based on one or more power control parameters indicated by (or associated with or mapped to or included in) the common/unified TCI state. DM-RS antenna port(s) of the transport block may be quasi co-located with a reference signal indicated by the common/unified TCI state.

Activation of the (single) common/unified TCI state may not be efficient, for example, in a multi-TRP operation comprising at least a first TRP and a second TRP. Using/sharing/applying the same common/unified TCI state for transmission/reception of a first transport block associated with the first TRP, and for transmission/reception of a second transport block associated with the second TRP, may not be efficient. The first TRP and the second TRP may not be co-located and may be subject to different channel conditions, which may result in using one or more parameters for a plurality of TRPs that, while suitable/ideal for a particular TRP may not be suitable/ideal for each TRP of the plurality of TRPs (e.g., if the plurality of TRPs are not co-located or are not QCLed).

In at least some systems, a wireless device may receive one or more messages, such as a control message/command (e.g., DCI, MAC-CE), indicating activation of at least two common/unified TCI states. The at least two common/unified TCI states may comprise a first common/unified TCI state and a second common/unified TCI state. The wireless device may not have information indicating whether the first common/unified TCI state is associated with the first TRP or the second TRP. There may not be an explicit/implicit association between the first common/unified TCI state and the first TRP or the second TRP. Configuration parameter(s) may not indicate, for the first common/unified TCI state, a TRP index (or a CORESET pool index, or a common/unified TCI state index, and the like) indicating an association between the first common/unified TCI state and the first TRP or the second TRP. The wireless device may not have information indicating whether the second common/unified TCI state is associated with the first TRP or the second TRP. There may not be an explicit/implicit association between the second common/unified TCI state and the first TRP or the second TRP. Configuration parameter(s) may not indicate, for the second common/unified TCI state, a TRP index (or a CORESET pool index, or a common/unified TCI state index, and the like) indicating an association between the second common/unified TCI state and the first TRP or the second TRP.

In at least some systems, a wireless device may not have information indicating whether at least one transport block (or other communication) is associated with a first TRP or a second TRP (or any other quantity of TRPs, nodes, antenna panels, etc.). A wireless device may not have information whether to apply the first common/unified TCI state and/or the second common/unified TCI state to transmission/reception of the transport block. This lack of information may lead to a beam misalignment between the wireless device and the base station. For example, the wireless device may apply/use the first common/unified TCI state to/for transmission/reception of the transport block. The base station may (incorrectly) assume that the wireless device applies/uses the second common/unified TCI state to/for transmission/reception of the transport block. This misalignment may lead to missing of the one or more transport blocks (or other communication) by the base station and/or the wireless device. This operation may result in retransmissions, increased latency of the communication, and/or increased power consumption at the base station and/or the wireless device.

As described herein, enhanced beam management may be achieved for DCI scheduling transmission/reception of a downlink signal if at least two common/unified TCI states are activated. For example, a wireless device may apply/use a first common/unified TCI state and/or a second common/unified TCI state to receive a downlink signal (e.g., PDSCH transmission). The wireless device may determine whether to receive the downlink signal using a first TCI state, or using a second TCI state, based on one or more indications. For example, two TCI states may be activated to support PDSCH repetition among multiple TRPs. The wireless device may determine which of two TCI states (e.g., a first unified/joint TCI state or a second unified/joint TCI state) to use for receiving the downlink signal based on a field and/or applying a default rule. The wireless device may use a value of a first field (e.g., a 1-bit field) in a message (e.g., DCI) to indicate using a first TCI state (e.g., value of 0) or using a second TCI state (e.g., value of 1). The wireless device may use a value of a second field (e.g., a 2-bit field) in a message (e.g., DCI) to indicate using a first TCI state, (e.g., value of 00), a second TCI state (e.g., value of 01), or both the first TCI state and the second TCI state (e.g., value of 10 or 11). A default rule may be applied if the message does not indicate the downlink signal to be a repetition, such that the wireless device may apply the first TCI state (or second TCI state) as a default rule. The first TCI state (e.g., first common/unified TCI state) may be a first/starting/earliest TCI state that occurs first in a set/list/vector of the at least two common/unified TCI states. By using the first and/or second field, and/or by applying a default rule, a wireless device and a base station may improve alignment for wireless communications by using the same TCI state(s).

A wireless device and a base station may use resources for wireless communications. One or more uniform transmission configuration indicator (TCI) state(s) may be indicated using a parameter, field, message, and/or signaling. The unified TCI state may be indicated by downlink control information (DCI) scheduling reception of a physical downlink shared channel (PDSCH) signal. The unified TCI state(s) may be applied for communication, of the PDSCH signal, between the wireless device and the base station for which at least two unified TCI states may be activated, without requiring additional signaling to configure parameters for each communication.

While examples herein describe transmission of at least one transport block, a transmission may comprise any communication (e.g., any message, signal, control information, data, packet, etc.). A wireless device may apply/use the first common/unified TCI state to transmission/reception of the at least one transport block (or other communication). The first common/unified TCI state may be a first/starting/earliest TCI state that occurs first in a set/list/vector of the at least two common/unified TCI states. The DCI scheduling the at least one transport block (or other communication) may, for example, indicate a quantity/number of repetitions that is equal to one (or any other quantity/number). The DCI scheduling the at least one transport block (or other communication) may, for example, indicate no repetition. The DCI scheduling the at least one transport block (or other communication) may, for example, be a fallback DCI (e.g., DCI format 0-0, DCI format 1-0, and the like). A wireless device may receive, via a CORESET, DCI scheduling/triggering transmission of the at least one transport block (or other communication). The DCI may comprise a field (e.g., TRP index or a CORESET pool index, or a common/unified TCI state index, and the like) with a value. The value may indicate common/unified TCI state(s) among the at least two common/unified TCI states. The wireless device may apply/use the common/unified TCI state(s) to transmission/reception of the transport block. The wireless device may monitor, for the DCI, PDCCH transmissions in the CORESET based on common/unified TCI state(s) among/of the at least two common/unified TCI states. The wireless device may apply/use the common/unified TCI state(s) to transmission/reception of the at least one transport block (or other communication). Examples described herein may reduce beam misalignment, which may lead to advantages such as reduced retransmissions, reduced latency/delay, and/or reduced power consumption.

A wireless device may receive (e.g., via a CORESET (e.g., Coreset in FIG. 17) of the plurality of CORESETS) second DCI (e.g., DCI 2 at time T3 in FIG. 17). The second DCI may (be configured to) schedule a transport block. A time offset between the second DCI and the transport block may be equal to or greater than a threshold (e.g., timeDurationForQCL, beamSwitchTiming). A time offset between the second DCI and the at least one transport block or other communication may be less (or smaller) than a threshold (e.g., timeDurationForQCL, beamSwitchTiming). The wireless device may send (e.g., transmit) a capability message/report (e.g., a UE capability message/report) indicating the threshold.

A CORESET may be associated with (e.g., mapped to) one or more search space sets. The one or more configuration parameters may indicate (e.g., for the CORESET) the one or more search space sets. The one or more configuration parameters may indicate an association/mapping/linkage between the CORESET and the one or more search space sets.

Second DCI may schedule transmission of the at least one transport block (e.g., PUSCH transmission). The second DCI may schedule a PUSCH transmission comprising/carrying/with the at least one transport block. The second DCI may be, for example, a DCI format 0-x, where x=0, 1, 2, . . . , etc. The second DCI may schedule reception of the at least one transport block (e.g., PDSCH transmission). The second DCI may schedule a PDSCH reception comprising/carrying/with the at least one transport block. The second DCI may be, for example, a DCI format 1-x, where x=0, 1, 2, . . . , etc. The second DCI may indicate one or more resources for transmission/reception of the at least one transport block.

A wireless device may send (e.g., transmit), via the one or more resources, at least one transport block. For example, the wireless device may send (e.g., transmit)/perform, via the one or more resources, the PUSCH transmission with/carrying the at least one transport block. The uplink BWP of the cell may comprise the one or more resources.

The wireless device may receive, via the one or more resources, the at least one transport block. For example, the wireless device may receive/perform, via the one or more resources, the PDSCH transmission with/carrying the at least one transport block. The downlink BWP of the cell may comprise the one or more resources.

One or more configuration parameters may comprise (e.g., for the CORESET via which the wireless device receives the second DCI) a parameter (e.g., ApplyTCI-State-UL-List, ApplyTCI-State-DL-List, ApplyTCI-State-List, Use-Indicated-TCI-State, Use-Indicated-UL-TCI-State, Use-Indicated-DL-TCI-State, Follow-Unified-TCI-State, Follow-Unified-UL-TCI-State, Follow-Unified-DL-TCI-State, and the like) indicating to apply/use common/unified TCI state(s). The parameter may be set to ‘enabled’. The parameter may indicate that the CORESET shares the same common/unified TCI state(s) as wireless-device-dedicated reception (e.g., UE-dedicated reception) on/via a PDCCH/PDSCH and for wireless-device-dedicated reception (e.g., UE-dedicated reception) on/via the one or more CORESETS or subset of the one or more CORESETS in the cell. The parameter may indicate that the CORESET shares the same common/unified TCI state(s) as dynamic-grant/configured-grant based PUSCH transmissions via/of the cell and transmissions via PUCCH resources of the cell.

One or more configuration parameters may comprise (e.g., for the CORESET) the parameter (or the parameter set to ‘enabled’), for example, based on the one or more search space sets associated with the CORESET being CSS set(s). The CSS set(s) may comprise at least one of: Type0-PDCCH CSS set, Type0A-PDCCH CSS set, Type1-PDCCH CSS set, and Type2-PDCCH CSS set. The CSS set(s) may not comprise a Type3-PDCCH CSS set. The one or more configuration parameters may comprise (e.g., for the CORESET) the parameter, for example, based on each search space set of the one or more search space sets associated with the CORESET being a CSS set. The one or more configuration parameters may comprise (e.g., for the CORESET) the parameter, for example, based on each search space set of the one or more search space sets associated with the CORESET being a CSS set other than a Type3-PDCCH CSS set. The CSS set(s) may comprise the CSS set. The one or more configuration parameters may comprise (e.g., for the CORESET) the parameter, for example, based on each search space set of the one or more search space sets associated with the CORESET being a respective CSS set. The one or more configuration parameters may comprise (e.g., for the CORESET) the parameter, for example, based on each search space set of the one or more search space sets associated with the CORESET being a respective CSS set other than a Type3-PDCCH CSS set. The one or more configuration parameters may comprise (e.g., for the one or more search space sets) a search space type parameter (e.g., searchSpaceType) that is equal/set to ‘CSS’ (or ‘common’). The one or more configuration parameters may comprise (e.g., for each search space set of the one or more search space sets) a search space type parameter that is equal/set to ‘CSS’. The one or more configuration parameters may comprise (e.g., for each search space set of the one or more search space sets) a respective search space type parameter that is equal/set to ‘CSS’.

One or more configuration parameters may comprise (e.g., for the CORESET) the parameter (or the parameter set to ‘enabled’), for example, based on at least one search space set of the one or more search space sets associated with the CORESET being a CSS set. The one or more configuration parameters may comprise (e.g., for the CORESET) the parameter, for example, based on at least one search space set of the one or more search space sets being a CSS set other than a Type3-PDCCH CSS set. The CSS set may comprise/be at least one of: Type0-PDCCH CSS set, Type0A-PDCCH CSS set, Type1-PDCCH CSS set, and Type2-PDCCH CSS set. The CSS set may, for example, not comprise a Type3-PDCCH CSS set. The one or more configuration parameters may comprise, for the at least one search space set, a search space type parameter (e.g., searchSpaceType) that is equal/set to ‘CSS’ (or ‘common’). The one or more configuration parameters may comprise (e.g., for each search space set of the at least one search space set) a search space type parameter that is equal/set to ‘CSS’. The one or more configuration parameters may comprise (e.g., for each search space set of the at least one search space set) a respective search space type parameter that is equal/set to ‘CSS’.

A wireless device may apply/use the common/unified TCI state(s) for the CORESET, for example, based on the one or more configuration parameters comprising, for the CORESET, the parameter. The wireless device may apply/use the common/unified TCI state(s) for the CORESET, for example, based on the one or more configuration parameters comprising, for the CORESET, the parameter that is set to ‘enabled’.

One or more configuration parameters may not comprise (e.g., for the CORESET that the wireless device receives the second DCI) the parameter (e.g., ApplyTCI-State-UL-List, ApplyTCI-State-DL-List, ApplyTCI-State-List, Use-Indicated-TCI-State, Use-Indicated-UL-TCI-State, Use-Indicated-DL-TCI-State, Follow-Unified-TCI-State, Follow-Unified-UL-TCI-State, Follow-Unified-DL-TCI-State, and the like) indicating to apply/use common/unified TCI state(s). The one or more configuration parameters may comprise, for the CORESET, the parameter. The parameter may be set to ‘disabled’ (or may not be set to ‘enabled’).

One or more configuration parameters may not comprise the parameter (or may comprise the parameter not set to ‘enabled’) for the CORESET, for example, based on the one or more search space sets associated with the CORESET being USS set(s) and/or Type3-PDCCH CSS set(s). Each search space set of the one or more search space sets may be a USS set or a Type3-PDCCH CSS set. The one or more configuration parameters may not comprise, for the CORESET, the parameter, for example, based on each search space set of the one or more search space sets associated with the CORESET being an USS set or a Type3-PDCCH CSS set. The USS set(s) may comprise the USS set. The one or more configuration parameters may not comprise, for the CORESET, the parameter, for example, based on each search space set of the one or more search space sets being a respective USS set or a Type3-PDCCH CSS set. The one or more configuration parameters may comprise, for the one or more search space sets, a search space type parameter (e.g., searchSpaceType) that is equal/set to ‘USS’ (or ‘ue-specific’) or ‘CSS’ for Type3-PDCCH CSS set. The one or more configuration parameters may comprise, for each search space set of the one or more search space sets, a search space type parameter that is equal/set to ‘USS’ or ‘CSS’ for Type3-PDCCH CSS set. The one or more configuration parameters may comprise, for each search space set of the one or more search space sets, a respective search space type parameter that is equal/set to ‘USS’ or ‘CSS’ for Type3-PDCCH CSS set.

One or more configuration parameters may not comprise the parameter (or may comprise the parameter not set to ‘enabled’) for the CORESET, for example, based on at least one search space set of the one or more search space sets associated with the CORESET being a USS set or a Type3-PDCCH CSS set. Each search space set of the at least one search space set may be a USS set or a Type3-PDCCH CSS set. The one or more configuration parameters may not comprise, for the CORESET, the parameter, for example, based on each search space set of the at least one search space set being a USS set or a Type3-PDCCH CSS set. The one or more configuration parameters may not comprise, for the CORESET, the parameter, for example, based on each search space set of the at least one search space set being a respective USS set or a Type3-PDCCH CSS set. The one or more configuration parameters may comprise, for the at least one search space set, a search space type parameter (e.g., searchSpaceType) that is equal/set to ‘USS’ (or ‘ue-specific’) or ‘CSS’ for Type3-PDCCH CSS set. The one or more configuration parameters may comprise, for each search space set of the at least one search space set, a search space type parameter that is equal/set to ‘USS’ or ‘CSS’ for Type3-PDCCH CSS set. The one or more configuration parameters may comprise, for each search space set of the at least one search space set, a respective search space type parameter that is equal/set to ‘USS’ or ‘CSS’ for Type3-PDCCH CSS set.

A wireless device may apply/use the common/unified TCI state(s) for the CORESET, for example, based on the one or more search space sets associated with the CORESET being USS set(s) and/or Type3-PDCCH CSS set(s). The wireless device may apply/use the common/unified TCI state(s) for the CORESET, for example, based on each search space set of the one or more search space sets associated with the CORESET being a USS set or a Type3-PDCCH CSS set. The wireless device may apply/use the common/unified TCI state(s) for the CORESET, for example, based on each search space set of the one or more search space sets being a respective USS set or a Type3-PDCCH CSS set. The wireless device may apply/use the common/unified TCI state(s) for the CORESET, for example, based on at least one search space set of the one or more search space sets associated with the CORESET being a USS set or a Type3-PDCCH CSS set.

A wireless device may transmit/receive at least one transport block, for example, based on at least one TCI state. The at least two TCI states may comprise the at least one TCI state. The wireless device may apply/use the at least one TCI state for transmission/reception of the transport block. The at least one TCI state may be at least one reference/default TCI state.

A wireless device may transmit/receive at least one transport block based on the at least one TCI state, for example, based on (e.g., in response to) the one or more configuration parameters comprising, for the CORESET, the parameter. The wireless device may transmit/receive the at least one transport block (or other communication) based on the at least one TCI state, for example, based on (e.g., in response to) the one or more configuration parameters comprising, for the CORESET, the parameter set to ‘enabled’. The wireless device may transmit/receive the at least one transport block based on the at least one TCI state, for example, based on (e.g., in response to) the one or more search space sets associated with the CORESET being CSS set(s). The wireless device may transmit/receive the at least one transport block based on the at least one TCI state, for example, based on (e.g., in response to) each search space set of the one or more search space sets associated with the CORESET being a CSS set. The wireless device may transmit/receive the at least one transport block based on the at least one TCI state, for example, based on (e.g., in response to) each search space set of the one or more search space sets associated with the CORESET being a CSS set other than a Type3-PDCCH CSS set. The wireless device may transmit/receive the at least one transport block based on the at least one TCI state, for example, based on (e.g., in response to) a search space set that the wireless device receives the second DCI being a CSS set other than a Type3-PDCCH CSS set. The one or more search space sets of the CORESET may comprise the search space set.

A wireless device may transmit/receive at least one transport block (or other communication) based on the at least one TCI state, for example, based on (e.g., in response to) the one or more search space sets associated with the CORESET being USS set(s) and/or Type3-PDCCH CSS set(s). The wireless device may transmit/receive the at least one transport block based on the at least one TCI state, for example, based on (e.g., in response to) each search space set of the one or more search space sets associated with the CORESET being a USS set or a Type3-PDCCH CSS set. The wireless device may transmit/receive the at least one transport block based on the at least one TCI state, for example, based on (e.g., in response to) at least one search space set of the one or more search space sets associated with the CORESET being a USS set or a Type3-PDCCH CSS set. The wireless device may transmit/receive the at least one transport block based on the at least one TCI state, for example, based on (e.g., in response to) a search space set that the wireless device receives the second DCI being a USS set or a Type3-PDCCH CSS set. The one or more search space sets of the CORESET may comprise the search space set.

A wireless device may select/determine, for transmission/reception of at least one transport block (or other communication), at least one TCI state among the at least two TCI states. The wireless device may select/determine, for transmission/reception of the at least one transport block, the at least one TCI state as reference/default TCI state(s). The wireless device may select/determine the at least one TCI state among the at least two TCI states, for example, as default/reference TCI state(s).

A wireless device may select/determine, for transmission/reception of at least one transport block (or other communication), the at least one TCI state among the at least two TCI states. The wireless device may select/determine the at least one TCI state among the at least two TCI states, for example, based on the one or more configuration parameters comprising (e.g., for the CORESET) the parameter. The wireless device may select/determine the at least one TCI state among the at least two TCI states, for example, based on the one or more configuration parameters comprising (e.g., for the CORESET) the parameter that is set to ‘enabled’. The wireless device may select/determine the at least one TCI state among the at least two TCI states, for example, based on the one or more search space sets associated with the CORESET being CSS set(s). The wireless device may select/determine the at least one TCI state among the at least two TCI states, for example, based on each search space set of the one or more search space sets associated with the CORESET being a CSS set. The wireless device may select/determine the at least one TCI state among the at least two TCI states, for example, based on each search space set of the one or more search space sets associated with the CORESET being a CSS set other than a Type3-PDCCH CSS set. The wireless device may select/determine the at least one TCI state among the at least two TCI states, for example, based on the search space set that the wireless device receives the second DCI being a CSS set other than a Type3-PDCCH CSS set.

A wireless device may select/determine, for transmission/reception of at least one transport block, at least one TCI state among the at least two TCI states, for example, based on one or more search space sets associated with the CORESET being USS set(s) and/or Type3-PDCCH CSS set(s). The wireless device may select/determine the at least one TCI state among the at least two TCI states, for example, based on each search space set of the one or more search space sets associated with the CORESET being a USS set or a Type3-PDCCH CSS set. The wireless device may select/determine the at least one TCI state among the at least two TCI states, for example, based on at least one search space set of the one or more search space sets associated with the CORESET being a USS set or a Type3-PDCCH CSS set. The wireless device may select/determine the at least one TCI state among the at least two TCI states, for example, based on the search space set that the wireless device receives the second DCI being a USS set or a Type3-PDCCH CSS set.

A wireless device may send (e.g., transmit) at least one transport block (or other communication) with/using at least one spatial domain transmitting/transmission filter/beam that may be determined based on the at least one TCI state. The wireless device may send (e.g., transmit) the at least one transport block with/using a respective spatial domain transmitting/transmission filter/beam, of the at least one spatial domain transmitting/transmission filter/beam, that may be determined based on each TCI state of the at least one TCI state. The wireless device may send (e.g., transmit) the at least one transport block with/using a respective spatial domain transmitting/transmission filter/beam, of the at least one spatial domain transmitting/transmission filter/beam, that may be determined based on a reference signal indicated by each TCI state of the at least one TCI state. The wireless device may determine each spatial domain transmitting/transmission filter/beam of the at least one spatial domain transmitting/transmission filter/beam, for example, based on a respective TCI state of the at least one TCI state. The wireless device may determine each spatial domain transmitting/transmission filter/beam of the at least one spatial domain transmitting/transmission filter/beam, for example, based on a reference signal indicated by a respective TCI state of the at least one TCI state.

The at least one TCI state may be/comprise a TCI state. The wireless device may send (e.g., transmit) at least one transport block (or other communication) with/using a spatial domain transmitting/transmission filter/beam that may be determined based on a reference signal indicated by the TCI state. The spatial domain transmitting/transmission filter/beam may be, for example, the same as (or substantially the same as, x degrees apart, x=0, 1, 5, 10, and the like) a spatial domain reception/receiving filter/beam used to receive the reference signal. The spatial domain transmitting/transmission filter/beam may be, for example, the same as (or substantially the same as, x degrees apart, x=0, 1, 5, 10, and the like) a spatial domain transmission/transmitting filter/beam used to transmit the reference signal.

A wireless device may send (e.g., transmit) at least one transport block (or other communication) with/using at least one transmission power that may be determined based on the at least one TCI state. The wireless device may send (e.g., transmit) the at least one transport block with/using a respective transmission power, of the at least one transmission power, that may be determined based on each TCI state of the at least one TCI state. The wireless device may send (e.g., transmit) the transport block with/using a respective transmission power, of the at least one transmission power, that may be determined based on one or more power control parameters (e.g., target received power, closed-loop index, pathloss compensation factor, alpha, pathloss reference signal, and the like) indicated by (or included in or associated with or mapped to) each TCI state of the at least one TCI state. The wireless device may determine each transmission power of the at least one transmission power, for example, based on a respective TCI state of the at least one TCI state. The wireless device may determine each transmission power of the at least one transmission power, for example, based on one or more power control parameters indicated by (or included in or associated with or mapped to) a respective TCI state of the at least one TCI state.

The at least one TCI state may be/comprise a TCI state. A wireless device may send (e.g., transmit) at least one transport block (or other communication) with/using a transmission power that may be determined based on one or more power control parameters (e.g., target received power, closed-loop index, pathloss compensation factor, alpha, pathloss reference signal, and the like) indicated by (or included in or associated with or mapped to) the TCI state. The one or more configuration parameters may indicate, for the TCI state, the one or more power control parameters. The one or more configuration parameters may indicate, for the TCI state, a power control set indicating the one or more power control parameters. The one or more configuration parameters may indicate, for the TCI state, a power control set index/ID/identifier indicating the power control set.

A first TCI state (e.g., TCI state 26) may indicate/comprise/have a first reference signal (e.g., CSI-RS, SS/PBCH block, SRS, and the like). The one or more configuration parameters may indicate, for the first TCI state, the first reference signal. The one or more configuration parameters may indicate, for the first TCI state, a first reference signal index indicating/identifying the first reference signal. The first TCI state (e.g., TCI state 26) may indicate/comprise/have a first quasi co-location type (e.g., QCL Type A, QCL Type B, QCL Type C, QCL Type D, and the like) for the first reference signal.

A second TCI state (e.g., TCI state 61) may indicate/comprise/have a second reference signal (e.g., CSI-RS, SS/PBCH block, SRS, and the like). The one or more configuration parameters may indicate, for the second TCI state, the second reference signal. The one or more configuration parameters may indicate, for the second TCI state, a second reference signal index indicating/identifying the second reference signal. The second TCI state (e.g., TCI state 61) may indicate/comprise/have a second quasi co-location type (e.g., QCL Type A, QCL Type B, QCL Type C, QCL Type D, and the like) for the second reference signal.

The at least one TCI state may be/comprise the first TCI state (e.g., TCI state 26). The wireless device may send (e.g., transmit) at least one transport block (or other communication) based on the first TCI state. The wireless device may send (e.g., transmit) the at least one transport block with/using a first spatial domain transmitting/transmission filter/beam that may be determined based on a first reference signal indicated by the first TCI state. The wireless device may send (e.g., transmit) the at least one transport block with a first transmission power that is determined based on one or more first power control parameters (e.g., target received power, closed-loop index, pathloss compensation factor, alpha, pathloss reference signal, and the like) indicated by (or included in or associated with or mapped to) the first TCI state.

The at least one TCI state may be/comprise the second TCI state (e.g., TCI state 61). The wireless device may send (e.g., transmit) the at least one transport block (or other communication) based on the second TCI state. The wireless device may transmit the at least one transport block with/using a second spatial domain transmitting/transmission filter/beam that may be determined based on a second reference signal indicated by the second TCI state. The wireless device may send (e.g., transmit) the transport block with/using a second transmission power that may be determined based on one or more second power control parameters (e.g., target received power, closed-loop index, pathloss compensation factor, alpha, pathloss reference signal, and the like) indicated by (or included in or associated with or mapped to) the second TCI state.

The at least one TCI state may be/comprise the first TCI state (e.g., TCI state 26) and the second TCI state (e.g., TCI state 61). The at least one TCI state may be the at least two TCI states comprising the first TCI state and the second TCI state. The wireless device may send (e.g., transmit) at least one transport block (or other communication) based on the at least two TCI states. The wireless device may send (e.g., transmit) the at least one transport block with/using the first spatial domain transmitting/transmission filter/beam that may be determined based on the first reference signal indicated by the first TCI state. The wireless device may send (e.g., transmit) the at least one transport block with/using the second spatial domain transmitting/transmission filter/beam that may be determined based on the second reference signal indicated by the second TCI state. For example, the wireless device may send (e.g., transmit) one or more first repetitions of the at least one transport block with/using the first spatial domain transmitting/transmission filter/beam. The wireless device may send (e.g., transmit) one or more second repetitions of the at least one transport block with/using the second spatial domain transmitting/transmission filter/beam. The wireless device may send (e.g., transmit) the at least one transport block with/using the first transmission power that may be determined based on the one or more first power control parameters indicated by (or included in or associated with or mapped to) the first TCI state. The wireless device may send (e.g., transmit) the at least one transport block with/using the second transmission power that may be determined based on the one or more second power control parameters indicated by (or included in or associated with or mapped to) the second TCI state. The wireless device may send (e.g., transmit) the one or more first repetitions of the at least one transport block with/using the first transmission power. The wireless device may send (e.g., transmit) the one or more second repetitions of the at least one transport block with the second transmission power. As described herein, reference to at least one transport block may indicate a single transport block or any quantity of a plurality of transport blocks, a single packet or any quantity of a plurality of packets, and/or a single or plurality of any type of information and/or data (e.g., any communication).

The at least one TCI state may be/comprise the first TCI state (e.g., TCI state 26) and the second TCI state (e.g., TCI state 61). The at least one TCI state may be the at least two TCI states comprising the first TCI state and the second TCI state. A wireless device may send (e.g., transmit) at least one transport block (or other communication) based on the at least two TCI states. For example, the wireless device may send (e.g., transmit) a first portion (e.g., first layer(s) or first data stream(s) or first symbol(s)) of the at least one transport block with/using the first spatial domain transmitting/transmission filter/beam that may be determined based on the first reference signal indicated by the first TCI state. The wireless device may send (e.g., transmit) the first portion of the at least one transport block in a transmission occasion. The wireless device may send (e.g., transmit) a second portion (e.g., second layer(s) or second data stream(s) or second symbol(s)) of the at least one transport block with/using the second spatial domain transmitting/transmission filter/beam that may be determined based on the second reference signal indicated by the second TCI state. The wireless device may send (e.g., transmit) the second portion of the at least one transport block in the transmission occasion. For example, the wireless device may send (e.g., transmit) the first portion (e.g., first layer(s) or first data stream(s) or first symbol(s)) of the at least one transport block with/using the first transmission power. The wireless device may send (e.g., transmit) the second portion (e.g., second layer(s) or second data stream(s) or second symbol(s)) of the transport block with/using the second transmission power.

A wireless device may receive at least one transport block (or other communication) with/using at least one spatial domain receiving/reception filter/beam that may be determined based on at least one TCI state. The wireless device may receive the at least one transport block with/using a respective spatial domain receiving/reception filter/beam, of the at least one spatial domain receiving/reception filter/beam, that may be determined based on each TCI state of the at least one TCI state. The wireless device may receive the at least one transport block with/using a respective spatial domain receiving/reception filter/beam, of the at least one spatial domain receiving/reception filter/beam, that may be determined based on a reference signal indicated by each TCI state of the at least one TCI state. The wireless device may determine each spatial domain receiving/reception filter/beam of the at least one spatial domain receiving/reception filter/beam, for example, based on a respective TCI state of the at least one TCI state. The wireless device may determine each spatial domain receiving/reception filter/beam of the at least one spatial domain receiving/reception filter/beam, for example, based on a reference signal indicated by a respective TCI state of the at least one TCI state.

The at least one TCI state may be/comprise a TCI state. The wireless device may receive at least one transport block (or other communication) with/using a spatial domain receiving/reception filter/beam that may be determined based on a reference signal indicated by the TCI state. The spatial domain receiving/reception filter/beam may be, for example, the same as (or substantially the same as, x degrees apart, x=0, 1, 5, 10, and the like) a spatial domain reception/receiving filter/beam used to receive the reference signal. The spatial domain receiving/reception filter/beam may be, for example, the same as (or substantially the same as, x degrees apart, x=0, 1, 5, 10, and the like) a spatial domain transmission/transmitting filter/beam used to send (e.g., transmit) the reference signal.

DM-RS antenna port(s) of at least one transport block (or other communication) may be quasi co-located with at least one reference signal indicated by at least one TCI state. The DM-RS antenna port(s) of the at least one transport block may be quasi co-located with the at least one reference signal with respect to at least one quasi co-location type (e.g., QCL Type A, QCL Type B, QCL Type C, QCL Type D, QCL Type E, and the like) indicated by the at least one TCI state. Each reference signal of the at least one reference signal may be indicated by a respective TCI state of the at least one TCI state. Each quasi co-location type of the at least one quasi co-location type may be indicated by a respective TCI state of the at least one TCI state. The DM-RS antenna port(s) of the at least one transport block may be quasi co-located with a respective reference signal, of the at least one reference signal, indicated by each TCI state of the at least one TCI state.

The at least one TCI state may be/comprise a TCI state. DM-RS antenna port(s) of the at least one transport block may be quasi co-located with a reference signal indicated by the TCI state. The DM-RS antenna port(s) of the at least one transport block may be quasi co-located with the reference signal with respect to a quasi co-location type indicated by the TCI state.

The at least one TCI state may be/comprise the first TCI state (e.g., TCI state 26). The wireless device may receive the at least one transport block based on the first TCI state. The wireless device may receive the at least one transport block with/using a first spatial domain receiving/reception filter/beam that may be determined based on a first reference signal indicated by the first TCI state. DM-RS antenna port(s) of the at least one transport block may be quasi co-located with a first reference signal indicated by the first TCI state. The DM-RS antenna port(s) of the at least one transport block may be quasi co-located with the first reference signal with respect to a first quasi co-location type indicated by the first TCI state.

The at least one TCI state may be/comprise the second TCI state (e.g., TCI state 61). The wireless device may receive the at least one transport block based on the second TCI state. The wireless device may receive the at least one transport block with/using a second spatial domain receiving/reception filter/beam that may be determined based on a second reference signal indicated by the second TCI state. DM-RS antenna port(s) of the at least one transport block may be quasi co-located with a second reference signal indicated by the second TCI state. The DM-RS antenna port(s) of the at least one transport block may be quasi co-located with the second reference signal with respect to a second quasi co-location type indicated by the second TCI state.

The at least one TCI state may be/comprise the first TCI state (e.g., TCI state 26) and the second TCI state (e.g., TCI state 61). The at least one TCI state may be the at least two TCI states comprising the first TCI state and the second TCI state. The wireless device may receive the at least one transport block based on the at least two TCI states. The wireless device may receive the at least one transport block with/using the first spatial domain receiving/reception filter/beam that may be determined based on the first reference signal indicated by the first TCI state. The wireless device may receive the at least one transport block with/using the second spatial domain receiving/reception filter/beam that may be determined based on the second reference signal indicated by the second TCI state. The second DCI may comprise an antenna port field.

One or more configuration parameters may indicate a time domain resource assignment/allocation (TDRA) table (e.g., PDSCH-TimeDomainResourceAllocation). The TDRA table may comprise one or more rows/entries. The one or more configuration parameters may indicate a repetition scheme. The repetition scheme may be, for example, a frequency domain repetition (e.g., ‘fdmSchemeA’, ‘fdmSchemeB’). The repetition scheme may be, for example, a time domain repetition (e.g., ‘tdmSchemeA’). The antenna port field may indicate DM-RS port(s) within one CDM group. The at least one TCI state may be the at least two TCI states comprising the first TCI state and the second TCI state. The wireless device may receive the at least one transport block based on the at least two TCI states, for example, based on the one or more configuration parameters indicating the repetition scheme. The wireless device may receive one or more first repetitions of the at least one transport block with/using the first spatial domain receiving/reception filter/beam. The wireless device may receive the one or more first repetitions of the at least one transport block in one or more first transmission occasions. Each repetition of the one or more first repetitions of the at least one at least one transport block may be received, by the wireless device, in a respective transmission occasion of the one or more first transmission occasions. The wireless device may receive one or more second repetitions of the at least one transport block with/using the second spatial domain receiving/reception filter/beam. The wireless device may receive the one or more second repetitions of the at least one transport block in one or more second transmission occasions. Each repetition of the one or more second repetitions of the at least one transport block may be received, by the wireless device, in a respective transmission occasion of the one or more second transmission occasions. DM-RS antenna port(s) of the at least one transport block may be quasi co-located with the first reference signal indicated by the first TCI state. The DM-RS antenna port(s) of the at least one transport block may be quasi co-located with the first reference signal with respect to the first quasi co-location type indicated by the first TCI state. The DM-RS antenna port(s) of the transport block may be quasi co-located with the first reference signal with respect to the first quasi co-location type in the one or more first repetitions (or in the one or more first transmission occasions). The DM-RS antenna port(s) of the at least one transport block may be quasi co-located with the second reference signal indicated by the second TCI state. The DM-RS antenna port(s) of the at least one transport block may be quasi co-located with the second reference signal with respect to the second quasi co-location type indicated by the second TCI state. The DM-RS antenna port(s) of the at least one transport block may be quasi co-located with the second reference signal with respect to the second quasi co-location type in the one or more second repetitions (or in the one or more second transmission occasions).

One or more configuration parameters may, for example, not indicate a repetition scheme. The second DCI may comprise a TDRA field indicating a row/entry in the one or more rows/entries in/of the TDRA table. The row/entry may comprise/indicate a quantity/number of repetitions (e.g., repetitionNumber). The quantity/number of repetitions may be, for example, greater than one (or at least two). The antenna port field may indicate DM-RS port(s) within one CDM group. The at least one TCI state may be the at least two TCI states comprising the first TCI state and the second TCI state. The wireless device may receive at least one transport block (or other communication), for example, based on the at least two TCI states, for example, based on the second DCI indicating the quantity/number of repetitions. The wireless device may receive the at least one transport block, for example, based on the at least two TCI states, for example, based on the second DCI indicating the quantity/number of repetitions that is greater than one. The wireless device may receive one or more first repetitions of the at least one transport block with/using the first spatial domain receiving/reception filter/beam. The wireless device may receive the one or more first repetitions of the at least one transport block in one or more first transmission occasions. Each repetition of the one or more first repetitions of the at least one transport block may be received, by the wireless device, in a respective transmission occasion of the one or more first transmission occasions. The wireless device may receive one or more second repetitions of the at least one transport block with/using the second spatial domain receiving/reception filter/beam. The wireless device may receive the one or more second repetitions of the at least one transport block in one or more second transmission occasions. Each repetition of the one or more second repetitions of the at least one transport block may be received, by the wireless device, in a respective transmission occasion of the one or more second transmission occasions. DM-RS antenna port(s) of the transport block may be quasi co-located with the first reference signal indicated by the first TCI state. The DM-RS antenna port(s) of the at least one transport block may be quasi co-located with the first reference signal with respect to the first quasi co-location type indicated by the first TCI state. The DM-RS antenna port(s) of the at least one transport block may be quasi co-located with the first reference signal with respect to the first quasi co-location type in the one or more first repetitions (or in the one or more first transmission occasions). The DM-RS antenna port(s) of the at least one transport block may be quasi co-located with the second reference signal indicated by the second TCI state. The DM-RS antenna port(s) of the at least one transport block may be quasi co-located with the second reference signal with respect to the second quasi co-location type indicated by the second TCI state. The DM-RS antenna port(s) of the at least one transport block may be quasi co-located with the second reference signal with respect to the second quasi co-location type in the one or more second repetitions (or in the one or more second transmission occasions).

One or more configuration parameters may, for example, not indicate a repetition scheme. The antenna port field may indicate DM-RS port(s) within two CDM groups. The at least one TCI state may be the at least two TCI states comprising the first TCI state and the second TCI state. The wireless device may receive at least one transport block (or other communication), for example, based on the at least two TCI states, for example, based on the second DCI indicating the DM-RS port(s) within two CDM groups. The wireless device may receive the at least one transport block, for example, based on the at least two TCI states, for example, based on the antenna port field of the second DCI indicating the DM-RS port(s) within two CDM groups. The wireless device may receive a first portion (e.g., first layer(s) or first data stream(s) or first symbol(s)) of the at least one transport block with/using the first spatial domain receiving/reception filter/beam. The wireless device may receive the first portion of the at least one transport block in a transmission occasion. The wireless device may receive a second portion (e.g., second layer(s) or second data stream(s) or second symbol(s)) of the at least one transport block with/using the second spatial domain receiving/reception filter/beam. The wireless device may receive the second portion of the at least one transport block in the transmission occasion. First DM-RS antenna port(s) of the at least one transport block may be quasi co-located with the first reference signal indicated by the first TCI state. The first DM-RS antenna port(s) of the at least one transport block may be quasi co-located with the first reference signal with respect to the first quasi co-location type indicated by the first TCI state. Second DM-RS antenna port(s) of the at least one transport block may be quasi co-located with the second reference signal indicated by the second TCI state. The second DM-RS antenna port(s) of the at least one transport block may be quasi co-located with the second reference signal with respect to the second quasi co-location type indicated by the second TCI state. The first TCI state may correspond to (or associated with) a first CDM group of the two CDM groups. The second TCI state may correspond to (or associated with) a second CDM group of the two CDM groups. The first DM-RS antenna port(s) and the second DM-RS antenna port(s) may be, for example, different.

At least one TCI state may not be associated with a TRP. The one or more configuration parameters may not indicate, for the at least one TCI state, a field (e.g., Unified/Common/Joint TCI state index field, TRP index field, CORESET pool index field, and the like) indicating an association between the at least one TCI state and a TRP. The at least one TCI state may not be associated explicitly or implicitly with a TRP. This lack of association may reduce signaling overhead. The one or more configuration parameters may not need to comprise/indicate an association between the at least one TCI state and a TRP (or a TRP index, CORESET pool index, Unified/Common/Joint TCI state index field, and the like). This operation may reduce RRC message size (and/or the size of the configuration parameters).

Each TCI state of the at least one TCI state may not be associated with a TRP. The one or more configuration parameters may not indicate, for each TCI state of the at least one TCI state, a field (e.g., Unified/Common/Joint TCI state index field, TRP index field, CORESET pool index field, and the like) indicating an association between a TCI state and a TRP. Each TCI state of the at least one TCI state may not be associated explicitly or implicitly with a TRP. This lack of association may reduce signaling overhead. The one or more configuration parameters may not need to comprise/indicate an association between each TCI state of the at least one TCI state and a TRP (or a TRP index, CORESET pool index, Unified/Common/Joint TCI state index field, and the like). This operation may reduce RRC message size (and/or or the size of the configuration parameters).

The at least one TCI state may be a first/starting/earliest TCI state among the at least two TCI states. The at least one TCI state may be the first/starting/earliest TCI state in a vector/set/list of the at least two TCI states. The at least one TCI state may be a first/starting/earliest element in a vector/set/list of the at least two TCI states. The at least one TCI state may be a first/starting/earliest TCI state among the at least two TCI states in (or indicated by) the TCI codepoint. A position/location of the at least one TCI state (or the first/starting/earliest TCI state) may be earliest/highest/lowest in the vector of the at least two TCI states. The at least one TCI state (or the first/starting/earliest TCI state) may occur first in a vector/set/list of the at least two TCI states. The at least one TCI state is TCI state 26, for example, if the vector of the at least two TCI states is equal to [TCI state 26, TCI state 61]. The at least one TCI state is TCI state 2, for example, if the vector of the at least two TCI states is equal to [TCI state 2, TCI state 1].

The at least one TCI state may be the first TCI state (e.g., TCI state 26 in FIG. 17). The at least one TCI state may be the first TCI state, for example, based on the first TCI state being the first/starting/earliest TCI state in the vector/set/list of the at least two TCI states.

A wireless device may transmit/receive at least one transport block (or other communication) based on the at least one TCI state (or the first/starting/earliest TCI state), for example, based on (e.g., in response to) the at least one TCI state (or the first/starting/earliest TCI state) being the first/starting/earliest TCI state in the vector/set/list of the at least two TCI states. The wireless device may select/determine, for transmission/reception of the at least one transport block, the at least one TCI state among the at least two TCI states, for example, based on the at least one TCI state being the first/starting/earliest TCI state in the vector/set/list of the at least two TCI states.

A TCI state index of the first/starting/earliest TCI state may be lowest (or highest) among at least two TCI state indexes of the at least two TCI states. The first/starting/earliest TCI state may be indicated/identified by/with the TCI state index that is lowest (or highest) among the at least two TCI state indexes of the at least two TCI states. The plurality of TCI state indexes may comprise the at least two TCI state indexes. The at least two TCI state indexes may comprise the TCI state index of the first/starting/earliest TCI state. Each TCI state of the at least two TCI states may be indicated/identified by a respective TCI state index of the at least two TCI state indexes. For example, the first/starting/earliest TCI state may be the first TCI state (e.g., TCI state 26) based on a first TCI state index of the first TCI state being lower (or higher) than a second TCI state index of the second TCI state. For example, the first/starting/earliest TCI state may be the second TCI state (e.g., TCI state 61) based on a second TCI state index of the second TCI state being lower (or higher) than a first TCI state index of the first TCI state. The at least two TCI state indexes may comprise the first TCI state index and the second TCI state index.

A wireless device may transmit/receive the at least one transport block based on the at least one TCI state (or the first/starting/earliest TCI state), for example, based on (e.g., in response to) the TCI state index of the first/starting/earliest TCI state being lowest (or highest) among the at least two TCI state indexes of the at least two TCI states. A wireless device may select/determine, for transmission/reception of the transport block, the at least one TCI state among the at least two TCI states, for example, based on the TCI state index of the first/starting/earliest TCI state being lowest (or highest) among the at least two TCI state indexes of the at least two TCI states.

Using the first/starting/earliest TCI state as a default/reference TCI state may reduce complexity of the wireless device. This operation may reduce configuration message size (e.g., no need to indicate an association between the transport block and the at least one TCI state.

Using the first/starting/earliest TCI state as a default/reference TCI state may reduce flexibility. The wireless device may not use, for transmission/reception of transport block(s), a second/second starting/second earliest/last/latest TCI state among the at least two TCI states. The second/second starting/second earliest/last/latest TCI state may be different from the first/starting/earliest TCI state.

Second DCI may not indicate a repetition. The second DCI may comprise a TDRA field indicating a row/entry in the one or more rows/entries in/of the TDRA table. The row/entry may comprise/indicate a quantity/number of repetitions (e.g., repetitionNumber) that is equal to one (or any other value).

A wireless device may transmit/receive the at least one transport block based on the at least one TCI state (or the first/starting/earliest TCI state), for example, based on (e.g., in response to) the second DCI not indicating a repetition (or indicating no repetition). The wireless device may transmit/receive the at least one transport block based on the at least one TCI state (or the first/starting/earliest TCI state), for example, based on (e.g., in response to) the row/entry indicating the quantity/number of repetitions that is equal to one. The wireless device may transmit/receive the transport block based on the at least one TCI state (or the first/starting/earliest TCI state), for example, based on (e.g., in response to) the row/entry not indicating a repetition (or indicating no repetition).

A wireless device may select/determine, for transmission/reception of the at least one transport block, the at least one TCI state (or the first/starting/earliest TCI state) among the at least two TCI states, for example, based on the second DCI not indicating a repetition (or indicating no repetition). The wireless device may select/determine, for transmission/reception of the transport block, the at least one TCI state (or the first/starting/earliest TCI state) among the at least two TCI states, for example, based on the row/entry indicating the quantity/number of repetitions that is equal to one. The wireless device may select/determine, for transmission/reception of the at least one transport block, the at least one TCI state (or the first/starting/earliest TCI state) among the at least two TCI states, for example, based on the row/entry not indicating a repetition (or indicating no repetition). Second DCI may be a fallback DCI. The fallback DCI may comprise, for example, a DCI format 0-0. The fallback DCI may comprise, for example, a DCI format 1-0.

A wireless device may transmit/receive at least one transport block (or other communication) based on the at least one TCI state (or the first/starting/earliest TCI state), for example, based on (e.g., in response to) the second DCI being a fallback DCI (e.g., DCI format 0-0, DCI format 1-0). The wireless device may select/determine, for transmission/reception of the at least one transport block, the at least one TCI state (or the first/starting/earliest TCI state) among the at least two TCI states, for example, based on the second DCI being a fallback DCI (e.g., DCI format 0-0, DCI format 1-0).

Second DCI may not comprise a TCI field. The second DCI may be a non-fallback DCI (e.g., DCI format 0-1, DCI format 1-1, DCI format 1-2, DCI format 0-2, and the like). The one or more configuration parameters may not comprise, for the CORESET that the wireless device receives the second DCI, a TCI-present-In-DCI parameter (e.g., tci-PresentInDCI). The one or more configuration parameters may not comprise, for the CORESET that the wireless device receives the second DCI, a TCI-present-In-DCI parameter that is enabled. The second DCI may not comprise the TCI field, for example, based on the second DCI being sent (e.g., transmitted) by the base station via the CORESET without (or not configured with) the TCI-present-In-DCI parameter. The second DCI may not comprise the TCI field, for example, based on the second DCI being sent (e.g., transmitted) by the base station via the CORESET without (or not configured with) the TCI-present-In-DCI parameter that is enabled.

A wireless device may transmit/receive the at least one transport block based on the at least one TCI state (or the first/starting/earliest TCI state), for example, based on (e.g., in response to) the second DCI not comprising the TCI field. The wireless device may transmit/receive the at least one transport block based on the at least one TCI state (or the first/starting/earliest TCI state), for example, based on (e.g., in response to) receiving the second DCI via the CORESET without (or not configured with) the TCI-present-In-DCI parameter. The wireless device may transmit/receive the at least one transport block based on the at least one TCI state (or the first/starting/earliest TCI state), for example, based on (e.g., in response to) the one or more configuration parameters not comprising, for the CORESET, the TCI-present-In-DCI parameter.

A wireless device may select/determine, for transmission/reception of at least one transport block (or other communication), at least one TCI state (or the first/starting/earliest TCI state) among at least two TCI states, for example, based on second DCI not comprising TCI field. The wireless device may select/determine, for transmission/reception of the at least one transport block, the at least one TCI state (or the first/starting/earliest TCI state) among the at least two TCI states, for example, based on receiving the second DCI via the CORESET without (or not configured with) the TCI-present-In-DCI parameter. The wireless device may select/determine, for transmission/reception of the at least one transport block, the at least one TCI state (or the first/starting/earliest TCI state) among the at least two TCI states, for example, based on the one or more configuration parameters not comprising, for the CORESET, the TCI-present-In-DCI parameter.

A wireless device may transmit/receive the at least one transport block based on the at least one TCI state (or the first/starting/earliest TCI state), for example, based on (e.g., in response to) the one or more search space sets associated with the CORESET being USS set(s) and/or Type3-PDCCH CSS set(s). The wireless device may transmit/receive the at least one transport block based on the at least one TCI state (or the first/starting/earliest TCI state), for example, based on (e.g., in response to) each search space set of the one or more search space sets associated with the CORESET being a USS set or a Type3-PDCCH CSS set. The wireless device may transmit/receive the at least one transport block based on the at least one TCI state (or the first/starting/earliest TCI state), for example, based on (e.g., in response to) at least one search space set of the one or more search space sets associated with the CORESET being a USS set or a Type3-PDCCH CSS set. The wireless device may transmit/receive the at least one transport block based on the at least one TCI state (or the first/starting/earliest TCI state), for example, based on (e.g., in response to) receiving the second DCI via a search space set that is a USS set or a Type3-PDCCH CSS set. The one or more search space sets associated with the CORESET may comprise the search space set. The wireless device may receive the second DCI in a PDCCH monitoring occasion of (or associated with) the search space set.

A wireless device may select/determine, for transmission/reception of the at least one transport block, the at least one TCI state (or the first/starting/earliest TCI state) among the at least two TCI states, for example, based on the one or more search space sets associated with the CORESET being USS set(s) and/or Type3-PDCCH CSS set(s). The wireless device may select/determine, for transmission/reception of the at least one transport block, the at least one TCI state (or the first/starting/earliest TCI state) among the at least two TCI states, for example, based on each search space set of the one or more search space sets associated with the CORESET being a USS set or a Type3-PDCCH CSS set. The wireless device may select/determine, for transmission/reception of the at least one transport block, the at least one TCI state (or the first/starting/earliest TCI state) among the at least two TCI states, for example, based on at least one search space set of the one or more search space sets associated with the CORESET being a USS set or a Type3-PDCCH CSS set. The wireless device may select/determine, for transmission/reception of the at least one transport block, the at least one TCI state (or the first/starting/earliest TCI state) among the at least two TCI states, for example, based on the search space set that the wireless device receives the second DCI being a USS set or a Type3-PDCCH CSS set.

A wireless device may transmit/receive at least one transport block (or other communication) based on at least one TCI state (or the first/starting/earliest TCI state), for example, based on (e.g., in response to) one or more search space sets associated with the CORESET being CSS set(s). The wireless device may transmit/receive the at least one transport block based on the at least one TCI state (or the first/starting/earliest TCI state), for example, based on (e.g., in response to) each search space set of the one or more search space sets associated with the CORESET being a CSS set. The wireless device may transmit/receive the at least one transport block based on the at least one TCI state (or the first/starting/earliest TCI state), for example, based on (e.g., in response to) each search space set of the one or more search space sets associated with the CORESET being a CSS set other than a Type3-PDCCH CSS set. The wireless device may transmit/receive the at least one transport block based on the at least one TCI state (or the first/starting/earliest TCI state), for example, based on (e.g., in response to) the search space set that the wireless device receives the second DCI being a CSS set. The wireless device may transmit/receive the at least one transport block based on the at least one TCI state (or the first/starting/earliest TCI state), for example, based on (e.g., in response to) the search space set that the wireless device receives the second DCI being a CSS set other than a Type3-PDCCH CSS set.

A wireless device may select/determine, for transmission/reception of at least one transport block (or other communication), at least one TCI state (or the first/starting/earliest TCI state) among at least two TCI states, for example, based on the one or more search space sets associated with the CORESET being CSS set(s). The wireless device may select/determine, for transmission/reception of the at least one transport block, the at least one TCI state (or the first/starting/earliest TCI state) among the at least two TCI states, for example, based on each search space set of the one or more search space sets associated with the CORESET being a CSS set. The wireless device may select/determine, for transmission/reception of the at least one transport block, the at least one TCI state (or the first/starting/earliest TCI state) among the at least two TCI states, for example, based on each search space set of the one or more search space sets associated with the CORESET being a CSS set other than a Type3-PDCCH CSS set. The wireless device may select/determine, for transmission/reception of the at least one transport block, the at least one TCI state (or the first/starting/earliest TCI state) among the at least two TCI states, for example, based on the search space set that the wireless device receives the second DCI being a CSS set. The wireless device may select/determine, for transmission/reception of the transport block, the at least one TCI state (or the first/starting/earliest TCI state) among the at least two TCI states, for example, based on the search space set that the wireless device receives the second DCI being a CSS set other than a Type3-PDCCH CSS set.

One or more configuration parameters may not indicate an SFN scheme/mode. The one or more configuration parameters may not comprise an SFN parameter (e.g., sfnSchemePdcch, sfnSchemePdsch) indicating an SFN scheme. The one or more configuration parameters may not indicate an SFN scheme, for example, for downlink control channels (e.g., PDCCH, sfnSchemePdcch). The one or more configuration parameters may not indicate an SFN scheme, for example, for downlink shared channels (e.g., PDSCH, sfnSchemePdsch).

A wireless device may transmit/receive at least one transport block (or other communication) based on at least one TCI state (or the first/starting/earliest TCI state), for example, based on (e.g., in response to) the one or more configuration parameters not indicating an SFN scheme. The wireless device may transmit/receive the at least one transport block based on the at least one TCI state (or the first/starting/earliest TCI state), for example, based on (e.g., in response to) the one or more configuration parameters not comprising the SFN parameter indicating an SFN scheme.

A wireless device may select/determine, for transmission/reception of the at least one transport block, the at least one TCI state (or the first/starting/earliest TCI state) among the at least two TCI states, for example, based on the one or more configuration parameters not indicating an SFN scheme. The wireless device may select/determine, for transmission/reception of the at least one transport block, the at least one TCI state (or the first/starting/earliest TCI state) among the at least two TCI states, for example, based on the one or more configuration parameters not comprising the SFN parameter indicating an SFN scheme.

Second DCI may indicate a repetition. The second DCI may comprise a TDRA field indicating a row/entry in the one or more rows/entries in/of the TDRA table. The row/entry may comprise/indicate a quantity/number of repetitions (e.g., repetitionNumber). The quantity/number of repetitions may be, for example, greater/larger than one. The quantity/number of repetitions may be, for example, 2, 4, or 8, and so on.

The at least one TCI state may be the at least two TCI states, for example, based on the quantity/number of repetitions being greater/larger than one. The wireless device may transmit/receive the at least one transport block based on the at least two TCI states, for example, based on (e.g., in response to) the second DCI indicating the quantity/number of repetitions that is greater/larger than one. The wireless device may transmit/receive the transport block based on the at least two TCI states, for example, based on (e.g., in response to) the row/entry indicating the quantity/number of repetitions that is greater/larger than one.

A wireless device may select/determine, for transmission/reception of the at least one transport block, the at least two TCI states. The wireless device may select/determine the at least two states based on the second DCI indicating a quantity/number of repetitions that is greater/larger than one. The wireless device may select/determine the at least two TCI states based on the row/entry indicating the quantity/number of repetitions that is greater/larger than one.

The at least one TCI state may be the at least two TCI states. The wireless device may transmit/receive at least one transport block (or any communication) based on the at least two TCI states. The wireless device may transmit/receive the at least one transport block based on the at least two TCI states, for example, based on (e.g., in response to) the one or more search space sets associated with the CORESET being USS set(s) and/or Type3-PDCCH CSS set(s). The wireless device may transmit/receive the at least one transport block based on the at least two TCI states, for example, based on (e.g., in response to) each search space set of the one or more search space sets associated with the CORESET being a USS set or a Type3-PDCCH CSS set. The wireless device may transmit/receive the at least one transport block based on the at least two TCI states, for example, based on (e.g., in response to) at least one search space set of the one or more search space sets associated with the CORESET being a USS set or a Type3-PDCCH CSS set. The wireless device may transmit/receive the at least one transport block based on the at least two TCI states, for example, based on (e.g., in response to) receiving the second DCI via a search space set that is a USS set or a Type3-PDCCH CSS set. The one or more search space sets associated with the CORESET may comprise the search space set. The wireless device may receive the second DCI in a PDCCH monitoring occasion of (or associated with) the search space set.

A wireless device may select/determine (e.g., for transmission/reception of at least one transport block) at least two TCI states among at least two TCI states. The wireless device may select/determine the at least two states, for example, based on the one or more search space sets associated with the CORESET being USS set(s) and/or Type3-PDCCH CSS set(s). The wireless device may select/determine, for transmission/reception of the at least one transport block, the at least two TCI states among the at least two TCI states, for example, based on each search space set of the one or more search space sets associated with the CORESET being a USS set or a Type3-PDCCH CSS set. The wireless device may select/determine, for transmission/reception of the at least one transport block, the at least two TCI states among the at least two TCI states, for example, based on at least one search space set of the one or more search space sets associated with the CORESET being a USS set or a Type3-PDCCH CSS set. The wireless device may select/determine, for transmission/reception of the at least one transport block, the at least two TCI states among the at least two TCI states, for example, based on the search space set that the wireless device receives the second DCI being a USS set or a Type3-PDCCH CSS set.

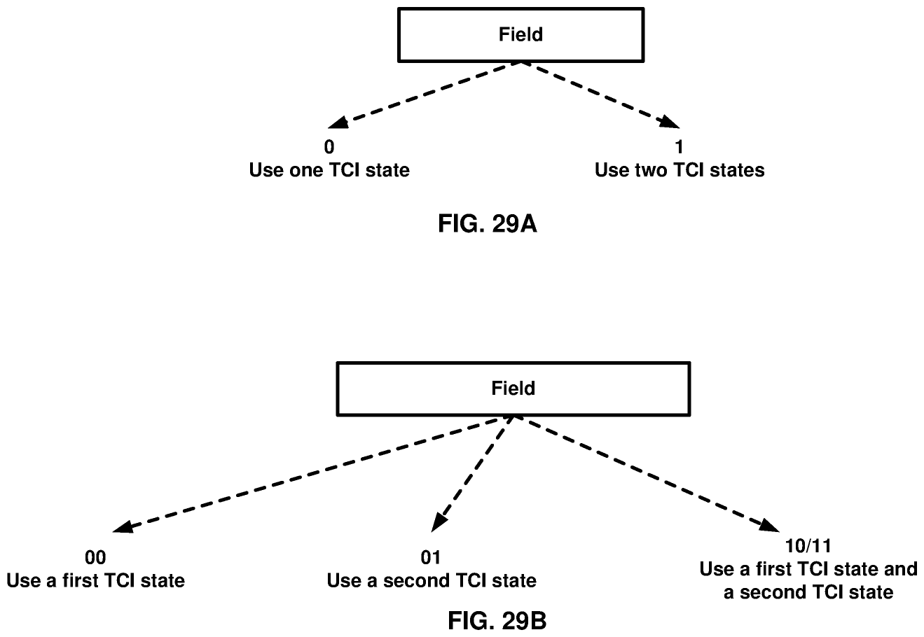

FIG. 29A and FIG. 29B show examples of a field and associated TCI state indication. The field may comprise a field in downlink control information (or any type of message, such as a MAC CE). The field may be used for a unified beam update. DCI (e.g., the second DCI described herein) may comprise the field (e.g., Unified/Common/Joint TCI state index field, TRP index field, CORESET pool index field, and the like). One or more configuration parameters may indicate the presence of the field (e.g., in the second DCI). The one or more configuration parameters may comprise a parameter (e.g., FieldPresenceDCI, Unified/Common/JointTCIFieldPresenceDCI, TRPFieldPresenceDCI, and the like) indicating the presence of the field in the second DCI. The parameter may indicate/configure whether the field is present or not in the second DCI (or in a DCI format 0-x, or in a DCI format 1-x, x=0, 1, 2, . . . ). The second DCI may comprise the field, for example, based on the one or more configuration parameters indicating the presence of the field in the second DCI. The second DCI may comprise the field, for example, based on the one or more configuration parameters comprising the parameter (e.g., FieldPresenceDCI, Unified/Common/JointTCIFieldPresenceDCI, TRPFieldPresenceDCI, and the like) indicating the presence of the field in the second DCI. The second DCI may not comprise the field (e.g., Unified/Common/Joint TCI state index field, TRP index field, CORESET pool index field, and the like), for example, if the one or more configuration parameters do not comprise the parameter (e.g., FieldPresenceDCI, Unified/Common/JointTCIFieldPresenceDCI, TRPFieldPresenceDCI, and the like). The field may be absent in the second DCI, for example, if the one or more configuration parameters do not comprise the parameter (e.g., FieldPresenceDCI, Unified/Common/JointTCIFieldPresenceDCI, TRPFieldPresenceDCI, and the like).

One or more configuration parameters may indicate a size/length (or a quantity/number of bits) of/for the field in the second DCI. The one or more configuration parameters may comprise a parameter (e.g., FieldSizeDCI, Unified/Common/JointTCIFieldSizeDCI, TRPFieldSizeDCI, numberOfBitsField-DCI, numberOfBitsUnified/Common/JointTCIField-DCI, numberOfBitsTRPField-DCI and the like) indicating the size/length of the field. A value of the parameter may be equal to, for example, zero (or any other value). The size/length (or the quantity/number of bits) of/for the field in the second DCI may be equal to zero (or the field is absent in the second DCI). A value of the parameter may be equal to, for example, one (or any other value). The size/length (or the quantity/number of bits) of/for the field in the second DCI may be equal to one. A value of the parameter may be equal to, for example, two. The size/length (e.g., the quantity/number of bits) of/for the field in DCI may be equal to two. The size/length of the field in the second DCI may be equal to two (e.g., Field in FIG. 29B). The field may be, for example, a 2-bit field. The field may be equal/set to either 00, 01, 10 or 11, for example, based on the field being a 2-bit field. The field may be any quantity/number of bits (e.g., 0, 1, 2, 3, 4, etc.).

The field may be a 2-bit field, for example, if a multi-TRP uplink (e.g., PUSCH, PUCCH) repetition is enabled/configured. The field may be a 2-bit field, for example, based on the one or more configuration parameters indicating a multi-TRP uplink (e.g., PUSCH, PUCCH) repetition. The one or more configuration parameters may indicate, for example, at least two SRS resource sets to indicate the multi-TRP uplink repetition. The one or more configuration parameters may indicate codebook, for example, for each SRS resource set of the at least two SRS resource sets. The one or more configuration parameters may indicate non-codebook, for example, for each SRS resource set of the at least two SRS resource sets. The one or more configuration parameters may indicate, for example, more than one repetition for a PUCCH resource to indicate the multi-TRP uplink repetition.

The field may be a 2-bit field, for example, if a multi-TRP downlink (e.g., PDSCH, PDCCH) repetition is enabled/configured. The field may be a 2-bit field, for example, based on the one or more configuration parameters indicating a multi-TRP downlink (e.g., PDSCH, PDCCH) repetition. The one or more configuration parameters may indicate, for example, a repetition scheme (e.g., ‘fdmSchemeA’, ‘fdmSchemeB’, ‘tdmSchemeA’) to indicate the multi-TRP downlink repetition. The second DCI may comprise a TDRA field indicating a row/entry, in the one or more rows/entries in/of the TDRA table, comprising/indicating a quantity/number of repetitions (e.g., repetitionNumber) to indicate the multi-TRP downlink repetition. The second DCI may comprise the antenna port field indicating DM-RS port(s) within two CDM groups to indicate the multi-TRP downlink repetition.

The field may indicate the at least one TCI state. A value of the field may indicate the at least one TCI state. The field (or the value of the field) may indicate whether to apply/use the first TCI state and/or the second TCI state for transmission/reception of the at least one transport block.

A wireless device may transmit/receive at least one transport block (or any communication) based on the at least one TCI state, for example, based on (e.g., in response to) the second DCI comprising a field that indicates the at least one TCI state. The wireless device may apply/use/select/determine, for transmission/reception of the at least one transport block, the at least one TCI state among the at least two TCI states, for example, based on the second DCI comprising the field that indicates the at least one TCI state.

A first value (e.g., 00 in FIG. 29B) of the field may indicate the first TCI state (e.g., TCI state 26). The at least one TCI state may be the first TCI state, for example, based on the value of the field being equal/set to the first value. The wireless device may receive/transmit the at least one transport block based on the first TCI state, for example, based on (e.g., in response to) the value of the field being equal to the first value. The wireless device may send (e.g., transmit) the at least one transport block with/using a first spatial domain transmission/transmitting filter/beam that may be determined based on the first reference signal indicated by the first TCI state. The wireless device may transmit the at least one transport block with/using a first transmission power that may be determined based on one or more first power control parameters (e.g., target received power, closed-loop index, pathloss compensation factor, alpha, pathloss reference signal, and the like) indicated by (or included in or associated with or mapped to) the first TCI state. The wireless device may receive the at least one transport block with/using a first spatial domain receiving/reception filter/beam that is determined based on the first reference signal indicated by the first TCI state. DM-RS antenna port(s) of the at least one transport block may be quasi co-located with a first reference signal indicated by the first TCI state. The DM-RS antenna port(s) of the at least one transport block may be quasi co-located with the first reference signal with respect to a first quasi co-location type indicated by the first TCI state.

A second value (e.g., 01 in FIG. 29B) of the field may indicate the second TCI state (e.g., TCI state 61). The at least one TCI state may be the second TCI state, for example, based on the value of the field being equal to the second value. The wireless device may receive/transmit the at least one transport block based on the second TCI state, for example, based on (e.g., in response to) the value of the field being equal to the second value. The wireless device may send (e.g., transmit) the at least one transport block with a second spatial domain transmission/transmitting filter/beam that is determined based on the second reference signal indicated by the second TCI state. The wireless device may send (e.g., transmit) the at least one transport block with/using a second transmission power that may be determined based on one or more second power control parameters (e.g., target received power, closed-loop index, pathloss compensation factor, alpha, pathloss reference signal, and the like) indicated by (or included in or associated with or mapped to) the second TCI state. The wireless device may receive the at least one transport block with a second spatial domain receiving/reception filter/beam that may be determined based on the second reference signal indicated by the second TCI state. DM-RS antenna port(s) of the at least one transport block may be quasi co-located with a second reference signal indicated by the second TCI state. The DM-RS antenna port(s) of the at least one transport block may be quasi co-located with the second reference signal with respect to a second quasi co-location type indicated by the second TCI state.

A third value (e.g., 10 in FIG. 29B) of the field may indicate the first TCI state (e.g., TCI state 26) and the second TCI state (e.g., TCI state 61). The at least one TCI state may be the first TCI state and the second TCI state (or may be the at least two TCI states), for example, based on the value of the field being equal to the third value. The wireless device may send (e.g., transmit) the at least one transport block based on the first TCI state and the second TCI state, for example, based on (e.g., in response to) the value of the field being equal to the third value. The wireless device may send (e.g., transmit) the at least one transport block with/using the first spatial domain transmitting/transmission filter/beam that may be determined based on the first reference signal indicated by the first TCI state. The wireless device may send (e.g., transmit) the at least one transport block with/using the second spatial domain transmitting/transmission filter/beam that may be determined based on the second reference signal indicated by the second TCI state. For example, the wireless device may send (e.g., transmit) one or more first repetitions of the at least one transport block with/using the first spatial domain transmitting/transmission filter/beam. The wireless device may send (e.g., transmit) one or more second repetitions of the at least one transport block with the second spatial domain transmitting/transmission filter/beam. The wireless device may send (e.g., transmit) the at least one transport block with/using the first transmission power that may be determined based on the one or more first power control parameters indicated by (or included in or associated with or mapped to) the first TCI state. The wireless device may send (e.g., transmit) the at least one transport block with/using the second transmission power that may be determined based on the one or more second power control parameters indicated by (or included in or associated with or mapped to) the second TCI state. The wireless device may send (e.g., transmit) the one or more first repetitions of the at least one transport block with/using the first transmission power. The wireless device may send (e.g., transmit) the one or more second repetitions of the at least one transport block with/using the second transmission power.

A wireless device may send (e.g., transmit) a first/starting/earliest/initial repetition of at least one transport block (or any communication) with/using a first spatial domain transmitting/transmission filter/beam, for example, based on a value of the field being equal to/set to the third value. The one or more first repetitions may comprise the first/starting/earliest/initial repetition. The wireless device may send (e.g., transmit) the first/starting/earliest/initial repetition of the at least one transport block with/using the first transmission power, for example, based on the value of the field being equal to/set to the third value. The wireless device may send (e.g., transmit) the first/starting/earliest/initial repetition of the transport block to a first TRP, for example, based on the value of the field being equal to/set to the third value. The wireless device may send (e.g., transmit) repetitions of the at least one transport block with/using spatial domain transmission/transmitting filters/beams in an order (e.g., an order of the first spatial domain transmitting/transmission filter/beam, the first spatial domain transmitting/transmission filter/beam, the second spatial domain transmitting/transmission filter/beam, the second spatial domain transmitting/transmission filter/beam) based on the one or more configuration parameters indicating sequential beam mapping, for example, if the repetition quantity/number of the at least one transport block is equal to four. The wireless device may send (e.g., transmit) repetitions of the at least one transport block with/using spatial domain transmission/transmitting filters/beams in an order (e.g., an order of the first spatial domain transmitting/transmission filter/beam, the second spatial domain transmitting/transmission filter/beam, the first spatial domain transmitting/transmission filter/beam, the second spatial domain transmitting/transmission filter/beam), for example, based on the one or more configuration parameters indicating cyclic beam mapping. The wireless device may send (e.g., transmit) repetitions of the at least one transport block with/using transmission powers in an order (e.g., an order of the first transmission power, the first transmission power, the second transmission power, the second transmission power), for example, based on the one or more configuration parameters indicating sequential beam mapping. The wireless device may send (e.g., transmit) repetitions of the at least one transport block with/using transmission powers in an order of [the first transmission power, the second transmission power, the first transmission power, the second transmission power], for example, based on the one or more configuration parameters indicating cyclic beam mapping. The wireless device may send (e.g., transmit) repetitions of the at least one transport block based on TCI states in an order of [the first TCI state, the first TCI state, the second TCI state, the second TCI state], for example, based on the one or more configuration parameters indicating sequential beam mapping. The wireless device may send (e.g., transmit) repetitions of the at least one transport block based on TCI states in an order of [the first TCI state, the second TCI state, the first TCI state, the second TCI state], for example, based on the one or more configuration parameters indicating cyclic beam mapping.

A third value (e.g., 10) of the field may indicate the first TCI state (e.g., TCI state 26) and the second TCI state (e.g., TCI state 61). The at least one TCI state may be the first TCI state and the second TCI state (or may be the at least two TCI states), for example, based on the value of the field being equal to the third value. The wireless device may send (e.g., transmit) the at least one transport block based on the first TCI state and the second TCI state, for example, based on (e.g., in response to) the value of the field being equal to the third value. For example, the wireless device may transmit a first portion (e.g., first layer(s) or first data stream(s) or first symbol(s)) of the at least one transport block with/using the first spatial domain transmitting/transmission filter/beam that may be determined based on the first reference signal indicated by the first TCI state. The wireless device may send (e.g., transmit) the first portion of the at least one transport block in a transmission occasion. The wireless device may send (e.g., transmit) a second portion (e.g., second layer(s) or second data stream(s) or second symbol(s)) of the at least one transport block with/using the second spatial domain transmitting/transmission filter/beam that may be determined based on the second reference signal indicated by the second TCI state. The wireless device may send (e.g., transmit) the second portion of the at least one transport block in the transmission occasion. For example, the wireless device may send (e.g., transmit) the first portion (e.g., first layer(s) or first data stream(s) or first symbol(s)) of the at least one transport block with/using the first transmission power that may be determined based on the one or more first power control parameters indicated by (or included in or associated with or mapped to) the first TCI state. The wireless device may send (e.g., transmit) the second portion (e.g., second layer(s) or second data stream(s) or second symbol(s)) of the at least one transport block with/using the second transmission power that may be determined based on the one or more second power control parameters indicated by (or included in or associated with or mapped to) the second TCI state.

A third value (e.g., 10) of the field may indicate the first TCI state (e.g., TCI state 26) and the second TCI state (e.g., TCI state 61). The at least one TCI state may be the first TCI state and the second TCI state (or may be the at least two TCI states), for example, based on the value of the field being equal to the third value. The wireless device may receive the at least one transport block based on the first TCI state and the second TCI state, for example, based on (e.g., in response to) the value of the field being equal to the third value. The wireless device may receive the at least one transport block with/using the first spatial domain receiving/reception filter/beam that may be determined based on the first reference signal indicated by the first TCI state. The wireless device may receive the at least one transport block with/using the second spatial domain receiving/reception filter/beam that may be determined based on the second reference signal indicated by the second TCI state. For example, the wireless device may receive one or more first repetitions of the at least one transport block with/using the first spatial domain receiving/reception filter/beam. The wireless device may receive one or more second repetitions of the at least one transport block with/using the second spatial domain receiving/reception filter/beam. DM-RS antenna port(s) of the transport block may be quasi co-located with the first reference signal indicated by the first TCI state. The DM-RS antenna port(s) of the at least one transport block may be quasi co-located with the first reference signal with respect to the first quasi co-location type indicated by the first TCI state. The DM-RS antenna port(s) of the at least one transport block may be quasi co-located with the first reference signal with respect to the first quasi co-location type in the one or more first repetitions. The DM-RS antenna port(s) of the at least one transport block may be quasi co-located with the second reference signal indicated by the second TCI state. The DM-RS antenna port(s) of the at least one transport block may be quasi co-located with the second reference signal with respect to the second quasi co-location type indicated by the second TCI state. The DM-RS antenna port(s) of the at least one transport block may be quasi co-located with the second reference signal with respect to the second quasi co-location type in the one or more second repetitions.

A wireless device may receive a first/starting/earliest/initial repetition of the at least one transport block with/using the first spatial domain receiving/reception filter/beam, for example, based on the value of the field being equal to/set to the third value. The one or more first repetitions may comprise the first/starting/earliest/initial repetition. The wireless device may receive the first/starting/earliest/initial repetition of the at least one transport block based on the first TCI state, for example, based on (e.g., in response to) the value of the field being equal to/set to the third value. The wireless device may receive the first/starting/earliest/initial repetition of the at least one transport block from a first TRP, for example, based on the value of the field being equal to/set to the third value. The wireless device may receive repetitions of the at least one transport block with/using spatial domain receiving/reception filters/beams in an order of [the first spatial domain receiving/reception filter/beam, the first spatial domain receiving/reception filter/beam, the second spatial domain receiving/reception filter/beam, the second spatial domain receiving/reception filter/beam] based on the one or more configuration parameters indicating sequential beam mapping, for example, if the repetition number of the transport block is equal to four. The wireless device may receive repetitions of the at least one transport block with/using spatial domain receiving/reception filters/beams in an order of [the first spatial domain receiving/reception filter/beam, the second spatial domain receiving/reception filter/beam, the first spatial domain receiving/reception filter/beam, the second spatial domain receiving/reception filter/beam], for example, based on the one or more configuration parameters indicating cyclic beam mapping. The wireless device may receive repetitions of the at least one transport block based on TCI states in an order of [the first TCI state, the first TCI state, the second TCI state, the second TCI state], for example, based on the one or more configuration parameters indicating sequential beam mapping. The wireless device may receive repetitions of the at least one transport block based on TCI states in an order of [the first TCI state, the second TCI state, the first TCI state, the second TCI state], for example, based on the one or more configuration parameters indicating cyclic beam mapping.

A third value (e.g., 10) of the field may indicate the first TCI state (e.g., TCI state 26) and the second TCI state (e.g., TCI state 61). The at least one TCI state may be the first TCI state and the second TCI state (or may be the at least two TCI states), for example, based on the value of the field being equal to the third value. The wireless device may receive the at least one transport block based on the first TCI state and the second TCI state, for example, based on (e.g., in response to) the value of the field being equal to the third value. For example, the wireless device may receive a first portion (e.g., first layer(s) or first data stream(s) or first symbol(s)) of the at least one transport block with/using the first spatial domain reception/receiving filter/beam that may be determined based on the first reference signal indicated by the first TCI state. The wireless device may receive the first portion of the at least one transport block in a transmission occasion. The wireless device may receive a second portion (e.g., second layer(s) or second data stream(s) or second symbol(s)) of the at least one transport block with/using the second spatial domain reception/receiving filter/beam that may be determined based on the second reference signal indicated by the second TCI state. The wireless device may receive the second portion of the at least one transport block in the transmission occasion. For example, the first portion (e.g., first layer(s) or first data stream(s) or first symbol(s)) of the at least one transport block may be quasi co-located with the first reference signal indicated by the first TCI state. The first portion of the at least one transport block may be quasi co-located with the first reference signal with respect to the first quasi co-location type indicated by the first TCI state. The second portion (e.g., second layer(s) or second data stream(s) or second symbol(s)) of the at least one transport block may be quasi co-located with the second reference signal indicated by the second TCI state. The second portion of the at least one transport block may be quasi co-located with the second reference signal with respect to the second quasi co-location type indicated by the second TCI state. For example, first DM-RS antenna port(s) of the at least one transport block may be quasi co-located with the first reference signal indicated by the first TCI state. The first DM-RS antenna port(s) of the at least one transport block may be quasi co-located with the first reference signal with respect to the first quasi co-location type indicated by the first TCI state. Second DM-RS antenna port(s) of the at least one transport block may be quasi co-located with the second reference signal indicated by the second TCI state. The second DM-RS antenna port(s) of the at least one transport block may be quasi co-located with the second reference signal with respect to the second quasi co-location type indicated by the second TCI state. The first TCI state may correspond to (or associated with) a first CDM group of the two CDM groups. The second TCI state may correspond to (or associated with) a second CDM group of the two CDM groups. The first DM-RS antenna port(s) and the second DM-RS antenna port(s) may be, for example, different.

A fourth value (e.g., 11 in FIG. 29B) of the field may indicate the first TCI state (e.g., TCI state 26) and the second TCI state (e.g., TCI state 61). The at least one TCI state may be the first TCI state and the second TCI state (or may be the at least two TCI states), for example, based on the value of the field being equal to the fourth value. The wireless device may send (e.g., transmit) the at least one transport block based on the first TCI state and the second TCI state, for example, based on (e.g., in response to) the value of the field being equal to the fourth value. The wireless device may send (e.g., transmit) the at least one transport block with/using the first spatial domain transmitting/transmission filter/beam that may be determined based on the first reference signal indicated by the first TCI state. The wireless device may send (e.g., transmit) the at least one transport block with/using the second spatial domain transmitting/transmission filter/beam that may be determined based on the second reference signal indicated by the second TCI state. For example, the wireless device may send (e.g., transmit) one or more first repetitions of the at least one transport block with/using the first spatial domain transmitting/transmission filter/beam. The wireless device may send (e.g., transmit) one or more second repetitions of the at least one transport block with/using the second spatial domain transmitting/transmission filter/beam. The wireless device may send (e.g., transmit) the transport block with/using the first transmission power that may be determined based on the one or more first power control parameters indicated by (or included in or associated with or mapped to) the first TCI state. The wireless device may send (e.g., transmit) the at least one transport block with the second transmission power that may be determined based on the one or more second power control parameters indicated by (or included in or associated with or mapped to) the second TCI state. The wireless device may send (e.g., transmit) the one or more first repetitions of the at least one transport block with/using the first transmission power. The wireless device may send (e.g., transmit) the one or more second repetitions of the at least one transport block with/using the second transmission power.

A wireless device may send (e.g., transmit) a first/starting/earliest/initial repetition of at least one transport block (or any communication) with/using the second spatial domain transmitting/transmission filter/beam, for example, based on the value of the field being equal to/set to the fourth value. The one or more second repetitions may comprise the first/starting/earliest/initial repetition. The wireless device may send (e.g., transmit) the first/starting/earliest/initial repetition of the at least one transport block with/using the second transmission power, for example, based on the value of the field being equal to/set to the fourth value. The wireless device may send (e.g., transmit) the first/starting/earliest/initial repetition of the at least one transport block to a second TRP, for example, based on the value of the field being equal to/set to the fourth value. The wireless device may send (e.g., transmit) repetitions of the at least one transport block with/using spatial domain transmission/transmitting filters/beams in an order of [the second spatial domain transmitting/transmission filter/beam, the second spatial domain transmitting/transmission filter/beam, the first spatial domain transmitting/transmission filter/beam, the first spatial domain transmitting/transmission filter/beam] based on the one or more configuration parameters indicating sequential beam mapping, for example, if the repetition number of the at least one transport block is equal to four. The wireless device may send (e.g., transmit) repetitions of the at least one transport block with/using spatial domain transmission/transmitting filters/beams in an order of [the second spatial domain transmitting/transmission filter/beam, the first spatial domain transmitting/transmission filter/beam, the second spatial domain transmitting/transmission filter/beam, the first spatial domain transmitting/transmission filter/beam], for example, based on the one or more configuration parameters indicating cyclic beam mapping. The wireless device may send (e.g., transmit) repetitions of the at least one transport block with/using transmission powers in an order of [the second transmission power, the second transmission power, the first transmission power, the first transmission power], for example, based on the one or more configuration parameters indicating sequential beam mapping. The wireless device may send (e.g., transmit) repetitions of the at least one transport block with/using transmission powers in an order of [the second transmission power, the first transmission power, the second transmission power, the first transmission power], for example, based on the one or more configuration parameters indicating cyclic beam mapping. The wireless device may send (e.g., transmit) repetitions of the at least one transport block based on TCI states in an order of [the second TCI state, the second TCI state, the first TCI state, the first TCI state], for example, based on the one or more configuration parameters indicating sequential beam mapping. The wireless device may send (e.g., transmit) repetitions of the at least one transport block based on TCI states in an order of [the second TCI state, the first TCI state, the second TCI state, the first TCI state], for example, based on the one or more configuration parameters indicating cyclic beam mapping.

A fourth value (e.g., 11) of the field may indicate the first TCI state (e.g., TCI state 26) and the second TCI state (e.g., TCI state 61). The at least one TCI state may be the first TCI state and the second TCI state (or may be the at least two TCI states), for example, based on the value of the field being equal to the fourth value. The wireless device may send (e.g., transmit) the at least one transport block based on the first TCI state and the second TCI state, for example, based on (e.g., in response to) the value of the field being equal to the fourth value. For example, the wireless device may send (e.g., transmit) a first portion (e.g., first layer(s) or first data stream(s) or first symbol(s)) of the at least one transport block with/using the first spatial domain transmitting/transmission filter/beam that may be determined based on the first reference signal indicated by the first TCI state. The wireless device may send (e.g., transmit) the first portion of the at least one transport block in a transmission occasion. The wireless device may send (e.g., transmit) a second portion (e.g., second layer(s) or second data stream(s) or second symbol(s)) of the at least one transport block with/using the second spatial domain transmitting/transmission filter/beam that may be determined based on the second reference signal indicated by the second TCI state. The wireless device may send (e.g., transmit) the second portion of the at least one transport block in the transmission occasion. For example, the wireless device may send (e.g., transmit) the first portion (e.g., first layer(s) or first data stream(s) or first symbol(s)) of the at least one transport block with/using the first transmission power that may be determined based on the one or more first power control parameters indicated by (or included in or associated with or mapped to) the first TCI state. The wireless device may send (e.g., transmit) the second portion (e.g., second layer(s) or second data stream(s) or second symbol(s)) of the transport block with/using the second transmission power that may be determined based on the one or more second power control parameters indicated by (or included in or associated with or mapped to) the second TCI state.

A fourth value (e.g., 11) of the field may indicate the first TCI state (e.g., TCI state 26) and the second TCI state (e.g., TCI state 61). The at least one TCI state may be the first TCI state and the second TCI state (or may be the at least two TCI states), for example, based on the value of the field being equal to the fourth value. The wireless device may receive the at least one transport block based on the first TCI state and the second TCI state, for example, based on (e.g., in response to) the value of the field being equal to the fourth value. The wireless device may receive the at least one transport block with/using the first spatial domain receiving/reception filter/beam that is determined based on the first reference signal indicated by the first TCI state. The wireless device may receive the at least one transport block with/using the second spatial domain receiving/reception filter/beam that may be determined based on the second reference signal indicated by the second TCI state. For example, the wireless device may receive one or more first repetitions of the at least one transport block with/using the first spatial domain receiving/reception filter/beam. The wireless device may receive one or more second repetitions of the at least one transport block with/using the second spatial domain receiving/reception filter/beam. DM-RS antenna port(s) of the at least one transport block may be quasi co-located with the first reference signal indicated by the first TCI state. The DM-RS antenna port(s) of the at least one transport block may be quasi co-located with the first reference signal with respect to the first quasi co-location type indicated by the first TCI state. The DM-RS antenna port(s) of the at least one transport block may be quasi co-located with the first reference signal with respect to the first quasi co-location type in the one or more first repetitions. The DM-RS antenna port(s) of the at least one transport block may be quasi co-located with the second reference signal indicated by the second TCI state. The DM-RS antenna port(s) of the at least one transport block may be quasi co-located with the second reference signal with respect to the second quasi co-location type indicated by the second TCI state. The DM-RS antenna port(s) of the at least one transport block may be quasi co-located with the second reference signal with respect to the second quasi co-location type in the one or more second repetitions.

A wireless device may receive a first/starting/earliest/initial repetition of the at least one transport block with/using the second spatial domain receiving/reception filter/beam, for example, based on the value of the field being equal to/set to the fourth value. The one or more second repetitions may comprise the first/starting/earliest/initial repetition. The wireless device may receive the first/starting/earliest/initial repetition of the at least one transport block based on the second TCI state, for example, based on (e.g., in response to) the value of the field being equal to/set to the fourth value. The wireless device may receive the first/starting/earliest/initial repetition of the at least one transport block from a second TRP, for example, based on the value of the field being equal to/set to the fourth value. The wireless device may receive repetitions of the at least one transport block with spatial domain receiving/reception filters/beams in an order of [the second spatial domain receiving/reception filter/beam, the second spatial domain receiving/reception filter/beam, the first spatial domain receiving/reception filter/beam, the first spatial domain receiving/reception filter/beam] based on the one or more configuration parameters indicating sequential beam mapping, for example, if the repetition number of the at least one transport block is equal to four. The wireless device may receive repetitions of the at least one transport block with/using spatial domain receiving/reception filters/beams in an order of [the second spatial domain receiving/reception filter/beam, the first spatial domain receiving/reception filter/beam, the second spatial domain receiving/reception filter/beam, the first spatial domain receiving/reception filter/beam], for example, based on the one or more configuration parameters indicating cyclic beam mapping. The wireless device may receive repetitions of the at least one transport block based on TCI states in an order of [the second TCI state, the second TCI state, the first TCI state, the first TCI state], for example, based on the one or more configuration parameters indicating sequential beam mapping. The wireless device may receive repetitions of the at least one transport block based on TCI states in an order of [the second TCI state, the first TCI state, the second TCI state, the first TCI state], for example, based on the one or more configuration parameters indicating cyclic beam mapping.

A fourth value (e.g., 11) of the field may indicate the first TCI state (e.g., TCI state 26) and the second TCI state (e.g., TCI state 61). The at least one TCI state may be the first TCI state and the second TCI state (or may be the at least two TCI states), for example, based on the value of the field being equal to the fourth value. The wireless device may receive the at least one transport block based on the first TCI state and the second TCI state, for example, based on (e.g., in response to) the value of the field being equal to the fourth value. For example, the wireless device may receive a first portion (e.g., first layer(s) or first data stream(s) or first symbol(s)) of the at least one transport block with/using the first spatial domain reception/receiving filter/beam that may be determined based on the first reference signal indicated by the first TCI state. The wireless device may receive the first portion of the at least one transport block in a transmission occasion. The wireless device may receive a second portion (e.g., second layer(s) or second data stream(s) or second symbol(s)) of the at least one transport block with/using the second spatial domain reception/receiving filter/beam that may be determined based on the second reference signal indicated by the second TCI state. The wireless device may receive the second portion of the at least one transport block in the transmission occasion. For example, the first portion (e.g., first layer(s) or first data stream(s) or first symbol(s)) of the at least one transport block may be quasi co-located with the first reference signal indicated by the first TCI state. The first portion of the at least one transport block may be quasi co-located with the first reference signal with respect to the first quasi co-location type indicated by the first TCI state. The second portion (e.g., second layer(s) or second data stream(s) or second symbol(s)) of the at least one transport block may be quasi co-located with the second reference signal indicated by the second TCI state. The second portion of the at least one transport block may be quasi co-located with the second reference signal with respect to the second quasi co-location type indicated by the second TCI state. For example, first DM-RS antenna port(s) of the at least one transport block may be quasi co-located with the first reference signal indicated by the first TCI state. The first DM-RS antenna port(s) of the at least one transport block may be quasi co-located with the first reference signal with respect to the first quasi co-location type indicated by the first TCI state. Second DM-RS antenna port(s) of the at least one transport block may be quasi co-located with the second reference signal indicated by the second TCI state. The second DM-RS antenna port(s) of the at least one transport block may be quasi co-located with the second reference signal with respect to the second quasi co-location type indicated by the second TCI state. The first TCI state may correspond to (or associated with) a first CDM group of the two CDM groups. The second TCI state may correspond to (or associated with) a second CDM group of the two CDM groups. The first DM-RS antenna port(s) and the second DM-RS antenna port(s) may be, for example, different, which may increase flexibility. The second DCI may dynamically indicate, for transmission/reception of the at least one transport block, the first TCI state and/or the second TCI state, which may increase the size of the second DCI. Adding the field into the second DCI may increase the size of the second DCI. Increased DCI size may reduce coverage.

As described herein, a size/length of a field in DCI (e.g., the second DCI) may be equal to one (e.g., Field in FIG. 29A) or any other value. The field may be, for example, a 1-bit field. The field may be either 0 or 1, for example, based on the field being a 1-bit field. A wireless device may monitor PDCCH transmission(s)/reception(s) in the CORESET based on a TCI state. The plurality of TCI states may comprise the TCI state. The wireless device may receive, via the CORESET, the second DCI based on the TCI state. DM-RS antenna port(s) of the PDCCH transmission(s)/reception(s) in the CORESET may be quasi co-located with a reference signal indicated by the TCI state. The DM-RS antenna port(s) of the PDCCH transmission(s)/reception(s) in the CORESET may be quasi co-located with the reference signal with respect to a quasi co-location type indicated by the TCI state. The DM-RS antenna port(s) of each PDCCH transmission/reception of the PDCCH transmission(s)/reception(s) in the CORESET may be quasi co-located with the reference signal with respect to the quasi co-location type. DM-RS antenna port(s) of a PDCCH transmission/reception with/carrying the second DCI in the CORESET may be quasi co-located with the reference signal with respect to the quasi co-location type. For example, the wireless device may receive a MAC-CE indicating/activating the TCI state for the CORESET. The wireless device may start monitoring the CORESET based on the TCI state, for example, based on (e.g., in response to) receiving the MAC-CE. The MAC-CE may or may not be the activation command at time T1 in FIG. 17. The wireless device may start monitoring the CORESET based on the TCI state, for example, based on (e.g., in response to) receiving the DCI at time T2 in FIG. 17. The at least two TCI states may, for example, comprise the TCI state of the CORESET. For example, the TCI state of the CORESET may be the first TCI state (e.g., TCI state 26). For example, the TCI state of the CORESET may be the second TCI state (e.g., TCI state 61). The at least two TCI states may, for example, not comprise the TCI state of the CORESET. The field may indicate the at least one TCI state. A value of the field may indicate the at least one TCI state.

A wireless device may transmit/receive at least one transport block (or any communication) based on at least one TCI state, for example, based on (e.g., in response to) second DCI comprising a field that indicates the at least one TCI state. The wireless device may apply/use/select/determine, for transmission/reception of the at least one transport block, the at least one TCI state among the at least two TCI states, for example, based on the second DCI comprising the field that indicates the at least one TCI state. For example, the field (or the value of the field) may indicate whether to apply the first TCI state and/or the second TCI state for transmission/reception of the at least one transport block. For example, the field (or the value of the field) may indicate whether to apply/use the TCI state of the CORESET that the wireless device receives the second DCI or the at least two TCI states for transmission/reception of the at least one transport block. The wireless device may send (e.g., transmit) the at least one transport block based on the TCI state of the CORESET, for example, based on (e.g., in response to) the one or more configuration parameters indicating the joint/common UL/DL TCI state mode.

A first value (e.g., 0 in FIG. 29A) of the field may indicate the TCI state of the CORESET. The at least one TCI state may be the TCI state of the CORESET, for example, based on the value of the field being equal/set to the first value. A wireless device may receive/transmit the at least one transport block based on the TCI state of the CORESET, for example, based on (e.g., in response to) the value of the field being equal to the first value. The wireless device may transmit the at least one transport block with a spatial domain transmission/transmitting filter/beam that is determined based on a reference signal indicated by the TCI state of the CORESET. The wireless device may transmit the at least one transport block with/using a transmission power that may be determined based on one or more power control parameters (e.g., target received power, closed-loop index, pathloss compensation factor, alpha, pathloss reference signal, and the like) indicated by (or included in or associated with or mapped to) the TCI state of the CORESET. The wireless device may receive the at least one transport block with/using a spatial domain receiving/reception filter/beam that may be determined based on the reference signal indicated by the TCI state of the CORESET. DM-RS antenna port(s) of the at least one transport block may be quasi co-located with a reference signal indicated by the TCI state of the CORESET. The DM-RS antenna port(s) of the at least one transport block may be quasi co-located with the reference signal with respect to a quasi co-location type indicated by the TCI state of the CORESET.

A wireless device may receive/transmit the at least one transport block based on the first TCI state, for example, if the TCI state of the CORESET is the first TCI state (e.g., TCI state 26). The wireless device may receive/transmit the at least one transport block based on the second TCI state, for example, if the TCI state of the CORESET is the second TCI state (e.g., TCI state 61).

A second value (e.g., 1 in FIG. 29A) of the field may indicate the at least two TCI states. The at least one TCI state may be the at least two TCI states, for example, based on the value of the field being equal to the second value. The second value of the field may indicate the first TCI state and the second TCI state (or the at least two TCI states). The at least one TCI state may be the first TCI state and the second TCI state, for example, based on the value of the field being equal to the second value. The wireless device may send (e.g., transmit) the at least one transport block based on the first TCI state and the second TCI state (or based on the at least two TCI states), for example, based on (e.g., in response to) the value of the field being equal to the second value. The wireless device may send (e.g., transmit) the at least one transport block with/using the first spatial domain transmitting/transmission filter/beam that may be determined based on the first reference signal indicated by the first TCI state. The wireless device may send (e.g., transmit) the at least one transport block with/using the second spatial domain transmitting/transmission filter/beam that may be determined based on the second reference signal indicated by the second TCI state. For example, the wireless device may send (e.g., transmit) one or more first repetitions of the at least one transport block with/using the first spatial domain transmitting/transmission filter/beam. The wireless device may send (e.g., transmit) one or more second repetitions of the at least one transport block with/using the second spatial domain transmitting/transmission filter/beam. The wireless device may send (e.g., transmit) the at least one transport block with/using the first transmission power that may be determined based on the one or more first power control parameters indicated by (or included in or associated with or mapped to) the first TCI state. The wireless device may send (e.g., transmit) the at least one transport block with/using the second transmission power that may be determined based on the one or more second power control parameters indicated by (or included in or associated with or mapped to) the second TCI state. The wireless device may send (e.g., transmit) the one or more first repetitions of the at least one transport block with/using the first transmission power. The wireless device may send (e.g., transmit) the one or more second repetitions of the at least one transport block with/using the second transmission power.

A second value (e.g., 1 in FIG. 29A) of the field may indicate the at least two TCI states. The at least one TCI state may be the at least two TCI states, for example, based on the value of the field being equal to the second value. The second value of the field may indicate the first TCI state and the second TCI state. The at least one TCI state may be the first TCI state and the second TCI state (or may be the at least two TCI states), for example, based on the value of the field being equal to the second value. The wireless device may send (e.g., transmit) the at least one transport block based on the first TCI state and the second TCI state (or based on the at least two TCI states), for example, based on (e.g., in response to) the value of the field being equal to the second value. For example, the wireless device may send (e.g., transmit) a first portion (e.g., first layer(s) or first data stream(s) or first symbol(s)) of the at least one transport block with/using the first spatial domain transmitting/transmission filter/beam that may be determined based on the first reference signal indicated by the first TCI state. The wireless device may send (e.g., transmit) the first portion of the at least one transport block in a transmission occasion. The wireless device may send (e.g., transmit) a second portion (e.g., second layer(s) or second data stream(s) or second symbol(s)) of the at least one transport block with/using the second spatial domain transmitting/transmission filter/beam that may be determined based on the second reference signal indicated by the second TCI state. The wireless device may send (e.g., transmit) the second portion of the at least one transport block in the transmission occasion. For example, the wireless device may send (e.g., transmit) the first portion (e.g., first layer(s) or first data stream(s) or first symbol(s)) of the at least one transport block with/using the first transmission power that may be determined based on the one or more first power control parameters indicated by (or included in or associated with or mapped to) the first TCI state. The wireless device may send (e.g., transmit) the second portion (e.g., second layer(s) or second data stream(s) or second symbol(s)) of the at least one transport block with/using the second transmission power that may be determined based on the one or more second power control parameters indicated by (or included in or associated with or mapped to) the second TCI state.

A second value (e.g., 1 in FIG. 29A) of the field may indicate the at least two TCI states. The at least one TCI state may be the at least two TCI states, for example, based on the value of the field being equal to the second value. The second value of the field may indicate the first TCI state and the second TCI state. The at least one TCI state may be the first TCI state and the second TCI state (or may be the at least two TCI states), for example, based on the value of the field being equal to the second value. The wireless device may receive the at least one transport block based on the first TCI state and the second TCI state (or based on the at least two TCI states), for example, based on (e.g., in response to) the value of the field being equal to the second value. The wireless device may receive the at least one transport block with/using the first spatial domain receiving/reception filter/beam that may be determined based on the first reference signal indicated by the first TCI state. The wireless device may receive the at least one transport block with/using the second spatial domain receiving/reception filter/beam that may be determined based on the second reference signal indicated by the second TCI state. For example, the wireless device may receive one or more first repetitions of the at least one transport block with/using the first spatial domain receiving/reception filter/beam. The wireless device may receive one or more second repetitions of the at least one transport block with/using the second spatial domain receiving/reception filter/beam. DM-RS antenna port(s) of the at least one transport block may be quasi co-located with the first reference signal indicated by the first TCI state. The DM-RS antenna port(s) of the at least one transport block may be quasi co-located with the first reference signal with respect to the first quasi co-location type indicated by the first TCI state. The DM-RS antenna port(s) of the at least one transport block may be quasi co-located with the first reference signal with respect to the first quasi co-location type in the one or more first repetitions. The DM-RS antenna port(s) of the at least one transport block may be quasi co-located with the second reference signal indicated by the second TCI state. The DM-RS antenna port(s) of the at least one transport block may be quasi co-located with the second reference signal with respect to the second quasi co-location type indicated by the second TCI state. The DM-RS antenna port(s) of the at least one transport block may be quasi co-located with the second reference signal with respect to the second quasi co-location type in the one or more second repetitions.

A second value (e.g., 1 in FIG. 29A) of the field may indicate the at least two TCI states. The at least one TCI state may be the at least two TCI states, for example, based on the value of the field being equal to the second value. The second value of the field may indicate the first TCI state and the second TCI state. The at least one TCI state may be the first TCI state and the second TCI state (or may be the at least two TCI states), for example, based on the value of the field being equal to the second value. The wireless device may receive the at least one transport block based on the first TCI state and the second TCI state (or based on the at least two TCI states), for example, based on (e.g., in response to) the value of the field being equal to the second value. For example, the wireless device may receive a first portion (e.g., first layer(s) or first data stream(s) or first symbol(s)) of the at least one transport block with/using the first spatial domain reception/receiving filter/beam that may be determined based on the first reference signal indicated by the first TCI state. The wireless device may receive the first portion of the at least one transport block in a transmission occasion. The wireless device may receive a second portion (e.g., second layer(s) or second data stream(s) or second symbol(s)) of the at least one transport block with/using the second spatial domain reception/receiving filter/beam that may be determined based on the second reference signal indicated by the second TCI state. The wireless device may receive the second portion of the at least one transport block in the transmission occasion. For example, the first portion (e.g., first layer(s) or first data stream(s) or first symbol(s)) of the at least one transport block may be quasi co-located with the first reference signal indicated by the first TCI state. The first portion of the transport block may be quasi co-located with the first reference signal with respect to the first quasi co-location type indicated by the first TCI state. The second portion (e.g., second layer(s) or second data stream(s) or second symbol(s)) of the at least one transport block may be quasi co-located with the second reference signal indicated by the second TCI state. The second portion of the at least one transport block may be quasi co-located with the second reference signal with respect to the second quasi co-location type indicated by the second TCI state. For example, first DM-RS antenna port(s) of the at least one transport block may be quasi co-located with the first reference signal indicated by the first TCI state. The first DM-RS antenna port(s) of the at least one transport block may be quasi co-located with the first reference signal with respect to the first quasi co-location type indicated by the first TCI state. Second DM-RS antenna port(s) of the at least one transport block may be quasi co-located with the second reference signal indicated by the second TCI state. The second DM-RS antenna port(s) of the at least one transport block may be quasi co-located with the second reference signal with respect to the second quasi co-location type indicated by the second TCI state. The first TCI state may correspond to (or associated with) a first CDM group of the two CDM groups. The second TCI state may correspond to (or associated with) a second CDM group of the two CDM groups. The first DM-RS antenna port(s) and the second DM-RS antenna port(s) may be, for example, different.

One or more configuration parameters may indicate an SFN scheme/mode. The one or more configuration parameters may comprise an SFN parameter (e.g., sfnSchemePdcch, sfnSchemePdsch) indicating the SFN scheme. The one or more configuration parameters may indicate the SFN scheme, for example, for downlink control channels (e.g., PDCCH, sfnSchemePdcch) or any other channel (e.g., uplink channel, sidelink channel, etc.). The one or more configuration parameters may indicate the SFN scheme, for example, for downlink shared channels (e.g., PDSCH, sfnSchemePdsch). The one or more configuration parameters may comprise the SFN parameter, for example, for the downlink BWP of the cell. The one or more configuration parameters may indicate the SFN scheme, for example, for the downlink BWP. The SFN parameter may indicate scheme 1 (sfnSchemeA) or TRP-based pre-compensation (sfnSchemeB).

The at least one TCI state may be the at least two TCI states, for example, based on the one or more configuration parameters indicating the SFN scheme. The at least one TCI state may be the at least two TCI states, for example, based on the one or more configuration parameters comprising the SFN parameter indicating the SFN scheme.

A wireless device may transmit/receive the at least one transport block based on the first TCI state and the second TCI state (or based on the at least two TCI states), for example, based on (e.g., in response to) the one or more configuration parameters indicating the SFN scheme. The wireless device may transmit/receive the at least one transport block based on the first TCI state and the second TCI state (or based on the at least two TCI states), for example, based on (e.g., in response to) the one or more configuration parameters comprising the SFN parameter indicating the SFN scheme.

DM-RS antenna port(s) of the at least one transport block may be quasi co-located with the first reference signal indicated by the first TCI state. The DM-RS antenna port(s) of the transport block may be quasi co-located with the second reference signal indicated by the second TCI state, except quasi co-location parameters {Doppler shift, Doppler spread} of (or indicated by) the second TCI state.

A wireless device may monitor PDCCH transmission(s)/reception(s) in the CORESET based on the at least one TCI state. DM-RS antenna port(s) of the PDCCH transmission(s)/reception(s) may be quasi co-located with at least one reference signal indicated by the at least one TCI state. The DM-RS antenna port(s) of the PDCCH transmission(s)/reception(s) may be quasi co-located with a respective reference signal, of the at least one reference signal, indicated by each TCI state of the at least one TCI state. Each TCI state of the at least one TCI state may indicate a respective reference signal of the at least one reference signal.

A wireless device may transmit/receive the at least one transport block based on the at least one TCI state of the CORESET, for example, based on (e.g., in response to) receiving the second DCI via the CORESET monitored with the at least one TCI state. The second DCI may, for example, comprise a TCI field. The wireless device may send (e.g., transmit) the at least one transport block based on the at least one TCI state of the CORESET, for example, based on (e.g., in response to) the one or more configuration parameters indicating the joint/common UL/DL TCI state mode. The at least one TCI state may comprise/be a TCI state. The wireless device may transmit/receive the at least one transport block based on the TCI state of the CORESET.

A wireless device may transmit/receive the at least one transport block based on the TCI state of the CORESET, for example, based on (e.g., in response to) receiving the second DCI via the CORESET monitored with the TCI state. The second DCI may, for example, comprise a TCI field. The second DCI may not, for example, comprise a TCI field. The wireless capability message (e.g., UE capability message) may indicate, for example, support of DCI scheduling with a TCI field. The wireless capability message (e.g., UE capability message) may indicate, for example, support of DCI scheduling without a TCI field. The wireless device may transmit/receive the at least one transport block based on the TCI state, for example, based on (e.g., in response to) the one or more configuration parameters indicating the SFN scheme (e.g., indicating sfnSchemePdcch and sfnSchemePdsch). The one or more configuration parameters may indicate an SFN scheme for downlink control channels (e.g., PDCCH, sfnSchemePdcch). The one or more configuration parameters may indicate an SFN scheme, for example, for downlink shared channels (e.g., PDSCH, sfnSchemePdsch). The wireless device may transmit/receive the at least one transport block based on the TCI state, for example, based on (e.g., in response to) the one or more configuration parameters comprising the SFN parameter indicating the SFN scheme. The time offset between the second DCI and the at least one transport block may be, for example, equal to or greater than the threshold.

A wireless device may monitor PDCCH transmission(s)/reception(s) in the CORESET based on the at least two TCI states. DM-RS antenna port(s) of the PDCCH transmission(s)/reception(s) may be quasi co-located with at least two reference signals indicated by the at least two TCI states. The DM-RS antenna port(s) of the PDCCH transmission(s)/reception(s) may be quasi co-located with a respective reference signal, of the at least two reference signals, indicated by each TCI state of the at least two TCI states. Each TCI state of the at least two TCI states may indicate a respective reference signal of the at least two reference signals. The DM-RS antenna port(s) of the PDCCH transmission(s)/reception(s) may be quasi co-located with the first reference signal, of the at least two reference signals, indicated by the first TCI state of the at least two TCI states. The DM-RS antenna port(s) of the PDCCH transmission(s)/reception(s) may be quasi co-located with the second reference signal, of the at least two reference signals, indicated by the second TCI state of the at least two TCI states. For example, The DM-RS antenna port(s) of the PDCCH transmission(s)/reception(s) may be quasi co-located with the second reference signal, except quasi co-location parameters {Doppler shift, Doppler spread} of (or indicated by) the second TCI state.

A wireless device may send (e.g., transmit) a capability indication (e.g., a UE capability message) indicating support of DCI scheduling with a TCI field. The DCI may comprise a TCI field based on the capability indication (e.g., UE capability message) indicating support of DCI scheduling with the TCI field. The wireless device may send (e.g., transmit) a capability indication (e.g., UE capability message) indicating support of DCI scheduling without a TCI field. For example, the DCI may not comprise a TCI field based on the capability indication (e.g., UE capability message) indicating support of DCI scheduling without the TCI field. The DCI may comprise a TCI field

The at least one TCI state may comprise/be the at least two TCI states. A wireless device may transmit/receive the transport block based on the at least two TCI states of the CORESET. The wireless device may transmit/receive the at least one transport block based on the at least two TCI states of the CORESET, for example, based on (e.g., in response to) receiving the second DCI via the CORESET monitored with the at least two TCI states. The second DCI may, for example, comprise a TCI field. The second DCI may not, for example, comprise a TCI field. The capability indication (e.g., UE capability message) may indicate, for example, support of DCI scheduling with a TCI field. The capability indication (e.g., UE capability message) may indicate, for example, support of DCI scheduling without a TCI field. The wireless device may transmit/receive the at least one transport block based on the first TCI state and the second TCI state (or based on the at least two TCI states), for example, based on (e.g., in response to) the one or more configuration parameters indicating the SFN scheme (e.g., indicating sfnSchemePdcch and sfnSchemePdsch). The one or more configuration parameters may indicate an SFN scheme for downlink control channels (e.g., PDCCH, sfnSchemePdcch). The one or more configuration parameters may indicate an SFN scheme, for example, for downlink shared channels (e.g., PDSCH, sfnSchemePdsch) or any other channel (e.g., uplink, sidelink, etc.). The wireless device may transmit/receive the transport block based on the first TCI state and the second TCI state (or based on the at least two TCI states), for example, based on (e.g., in response to) the one or more configuration parameters comprising the SFN parameter indicating the SFN scheme. The time offset between the second DCI and the transport block may be, for example, equal to or greater than the threshold.

A wireless device may send (e.g., transmit) the at least one transport block based on the at least two TCI states of the CORESET, for example, based on (e.g., in response to) the one or more configuration parameters indicating the joint/common UL/DL TCI state mode. The at least one TCI state may comprise/be a first/starting/earliest/initial TCI state among the at least two TCI states of the CORESET. The wireless device may transmit/receive the at least one transport block based on the first/starting/earliest/initial TCI state of the at least two TCI states of the CORESET. The one or more configuration parameters may indicate an SFN scheme for downlink control channels (e.g., PDCCH, sfnSchemePdcch). The one or more configuration parameters may not indicate an SFN scheme, for example, for downlink shared channels (e.g., PDSCH, sfnSchemePdsch) or any other channels (e.g., uplink, sidelink, etc.). The wireless device may transmit/receive the at least one transport block based on the first/starting/earliest/initial TCI state, for example, based on (e.g., in response to) the one or more configuration parameters indicating an SFN scheme for downlink control channels (e.g., PDCCH, sfnSchemePdcch). The wireless device may transmit/receive the at least one transport block based on the first/starting/earliest/initial TCI state, for example, based on (e.g., in response to) the one or more configuration parameters not indicating an SFN scheme for downlink shared channels (e.g., PDSCH, sfnSchemePdsch). The second DCI may, for example, comprise a TCI field. The second DCI may not, for example, comprise a TCI field. The capability indication (e.g., UE capability message) may indicate, for example, support of DCI scheduling with a TCI field. The capability indication (e.g., UE capability message) may indicate, for example, support of DCI scheduling without a TCI field. The time offset between the second DCI and the transport block may be, for example, equal to or greater than the threshold. The wireless device may send (e.g., transmit) the at least one transport block based on the first/starting/earliest/initial TCI state of the CORESET, for example, based on (e.g., in response to) the one or more configuration parameters indicating the joint/common UL/DL TCI state mode.

At least some wireless devices may not be configured to receive at least some wireless communications. For example, if a wireless device is configured/indicated by one or more configuration parameters (e.g., with/by both sfnSchemePdcch and sfnSchemePdsch) and if a time offset between reception of DCI (e.g., second DCI) and a corresponding transport block of a cell is equal to or greater than a threshold (e.g., timeDurationForQCL), a wireless device may be unable to successfully receive at least one transport block (or any other communication). For example, under such conditions, if the wireless device supports DCI scheduling without a TCI field, the wireless device may assume/determine that TCI state(s) (and/or the QCL assumption(s)) for at least one transport block is/are identical to the TCI state(s) for the CORESET used for the reception of the DCI (e.g., second DCI) regardless of the number of active TCI states of the CORESET, such that the wireless device may receive the at least one transport block based on the TCI state(s) of the CORESET. However, if such a wireless device does not support DCI scheduling without a TCI field, such a wireless device may expect a TCI field present in the DCI (e.g., second DCI), for example, if scheduled by DCI format 1_1/1_2. In such wireless devices, for the at least one transport block scheduled by DCI (e.g., second DCI) without a TCI field, if the wireless device is configured/indicated (e.g., by one or more configuration parameters) with/by sfnSchemePdcch set to ‘sfnSchemeA,’ and with sfnSchemePdsch not being configured/indicated, and if there is no TCI codepoint with two TCI states in the activation command (e.g., Activation command at time T1 in FIG. 17), and if the time offset between the reception of the DCI (e.g., the second DCI) and the corresponding transport block is equal or greater than a threshold (e.g., timeDurationForQCL) and the CORESET which schedules the transport block is indicated/activated/monitored with two TCI states, such a wireless device may assume/determine that the TCI state (and/or the QCL assumption) for the transport block is identical to a first/starting/earliest/initial TCI state of the two TCI states for the CORESET.

One or more configuration parameters may indicate (e.g., for an uplink BWP) one or more uplink resources (e.g., PUCCH resources). The one or more configuration parameters may indicate, for the one or more uplink resources, one or more uplink resource indexes/identifiers/indicators. The one or more configuration parameters may indicate, for each uplink resource of the one or more uplink resources, a respective uplink resource index of the one or more uplink resource indexes.

An uplink resource index of an uplink resource (e.g., a PUCCH resource) of the one or more uplink resources may be lowest among the one or more uplink resource indexes of the one or more uplink resources. The one or more uplink resource indexes may comprise the uplink resource index.

A wireless device may send (e.g., transmit), via the uplink resource, an uplink signal (e.g., HARQ-ACK, SR, CSI report, uplink control information, and the like) based on the at least one TCI state. The at least one TCI state used for transmission of at least one transport block (or other communication) may be the at least one TCI state of (or associated with) the uplink resource. The wireless device may send (e.g., transmit) the at least one transport block based on the at least one TCI state of the uplink resource. The wireless device may send (e.g., transmit) the at least one transport block based on the at least one TCI state of the uplink resource, for example, based on (e.g., in response to) the one or more configuration parameters indicating a separate UL/DL TCI state mode. The wireless device may send (e.g., transmit) the at least one transport block based on the at least one TCI state of the uplink resource, for example, based on (e.g., in response to) the second DCI being a fallback DCI (e.g., DCI format 0-0).

The at least one TCI state of the uplink resource may be/comprise a TCI state. The wireless device may send (e.g., transmit), via the uplink resource, an uplink signal (e.g., HARQ-ACK, SR, CSI report, uplink control information, and the like) based on the TCI state. The wireless device may send (e.g., transmit) the at least one transport block based on the TCI state of the uplink resource. The wireless device may send (e.g., transmit) the at least one transport block based on the TCI state of the uplink resource, for example, based on (e.g., in response to) the one or more configuration parameters indicating a separate UL/DL TCI state mode. The wireless device may send (e.g., transmit) the at least one transport block based on the TCI state of the uplink resource, for example, based on (e.g., in response to) the second DCI being a fallback DCI (e.g., DCI format 0-0).

The at least one TCI state of the uplink resource may be/comprise the at least two TCI states. The wireless device may send (e.g., transmit), via the uplink resource, an uplink signal (e.g., HARQ-ACK, SR, CSI report, uplink control information, and the like) based on the at least two TCI states.

A wireless device may send (e.g., transmit) the at least one transport block based on the at least two TCI states of the uplink resource. The wireless device may send (e.g., transmit) the at least one transport block based on the at least two TCI states of the uplink resource, for example, based on (e.g., in response to) the one or more configuration parameters indicating a separate UL/DL TCI state mode. The wireless device may send (e.g., transmit) one or more first repetitions of the at least one transport block with/using the first spatial domain transmission filter determined based on the first TCI state of the at least two TCI states. The wireless device may send (e.g., transmit) the one or more first repetitions of the at least one transport block with/using the first transmission power determined based on the first TCI state. The wireless device may send (e.g., transmit) one or more second repetitions of the at least one transport block with/using the second spatial domain transmission filter determined based on the second TCI state of the at least two TCI states. The wireless device may send (e.g., transmit) the one or more second repetitions of the at least one transport block with the second transmission power determined based on the second TCI state.

A wireless device may send (e.g., transmit) the at least one transport block based on a first/starting/earliest/initial TCI state of the at least two TCI states of the uplink resource. The wireless device may send (e.g., transmit) the at least one transport block based on the first/starting/earliest/initial TCI state of the uplink resource, for example, based on (e.g., in response to) the one or more configuration parameters indicating a separate UL/DL TCI state mode. The wireless device may send (e.g., transmit) the at least one transport block based on the first/starting/earliest/initial TCI state of the uplink resource, for example, based on (e.g., in response to) the second DCI being a fallback DCI (e.g., DCI format 0-0).

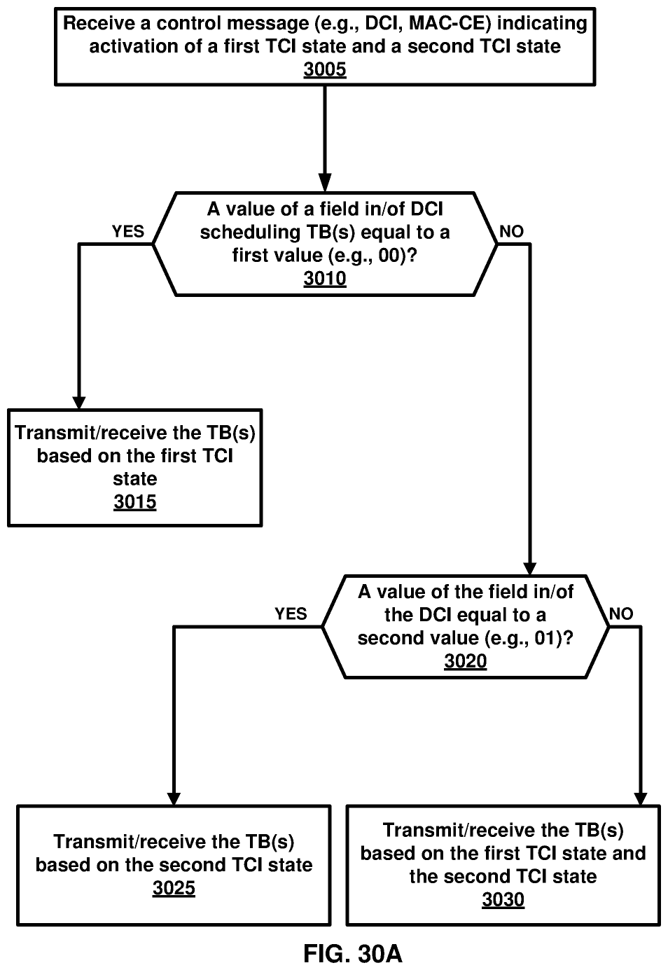

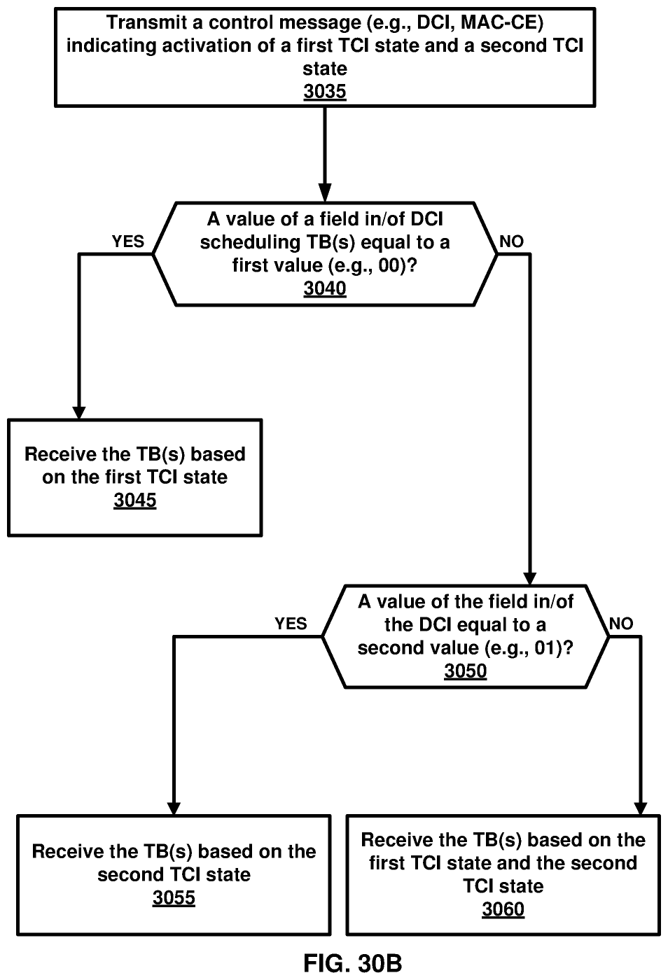

FIG. 30A and FIG. 30B show example methods of using an indication of a TCI state. The indication of a TCI state may be for a unified beam update. At step 3005, a wireless device may receive, for example, from a base station, one or more messages comprising one or more configuration parameters for a cell. At step 3035, the base station may send (e.g., transmit), to the wireless device, the one or more messages comprising the one or more configuration parameters. The one or more messages may comprise a control message (e.g., DCI, MAC-CE) indicating activation of at least a first TCI state and a second TCI state. The one or more configuration parameters may indicate a plurality of TCI states. For example, the one or more configuration parameters may indicate, for an uplink BWP of the cell, the plurality of TCI states. For example, the one or more configuration parameters may indicate, for a downlink BWP of the cell, the plurality of TCI states.

The wireless device may activate (or set) the uplink BWP as an active uplink BWP of the cell. The wireless device may activate (or set) the downlink BWP as an active downlink BWP of the cell. The base station may send (e.g., transmit) a downlink message (e.g., DCI, MAC-CE, RRC message) indicating the activation of the uplink BWP. The base station may send (e.g., transmit) a downlink message (e.g., DCI, MAC-CE, RRC message) indicating the activation of the downlink BWP. A plurality of TCI states may comprise a plurality of joint/downlink TCI states (or joint uplink/downlink TCI states). A plurality of TCI states may comprise a plurality of uplink TCI states. A plurality of TCI states may comprise a plurality of downlink TCI states.

A wireless device may receive an activation command (e.g., MAC-CE, DCI) indicating activation of a subset of the plurality of TCI states (e.g., at step 3005). A base station may send (e.g., transmit) the activation command indicating activation of the subset of the plurality of TCI states (e.g., at step 3035). The wireless device may map the subset of the plurality of TCI states to one or more TCI codepoints. Each TCI codepoint of the one or more TCI codepoints may indicate respective TCI state(s) of the subset of the plurality of TCI states. The base station may map the subset of the plurality of TCI states to the one or more TCI codepoints.

A wireless device may receive a control message/command (e.g., DCI, MAC-CE) indicating activation of at least two transmission configuration indicator (TCI) states (e.g., at step 3005). The subset of the plurality of TCI states may comprise the at least two TCI states. The base station may send (e.g., transmit) the control message/command (e.g., at step 3035). The control message (e.g., DCI) may comprise a TCI field indicating the at least two TCI states. At step 3010, the wireless device may determine a value of a field in a message (e.g., DCI). At step 3040, the base station may determine the value of the field in the message. The message may comprise DCI scheduling transmission/reception of at least one transport block. The wireless device (e.g., at step 3010) and/or the base station (e.g., at step 3040) may determine whether the value of the field is equal to a first value (e.g., 00). At step 3020, the wireless device may determine whether the value of the field is equal to a second value (e.g., 01), for example, if the wireless device determines that the value is not equal to the first value. At step 3050, the base station may determine whether the value of the field is equal to a second value (e.g., 01), for example, if base station determines the value is not equal to the first value. A TCI codepoint of the one or more TCI codepoints may indicate/comprise the at least two TCI states. The TCI field may indicate the TCI codepoint. The control message may be, for example, the activation command. The at least two TCI states may be the subset of the plurality of TCI states. The one or more TCI codepoints may be/comprise a single TCI codepoint.

At least two TCI states may be/comprise at least two joint/common/unified TCI states. The at least two TCI states may be/comprise at least two joint/common/unified uplink and downlink TCI states. The at least two TCI states may be/comprise at least two joint/common/unified uplink TCI states. The at least two TCI states may be/comprise at least two uplink TCI states. The at least two TCI states may be/comprise at least two joint/common/unified downlink TCI states. The at least two TCI states may be/comprise at least two downlink TCI states. The at least two TCI states may comprise a first TCI state and a second TCI state.

The wireless device may receive, via a CORESET, a second DCI. The second DCI may schedule transmission/reception of a transport block. The downlink BWP of the cell may comprise the CORESET. The wireless device may monitor PDCCH transmission(s)/receptions in the CORESET based on a TCI state. The wireless device may receive a MAC-CE indicating activation of the TCI state for the CORESET. The at least two TCI states may comprise the TCI state of the CORESET. The at least two TCI states may not comprise the TCI state of the CORESET. The plurality of TCI states may comprise the TCI state of the CORESET.

The wireless device and/or the base station may transmit/receive, via one or more resources, at least one transport block (e.g., PUSCH transmission, PDSCH transmission) based on at least one TCI state of the at least two TCI states. At step 3015, the wireless device may transmit/receive, via one or more resources, the at least one transport block (e.g., PUSCH transmission, PDSCH reception) based on the first TCI state of the at least two TCI states, for example, if the value of the field is equal to the first value (e.g., equal to 00). At step 3025, the wireless device may transmit/receive, via one or more resources, the at least one transport block (e.g., PUSCH transmission, PDSCH reception) based on the second TCI state of the at least two TCI states, for example, if the value of the field is equal to a second value (e.g., equal to 01). At step 3030, the wireless device may transmit/receive via one or more resources, the at least one transport block (e.g., PUSCH transmission, PDSCH reception) based on the first TCI state and the second TCI state, for example, if the value of the field is not equal to either the first value or the second value and/or is equal to a third value (e.g., 10) or a fourth value (e.g., 11). For example, the uplink BWP may comprise the one or more resources. For example, the downlink BWP may comprise the one or more resources. The wireless device may apply/use the at least one TCI state for transmission/reception of the at least one transport block.

Applying/using the at least one TCI state for transmission of the at least one transport block may comprise sending (e.g., transmitting) the at least one transport block with/using (or based on) at least one spatial domain transmission filter that may be determined based on the at least one TCI state. The wireless device may determine each spatial domain transmission filter of the at least one spatial domain transmission filter, for example, based on a respective TCI state of the at least one TCI state. The wireless device may determine each spatial domain transmission filter of the at least one spatial domain transmission filter, for example, based on a reference signal indicated by a respective TCI state of the at least one TCI state. Applying/using the at least one TCI state for transmission of the at least one transport block may comprise transmitting the at least one transport block with/using (or based on) at least one transmission power that may be determined based on the at least one TCI state. The wireless device may determine each transmission power of the at least one transmission power, for example, based on a respective TCI state of the at least one TCI state. The wireless device may determine each transmission power of the at least one transmission power, for example, based on one or more power control parameters indicated by (or associated with or mapped to or included in) by a respective TCI state of the at least one TCI state. The one or more configuration parameters may indicate, for each TCI state of the at least one TCI state, a respective power control parameter set comprising the one or more power control parameters.

A base station may apply/use the at least one TCI state for reception of the at least one transport block. At step 3045, the base station may apply/use the first TCI state for reception of the at least one transport block, for example, if the value of the field is equal to a first value (e.g., equal to 00). At step 3055, the base station may apply/use the second TCI state for reception of the at least one transport block, for example, if the value of the field is equal to a second value (e.g., equal to 01). At step 3060, the base station may apply/use the first TCI state and the second TCI state for reception of the at least one transport block, for example, if the value of the field is not equal to either the first value or the second value and/or is equal to a third value (e.g., 10) or a fourth value (e.g., 11). Applying/using the at least one TCI state for reception of the at least one transport block may comprise receiving the at least one transport block with/using (or based on) at least one spatial domain reception/receiving filter that may be determined based on the at least one TCI state. The base station may determine each spatial domain reception filter of the at least one spatial domain reception filter, for example, based on a respective TCI state of the at least one TCI state. The base station may determine each spatial domain reception filter of the at least one spatial domain reception filter, for example, based on a reference signal indicated by a respective TCI state of the at least one TCI state.

Applying/using the at least one TCI state for reception of the at least one transport block may comprise receiving the at least one transport block with/using (or based on) at least one spatial domain reception filter that is determined based on the at least one TCI state. The wireless device may determine each spatial domain reception filter of the at least one spatial domain reception filter, for example, based on a respective TCI state of the at least one TCI state. The wireless device may determine each spatial domain reception filter of the at least one spatial domain reception filter, for example, based on a reference signal indicated by a respective TCI state of the at least one TCI state. Applying/using the at least one TCI state for reception of the at least one transport block may comprise DM-RS antenna port(s) of the at least one transport block being quasi co-located with at least one reference signal indicated by the at least one TCI state. Each TCI state of the at least one TCI state may indicate a respective reference signal of the at least one reference signal.

A base station may apply/use the at least one TCI state for transmission of the at least one transport block. Applying/using the at least one TCI state for transmission of the transport block may comprise sending (e.g., transmitting) the at least one transport block with/using (or based on) at least one spatial domain transmission filter that may be determined based on the at least one TCI state. The base station may determine each spatial domain transmission filter of the at least one spatial domain transmission filter, for example, based on a respective TCI state of the at least one TCI state. The base station may determine each spatial domain transmission filter of the at least one spatial domain transmission filter, for example, based on a reference signal indicated by a respective TCI state of the at least one TCI state.

A wireless device may determine the at least one TCI state based on one or more criteria described with respect to FIG. 17, FIG. 29A and/or FIG. 29B. A base station may determine the at least one TCI state based on one or more criteria described with respect to FIG. 17, FIG. 29A and/or FIG. 29B.

The at least one TCI state may be a first/earliest/starting TCI state that occurs first in a list/vector/set of the at least two TCI states. The at least one TCI state may be a first/earliest/starting TCI state with a lowest (or highest) TCI state index among at least two TCI state indexes of the at least two TCI states. Each TCI state of the at least two TCI states may be indicated/identified with/by a respective TCI state index of the at least two TCI state indexes.

Second DCI may be, for example, different from the control message. The second DCI may be, for example, the same as the control message. The second DCI may comprise a field (e.g., Unified/Common/Joint TCI state index field, TRP index field, CORESET pool index field, and the like). The field may comprise a value indicating the at least one TCI state.

The field may be, for example, a 2-bit field (or a field comprising any quantity of bits). The least one TCI state may be the first TCI state of the at least two TCI states based on the value being equal to a first value (e.g., 00). The least one TCI state may be the second TCI state of the at least two TCI states based on the value being equal to a second value (e.g., 01). The least one TCI state may be the first TCI state and the second TCI state based on the value being equal to a third value (e.g., 10). The least one TCI state may be the first TCI state and the second TCI state based on the value being equal to a fourth value (e.g., 11).

The field may be, for example, a 1-bit field. The least one TCI state may be the TCI state of the CORESET based on the value being equal to a first value (e.g., 0). The least one TCI state may be the first TCI state of the at least two TCI states and the second TCI state of the at least two TCI states based on the value being equal to a second value (e.g., 1). The least one TCI state may be the at least two TCI states based on the value being equal to a second value (e.g., 1).

The least one TCI state may be the first TCI state and the second TCI state based on the second DCI indicating repetitions of the at least one transport block. The least one TCI state may be the first TCI state and the second TCI state based on the one or more configuration parameters indicating a repetition scheme. The least one TCI state may be the first TCI state and the second TCI state based on an antenna port field of the second DCI indicating DM-RS port(s) within two CDM groups.

At least one TCI state may not be associated with a TRP. The one or more configuration parameters may not indicate, for the at least one TCI state, a field (e.g., Unified/Common/Joint TCI state index field, TRP index field, CORESET pool index field, and the like) indicating an association between the at least one TCI state and a TRP. The at least one TCI state may not be associated explicitly or implicitly with a TRP. This lack of association may reduce signaling overhead. The one or more configuration parameters may not need to comprise/indicate an association between the at least one TCI state and a TRP (or a TRP index, CORESET pool index, Unified/Common/Joint TCI state index field, and the like). This operation may reduce RRC message size (and/or the size of the configuration parameters).

Each TCI state of the at least one TCI state may not be associated with a TRP. The one or more configuration parameters may not indicate, for each TCI state of the at least one TCI state, a field (e.g., Unified/Common/Joint TCI state index field, TRP index field, CORESET pool index field, and the like) indicating an association with a TRP. Each TCI state of the at least one TCI state may not be associated explicitly or implicitly with a TRP. This lack of association may reduce signaling overhead. The one or more configuration parameters may not need to comprise/indicate an association between each TCI state of the at least one TCI state and a respective TRP (or a TRP index, CORESET pool index, Unified/Common/Joint TCI state index field, and the like). This operation may reduce RRC message size (and/or the size of the configuration parameters).

Each TCI state of the at least two TCI states may not be associated with a TRP. The one or more configuration parameters may not indicate, for each TCI state of the at least two TCI states, a field (e.g., Unified/Common/Joint TCI state index field, TRP index field, CORESET pool index field, and the like) indicating an association with a TRP. Each TCI state of the at least two TCI states may not be associated explicitly or implicitly with a TRP. This lack of association may reduce signaling overhead. The one or more configuration parameters may not need to comprise/indicate an association between each TCI state of the at least two TCI states and a respective TRP (or a TRP index, CORESET pool index, Unified/Common/Joint TCI state index field, and the like). This operation may reduce RRC message size (and/or the size of the configuration parameters).

A wireless device may perform a method comprising multiple operations. The wireless device may receive at least one configuration parameter indicating, for a unified transmission configuration indicator (TCI) state index associated with a sounding reference signal (SRS) resource set, one of a first value or a second value, wherein: the first value indicates a first unified TCI state of at least two unified TCI states; and the second value indicates a second unified TCI state of the at least two unified TCI states. The wireless device may receive a message indicating activation of a plurality of TCI states, wherein the plurality of TCI states comprises a unified TCI state, and wherein the unified TCI state is indicated by the unified TCI state index. The wireless device may transmit, via an SRS resource of the SRS resource set and based on the unified TCI state indicated by the unified TCI state index, an uplink signal. The wireless device may transmit the uplink signal based on the unified TCI state indicated by the unified TCI state index by transmitting the uplink signal using at least one of: an uplink transmission power associated with the unified TCI state indicated by the unified TCI state index; a spatial transmission filter associated with the unified TCI state indicated by the unified TCI state index; or a transmission precoder associated with the unified TCI state indicated by the unified TCI state index. The wireless device may transmit the uplink signal by one of: transmitting the uplink signal using at least one resource based on the first unified TCI state, wherein the at least one configuration parameter indicates the first value; or transmitting the uplink signal using at least one resource based on the second unified TCI state, wherein the at least one configuration parameter indicates the second value. The wireless device may receive at least one second configuration parameter indicating, for a second unified TCI state index associated with a channel state information-reference signal (CSI-RS) resource set, one of the first value or the second value; and receive, via a CSI-RS resource of the CSI-RS resource set and based on a unified TCI state indicated by the second unified TCI state index, a downlink signal. The wireless device may receive an indication of a TCI codepoint associated with the at least two unified TCI states. The at least one configuration parameter may indicate a one-bit field, wherein the one-bit field comprises one of the first value or the second value. The wireless device may comprise one or more processors and memory, storing instructions, that when executed by the one or more processors perform the method described herein. A system may comprise the wireless device configured to perform the described method, additional operations, and/or include the additional elements; and a base station configured to transmit the at least one configuration parameter. A computer-readable medium may store instructions that, when executed, cause performance of the described method, additional operations, and/or include additional elements. A base station may perform a corresponding method comprising multiple operations. The base station may perform a corresponding method, for example, by transmitting the at least one configuration parameter, transmitting the message indicating activation of the plurality of TCI states, and/or receiving the uplink signal.

A base station may perform a method comprising multiple operations. The base station may transmit at least one configuration parameter indicating, for a unified transmission configuration indicator (TCI) state index associated with a sounding reference signal (SRS) resource set, one of a first value or a second value, wherein: the first value indicates a first unified TCI state of at least two unified TCI states; and the second value indicates a second unified TCI state of the at least two unified TCI states. The base station may transmit a message indicating activation of a plurality of TCI states, wherein plurality of TCI states comprises a unified TCI state, wherein the unified TCI state is indicated by the unified TCI state index. The base station may receive, via an SRS resource of the SRS resource set and based on the unified TCI state indicated by the unified TCI state index, an uplink signal. The base station may receive the uplink signal based on the unified TCI state indicated by the unified TCI state index by receiving the uplink signal using a spatial reception filter associated with the unified TCI state indicated by the unified TCI state index. The base station may receive the uplink signal by one of: receiving the uplink signal using at least one resource based on the first unified TCI state, wherein the at least one configuration parameter indicates the first value; or receiving the uplink signal using at least one resource based on the second unified TCI state, wherein the at least one configuration parameter indicates the second value. The base station may transmit at least one second configuration parameter indicating, for a second unified TCI state index associated with a channel state information-reference signal (CSI-RS) resource set, one of the first value or the second value; and transmit, via a CSI-RS resource of the CSI-RS resource set and based on a unified TCI state indicated by the second unified TCI state index, a downlink signal. The base station may transmit an indication of a TCI codepoint associated with the at least two unified TCI states. The at least one configuration parameter may indicate a one-bit field, wherein the one-bit field comprises one of the first value or the second value. The base station may comprise one or more processors and memory, storing instructions, that when executed by the one or more processors perform the method described herein. A system may comprise the base station configured to perform the described method, additional operations, and/or include the additional elements; and a wireless device configured to receive the at least one configuration parameter and/or transmit the uplink signal. A computer-readable medium may store instructions that, when executed, cause performance of the described method, additional operations, and/or include additional elements. A wireless device may perform a corresponding method comprising multiple operations. The wireless device may perform a corresponding method, for example, by receiving the at least one configuration parameter, receiving the message indicating activation of the plurality of TCI states, and/or transmitting the uplink signal.

A wireless device may perform a method comprising multiple operations. The wireless device may receive at least one configuration parameter indicating, for a unified transmission configuration indicator (TCI) state index associated with a reference signal (RS) resource set, one of a first value or a second value, wherein: the first value indicates a first unified TCI state of at least two unified TCI states; and the second value indicates a second unified TCI state of the at least two unified TCI states. The wireless device may receive a message indicating activation of a plurality of TCI states, wherein plurality of TCI states comprises a unified TCI state, wherein the unified TCI state is indicated by the unified TCI state index. The wireless device may transmit or receive, via an RS of the RS resource set and based on the unified TCI state indicated by the unified TCI state index, a signal. The RS resource set may comprise a sounding reference signal (SRS) resource set, and the wireless device may transmit or receive the signal by: transmitting, via an SRS of the SRS resource set and based on the unified TCI state indicated by the unified TCI state index, the signal. The RS resource set may comprise a channel state information (CSI)-RS resource set, and the wireless device may transmit or receive the signal by: receiving, via a CSI-RS of the CSI-RS resource set and based on the unified TCI state indicated by the unified TCI state index, the signal. The wireless device may transmit or receive the signal based on the unified TCI state indicated by the unified TCI state index by transmitting or receiving the signal using a spatial filter associated with the unified TCI state indicated by the unified TCI state index. The wireless device may transmit or receive the signal by one of: transmitting or receiving the signal using at least one resource based on the first unified TCI state, wherein the at least one configuration parameter indicates the first value; or transmitting or receiving the signal using at least one resource based on the second unified TCI state, wherein the at least one configuration parameter indicates the second value. The RS resource set may comprise a sounding reference signal (SRS) resource set, and the wireless device may: receive at least one second configuration parameter indicating, for a second unified TCI state index associated with a channel state information-reference signal (CSI-RS) resource set, one of the first value or the second value; and receive, via a CSI-RS resource of the CSI-RS resource set and based on a unified TCI state indicated by the second unified TCI state index, a downlink signal. The wireless device may receive an indication of a TCI codepoint associated with the at least two unified TCI states. The at least one configuration parameter may indicate a one-bit field, wherein the one-bit field comprises one of the first value or the second value. The wireless device may comprise one or more processors and memory, storing instructions, that when executed by the one or more processors perform the method described herein. A system may comprise the wireless device configured to perform the described method, additional operations, and/or include the additional elements; and a base station configured to transmit the at least one configuration parameter. A computer-readable medium may store instructions that, when executed, cause performance of the described method, additional operations, and/or include additional elements. A base station may perform a corresponding method comprising multiple operations. The base station may perform a corresponding method, for example, by transmitting the at least one configuration parameter, transmitting the message indicating activation of the plurality of TCI states, and/or receiving or transmitting the signal.

A wireless device may perform a method comprising multiple operations. The wireless device may receive one or more configuration parameters indicating a unified transmission configuration indicator (TCI) state index for a sounding reference signal (SRS) resource set. The wireless device may receive one or more configuration parameters indicating, for a unified TCI state index of a sounding reference signal (SRS) resource set, one of a first value or a second value, wherein: the first value indicates a first unified transmission configuration indicator (TCI) state that occurs first in a list of two unified TCI states; and the second value indicates a second unified TCI state that occurs second in the list of two unified TCI states. The wireless device may receive one or more configuration parameters indicating, for a sounding reference signal (SRS) resource set, one of a first value or a second value. The wireless device may receive a control message indicating activation of a list of at least two unified TCI states, wherein the unified TCI state index indicates one of the at least two unified TCI states. The wireless device may receive a control message indicating activation of a list of at least two transmission configuration indicator (TCI) states, wherein: the first value of the SRS resource set indicates a first TCI state that occurs first in the list; and the second value of the SRS resource set indicates a second TCI state that occurs second in the list. The wireless device may transmit, via an SRS resource of the SRS resource set, an uplink signal based on the one of the at least two TCI states indicated by the unified TCI state index. The wireless device may transmit, via an SRS resource of the SRS resource set, an uplink signal based on a TCI state, among the first TCI state and the second TCI state, indicated by one of the first value or the second value of the SRS resource set. The one or more configuration parameters may indicate a plurality of TCI states comprising the first TCI state and the second TCI state. The first TCI state may be a first joint TCI state; and the second TCI state may be a second joint TCI state. The first TCI state may be a first uplink TCI state; and the second TCI state may be a second uplink TCI state. The wireless device may receive a medium-access control control element (MAC-CE) indicating activation of a subset of the plurality of TCI states that comprise the list of at least two TCI states. The wireless device may map the subset of the plurality of TCI states to one or more TCI codepoints, wherein: each TCI codepoint of the one or more TCI codepoints indicates one or more respective TCI states of the subset of the plurality of TCI states; and a TCI codepoint of the one or more TCI codepoints indicates the first TCI state and the second TCI state. The control message may be the MAC-CE based on a number of the one or more TCI codepoints being equal to one. The control message may be downlink control information (DCI) based on a number of the one or more TCI codepoints being more than one, and wherein the DCI comprises a TCI field indicating the TCI codepoint. The one or more configuration parameters may indicate no transmission-and-reception point (TRP) index for both: the first TCI state indicating an association between the first TCI state and a TRP; and the second TCI state indicating an association between the second TCI state and a TRP. The TCI state may be the first TCI state based on the one or more configuration parameters indicating, for the SRS resource set, the first value. The TCI state may be the second TCI state based on the one or more configuration parameters indicating, for the SRS resource set, the second value. The wireless device may transmit the uplink signal based on the TCI state by transmitting the uplink signal in response to the one or more configuration parameters comprising, for the SRS resource set, a follow-unified-TCI-state parameter that indicates to apply a unified TCI state for the SRS resource set. The wireless device may transmit the uplink signal with a spatial domain transmission filter that is determined based on a reference signal indicated by the TCI state. The wireless device may transmit the uplink signal is with a transmission power that is determined based on one or more power control parameters associated with the TCI state. The one or more power control parameters may comprise at least one of: a target received power; a closed-loop index; a pathloss compensation factor, and a pathloss reference signal. The one or more configuration parameters may indicate, for the TCI state, a power control parameter set comprising the one or more power control parameters. The one or more configuration parameters may indicate: a first TCI state index for the first TCI state, and a second TCI state index for the second TCI state. The first TCI state index may be less than the second TCI state index. The one or more configuration parameters may indicate, for the SRS resource set, a field with one of the first value or the second value. The field may comprise at least one of: a unified TCI state field, TRP field, or a control resource set (CORESET) pool field. The wireless device may comprise one or more processors and memory, storing instructions, that when executed by the one or more processors perform the method described herein. A system may comprise the wireless device configured to perform the described method, additional operations, and/or include the additional elements; and a base station configured to transmit the one or more configuration parameters. A computer-readable medium may store instructions that, when executed, cause performance of the described method, additional operations, and/or include additional elements. A base station may perform a corresponding method comprising multiple operations. The base station may perform a corresponding method, for example, by transmitting the one or more configuration parameters and/or transmitting the control message.

A wireless device may perform a method comprising multiple operations. The wireless device may receive one or more configuration parameters of a sounding reference signal (SRS) resource set. The wireless device may receive a control message indicating activation of a list of at least two transmission configuration indicator (TCI) states. In response to a field being absent in the one or more configuration parameters of the SRS resource set, the wireless device may transmit, via an SRS resource of the SRS resource set, an uplink signal based on a first TCI state that occurs first in the list. The one or more configuration parameters of the SRS resource set may not comprise the field. The field may be at least one of: a unified TCI state field, a transmission-and-reception point (TRP) field, or a control resource set (CORESET) pool field. The one or more configuration parameters may indicate no TRP index for the first TCI state indicating an association between the first TCI state and a TRP. The wireless device may comprise one or more processors and memory, storing instructions, that when executed by the one or more processors perform the method described herein. A system may comprise the wireless device configured to perform the described method, additional operations, and/or include the additional elements; and a base station configured to transmit the one or more configuration parameters. A computer-readable medium may store instructions that, when executed, cause performance of the described method, additional operations, and/or include additional elements. A base station may perform a corresponding method comprising multiple operations. The base station may perform a corresponding method, for example, by transmitting the one or more configuration parameters.

A wireless device may perform a method comprising multiple operations. The wireless device may receive a control message indicating activation of a list of at least two transmission configuration indicator (TCI) states. The wireless device may receive a downlink control information (DCI) comprising a sounding reference signal (SRS) request field indicating an SRS resource set. The DCI may comprise a field indicating one of a first value or a second value, wherein: the first value indicates a first TCI state that occurs first in the list; and the second value indicates a second TCI state that occurs second in the list. The wireless device may transmit, via an SRS resource of the SRS resource set, an uplink signal based on a TCI state, among the first TCI state and the second TCI state, indicated by one of the first value or the second value of the DCI. The wireless device may receive one or more messages comprising one or more configuration parameters. The one or more configuration parameters may indicate, for the SRS resource set, a value of an aperiodic-SRS-resource-trigger parameter. The value of the aperiodic-SRS-resource-trigger parameter may be equal to a value of the SRS request field of the DCI. The field may be at least one of: a unified TCI state field, TRP field, or a control resource set (CORESET) pool field. The one or more configuration parameters may indicate no transmission-and-reception point (TRP) index for both: the first TCI state indicating an association between the first TCI state and a TRP; and the second TCI state indicating an association between the second TCI state and a TRP. The wireless device may comprise one or more processors and memory, storing instructions, that when executed by the one or more processors perform the method described herein. A system may comprise the wireless device configured to perform the described method, additional operations, and/or include the additional elements; and a base station configured to transmit the control message and/or the DCI. A computer-readable medium may store instructions that, when executed, cause performance of the described method, additional operations, and/or include additional elements. A base station may perform a corresponding method comprising multiple operations. The base station may perform a corresponding method, for example, by transmitting the control message and/or transmitting the DCI.

A wireless device may perform a method comprising multiple operations. The wireless device may receive a control message indicating activation of at least two transmission configuration indicator (TCI) states. The wireless device may receive, via a control resource set (CORESET) monitored with a TCI state among the at least two TCI states, a downlink control information (DCI) comprising a sounding reference signal (SRS) request field indicating an SRS resource set. In response to receiving the DCI via the CORESET monitored with the TCI state, the wireless device may transmit, via an SRS resource of the SRS resource set, an uplink signal based on the TCI state of the CORESET. The wireless device may monitor the CORESET based on the TCI state. The wireless device may monitor the CORESET based on the at least two TCI states. The TCI state is a first TCI state that may occur first in a list of the at least two TCI states. The TCI state is a TCI state, of the at least two TCI states, with a lowest TCI state index among at least two TCI state indexes of the at least two TCI states. The wireless device may comprise one or more processors and memory, storing instructions, that when executed by the one or more processors perform the method described herein. A system may comprise the wireless device configured to perform the described method, additional operations, and/or include the additional elements; and a base station configured to transmit the control message and/or the DCI. A computer-readable medium may store instructions that, when executed, cause performance of the described method, additional operations, and/or include additional elements. A base station may perform a corresponding method comprising multiple operations. The base station may perform a corresponding method, for example, by transmitting the control message and/or transmitting the DCI.

A wireless device may perform a method comprising multiple operations. The wireless device may receive one or more configuration parameters indicating, for a channel-state-information reference signal (CSI-RS) resource set, one of a first value or a second value. The wireless device may receive a control message indicating activation of a list of at least two transmission configuration indicator (TCI) states, wherein: the first value of the CSI-RS resource set indicates a first TCI state that occurs first in the list; and the second value of the CSI-RS resource set indicates a second TCI state that occurs second in the list. The wireless device may receive, via a CSI-RS resource of the CSI-RS resource set, a CSI-RS based on a TCI state, among the first TCI state and the second TCI state, indicated by one of the first value or the second value of the CSI-RS resource set. The one or more configuration parameters indicate one or more CSI trigger states. The DCI may comprise a CSI request field indicating a CSI trigger state among the one or more CSI trigger states. The CSI trigger state may comprise one or more CSI-RS resource sets that comprise the CSI-RS resource set. The CSI-RS resource set comprises one or more CSI-RS resources that may comprise the CSI-RS resource. The CSI-RS may comprise an aperiodic CSI-RS. The DCI may indicate transmission of a CSI report. The CSI report may comprise an aperiodic CSI report. The wireless device may transmit the aperiodic CSI report comprising a radio link quality of the CSI-RS. The CSI-RS may be quasi co-located with a reference signal indicated by the TCI state. The wireless device may receive the CSI-RS with a spatial domain reception filter determined based on the reference signal indicated by the TCI state. The one or more configuration parameters may indicate no transmission-and-reception point (TRP) index for both: the first TCI state indicating an association between the first TCI state and a TRP; and the second TCI state indicating an association between the second TCI state and a TRP. The wireless device may comprise one or more processors and memory, storing instructions, that when executed by the one or more processors perform the method described herein. A system may comprise the wireless device configured to perform the described method, additional operations, and/or include the additional elements; and a base station configured to transmit the one or more configuration parameters. A computer-readable medium may store instructions that, when executed, cause performance of the described method, additional operations, and/or include additional elements. A base station may perform a corresponding method comprising multiple operations. The base station may perform a corresponding method, for example, by transmitting the one or more configuration parameters, transmitting the control message, and/or transmitting the CSI-RS.

A wireless device may perform a method comprising multiple operations. The wireless device may receive one or more configuration parameters indicating, for reference signal (RS) resource set, one of a first value or a second value. The wireless device may receive a control message indicating activation of a list of at least two transmission configuration indicator (TCI) states, wherein: the first value of the RS resource set indicates a first TCI state that occurs first in the list; and the second value of the RS resource set indicates a second TCI state that occurs second in the list. The wireless device may receive and/or transmit, via an RS resource of the RS resource set, an RS based on a TCI state, among the first TCI state and the second TCI state, indicated by one of the first value or the second value of the RS resource set. The RS resource set may be a sounding reference signal (SRS) resource set. The RS resource may be an SRS resource. The RS may be an SRS. The RS resource set may be a channel-state-information reference signal (CSI-RS) resource set. The RS resource may be an CSI-RS resource. The RS may be an CSI-RS. The one or more configuration parameters may indicate no transmission-and-reception point (TRP) index for both: the first TCI state indicating an association between the first TCI state and a TRP; and the second TCI state indicating an association between the second TCI state and a TRP. The wireless device may comprise one or more processors and memory, storing instructions, that when executed by the one or more processors perform the method described herein. A system may comprise the wireless device configured to perform the described method, additional operations, and/or include the additional elements; and a base station configured to transmit the one or more configuration parameters. A computer-readable medium may store instructions that, when executed, cause performance of the described method, additional operations, and/or include additional elements. A base station may perform a corresponding method comprising multiple operations. The base station may perform a corresponding method, for example, by transmitting the one or more configuration parameters, transmitting the control message, and/or transmitting or receiving the RS.

A wireless device may perform a method comprising multiple operations. The wireless device may receive one or more messages comprising one or more configuration parameters indicating, for a reference signal (RS) resource set, a first value of a field. receiving a control message indicating activation of a list of at least two transmission configuration indicator (TCI) states. The first value of the RS resource set may indicate a first TCI state that occurs first in the list. The wireless device may receive and/or transmit, via an RS resource of the RS resource set, a first RS based on the first TCI state indicated by the first value of the SRS resource set. The wireless device may receive a medium-access-control control element (MAC-CE) with: a first field indicating the RS resource set; and a second field indicating a value for the RS resource set indicated by the first field. The value may indicate a second TCI state of the at least two TCI states. The second field may indicate a second value for the field, wherein the second value indicates a second TCI state that occurs second in the list. The wireless device may receive and/or transmit, via the RS resource of the RS resource set, a second RS based on the second TCI state indicated by the second value of the SRS resource set. The wireless device may replace the first value of the field with the second value based on the receiving the MAC-CE. The wireless device may update the first value of the field with the second value based on the receiving the MAC-CE. The wireless device may receive and/or transmit the first RS based on the first TCI state by receiving and/or transmitting the first RS in response to the one or more configuration parameters indicating, for the RS resource set, the first value indicating the first TCI state. The first field of the MAC-CE may comprise an RS resource set index identifying the RS resource set. The one or more configuration parameters may indicate, for the RS resource set, the RS resource set index. The wireless device may receive and/or transmit the second RS based on the second TCI state by receiving and/or transmitting the second RS in response to receiving the MAC-CE indicating, for the RS resource set, the second value indicating the second TCI state. The wireless device may comprise one or more processors and memory, storing instructions, that when executed by the one or more processors perform the method described herein. A system may comprise the wireless device configured to perform the described method, additional operations, and/or include the additional elements; and a base station configured to transmit the one or more messages and/or the MAC-CE. A computer-readable medium may store instructions that, when executed, cause performance of the described method, additional operations, and/or include additional elements. A base station may perform a corresponding method comprising multiple operations. The base station may perform a corresponding method, for example, by transmitting the one or more messages and/or transmitting the MAC-CE.

A wireless device may perform a method comprising multiple operations. The wireless device may receive a first control message indicating activation of at least one transmission configuration indicator (TCI) states. The wireless device may transmit first uplink signals based on the at least one TCI state. The wireless device may receive a second control message indicating activation of at least two TCI states. Based on at least one TCI state of the at least two TCI states being different from the at least one TCI state, the wireless device may transmit second uplink signals based on the at least two TCI states after a beam application time. The at least one TCI state may be a single TCI state. The wireless device may transmit the first uplink signals by transmitting the first uplink signals based on the single TCI state. The at least one TCI state of the at least two TCI states may be different from the single TCI state. The at least one TCI state may be at least two first TCI states. The wireless device may transmit the first uplink signals by transmitting: one or more first uplink signals of the first uplink signals based on a first TCI state of the at least two first TCI states, and/or one or more second uplink signals of the first uplink signals based on a second TCI state of the at least two first TCI states. The wireless device may transmit the first uplink signals further by transmitting one or more third uplink signals of the first uplink signals based on the first TCI state and the second TCI state. The at least one TCI state of the at least two TCI states may be different from each TCI state of the at least two first TCI states. The at least one TCI state of the at least two TCI states may be different from at least one TCI state of the at least two first TCI states. The wireless device may transmit the second uplink signals by transmitting: one or more first uplink signals of the second uplink signals based on a first TCI state of the at least two TCI states, and/or one or more second uplink signals of the second uplink signals based on a second TCI state of the at least two TCI states. The wireless device may transmit the second uplink signals further by transmitting one or more third uplink signals of the second uplink signals based on the first TCI state and the second TCI state. The wireless device may comprise one or more processors and memory, storing instructions, that when executed by the one or more processors perform the method described herein. A system may comprise the wireless device configured to perform the described method, additional operations, and/or include the additional elements; and a base station configured to transmit the first message and/or the second message. A computer-readable medium may store instructions that, when executed, cause performance of the described method, additional operations, and/or include additional elements. A base station may perform a corresponding method comprising multiple operations. The base station may perform a corresponding method, for example, by transmit the first control message and/or transmitting the second control message.

A wireless device may perform a method comprising multiple operations. The wireless device may receive a first message comprising: a first field indicating at least one physical uplink control channel (PUCCH) resource; and a second field indicating a unified transmission configuration indicator (TCI) state index associated with the at least one PUCCH resource. The wireless device may receive a second message indicating activation of at least two TCI states of a plurality of TCI states. The wireless device may transmit, via the at least one PUCCH resource and based on one or more TCI states, of the at least two TCI states, being indicated by the unified TCI state index, an uplink signal. The first message may comprise a radio resource control (RRC) message. The second message may comprise at least one of a media access control (MAC)-control element (CE) or downlink control information (DCI). The first message may indicate the at least one PUCCH resource by indicating at least one PUCCH resource group comprising the at least one PUCCH resource. The wireless device may transmit the uplink signal based on the one or more TCI states, of the at least two TCI states, being indicated by the unified TCI state index by transmitting the uplink signal using at least one of: an uplink transmission power associated with the one or more TCI states, of the at least two TCI states, being indicated by the unified TCI state index; a spatial transmission filter associated with the one or more TCI states, of the at least two TCI states, being indicated by the unified TCI state index; or a transmission precoder associated with the one or more TCI states, of the at least two TCI states, being indicated by the unified TCI state index. The wireless device may transmit the uplink signal by one of: transmitting the uplink signal using at least one resource based on a first unified TCI state of the one or more TCI states, wherein the second field indicates a first value; transmitting the uplink signal using at least one resource based on a second unified TCI state of the one or more TCI states, wherein the second field indicates the second value; or transmitting the uplink signal using at least one resource based on the first unified TCI state and using at least one resource based on the second unified TCI state, wherein the second field indicates a third value that is different from the first value and that is different from the second value. The wireless device may receive an indication of a TCI codepoint associated with the at least two TCI states. The wireless device may comprise one or more processors and memory, storing instructions, that when executed by the one or more processors perform the method described herein. A system may comprise the wireless device configured to perform the described method, additional operations, and/or include the additional elements; and a base station configured to transmit the first message. A computer-readable medium may store instructions that, when executed, cause performance of the described method, additional operations, and/or include additional elements. A base station may perform a corresponding method comprising multiple operations. The base station may perform a corresponding method, for example, by transmitting the first message.

A wireless device may perform a method comprising multiple operations. The wireless device may receive one or more messages. The one or more messages may indicate: activation of at least two TCI states of a plurality of TCI states; at least one physical uplink control channel (PUCCH) resource; and/or a unified transmission configuration indicator (TCI) state index associated with the at least one PUCCH resource and indicating one or more TCI states of the at least two TCI states of the plurality of TCI states. The wireless device may transmit, via the at least one PUCCH resource and based on the one or more TCI states indicated by the unified TCI state index, an uplink signal. The one or more messages may comprise: a first message indicating the at least one PUCCH resource and the unified TCI state index associated with the at least one PUCCH resource, wherein the first message comprises a radio resource control (RRC) message; and a second message indicating the activation of the at least two TCI states of the plurality of TCI states, wherein the second message comprises at least one of a media access control (MAC)-control element (CE) or downlink control information (DCI). The one or more messages may indicate the at least one PUCCH resource by indicating at least one PUCCH resource group comprising the at least one PUCCH resource. The wireless device may transmit the uplink signal based on the one or more TCI states, of the at least two TCI states, being indicated by the unified TCI state index by transmitting the uplink signal using at least one of: an uplink transmission power associated with the one or more TCI states, of the at least two TCI states, being indicated by the unified TCI state index; a spatial transmission filter associated with the one or more TCI states, of the at least two TCI states, being indicated by the unified TCI state index; or a transmission precoder associated with the one or more TCI states, of the at least two TCI states, being indicated by the unified TCI state index. The wireless device may transmit the uplink signal by one of: transmitting the uplink signal using at least one resource based on a first unified TCI state of the one or more TCI states, wherein the unified TCI state index indicates the first value; transmitting the uplink signal using at least one resource based on a second unified TCI state of the one or more TCI states, wherein the unified TCI state index indicates the second value; or transmitting the uplink signal using at least one resource based on the first unified TCI state and using at least one resource based on the second unified TCI state, wherein the unified TCI state index indicates a third value that is different from the first value and that is different from the second value. The wireless device may receive an indication of a TCI codepoint associated with the at least two TCI states. The unified TCI state index may indicate the one or more TCI states by indicating one of: a first value associated with a first TCI state of the at least two TCI states; a second value associated with a second TCI state of the at least two TCI states; or a third value associated with both the first TCI state and the second TCI state of the at least two TCI states. The wireless device may comprise one or more processors and memory, storing instructions, that when executed by the one or more processors perform the method described herein. A system may comprise the wireless device configured to perform the described method, additional operations, and/or include the additional elements; and a base station configured to transmit the one or more messages. A computer-readable medium may store instructions that, when executed, cause performance of the described method, additional operations, and/or include additional elements. A base station may perform a corresponding method comprising multiple operations. The base station may perform a corresponding method, for example, by transmitting the one or more messages.

A base station may perform a method comprising multiple operations. The base station may transmit one or more messages. The one or more messages may indicate: activation of at least two TCI states of a plurality of TCI states; at least one physical uplink control channel (PUCCH) resource; and a unified transmission configuration indicator (TCI) state index associated with the at least one PUCCH resource and indicating one or more TCI states of the at least two TCI states of the plurality of TCI states. The base station may receive, via the at least one PUCCH resource and based on the one or more TCI states indicated by the unified TCI state index, an uplink signal. The one or more messages may comprise: a first message indicating the at least one PUCCH resource and the unified TCI state index associated with the at least one PUCCH resource, wherein the first message comprises a radio resource control (RRC) message; and a second message indicating the activation of the at least two TCI states of the plurality of TCI states, wherein the second message comprises at least one of a media access control (MAC)-control element (CE) or downlink control information (DCI). The one or more messages may indicate the at least one PUCCH resource by indicating at least one PUCCH resource group comprising the at least one PUCCH resource. The base station may receive the uplink signal based on the one or more TCI states, of the at least two TCI states, being indicated by the unified TCI state index by receiving the uplink signal using a spatial filter associated with the one or more TCI states, of the at least two TCI states, being indicated by the unified TCI state index. The base station may receive the uplink signal by one of: receiving the uplink signal using at least one resource based on a first unified TCI state of the one or more TCI states, wherein the unified TCI state index indicates the first value; receiving the uplink signal using at least one resource based on a second unified TCI state of the one or more TCI states, wherein the unified TCI state index indicates the second value; or receiving the uplink signal using at least one resource based on the first unified TCI state and using at least one resource based on the second unified TCI state, wherein the unified TCI state index indicates a third value that different from the first value and that is different from the second value. The base station may transmit an indication of a TCI codepoint associated with the at least two TCI states. The unified TCI state index indicates the one or more TCI states by indicating one of: a first value associated with a first TCI state of the at least two TCI states; a second value associated with a second TCI state of the at least two TCI states; or a third value associated with both the first TCI state and the second TCI state of the at least two TCI states. The base station may comprise one or more processors and memory, storing instructions, that when executed by the one or more processors perform the method described herein. A system may comprise the base station configured to perform the described method, additional operations, and/or include the additional elements; and a wireless device configured to transmit the uplink signal. A computer-readable medium may store instructions that, when executed, cause performance of the described method, additional operations, and/or include additional elements. A wireless device may perform a corresponding method comprising multiple operations. The wireless device may perform a corresponding method, for example, by transmitting the uplink signal

A wireless device may perform a method comprising multiple operations. The wireless device may receive one or more configuration parameters indicating a unified TCI state index for a physical uplink control channel (PUCCH) resource. The wireless device may receive one or more configuration parameters indicating, for a physical uplink control channel (PUCCH) resource, one of a first value, a second value, or a third value. The wireless device may receive a control message indicating activation of at least two unified TCI states, wherein the unified TCI state index may indicate at least one of the at least two unified TCI states. The first value of the PUCCH resource may indicate a first TCI state that occurs first in the list; the second value of the PUCCH resource may indicate a second TCI state that occurs second in the list; and the third value of the PUCCH resource may indicate the first TCI state and the second TCI state. The wireless device may transmit, via the PUCCH resource, an uplink signal based on the at least one of the at least two TCI states indicated by the unified TCI state index. The wireless device may transmit, via the PUCCH resource, an uplink signal based on at least one TCI state, among the first TCI state and the second TCI state, indicated by one of the first value, the second value, or the third value of the PUCCH resource. The one or more configuration parameters may indicate, for a PUCCH resource group comprising the PUCCH resource, one of the first value, the second value, or the third value. The uplink signal may comprise at least one of: a hybrid automatic repeat request acknowledgement (HARQ-ACK) information bit; a scheduling request (SR); and/or a channel-state-information (CSI) report. The one or more configuration parameters may indicate a plurality of TCI states comprising the first TCI state and the second TCI state. The first TCI state may be a first joint TCI state; and/or the second TCI state may be a second joint TCI state. The first TCI state may be a first uplink TCI state; and/or the second TCI state may be a second uplink TCI state. The wireless device may receive a medium-access control control element (MAC-CE) indicating activation of a subset of the plurality of TCI states that comprise the list of at least two TCI states. The wireless device may map the subset of the plurality of TCI states to one or more TCI codepoints, wherein: each TCI codepoint of the one or more TCI codepoints indicates one or more respective TCI states of the subset of the plurality of TCI states; and a TCI codepoint of the one or more TCI codepoints indicates the first TCI state and the second TCI state. The control message may be the MAC-CE based on a number of the one or more TCI codepoints being equal to one. The control message may comprise downlink control information (DCI) based on a number of the one or more TCI codepoints being more than one. The DCI may comprise a TCI field indicating the TCI codepoint. The one or more configuration parameters may indicate no transmission-and-reception point (TRP) index for both: the first TCI state indicating an association between the first TCI state and a TRP; and the second TCI state indicating an association between the second TCI state and a TRP. The wireless device may transmit the uplink signal with at least one spatial domain transmission filter that is determined based on at least one reference signal indicated by the at least one TCI state. The wireless device may transmit the uplink signal with at least one transmission power that is determined based on one or more power control parameters associated with the at least one TCI state. The at least one TCI state may be the first TCI state based on the one or more configuration parameters indicating, for the PUCCH resource, the first value. The wireless device may transmit the uplink signal with: a first spatial domain transmission filter that is determined based on a first reference signal indicated by the first TCI state; and a first transmission power that is determined based on one or more first power control parameters associated with the first TCI state. The at least one TCI state may be the second TCI state based on the one or more configuration parameters indicating, for the PUCCH resource, the second value. The wireless device may transmit the uplink signal with: a second spatial domain transmission filter that is determined based on a second reference signal indicated by the second TCI state; and a second transmission power that is determined based on one or more second power control parameters associated with the second TCI state. The at least one TCI state may comprise the first TCI state and the second TCI state based on the one or more configuration parameters indicating, for the PUCCH resource, the third value. The wireless device may transmit the uplink signal by transmitting: one or more first repetitions of the uplink signal with a first spatial domain transmission filter that is determined based on a first reference signal indicated by the first TCI state; and one or more second repetitions of the uplink signal with a second spatial domain transmission filter that is determined based on a second reference signal indicated by the second TCI state. The wireless device may transmit: the one or more first repetitions with a first transmission power that is determined based on one or more first power control parameters associated with the first TCI state; and the one or more second repetitions with a second transmission power that is determined based on one or more second power control parameters associated with the second TCI state. The one or more configuration parameters may indicate, for the PUCCH resource or the PUCCH resource group, a field with one of the first value, the second value, or the third value. The field may comprise at least one of: a unified TCI state field, a TRP field, or a control resource set (CORESET) pool field. A size of the field may be 2 bits. The size of the field may be 2 bits based on the one or more configuration parameters indicating at least two sounding reference signal (SRS) resource sets with codebook or non-codebook. The size of the field may be 2 bits based on the one or more configuration parameters indicating, for the PUCCH resource, a repetition number. The repetition number may be greater than one. The wireless device may comprise one or more processors and memory, storing instructions, that when executed by the one or more processors perform the method described herein. A system may comprise the wireless device configured to perform the described method, additional operations, and/or include the additional elements; and a base station configured to transmit the one or more configuration parameters. A computer-readable medium may store instructions that, when executed, cause performance of the described method, additional operations, and/or include additional elements. A base station may perform a corresponding method comprising multiple operations. The base station may perform a corresponding method, for example, by transmitting the one or more configuration parameters.

A wireless device may perform a method comprising multiple operations. The wireless device may receive one or more configuration parameters indicating, for a physical uplink control channel (PUCCH) resource, one of a first value or a second value. The wireless device may receive a control message indicating activation of a list of at least two transmission configuration indicator (TCI) states, wherein: the first value of the PUCCH resource indicates a first TCI state that occurs first in the list; and the second value of the PUCCH resource indicates a second TCI state that occurs second in the list. The wireless device may transmit, via the PUCCH resource, an uplink signal based on a TCI state, among the first TCI state and the second TCI state, indicated by one of the first value or the second value of the PUCCH resource. The one or more configuration parameters may indicate, for a PUCCH resource group comprising the PUCCH resource, one of the first value or the second value. The one or more configuration parameters may indicate, for the PUCCH resource or the PUCCH resource group, a field with one of the first value or the second value. The field may comprise at least one of: a unified TCI state field, TRP field, or a control resource set (CORESET) pool field. A size of the field may be 1 bit. The size of the field may be 1 bit based on the one or more configuration parameters not indicating at least two sounding reference signal (SRS) resource sets with codebook or non-codebook. The size of the field may be 1 bit based on the one or more configuration parameters indicating an uplink repetition among multiple TRPs. The one or more configuration parameters may indicate no transmission-and-reception point (TRP) index for both: the first TCI state indicating an association between the first TCI state and a TRP; and the second TCI state indicating an association between the second TCI state and a TRP. The wireless device may comprise one or more processors and memory, storing instructions, that when executed by the one or more processors perform the method described herein. A system may comprise the wireless device configured to perform the described method, additional operations, and/or include the additional elements; and a base station configured to transmit the one or more configuration parameters. A computer-readable medium may store instructions that, when executed, cause performance of the described method, additional operations, and/or include additional elements. A base station may perform a corresponding method comprising multiple operations. The base station may perform a corresponding method, for example, by transmitting the one or more configuration parameters.

A wireless device may perform a method comprising multiple operations. The wireless device may receive one or more configuration parameters of a physical uplink control channel (PUCCH) resource. The wireless device may receive a control message indicating activation of a list of at least two transmission configuration indicator (TCI) states. In response to a field being absent in the one or more configuration parameters of the PUCCH resource, the wireless device may transmit, via the PUCCH resource, an uplink signal based on a first TCI state that occurs first in the list. The field may comprise at least one of: a unified TCI state field, a transmission-and-reception point (TRP) field, or a control resource set (CORESET) pool field. The one or more configuration parameters of the PUCCH resource may not comprise the field. The one or more configuration parameters of a PUCCH resource group comprising the PUCCH resource may not comprise the field. The one or more configuration parameters may indicate no TRP index for the first TCI state indicating an association between the first TCI state and a TRP. The wireless device may comprise one or more processors and memory, storing instructions, that when executed by the one or more processors perform the method described herein. A system may comprise the wireless device configured to perform the described method, additional operations, and/or include the additional elements; and a base station configured to transmit the one or more configuration parameters. A computer-readable medium may store instructions that, when executed, cause performance of the described method, additional operations, and/or include additional elements. A base station may perform a corresponding method comprising multiple operations. The base station may perform a corresponding method, for example, by transmitting the one or more configuration parameters.

A wireless device may perform a method comprising multiple operations. The wireless device may receive a control message indicating activation of a list of at least two transmission configuration indicator (TCI) states. The wireless device may receive downlink control information (DCI) triggering transmission of an uplink signal via a physical uplink control channel (PUCCH) resource. The DCI may comprise a field indicating one of a first value, a second value, or a third value, wherein: the first value indicates a first TCI state that occurs first in the list; the second value indicates a second TCI state that occurs second in the list; and the third value indicates the first TCI state and the second TCI state. The wireless device may transmit, via the PUCCH resource, the uplink signal based on at least one TCI state, among the first TCI state and the second TCI state, indicated by one of the first value, the second value, or the third value of the field of the DCI. The field may comprise at least one of: a unified TCI state field, a transmission-and-reception point (TRP) field, or a control resource set (CORESET) pool field. The one or more configuration parameters may indicate no TRP index for both: the first TCI state indicating an association between the first TCI state and a TRP; and the second TCI state indicating an association between the second TCI state and a TRP. The DCI may configure the wireless device to schedule a physical downlink shared channel (PDSCH) reception. The wireless device may comprise one or more processors and memory, storing instructions, that when executed by the one or more processors perform the method described herein. A system may comprise the wireless device configured to perform the described method, additional operations, and/or include the additional elements; and a base station configured to transmit the control message. A computer-readable medium may store instructions that, when executed, cause performance of the described method, additional operations, and/or include additional elements. A base station may perform a corresponding method comprising multiple operations. The base station may perform a corresponding method, for example, by transmitting the control message

A wireless device may perform a method comprising multiple operations. The wireless device may receive a control message indicating activation of at least two transmission configuration indicator (TCI) states. The wireless device may receive, via a control resource set (CORESET) monitored with a TCI state among the at least two TCI states, a downlink control information (DCI) triggering transmission of an uplink signal via a physical uplink control channel (PUCCH) resource. In response to receiving the DCI via the CORESET monitored with the TCI state, the wireless device may transmit, via the PUCCH resource, the uplink signal based on the TCI state of the CORESET. The wireless device may monitor the CORESET based on the TCI state. The wireless device may monitor the CORESET based on the at least two TCI states comprising the TCI state. The TCI state may be a first TCI state that occurs first in a list of the at least two TCI states. The TCI state may be a TCI state, of the at least two TCI states, with a lowest TCI state index among at least two TCI state indexes of the at least two TCI states. The wireless device may comprise one or more processors and memory, storing instructions, that when executed by the one or more processors perform the method described herein. A system may comprise the wireless device configured to perform the described method, additional operations, and/or include the additional elements; and a base station configured to transmit the control message. A computer-readable medium may store instructions that, when executed, cause performance of the described method, additional operations, and/or include additional elements. A base station may perform a corresponding method comprising multiple operations. The base station may perform a corresponding method, for example, by transmitting the control message.

A wireless device may perform a method comprising multiple operations. The wireless device may receive one or more messages comprising one or more configuration parameters indicating, for a physical uplink control channel (PUCCH) resource, a first value of a field. The wireless device may receive a control message indicating activation of at least two transmission configuration indicator (TCI) states. The wireless device may receive a control message indicating activation of a list of at least two transmission configuration indicator (TCI) states, wherein the first value of the field indicates a first TCI state that occurs first in the list. The wireless device may transmit, via a physical uplink control channel (PUCCH) resource, a first uplink signal based on at least one first TCI state of the at least two TCI states, wherein a first unified TCI state index of the PUCCH resource indicates the at least one first TCI state. The wireless device may transmit, via the PUCCH resource, a first uplink signal based on the first TCI state indicated by the first value. The wireless device may receive a medium-access-control control element (MAC-CE) comprising: a first field indicating the PUCCH resource; and a second field indicating a second unified TCI state index that indicates at least one second TCI state of the at least two TCI states. The second field may indicate a second value for the field of the PUCCH resource, wherein the second value may indicate a second TCI state that occurs second in the list. The wireless device may transmit, via the PUCCH resource, a second uplink signal based on the at least one second TCI state indicated by the second unified TCI state index. The wireless device may transmit, via the PUCCH resource, a second uplink signal based on the second TCI state indicated by the second value. The wireless device may replace the first value of the field with the second value based on receiving the MAC-CE. The wireless device may update the first value of the field with the second value based on receiving the MAC-CE. The wireless device may transmit the first uplink signal based on the first TCI state by transmitting the first uplink signal in response to the one or more configuration parameters indicating, for the PUCCH resource, the first value indicating the first TCI state. The first field of the MAC-CE may comprise a PUCCH resource index identifying the PUCCH resource. The one or more configuration parameters may indicate, for the PUCCH resource, the PUCCH resource index. The wireless device may transmit the second uplink signal based on the second TCI state by transmitting the second signal in response to the receiving the MAC-CE indicating, for the PUCCH resource, the second value indicating the second TCI state. The one or more configuration parameters may indicate, for a PUCCH resource group comprising the PUCCH resource, the first value of the field. The first field of the MAC-CE may indicate the PUCCH resource group comprising the PUCCH resource. The wireless device may receive a second MAC-CE comprising: a first field indicating the PUCCH resource; and a second field indicating a third value for the field, wherein the third value indicates the first TCI state and the second TCI state. The wireless device may transmit, via the PUCCH resource: one or more first repetitions of a third uplink signal based on the first TCI state indicated by the third value; and one or more second repetitions of the third uplink signal based on the second TCI state indicated by the third value. The wireless device may comprise one or more processors and memory, storing instructions, that when executed by the one or more processors perform the method described herein. A system may comprise the wireless device configured to perform the described method, additional operations, and/or include the additional elements; and a base station configured to transmit the one or more messages. A computer-readable medium may store instructions that, when executed, cause performance of the described method, additional operations, and/or include additional elements. A base station may perform a corresponding method comprising multiple operations. The base station may perform a corresponding method, for example, by transmitting the one or more messages.

A wireless device may perform a method comprising multiple operations. The wireless device may receive at least one configuration parameter indicating: a single frequency network (SFN) for at least one downlink control channel; and a unified transmission configuration indicator (TCI) state field associated with a control resource set (CORESET). The unified TCI state field may be indicated by at least two bits based on the at least one configuration parameter indicating the SFN. The wireless device may receive an indication to activate at least two unified TCI states. The unified TCI state field associated with the CORESET may indicate at least one TCI state of the at least two unified TCI states. The wireless device may receive, via the CORESET and based on the at least one TCI state indicated by the unified TCI state field, a downlink signal. The unified TCI state field may indicate, based on the at least one parameter indicating the SFN, one of: a first TCI state of a plurality of TCI states; a second TCI state of the plurality of TCI states; or both the first TCI state and the second TCI state of the plurality of TCI states. The wireless device may receive the downlink signal based on the at least one TCI state being indicated by the unified TCI state field by receiving the downlink signal using a spatial filter associated with the at least one TCI state being indicated by the unified TCI state field. The unified TCI state field may indicate both a first TCI state of the at least two unified TCI states and a second TCI state of the at least two unified TCI states, wherein the wireless device may receive the downlink signal by: receiving a first portion of the downlink signal using a spatial filter associated with the first TCI state; and receiving a second portion of the downlink signal using a spatial filter associated with the second TCI state. The wireless device may use two spatial filters to receive the downlink signal (e.g., in an SFN mode). The wireless device may use the first spatial filter for a first subset of data layers of the downlink signal and the second spatial filter for a second subset of data layers of the downlink signal (e.g., in SDM mode). The wireless device may receive at least one second configuration parameter indicating: downlink control channels lack an SFN; and a second unified TCI state field for associated with the CORESET, wherein a size of the second unified TCI state field is one bit based on the at least one second configuration parameter indicating downlink control channels lack an SFN. The wireless device may receive a second indication to activate at least two unified TCI states, wherein the second unified TCI state field indicates one of the at least two unified TCI states. The wireless device may receive, via the CORESET and based on the one of the at least two unified TCI states indicated by the second unified TCI state field, a second downlink signal. The wireless device may receive an indication of a TCI codepoint associated with the at least two unified TCI states. The least one TCI state indicated by the unified TCI state field may comprise a first TCI state and a second TCI state. The first TCI state may be associated with a first transmission and reception point, and the second TCI state may be associated with a second transmission and reception point. The wireless device may comprise one or more processors and memory, storing instructions, that when executed by the one or more processors perform the method described herein. A system may comprise the wireless device configured to perform the described method, additional operations, and/or include the additional elements; and a base station configured to transmit the at least one configuration parameter. A computer-readable medium may store instructions that, when executed, cause performance of the described method, additional operations, and/or include additional elements. A base station may perform a corresponding method comprising multiple operations. The base station may perform a corresponding method, for example, by transmitting the at least one configuration parameter.

A base station may perform a method comprising multiple operations. The base station may transmit at least one configuration parameter indicating: a single frequency network (SFN) for at least one downlink control channel; and a unified transmission configuration indicator (TCI) state field associated with a control resource set (CORESET), wherein the unified TCI state field is indicated by at least two bits based on the at least one configuration parameter indicating the SFN. The base station may transmit an indication to activate at least two unified TCI states, wherein the unified TCI state field associated with the CORESET indicates at least one TCI state of the at least two unified TCI states. The base station may transmit, via the CORESET and based on the at least one TCI state indicated by the unified TCI state field, a downlink signal. The unified TCI state field may indicate, based on the at least one parameter indicating the SFN, one of: a first TCI state of a plurality of TCI states; a second TCI state of the plurality of TCI states; or both the first TCI state and the second TCI state of the plurality of TCI states. The base station may transmit the downlink signal based on the at least one TCI state being indicated by the unified TCI state field by transmitting the downlink signal using a spatial filter associated with the at least one TCI state being indicated by the unified TCI state field. The unified TCI state field may indicate both a first TCI state of the at least two unified TCI states and a second TCI state of the at least two unified TCI states, wherein the base station may transmit the downlink signal by transmitting via the CORESET and using at least one of: a spatial filter associated with the first TCI state; or a spatial filter associated with the second TCI state. The base station may transmit at least one second configuration parameter indicating: downlink control channels lack an SFN; and a second unified TCI state field for associated with the CORESET, wherein a size of the second unified TCI state field is one bit based on the at least one second configuration parameter indicating downlink control channels lack an SFN. The base station may transmit a second indication to activate at least two unified TCI states, wherein the second unified TCI state field indicates one of the at least two unified TCI states. The base station may transmit, via the CORESET and based on the one of the at least two unified TCI states indicated by the second unified TCI state field, a second downlink signal. The base station may transmit an indication of a TCI codepoint associated with the at least two unified TCI states. The least one TCI state indicated by the unified TCI state field may comprise a first TCI state and a second TCI state. The first TCI state may be associated with a first transmission and reception point, and the second TCI state may be associated with a second transmission and reception point. The base station may comprise one or more processors and memory, storing instructions, that when executed by the one or more processors perform the method described herein. A system may comprise the base station configured to perform the described method, additional operations, and/or include the additional elements; and a wireless device configured to receive the downlink signal. A computer-readable medium may store instructions that, when executed, cause performance of the described method, additional operations, and/or include additional elements. A wireless device may perform a corresponding method comprising multiple operations. The wireless device may perform a corresponding method, for example, by receiving the downlink signal.

A wireless device may perform a method comprising multiple operations. The wireless device may receive one or more messages. The one or more messages may indicate: a single frequency network (SFN) for at least one downlink control channel; a unified transmission configuration indicator (TCI) state field associated with a control resource set (CORESET), wherein the unified TCI state field indicates, based on the one or more messages indicating the SFN, one of: a first TCI state of a plurality of TCI states, a second TCI state of the plurality of TCI states, or both the first TCI state and the second TCI state of the plurality of TCI states; and activation of at least two unified TCI states, wherein the at least two unified TCI states comprise one or both of the first TCI state and the second TCI state. The wireless device may receive, via the CORESET and based on at least one TCI state indicated by the unified TCI state field, a downlink signal. The unified TCI state field may be indicated by at least two bits based on the one or more messages indicating the SFN. The wireless device may receive the downlink signal based on the at least one TCI state being indicated by the unified TCI state field by receiving the downlink signal using a spatial filter associated with the at least one TCI state being indicated by the unified TCI state field. The unified TCI state field may indicate both the first TCI state and the second TCI state of the plurality of TCI states, wherein receiving the downlink signal comprises: receiving a first portion of the downlink signal using a spatial filter associated with the first TCI state; and receiving a second portion of the downlink signal using a spatial filter associated with the second TCI state. The wireless device may receive at least one second configuration parameter indicating: downlink control channels lack an SFN; and a second unified TCI state field for associated with the CORESET, wherein a size of the second unified TCI state field is one bit based on the at least one second configuration parameter indicating downlink control channels lack an SFN. The wireless device may receive a second indication to activate at least two unified TCI states, wherein the second unified TCI state field indicates one of the at least two unified TCI states. The wireless device may receive, via the CORESET and based on the one of the at least two unified TCI states indicated by the second unified TCI state field, a second downlink signal. The least one TCI state indicated by the unified TCI state field may comprise a first TCI state and a second TCI state. The first TCI state may be associated with a first transmission and reception point, and the second TCI state may be associated with a second transmission and reception point. The wireless device may comprise one or more processors and memory, storing instructions, that when executed by the one or more processors perform the method described herein. A system may comprise the wireless device configured to perform the described method, additional operations, and/or include the additional elements; and a base station configured to transmit the one or more messages. A computer-readable medium may store instructions that, when executed, cause performance of the described method, additional operations, and/or include additional elements. A base station may perform a corresponding method comprising multiple operations. The base station may perform a corresponding method, for example, by transmitting the one or more messages.

A wireless device may perform a method comprising multiple operations. The wireless device may receive one or more configuration parameters indicating: a single frequency network (SFN) for downlink control channels; and a unified TCI state field for a control resource set (CORESET), wherein size of the unified TCI state field is two bits based on the one or more configuration parameters indicating the SFN. The wireless device may receive one or more configuration parameters indicating: a single frequency network (SFN) for downlink control channels, and one of a first value, a second value, or a third value for a control resource set (CORESET). The wireless device may receive a control message indicating activation of at least two unified TCI states, wherein the unified TCI state field of the CORESET indicates at least TCI state of the at least two unified TCI states. The wireless device may receive a control message indicating activation of a list of at least two transmission configuration indicator (TCI) states, wherein: the first value of the CORESET indicates a first TCI state that occurs first in the list; the second value of the CORESET indicates a second TCI state that occurs second in the list; and the third value of the CORESET indicates the first TCI state and the second TCI state. The wireless device may receive, via the CORESET, downlink control information (DCI) based on the at least one TCI state indicated by the unified TCI state field. The wireless device may receive, via the CORESET, downlink control information (DCI) based on at least one TCI state, among the first TCI state and the second TCI state, indicated by one of the first value, the second value, or the third value of the CORESET. The wireless device may receive one or more second configuration parameters indicating: no SFN for downlink control channels; and a second unified TCI state field for the CORESET, wherein a size of the second unified TCI state field is one bit based on the one or more second configuration parameters indicating no SFN. The wireless device may receive a second control message indicating activation of two unified TCI states, wherein the second unified TCI state field indicates one of the two unified TCI states. The wireless device may receive, via the CORESET, second DCI based on the one of the two TCI states. The wireless device may monitor, for the DCI, downlink control channels in the CORESET based on the at least one TCI state. The one or more configuration parameters may indicate, for the CORESET, one or more search space sets. The one or more configuration parameters may comprise, for the CORESET, a follow-unified-TCI-state parameter that indicates to apply one or more unified TCI states for the CORESET. At least one search space set of the one or more search space sets may be a common search space (CSS) set different from a Type3 CSS set. The wireless device may receive, via the CORESET, the DCI based on the at least one TCI state by receiving the DCI in response to the one or more configuration parameters comprising, for the CORESET, the follow-unified-TCI-state parameter. The one or more configuration parameters may not comprise, for the CORESET, a follow-unified-TCI-state parameter that indicates to apply one or more unified TCI states for the CORESET. Each search space set of the one or more search space sets may be a user-specific search space (USS) set or a Type3 CSS set. The one or more configuration parameters may indicate, for an active downlink bandwidth part (BWP) of a cell, the CORESET. The at least one TCI state may be the first TCI state based on the one or more configuration parameters indicating, for the CORESET, the first value. At least one demodulation reference signal (DM-RS) of physical downlink control channel (PDCCH) transmissions via the CORESET may be quasi co-located with a first reference signal indicated by the first TCI state. The at least one TCI state may be the second TCI state based on the one or more configuration parameters indicating, for the CORESET, the second value. At least one DM-RS of PDCCH transmissions via the CORESET may be quasi co-located with a second reference signal indicated by the second TCI state. The at least one TCI state may comprise the first TCI state and the second TCI state based on the one or more configuration parameters indicating, for the CORESET, the third value. At least one DM-RS of PDCCH transmissions via the CORESET may be quasi co-located with: a first reference signal indicated by the first TCI state; and a second reference signal indicated by the second TCI state. The one or more configuration parameters may indicate a plurality of TCI states comprising the first TCI state and the second TCI state. The first TCI state may be a first joint TCI state; and the second TCI state may be a second joint TCI state. The first TCI state may be a first downlink TCI state; and the second TCI state may be a second downlink TCI state. The wireless device may receive a medium access control (MAC) control element (CE) (MAC-CE) indicating activation of a subset of the plurality of TCI states that comprise the list of at least two TCI states. The wireless device may map the subset of the plurality of TCI states to one or more TCI codepoints, wherein: each TCI codepoint of the one or more TCI codepoints indicates one or more respective TCI states of the subset of the plurality of TCI states; and a TCI codepoint of the one or more TCI codepoints indicates the first TCI state and the second TCI state. The control message may comprise the MAC-CE based on a number of the one or more TCI codepoints being equal to one. The control message may comprise second DCI based on a number of the one or more TCI codepoints being more than one, and wherein the second DCI comprises a TCI field indicating the TCI codepoint. The one or more configuration parameters may indicate no transmission-and-reception point (TRP) index for both: the first TCI state indicating an association between the first TCI state and a TRP; and the second TCI state indicating an association between the second TCI state and a TRP. The one or more configuration parameters may indicate, for the CORESET, a field with one of the first value, the second value, or the third value. The field may comprise at least one of: a unified TCI state field, a TRP field, or a control resource set (CORESET) pool field. A size of the field may be 2 bits. The size of the field may be 2 bits based on the one or more configuration parameters indicating the SFN for downlink control channels. The wireless device may comprise one or more processors and memory, storing instructions, that when executed by the one or more processors perform the method described herein. A system may comprise the wireless device configured to perform the described method, additional operations, and/or include the additional elements; and a base station configured to transmit the one or more configuration parameters. A computer-readable medium may store instructions that, when executed, cause performance of the described method, additional operations, and/or include additional elements. A base station may perform a corresponding method comprising multiple operations. The base station may perform a corresponding method, for example, by transmitting the one or more parameters.

A wireless device may perform a method comprising multiple operations. The wireless device may receive one or more configuration parameters indicating one of a first value or a second value for a control resource set (CORESET). The wireless device may receive a control message indicating activation of a list of at least two transmission configuration indicator (TCI) states, wherein: the first value of the CORESET indicates a first TCI state that occurs first in the list; and the second value of the CORESET indicates a second TCI state that occurs second in the list. The wireless device may receive, via the CORESET, downlink control information (DCI) based on a TCI state, among the first TCI state and the second TCI state, indicated by one of the first value or the second value of the CORESET. The one or more configuration parameters may not indicate a single frequency network (SFN) for downlink control channels. The one or more configuration parameters may indicate, for the CORESET, a field with one of the first value or the second value. The field may comprise at least one of: a unified TCI state field, a transmission-and-reception point (TRP) field, or a control resource set (CORESET) pool field. A size of the field may be 1 bit. The size of the field may be 1 bit based on the one or more configuration parameters not indicating the SFN for downlink control channels. The one or more configuration parameters may indicate no TRP index for both: the first TCI state indicating an association between the first TCI state and a TRP; and the second TCI state indicating an association between the second TCI state and a TRP. The wireless device may monitor, for the DCI, downlink control channels in the CORESET based on the TCI state. The TCI state may be the first TCI state based on the one or more configuration parameters indicating, for the CORESET, the first value. At least one demodulation reference signal (DM-RS) of physical downlink control channel (PDCCH) transmissions via the CORESET may be quasi co-located with a first reference signal indicated by the first TCI state. The TCI state is the second TCI state based on the one or more configuration parameters indicating, for the CORESET, the second value. At least one DM-RS of PDCCH transmissions via the CORESET may be quasi co-located with a second reference signal indicated by the second TCI state. The wireless device may comprise one or more processors and memory, storing instructions, that when executed by the one or more processors perform the method described herein. A system may comprise the wireless device configured to perform the described method, additional operations, and/or include the additional elements; and a base station configured to transmit the one or more configuration parameters. A computer-readable medium may store instructions that, when executed, cause performance of the described method, additional operations, and/or include additional elements. A base station may perform a corresponding method comprising multiple operations. The base station may perform a corresponding method, for example, by transmitting the one or more configuration parameters.

A wireless device may perform a method comprising multiple operations. The wireless device may receive one or more configuration parameters indicating: a single frequency network (SFN) for downlink control channels, and one or more search space sets for a control resource set (CORESET), wherein each search space set of the one or more search space sets is a user-specific search space (USS) set. The wireless device may receive a control message indicating activation of at least two transmission configuration indicator (TCI) states. The wireless device may receive, via the CORESET, downlink control information (DCI) based on the at least two TCI states, wherein the receiving is in response to the one or more configuration parameters indicating: the SFN for downlink control channels; and the one or more search space sets that are USS sets. The wireless device may comprise one or more processors and memory, storing instructions, that when executed by the one or more processors perform the method described herein. A system may comprise the wireless device configured to perform the described method, additional operations, and/or include the additional elements; and a base station configured to transmit the one or more configuration parameters. A computer-readable medium may store instructions that, when executed, cause performance of the described method, additional operations, and/or include additional elements. A base station may perform a corresponding method comprising multiple operations. The base station may perform a corresponding method, for example, by transmitting the one or more configuration parameters.

A wireless device may perform a method comprising multiple operations. The wireless device may receive one or more configuration parameters of a control resource set (CORESET). The wireless device may receive a control message indicating activation of a list of at least two transmission configuration indicator (TCI) states. In response to a field being absent in the one or more configuration parameters of the CORESET, the wireless device may receive, via the CORESET, downlink control information (DCI) based on a first TCI state that occurs first in the list. The field maybe at least one of: a unified TCI state field, a transmission-and-reception point (TRP) field, or a control resource set (CORESET) pool field. The one or more configuration parameters of the CORESET may not comprise the field. The one or more configuration parameters may indicate no TRP index for the first TCI state indicating an association between the first TCI state and a TRP. The wireless device may comprise one or more processors and memory, storing instructions, that when executed by the one or more processors perform the method described herein. A system may comprise the wireless device configured to perform the described method, additional operations, and/or include the additional elements; and a base station configured to transmit the one or more configuration parameters. A computer-readable medium may store instructions that, when executed, cause performance of the described method, additional operations, and/or include additional elements. A base station may perform a corresponding method comprising multiple operations. The base station may perform a corresponding method, for example, by transmitting the one or more configuration parameters.

A wireless device may perform a method comprising multiple operations. The wireless device may receive one or more messages comprising one or more configuration parameters indicating, for a control resource set (CORESET), a first value of a field. The wireless device may receive a control message indicating activation of a list of at least two transmission configuration indicator (TCI) states, wherein the first value of the CORESET indicates a first TCI state that occurs first in the list. The wireless device may receive, via the CORESET, first downlink control information (DCI) based on the first TCI state indicated by the first value. The wireless device may receive a medium-access-control control element (MAC-CE) with: a first field indicating the CORESET; and a second field indicating a second value for the field, wherein the second value indicates a second TCI state that occurs second in the list. The wireless device may receive, via the CORESET, second DCI based on the second TCI state indicated by the second value. The wireless device may replace the first value of the field with the second value based on receiving the MAC-CE. The wireless device may update the first value of the field with the second value based on receiving the MAC-CE. The wireless device may receive the first DCI based on the first TCI state by receiving the first DCI in response to the one or more configuration parameters indicating, for the CORESET, the first value indicating the first TCI state. The first field of the MAC-CE may comprise a CORESET index identifying the CORESET. The one or more configuration parameters may indicate, for the CORESET, the CORESET index. The wireless device may receive the second DCI based on the second TCI state by receiving the second DCI in response to receiving the MAC-CE indicating, for the CORESET, the second value indicating the second TCI state. The wireless device may receive a second MAC-CE comprising: a first field indicating the CORESET; and a second field indicating a third value for the field, wherein the third value indicates the first TCI state and the second TCI state. The wireless device may receive, via the CORESET, third DCI based on the first TCI state and the second TCI state indicated by the third value. The wireless device may comprise one or more processors and memory, storing instructions, that when executed by the one or more processors perform the method described herein. A system may comprise the wireless device configured to perform the described method, additional operations, and/or include the additional elements; and a base station configured to transmit the one or more messages. A computer-readable medium may store instructions that, when executed, cause performance of the described method, additional operations, and/or include additional elements. A base station may perform a corresponding method comprising multiple operations. The base station may perform a corresponding method, for example, by transmitting the one or more messages.

A wireless device may perform a method comprising multiple operations. The wireless device may receive a message indicating activation of at least two unified transmission configuration indicator (TCI) states comprising a first TCI state and a second TCI state. The wireless device may receive downlink control information (DCI) scheduling reception of a physical downlink shared channel (PDSCH) signal. The DCI may comprise a unified TCI state field indicating one of a first value, a second value, and a third value, and wherein: the first value indicates the first TCI state; the second value indicates the second TCI state; and the third value indicates the first TCI state and the second TCI state. The wireless device may receive, based on at least one TCI state indicated by the unified TCI state field, the PDSCH signal. The wireless device may receive the PDSCH signal based on the at least one TCI state indicated by the unified TCI state field by receiving the PDSCH signal using a spatial filter associated with the at least one TCI state indicated by the unified TCI state field. The unified TCI state field may indicate the third value, and the wireless device may receive the PDSCH signal by: receiving a first portion of the PDSCH signal using a spatial filter associated with the first TCI state; and receiving a second portion of the PDSCH signal using a spatial filter associated with the second TCI state. Based on the unified TCI state field indicating the first value, the wireless device may receive the PDSCH signal using a first spatial filter associated with the first TCI state. Based on the unified TCI state field indicating the second value, the wireless device may receive the PDSCH signal using a second spatial filter associated with the second TCI state. Based on the unified TCI state field indicating the third value, the wireless device may receive the PDSCH signal using a first spatial filter associated with the first TCI state and using a second spatial filter associated with the second TCI state. The wireless device may receive an indication of a TCI codepoint associated with the at least one TCI state. The least one TCI state indicated by the unified TCI state field comprises the first TCI state and the second TCI state. The first TCI state may be associated with a first transmission and reception point, and the second TCI state may be associated with a second transmission and reception point. The wireless device may comprise one or more processors and memory, storing instructions, that when executed by the one or more processors perform the method described herein. A system may comprise the wireless device configured to perform the described method, additional operations, and/or include the additional elements; and a base station configured to transmit the message and/or the PDSCH signal. A computer-readable medium may store instructions that, when executed, cause performance of the described method, additional operations, and/or include additional elements. A base station may perform a corresponding method comprising multiple operations. The base station may perform a corresponding method, for example, by transmitting the message and/or the PDSCH signal.

A base station may perform a method comprising multiple operations. The base station may transmit a message indicating activation of at least two unified transmission configuration indicator (TCI) states comprising a first TCI state and a second TCI state. The base station may transmit downlink control information (DCI) scheduling reception of a physical downlink shared channel (PDSCH) signal. The DCI may comprise a unified TCI state field indicating one of a first value, a second value, and a third value, and wherein: the first value indicates the first TCI state; the second value indicates the second TCI state; and the third value indicates the first TCI state and the second TCI state. The base station may transmit, based on at least one TCI state indicated by the unified TCI state field, the PDSCH signal. The base station may transmit the PDSCH signal based on the at least one TCI state indicated by the unified TCI state field by transmitting the PDSCH signal using a spatial filter associated with the at least one TCI state indicated by the unified TCI state field. The unified TCI state field may indicate the third value, wherein the base station may transmit the PDSCH signal by transmitting the PDSCH signal using at least one of: a spatial filter associated with the first TCI state; or a spatial filter associated with the second TCI state. Based on the unified TCI state field indicating the first value, the base station may transmit the PDSCH signal using a first spatial filter associated with the first TCI state. Based on the unified TCI state field indicating the second value, the base station may transmit the PDSCH signal using a second spatial filter associated with the second TCI state. Based on the unified TCI state field indicating the third value, the base station may transmit the PDSCH signal using a first spatial filter associated with the first TCI state and using a second spatial filter associated with the second TCI state. The base station may transmit an indication of a TCI codepoint associated with the at least one TCI state. The least one TCI state indicated by the unified TCI state field may comprise the first TCI state and the second TCI state. The first TCI state may be associated with a first transmission and reception point, and the second TCI state may be associated with a second transmission and reception point. The base station may comprise one or more processors and memory, storing instructions, that when executed by the one or more processors perform the method described herein. A system may comprise the base station configured to perform the described method, additional operations, and/or include the additional elements; and a wireless device configured to receive the PDSCH signal. A computer-readable medium may store instructions that, when executed, cause performance of the described method, additional operations, and/or include additional elements. A wireless device may perform a corresponding method comprising multiple operations. The wireless device may perform a corresponding method, for example, by receiving the PDSCH signal.

A wireless device may perform a method comprising multiple operations. The wireless device may receive a message indicating activation of at least two unified transmission configuration indicator (TCI) states comprising a first TCI state and a second TCI state. The wireless device may receive downlink control information (DCI) scheduling reception of a physical downlink shared channel (PDSCH) signal, wherein the DCI comprises a field indicating which one or both of the first TCI state and the second TCI state to apply for PDSCH reception. The wireless device may receive, based on the field, the PDSCH signal. The wireless device may receive the PDSCH signal based on the field by receiving the PDSCH signal using a spatial filter associated with at least one TCI state indicated by the field. The field may comprise a unified TCI state field. The field may indicate both of the first TCI state and the second TCI state, and the wireless device may receive the PDSCH signal by: receiving a first portion of the PDSCH signal using a spatial filter associated with the first TCI state; and receiving a second portion of the PDSCH signal using a spatial filter associated with the second TCI state. Based on the field indicating the first TCI state, the wireless device may receive the PDSCH signal using a first spatial filter associated with the first TCI state. Based on the field indicating the second TCI state, the wireless device may receive the PDSCH signal using a second spatial filter associated with the second TCI state. The first TCI state may be associated with a first transmission and reception point, and the second TCI state may be associated with a second transmission and reception point. The wireless device may receive at least one configuration parameter indicating a presence of the field in DCI. The wireless device may comprise one or more processors and memory, storing instructions, that when executed by the one or more processors perform the method described herein. A system may comprise the wireless device configured to perform the described method, additional operations, and/or include the additional elements; and a base station configured to transmit the message and/or the PDSCH signal. A computer-readable medium may store instructions that, when executed, cause performance of the described method, additional operations, and/or include additional elements. A base station may perform a corresponding method comprising multiple operations. The base station may perform a corresponding method, for example, by transmitting the message and/or the PDSCH signal.

A wireless device may perform a method comprising multiple operations. The wireless device may receive a control message indicating activation of at least two unified transmission configuration indicator (TCI) states. The wireless device may receive downlink control information (DCI) scheduling a physical downlink shared channel (PDSCH) signal/reception. The DCI may comprise a unified TCI state field indicating at least one unified TCI state of the at least two unified TCI states. The wireless device may receive the PDSCH reception based on the at least one unified TCI state indicated by the unified TCI state field. The wireless device may receive one or more messages comprising one or more configuration parameters. The at least two unified TCI states may comprise: a first TCI state that occurs first in a list of the at least two unified TCI states; and a second TCI state that occurs second in the list. The first TCI state may indicate a first reference signal; and the second TCI state may indicate a second reference signal. The at least one unified TCI state may comprise the first TCI state based on the unified TCI state field being equal to a first value. At least one demodulation reference signal (DM-RS) antenna port of the PDSCH signal/reception may be quasi co-located with the first reference signal indicated by the first TCI state. The at least one unified TCI state may be the second TCI state based on the unified TCI state field being equal to a second value. At least one DM-RS antenna port of the PDSCH signal/reception may be quasi co-located with the second reference signal indicated by the second TCI state. The at least one unified TCI state may be the first TCI state and the second TCI state based on the unified TCI state field being equal to a third value. At least one DM-RS antenna port of the PDSCH signal/reception may be quasi co-located with: the first reference signal indicated by the first TCI state; and the second reference signal indicated by the second TCI state. At least one first DM-RS antenna port of the PDSCH signal/reception may be quasi co-located with the first reference signal indicated by the first TCI state; and at least one second DM-RS antenna port of the PDSCH reception may be quasi co-located with the second reference signal indicated by the second TCI state. A time offset between the DCI and the PDSCH reception may be equal to or greater than a threshold. The one or more configuration parameters may indicate a repetition scheme. The repetition scheme may comprise: a time domain repetition scheme; or a frequency domain repetition scheme. The DCI may comprise an antenna port field indicating DM-RS antenna ports in one code domain multiplexing (CDM) group. The one or more configuration parameters may indicate no repetition scheme. The one or more configuration parameters may indicate a time domain resource allocation (TDRA) table comprising one or more rows, wherein each row of the one or more rows may indicate a respective: slot offset value; starting symbol; length; and/or repetition number. The DCI comprises a TDRA field indicating a row of the one or more rows, wherein the row indicates a number of repetitions greater than one. The DCI may comprise an antenna port field indicating DM-RS antenna ports in one CDM group. The DCI may comprise an antenna port field indicating DM-RS antenna ports in two CDM groups. The wireless device may receive DCI via a control resource set (CORESET). The wireless device may receive the DCI via a user-specific search space (USS) set of the CORESET. The one or more configuration parameters may indicate presence of the unified TCI state field in the DCI. The one or more configuration parameters may comprise a field-presence-DCI parameter indicating presence of the unified TCI state field in the DCI. A size of the unified TCI state field may be 2 bits. The size of the unified TCI state field may be 2 bits in response to the one or more configuration parameters indicating a repetition scheme. The size of the unified TCI state field may be 2 bits in response to the row indicating the number of repetitions that is greater than one. A size of the unified TCI state field may be 1 bit. The size of the unified TCI state field may be 1 bit in response to the one or more configuration parameters indicating no repetition scheme. The one or more configuration parameters may indicate a size of the unified TCI state field in the DCI. The one or more configuration parameters may comprise a field-size-DCI parameter indicating the size of the unified TCI state field in the DCI. The one or more configuration parameters may indicate a plurality of TCI states comprising the first TCI state and the second TCI state. The first TCI state may be a first joint TCI state; and the second TCI state may be a second joint TCI state. The first TCI state may be a first downlink TCI state; and the second TCI state may be a second downlink TCI state. The wireless device may receive a medium access control (MAC) control element (CE) (MAC-CE) indicating activation of a subset of the plurality of TCI states that comprise the list of at least two TCI states. The wireless device may map the subset of the plurality of TCI states to one or more TCI codepoints, wherein: each TCI codepoint of the one or more TCI codepoints indicates one or more respective TCI states of the subset of the plurality of TCI states; and a TCI codepoint of the one or more TCI codepoints indicates the first TCI state and the second TCI state. The control message may comprise the MAC-CE based on a number of the one or more TCI codepoints being equal to one. The control message may comprise second DCI based on a number of the one or more TCI codepoints being more than one. The second DCI may comprise a TCI field indicating the TCI codepoint. The one or more configuration parameters indicate no transmission-and-reception point (TRP) index for both: the first TCI state indicating an association between the first TCI state and a TRP; and the second TCI state indicating an association between the second TCI state and a TRP. The method of claim 1, wherein the DCI comprises a TCI field. The wireless device may comprise one or more processors and memory, storing instructions, that when executed by the one or more processors perform the method described herein. A system may comprise the wireless device configured to perform the described method, additional operations, and/or include the additional elements; and a base station configured to transmit the control message, the DCI, and/or the PDSCH transmission (e.g., for reception by the wireless device). A computer-readable medium may store instructions that, when executed, cause performance of the described method, additional operations, and/or include additional elements. A base station may perform a corresponding method comprising multiple operations. The base station may perform a corresponding method, for example, by transmitting the control message, the DCI, and/or the PDSCH signal (e.g., for reception by the wireless device).

A wireless device may perform a method comprising multiple operations. The wireless device may receive a control message indicating activation of a list of at least two unified transmission configuration indicator (TCI) states comprising: a first TCI state that occurs first in the list; and a second TCI state that occurs second in the list. The wireless device may receive downlink control information (DCI) scheduling a physical downlink shared channel (PDSCH) signal/reception. The DCI may comprise a unified TCI state field indicating one of a first value, a second value, and a third value, wherein: the first value indicates the first TCI state; the second value indicates the second TCI state; and the third value indicates the first TCI state and the second TCI state. The wireless device may receive the PDSCH signal/reception based on at least TCI state, of the at least two unified TCI states, indicated by the unified TCI state field. The wireless device may comprise one or more processors and memory, storing instructions, that when executed by the one or more processors perform the method described herein. A system may comprise the wireless device configured to perform the described method, additional operations, and/or include the additional elements; and a base station configured to transmit the control message, the DCI, and/or the PDSCH signal. A computer-readable medium may store instructions that, when executed, cause performance of the described method, additional operations, and/or include additional elements. A base station may perform a corresponding method comprising multiple operations. The base station may perform a corresponding method, for example, by transmitting the control message, the DCI, and/or the PDSCH signal.

A wireless device may perform a method comprising multiple operations. The wireless device may receive one or more messages comprising one or more configuration parameters indicating a plurality of transmission configuration indictor (TCI) states. The wireless device may receive a medium access control (MAC) control element (CE) (MAC-CE) indicating activation of a subset of the plurality of TCI states. The wireless device may receive first downlink control information (DCI) indicating activation of at least two TCI states of the subset of the plurality of TCI states. The wireless device may receive second DCI scheduling a physical downlink shared channel (PDSCH) signal/reception. The wireless device may receive the PDSCH signal/reception based on at least one TCI state of the at least two TCI states. The at least two TCI states may comprise: a first TCI state that occurs first in a list of the at least two TCI states; and a second TCI state that occurs second in the list. The at least one TCI state may be the first TCI state. The second DCI may comprise a DCI format 0-0. The wireless device may receive the PDSCH signal/reception based on the first TCI state in response to the second DCI being the DCI format 1-0. The one or more configuration parameters may indicate a time domain resource allocation (TDRA) table comprising one or more rows, wherein each row of the one or more rows indicates a respective: slot offset value; starting symbol; length; and/or repetition number. The second DCI may comprise a TDRA field indicating a row of the one or more rows, wherein the row indicates: a repetition number that is equal to one; or no repetition. The wireless device may receive the PDSCH signal/reception based on the first TCI state by receiving the PDSCH signal/reception in response to the row indicating: a repetition number that is equal to one; or no repetition. The wireless device may receive the second DCI via a control resource set (CORESET). The wireless device may monitor the CORESET based on the at least one TCI state. The wireless device may receive the PDSCH signal/reception based on the at least one TCI state by receiving the PDSCH signal/reception in response to receiving the second DCI via the CORESET monitored based on the at least one TCI state. The wireless device may monitor the CORESET based on the at least two TCI states. The at least one TCI state may be the first TCI state of the at least two TCI states of the CORESET in response to the wireless device receiving the DCI via the CORESET monitored based on the at least two TCI states. One or more configuration parameters may indicate joint downlink and uplink TCI states. The at least one TCI state may be the first TCI state in response to the wireless device receiving the second DCI via a common search space (CSS) set of the CORESET. The at least one TCI state may be the first TCI state in response to the one or more configuration parameters not indicating a single frequency network (SFN) for PDSCH receptions. The wireless device may comprise one or more processors and memory, storing instructions, that when executed by the one or more processors perform the method described herein. A system may comprise the wireless device configured to perform the described method, additional operations, and/or include the additional elements; and a base station configured to transmit the one or more configuration parameters, DCI, and/or a PDSCH signal/reception. A computer-readable medium may store instructions that, when executed, cause performance of the described method, additional operations, and/or include additional elements. A base station may perform a corresponding method comprising multiple operations. The base station may perform a corresponding method, for example, by transmitting the one or more configuration parameters, DCI, and/or a PDSCH signal/reception.

One or more of the operations described herein may be conditional. For example, one or more operations may be performed if certain criteria are met, such as in a wireless device, a base station, a radio environment, a network, a combination of the above, and/or the like. Example criteria may be based on one or more conditions such as wireless device and/or network node configurations, traffic load, initial system set up, packet sizes, traffic characteristics, a combination of the above, and/or the like. If the one or more criteria are met, various examples may be used. It may be possible to implement any portion of the examples described herein in any order and based on any condition.

A base station may communicate with one or more of wireless devices. Wireless devices and/or base stations may support multiple technologies, and/or multiple releases of the same technology. Wireless devices may have some specific capability(ies) depending on wireless device category and/or capability(ies). A base station may comprise multiple sectors, cells, and/or portions of transmission entities. A base station communicating with a plurality of wireless devices may refer to a base station communicating with a subset of the total wireless devices in a coverage area. Wireless devices referred to herein may correspond to a plurality of wireless devices compatible with a given LTE, 5G, or other 3GPP or non-3GPP release with a given capability and in a given sector of a base station. A plurality of wireless devices may refer to a selected plurality of wireless devices, a subset of total wireless devices in a coverage area, and/or any group of wireless devices. Such devices may operate, function, and/or perform based on or according to drawings and/or descriptions herein, and/or the like. There may be a plurality of base stations and/or a plurality of wireless devices in a coverage area that may not comply with the disclosed methods, for example, because those wireless devices and/or base stations may perform based on older releases of LTE, 5G, or other 3GPP or non-3GPP technology.

One or more parameters, fields, and/or Information elements (IEs), may comprise one or more information objects, values, and/or any other information. An information object may comprise one or more other objects. At least some (or all) parameters, fields, IEs, and/or the like may be used and can be interchangeable depending on the context. If a meaning or definition is given, such meaning or definition controls.

One or more elements in examples described herein may be implemented as modules. A module may be an element that performs a defined function and/or that has a defined interface to other elements. The modules may be implemented in hardware, software in combination with hardware, firmware, wetware (e.g., hardware with a biological element) or a combination thereof, all of which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. Additionally or alternatively, it may be possible to implement modules using physical hardware that incorporates discrete or programmable analog, digital and/or quantum hardware. Examples of programmable hardware may comprise: computers, microcontrollers, microprocessors, application-specific integrated circuits (ASICs); field programmable gate arrays (FPGAs); and/or complex programmable logic devices (CPLDs). Computers, microcontrollers and/or microprocessors may be programmed using languages such as assembly, C, C++ or the like. FPGAs, ASICs and CPLDs are often programmed using hardware description languages (HDL), such as VHSIC hardware description language (VHDL) or Verilog, which may configure connections between internal hardware modules with lesser functionality on a programmable device. The above-mentioned technologies may be used in combination to achieve the result of a functional module.

One or more features described herein may be implemented in a computer-usable data and/or computer-executable instructions, such as in one or more program modules, executed by one or more computers or other devices. Generally, program modules include routines, programs, objects, components, data structures, etc. that perform particular tasks or implement particular abstract data types when executed by a processor in a computer or other data processing device. The computer executable instructions may be stored on one or more computer readable media such as a hard disk, optical disk, removable storage media, solid state memory, RAM, etc. The functionality of the program modules may be combined or distributed as desired. The functionality may be implemented in whole or in part in firmware or hardware equivalents such as integrated circuits, field programmable gate arrays (FPGA), and the like. Particular data structures may be used to more effectively implement one or more features described herein, and such data structures are contemplated within the scope of computer executable instructions and computer-usable data described herein.

A non-transitory tangible computer readable media may comprise instructions executable by one or more processors configured to cause operations of multi-carrier communications described herein. An article of manufacture may comprise a non-transitory tangible computer readable machine-accessible medium having instructions encoded thereon for enabling programmable hardware to cause a device (e.g., a wireless device, wireless communicator, a wireless device, a base station, and the like) to allow operation of multi-carrier communications described herein. The device, or one or more devices such as in a system, may include one or more processors, memory, interfaces, and/or the like. Other examples may comprise communication networks comprising devices such as base stations, wireless devices or user equipment (wireless device), servers, switches, antennas, and/or the like. A network may comprise any wireless technology, including but not limited to, cellular, wireless, WiFi, 4G, 5G, any generation of 3GPP or other cellular standard or recommendation, any non-3GPP network, wireless local area networks, wireless personal area networks, wireless ad hoc networks, wireless metropolitan area networks, wireless wide area networks, global area networks, satellite networks, space networks, and any other network using wireless communications. Any device (e.g., a wireless device, a base station, or any other device) or combination of devices may be used to perform any combination of one or more of steps described herein, including, for example, any complementary step or steps of one or more of the above steps.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the descriptions herein. Accordingly, the foregoing description is by way of example only, and is not limiting.

What is claimed is:

1. A method comprising:
receiving, by a wireless device, a first message comprising:
a first field indicating at least one physical uplink control channel (PUCCH) resource; and
a second field indicating a unified transmission configuration indicator (TCI) state index associated with the at least one PUCCH resource;
receiving a second message indicating activation of at least two TCI states of a plurality of TCI states; and
transmitting, via the at least one PUCCH resource and based on one or more TCI states, of the at least two TCI states, being indicated by the unified TCI state index, an uplink signal.

2. The method of claim 1, wherein the first message comprises a radio resource control (RRC) message, and wherein the second message comprises at least one of a media access control (MAC)-control element (CE) or downlink control information (DCI).

3. The method of claim 1, wherein the first message indicates the at least one PUCCH resource by indicating at least one PUCCH resource group comprising the at least one PUCCH resource.

4. The method of claim 1, wherein the transmitting the uplink signal based on the one or more TCI states, of the at least two TCI states, being indicated by the unified TCI state index comprises transmitting the uplink signal using at least one of:
an uplink transmission power associated with the one or more TCI states, of the at least two TCI states, being indicated by the unified TCI state index;
a spatial transmission filter associated with the one or more TCI states, of the at least two TCI states, being indicated by the unified TCI state index; or
a transmission precoder associated with the one or more TCI states, of the at least two TCI states, being indicated by the unified TCI state index.

5. The method of claim 1, wherein the transmitting the uplink signal comprises one of:
transmitting the uplink signal using at least one resource based on a first unified TCI state of the one or more TCI states, wherein the second field indicates a first value;
transmitting the uplink signal using at least one resource based on a second unified TCI state of the one or more TCI states, wherein the second field indicates the second value; or
transmitting the uplink signal using at least one resource based on the first unified TCI state and using at least one resource based on the second unified TCI state, wherein the second field indicates a third value that is different from the first value and that is different from the second value.

6. The method of claim 1, further comprising receiving an indication of a TCI codepoint associated with the at least two TCI states.

7. A method comprising:
receiving, by a wireless device one or more messages, wherein the one or more messages indicate:
activation of at least two TCI states of a plurality of TCI states;
at least one physical uplink control channel (PUCCH) resource; and
a unified transmission configuration indicator (TCI) state index associated with the at least one PUCCH resource and indicating one or more TCI states of the at least two TCI states of the plurality of TCI states; and
transmitting, via the at least one PUCCH resource and based on the one or more TCI states indicated by the unified TCI state index, an uplink signal.

8. The method of claim 7, wherein the one or more messages comprises:
a first message indicating the at least one PUCCH resource and the unified TCI state index associated with the at least one PUCCH resource, wherein the first message comprises a radio resource control (RRC) message; and
a second message indicating the activation of the at least two TCI states of the plurality of TCI states, wherein the second message comprises at least one of a media access control (MAC)-control element (CE) or downlink control information (DCI).

9. The method of claim 7, wherein the one or more messages indicate the at least one PUCCH resource by indicating at least one PUCCH resource group comprising the at least one PUCCH resource.

10. The method of claim 7, wherein the transmitting the uplink signal based on the one or more TCI states, of the at least two TCI states, being indicated by the unified TCI state index comprises transmitting the uplink signal using at least one of:
an uplink transmission power associated with the one or more TCI states, of the at least two TCI states, being indicated by the unified TCI state index;
a spatial transmission filter associated with the one or more TCI states, of the at least two TCI states, being indicated by the unified TCI state index; or
a transmission precoder associated with the one or more TCI states, of the at least two TCI states, being indicated by the unified TCI state index.

11. The method of claim 7, wherein the transmitting the uplink signal comprises one of:
transmitting the uplink signal using at least one resource based on a first unified TCI state of the one or more TCI states, wherein the unified TCI state index indicates the first value;
transmitting the uplink signal using at least one resource based on a second unified TCI state of the one or more TCI states, wherein the unified TCI state index indicates the second value; or
transmitting the uplink signal using at least one resource based on the first unified TCI state and using at least one resource based on the second unified TCI state, wherein the unified TCI state index indicates a third value that is different from the first value and that is different from the second value.

12. The method of claim 7, further comprising receiving an indication of a TCI codepoint associated with the at least two TCI states.

13. The method of claim 7, wherein the unified TCI state index indicates the one or more TCI states by indicating one of:
a first value associated with a first TCI state of the at least two TCI states;
a second value associated with a second TCI state of the at least two TCI states; or
a third value associated with both the first TCI state and the second TCI state of the at least two TCI states.

14. A method comprising:
transmitting, by a base station one or more messages, wherein the one or more messages indicate:
activation of at least two TCI states of a plurality of TCI states;
at least one physical uplink control channel (PUCCH) resource; and
a unified transmission configuration indicator (TCI) state index associated with the at least one PUCCH resource and indicating one or more TCI states of the at least two TCI states of the plurality of TCI states; and
receiving, via the at least one PUCCH resource and based on the one or more TCI states indicated by the unified TCI state index, an uplink signal.

15. The method of claim 14, wherein the one or more messages comprises:
a first message indicating the at least one PUCCH resource and the unified TCI state index associated with the at least one PUCCH resource, wherein the first message comprises a radio resource control (RRC) message; and
a second message indicating the activation of the at least two TCI states of the plurality of TCI states, wherein the second message comprises at least one of a media access control (MAC)-control element (CE) or downlink control information (DCI).

16. The method of claim 14, wherein the one or more messages indicate the at least one PUCCH resource by indicating at least one PUCCH resource group comprising the at least one PUCCH resource.

17. The method of claim 14, wherein the receiving the uplink signal based on the one or more TCI states, of the at least two TCI states, being indicated by the unified TCI state index comprises receiving the uplink signal using a spatial filter associated with the one or more TCI states, of the at least two TCI states, being indicated by the unified TCI state index.

18. The method of claim 14, wherein the receiving the uplink signal comprises one of:
receiving the uplink signal using at least one resource based on a first unified TCI state of the one or more TCI states, wherein the unified TCI state index indicates the first value;
receiving the uplink signal using at least one resource based on a second unified TCI state of the one or more TCI states, wherein the unified TCI state index indicates the second value; or
receiving the uplink signal using at least one resource based on the first unified TCI state and using at least one resource based on the second unified TCI state, wherein the unified TCI state index indicates a third value that different from the first value and that is different from the second value.

19. The method of claim 14, further comprising transmitting an indication of a TCI codepoint associated with the at least two TCI states.

20. The method of claim 14, wherein the unified TCI state index indicates the one or more TCI states by indicating one of:
a first value associated with a first TCI state of the at least two TCI states;
a second value associated with a second TCI state of the at least two TCI states; or
a third value associated with both the first TCI state and the second TCI state of the at least two TCI states.
